(19) United States
(12) Patent Application Publication
(10) Pub. No.: US 2013/0269735 A1
(43) Pub. Date: Oct. 17, 2013

(54) System and method for treating a contaminated substrate

(71) Applicant: Green Oilfield Environmental Services, Inc., Newport, AR (US)

(72) Inventors: Gary Wade Roetzel, Searcy, AR (US); Gregory Lynn Bell, Judsonia, AR (US); David M. Pitts, Knoxville, TN (US); Rodney K. Breuer, Roland, AR (US); Donald Wayne Kite, Texarkana, AR (US)

(73) Assignee: Green Oilfield Environmental Services, Inc.

(21) Appl. No.: 13/694,732

(22) Filed: Dec. 28, 2012

Related U.S. Application Data
(60) Provisional application No. 61/631,223, filed on Dec. 29, 2011.

(51) Int. Cl. B08B 3/10

(52) U.S. Cl. CPC B08B 3/102
USPC 134/40; 134/184

(57) ABSTRACT

A method and apparatus is disclosed for treating and processing an oil, water or oil and water-contaminated substrate such as oil field waste. The substrate may be pretreated with water and/or surfactant and may be mixed under low shear conditions with a base such as a compound containing alkaline earth or lime and an optional catalyst. Mixing the substrate with the base creates a heat. Next, the substrate may be mixed with an acid such as sulfuric acid. As the substrate is mixed, it causes an exothermic reaction with a heat that vaporizes the oil, reaction products and water. Recoverable constituents in the vapor can be condensed in a vapor collection system. The treated substrate may be essentially free of oil and has a controlled water content and pH that can be adjusted according to the use of the end dry product.

### CROSS-REFERENCE TO RELATED APPLICATIONS

This application claims benefit of U.S. provisional patent application Ser. No. 61/631,223, filed Dec. 29, 2011 and having the title “System and Method for Treating a Contaminated Substrate,” and is herein incorporated by reference. This application further claims benefit of PCT Patent application (serial number PCT/US12/00589) filed on Dec. 28, 2012 entitled “System and Method for Treating a Contaminated Substrate,” and is also incorporated by reference.

### BACKGROUND OF THE INVENTION

1. Field of the Invention

Embodiments generally relate to treatment of a contaminated substrate.

2. Description of the Related Art

To recover hydrocarbons and/or water, wellbores are drilled into the earth using drill bits. The drill bit may be located at an end of a drill string or on casing for a wellbore. Oil well drilling typically requires a drilling fluid or drilling mud to perform purposes such as cooling and lubricating the drill bit, forming a filter cake for temporarily casing the wellbore, carrying the drill cuttings (pieces of material cut by the drill bit) to the surface of the wellbore, and preventing blowout of wellbore fluids.

The drilling fluid or drilling mud is typically injected into a first end of the drill string through an inner diameter of the drill string or casing which is drilling the wellbore. The drilling fluid then flows through the inner diameter of the drill string or casing, through or around the drill bit, and around an annulus formed by the outer diameter of the drill string or casing and an inner diameter of the wellbore to the surface. At the surface, the drilling fluid or drilling mud is separated from the drill cuttings. The drilling fluid or drilling mud may then be recycled or re-used, and the drill cuttings may be disposed of such as in landfills.

Prior to disposing of the drill cuttings, environmental standards require that only a small percentage of oil remain in the drill cuttings prior to their disposal. Without removal of the required percentage of oil from the drill cuttings, the drill cuttings may be considered hazardous waste.

One method for removing oil is chemical desorption, for example as disclosed in U.S. Pat. Nos. 6,978,851, 6,668,947, 6,978,851 B2, 7,481,878 B1, and 7,690,445 B2 to Perez-Cordova. This process disclosed in the Perez-Cordova patents is a continuous process, requires constant supervision, requires many people to operate and constantly adjust the process, does not permit recovery of a product with less than 4 percent of oil, and discharges a large amount of hydrocarbons into the air.

Therefore, there is a need for a system and method for effectively and efficiently removing oil from drill cuttings.

There is also a need for a system and method for effectively and efficiently removing a liquid component such as water or oil (or other hydrocarbons) from a substrate.

### SUMMARY OF THE INVENTION

Embodiments disclosed herein generally provide a system and method for removing a liquid (e.g., oil, hydrocarbons, and/or water) from a substrate to produce a generally dry substance. Embodiments may generally relate to the treatment of an oil-contaminated, water-contaminated, or oil/water mixture-contaminated substrate. Some embodiments disclosed herein provide a system and method for removing oil from drilling cuttings to result in drill cuttings which are essentially oil-free.

Some embodiments generally include a method for removing oil from an oil-contaminated substrate, comprising mixing the oil-contaminated substrate with an alkaline metal oxide to create a mixture and a first reaction; and mixing a mineral acid with the mixture in an amount effective to generate an exothermic reaction to vaporize the oil and reaction products thereof, thereby removing oil from the oil-contaminated substrate to produce a solid reaction product with reduced oil content.

Some embodiments generally include a system for removing oil from an oil-contaminated substrate, comprising a mixer comprising an enclosure having an internal chamber therein; two or more shafts in the internal chamber rotatable in opposite directions from one another, each shaft having one or more paddles operatively attached thereto; and an upper chamber of the internal chamber disposed above the two or more shafts capable of allowing a reaction between components disposed in the internal chamber to occur therein upon manipulation of the components by the paddles upon rotation of the shafts, wherein the mixer is sealable to operate at a positive pressure.

Some embodiments generally include a method for removing oil from an oil-contaminated substrate, comprising mixing the oil-contaminated substrate with a base to create a mixture and a first reaction, the base comprising a compound including an alkaline earth; and mixing a mineral acid with the mixture in an amount effective to generate an exothermic reaction to vaporize the oil and reaction products thereof, thereby removing oil from the oil-contaminated substrate to produce a solid reaction product with reduced oil content.

### BRIEF DESCRIPTION OF THE DRAWINGS

So that the manner in which the above recited features of embodiments can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a process flow diagram showing a first embodiment of a system for removing a liquid from a substrate.

FIG. 1A is a process flow diagram showing a second embodiment of a process and system for removing a liquid from a substrate.

FIG. 2A is a first side view of a portion of the system for removing a liquid from a substrate of FIG. 1.

FIG. 2B is a second side view of the portion of the system of FIG. 1, taken from a side opposite from that of FIG. 2A.

FIG. 2C is a top view of the portion of the system of FIG. 2A.

FIG. 2D is an isolated view of an emergency stop bracket from the system of FIG. 2A.

FIG. 2E is an isolated view of an interlock box bracket on the mixer assembly of FIG. 2B.

FIG. 3A is a first side top and perspective view of a portion of the system for removing a liquid from a substrate of FIG. 1.

FIG. 3B is a second side top and perspective view of the portion of the system of FIG. 3A, taken from a side opposite that of FIG. 3A.

FIG. 3C is a top view of mounting baseplates for the system of FIG. 3A, including Foundation Plate A (the mixer and screws mounting baseplate) and Foundation Plate C (the shaker support mounting baseplate).

FIG. 3D is a top view of mounting baseplates for the system of FIG. 3A, including Foundation Plate B (the receiving hopper and screws mounting baseplate).

FIG. 4A is a side view of a portion of the system for removing a liquid from a substrate of FIG. 1.

FIG. 4B is an end view of the portion of the system of FIG. 4A.

FIG. 4C is a top view of the portion of the system of FIG. 4A.

FIG. 5A1 is a top view of a mixer skid assembly of the system for removing a liquid from a substrate of FIG. 1.

FIG. 5A2 is a side view of the mixer skid assembly of FIG. 5A1.

FIG. 5A3 is an end view of the mixer skid assembly of FIG. 5A1.

FIG. 5B1 is a top view of a batcher assembly of the system for removing liquid from a substrate of FIG. 1.

FIG. 5B2 is a side view of the batcher assembly of FIG. 5B1.

FIG. 5B3 is an end view of the batcher assembly of FIG. 5B1.

FIG. 5C1 is a top view of a silo of the system for removing a liquid from a substrate of FIG. 1.

FIG. 5C2 is a side view of the silo of FIG. 5C1.

FIG. 5C3 is an end view of the silo of FIG. 5C1.

FIG. 5D1 is a top view of an upper shaker skid assembly of the system for removing a liquid from a substrate of FIG. 1.

FIG. 5D2 is an end view of the upper shaker skid assembly of FIG. 5D1.

FIG. 5D3 is a side view of the upper shaker skid assembly of FIG. 5D1.

FIG. 5E1 is a top view of a lower shaker skid assembly of the system for removing a liquid from a substrate of FIG. 1.

FIG. 5E2 is an end view of the lower shaker skid assembly of FIG. 5E1.

FIG. 5E3 is side view of the lower shaker skid assembly of FIG. 5E1.

FIG. 5F1 is a top view of a mixer charge screw/hopper assembly of the system for removing a liquid from a substrate of FIG. 1.

FIG. 5F2 is an end view of the mixer charge screw/hopper assembly of FIG. 5F1.

FIG. 5F3 is a side view of the mixer charge screw/hopper assembly of FIG. 5F1.

FIG. 5G1 is a top view of a receiving hopper skid assembly of the system for removing a liquid from a substrate of FIG. 1.

FIG. 5G2 is a side view of the receiving hopper skid assembly of FIG. 5G1.

FIG. 5G3 is an end view of the receiving hopper skid assembly of FIG. 5G1.

FIG. 6 shows an embodiment of a pump and water meter assembly for pumping and metering the water (and/or surfactant) into the mixer of the system for removing a liquid from a substrate of FIG. 1.

FIG. 7A is a side view of an embodiment of a pump and acid meter assembly for pumping and metering the acid into the mixer of the system for removing a liquid from a substrate of FIG. 1.

FIG. 7B is an end view of the pump and acid meter assembly of FIG. 7A.

FIG. 7C is a section view of a portion of the pump and acid meter assembly of FIG. 7A.

FIG. 8A is a top view of a batcher assembly of the system for removing a liquid from a substrate of FIG. 1.

FIG. 8B is a side view of the batcher assembly of FIG. 8A.

FIG. 8C is an end view of the batcher assembly of FIG. 8A.

FIG. 9 shows a side view of additional components of a shale shaker, including a shaker chute assembly.

FIG. 10 is a top perspective view of a three-mixer system which may be included with the system for removing a liquid from a substrate of FIG. 1.

FIG. 11A is a top view of a mixer feed screw and hopper assembly of the system for removing a liquid from a substrate of FIG. 1.

FIG. 11B is a side view of the mixer feed screw and hopper assembly of FIG. 11A.

FIG. 11C is a top perspective view of the mixer feed screw and hopper assembly of FIG. 11A.

FIG. 11D is an end view of the mixer feed screw and hopper assembly of FIG. 11A.

FIG. 11E is a section view of FIG. 11B.

FIG. 12A is a top view of an embodiment of a mixer discharge screw assembly and its associated components for use with the mixer for removing a liquid from a substrate of FIG. 1.

FIG. 12B is a side view of the mixer discharge screw assembly of FIG. 12A and its associated components.

FIG. 12C is an end view of the mixer discharge screw assembly of FIG. 12A and its associated components.

FIG. 12D is a section view of a screw support of the mixer discharge screw assembly FIG. 12B.

FIG. 12E is a first section view of the screw support of FIG. 12B.

FIG. 12F is a second section view of the screw support of FIG. 12B.

FIG. 13 is a diagram of an air piping assembly for the mixer of FIG. 1.

FIG. 14A is a top view of a mixer cover assembly or mixer lid assembly which may be used with the mixer of FIG. 1.

FIG. 14B is a side view of the mixer cover assembly or mixer lid assembly of FIG. 14A.

FIG. 14C is a bottom view of the mixer cover assembly or mixer lid assembly of FIG. 14A.

FIG. 15A is a side view of a mixer discharge door assembly for use with the mixer of FIG. 1.

FIG. 15B is a section view through line A-A of the mixer discharge door assembly of FIG. 15A.

FIG. 16A is a cross sectional view of a portion of the mixer of FIG. 1.

FIG. 16B is section view through line FIG. 16B-16B of FIG. 16A.

FIG. 16C is a section view through line FIG. 16C-FIG. 16C of FIG. 16A.

FIG. 17A is a front view of a mixer and load cell assembly of the system for removing a liquid from a substrate of FIG. 1.

FIG. 17B is a top view of the mixer and load cell assembly of FIG. 17A.

FIG. 17C is an enlarged view of a portion of the mixer and load cell assembly of FIG. 17A.

FIG. 17D is a still further enlarged view of the portion of the mixer and load cell assembly of FIG. 17C.

FIG. 17E is an end view of the portion of the mixer and load cell assembly of FIG. 17A.

FIG. 18A is a top view of the mixer of FIG. 1 and its bottom cleanout door assemblies.

FIG. 18B is an end view of the mixer of FIG. 18A.

FIG. 18C is a cross-sectional view taken through line FIG. 18A-FIG. 18A of FIG. 18B.

FIG. 18D is a side view of the mixer of FIG. 18A.

FIG. 18E is a cross-sectional view of the mixer of FIG. 18A.

FIG. 19A is a top perspective view of a main shaft assembly (right hand drive) of the mixer of FIG. 13.

FIG. 19B is a side view of the main shaft assembly (right hand drive) of FIG. 19A.

FIG. 20A is a side view of a main shaft left hand assembly of the mixer of FIG. 1 as viewed from the drive side of the mixer.

FIG. 20B is a top view of the main shaft left hand assembly of FIG. 20A.

FIG. 20C is an end view of the main shaft left hand assembly of FIG. 20A.

FIG. 20D is a side view of a main shaft right hand assembly of the mixer of FIG. 1 as viewed from the drive side of the mixer.

FIG. 20E is a top view of the main shaft right hand assembly of FIG. 20D.

FIG. 20F is an end view of the main shaft right hand assembly of FIG. 20D.

FIG. 21A is a section view of a liner assembly and timeshaft of the mixer of FIG. 1.

FIG. 21B is a section view taken through line FIG. 21B-FIG. 21B of FIG. 21A.

FIG. 21C is a section view through line FIG. 21C-FIG. 21C of FIG. 21A.

FIG. 21D is a section view of a portion of the liner assembly of FIG. 21C.

FIG. 21E is a section view of another portion of the liner assembly of FIG. 21C.

FIG. 22A is a top view of the mixer of FIG. 1.

FIG. 22B is a side view of the mixer of FIG. 22A.

FIG. 22C is an end view of the mixer of FIG. 22A.

FIG. 23 is a perspective view of a front side of the mixer which may be a part of the system of FIG. 1.

FIG. 24 is a perspective view of a back side of the mixer of FIG. 1, taken opposite the view of FIG. 23.

FIG. 25 is a back side perspective view of a portion of the mixer of FIG. 23.

FIG. 26 is a back side perspective view of a portion of the mixer of FIG. 23, taken opposite the view of FIG. 25.

FIG. 27 is a perspective view of an inside portion of the mixer of FIG. 23.

FIG. 28 is a perspective view of an electrical portion of the mixer of FIG. 23.

FIG. 29 is an end perspective view of a portion of the mixer of FIG. 23.

FIG. 30 is another perspective view of a portion of the mixer of FIG. 23.

FIG. 31 is a flow diagram of a method for substrate treatment and gas cleaning and oil (or other liquid in the substrate feed) recovery, as may be performed using the system of FIG. 1.

FIG. 32 is a flow diagram showing treatment options for dirty oil/water from a sludge tank in the method of FIG. 31.

FIG. 33 is a flow diagram showing treatment options for substrate in the method of FIG. 31.

FIG. 34 is a flow diagram showing options for handling gray water in the method of FIG. 31.

FIG. 35 is a flow diagram of a system for removing a liquid component from a feed material or substrate, in one embodiment.

FIG. 36 is a flow diagram of a gas collection and recovery system which may be included in the system of FIG. 35.

FIG. 36A shows an embodiment of a Venturi scrubber.

FIG. 37 is a side view of a portion of the system of FIG. 35 showing a mixer and components introduced into the mixer.

FIG. 38 is a top view of the mixer of FIG. 37.

FIG. 39 is a top view of portions of the system of FIG. 35.

FIG. 40 is a flow diagram of possible inlet and outlet streams into and out from a gray water tank of the system of FIG. 35.

FIG. 41 is a flow diagram showing a method for removing a liquid component from a substrate or feed material and a gas/vapor collection and condensation system.

FIGS. 42A, 42B, 42C, and 42D show illustrative tables for values associated with a Mixer Operator Interface, Resulting ChemCad Calculated Input Values to PLC, PLC Calculations from Above Inputs, and Other Calculations.

FIGS. 43A, 43B, and 43C show an example Table of ChemCad Simulation Results which may be in the form of a spreadsheet and may be based on the example values in FIGS. 42A-42D.

FIG. 44 is a table showing reagent calculations.

FIG. 45 is an example CaO usage graph obtained using the values in FIGS. 42A-42D, 43A-43C, and 44.

FIG. 46 is an example 93% H₂SO₄ usage graph obtained using the values in FIGS. 42A-42D, 43A-43C, and 44.

FIG. 47 is an example sludge feed pound per batch graph obtained using the values in FIGS. 42A-42D, 43A-43C, and 44.

FIG. 48 shows a computer display of embodiments of the system and method which displays input and calculated parameters of the system and method.

FIG. 49 shows a computer display of embodiments of the system and method which shows information from the computer processor and from various points in the system.

FIGS. 50A, 50B, 50C, and 50D show a first embodiment of a block flow diagram of the system of FIG. 1 with mass and heat balance summary in an example of embodiments.

FIGS. 51A, 51B, and 51C show a second embodiment of a block flow diagram of the system with mass and heat balance summary in an example of embodiments.

FIGS. 52A-1, 52A-2, 52B-1, 52B-2, 52C-1, and 52C-2 are a table showing some of the equipment and inlet and outlet stream exemplary parameter values in a scrubber and oil recovery system and method of embodiments. FIGS. 52A-1 and 52A-2 cooperate together side-by-side as columns of the same table, FIGS. 52B-1 and 52B-2 cooperate together side-by-side as columns of the same table, and FIGS. 52C-1 and 52C-2 cooperate together side-by-side as columns of the same table.

FIG. 53 is a side perspective view of a Venturi which may be included in the system of FIG. 1

FIG. 54 is a first top perspective view of the Venturi of FIG. 53.

FIG. 55 is second top perspective view of the Venturi of FIG. 53.

FIG. 56 is a flow diagram illustrating how an embodiment of the control system determines required weight percents of components to feed into the mixer of the system of FIG. 1.

FIG. 57 is a perspective view of an embodiment of a control panel of as may be used with the system of FIG. 1.

FIG. 58 is a section view of the control panel of FIG. 57.

FIG. 59 is a top perspective view of the system of FIG. 1.

FIG. 60 is a perspective view of the system of FIG. 59, taken from an opposite side.

FIG. 61 is another perspective view of the system of FIG. 59, taken from an end.

FIG. 62 is still another perspective view of the system of FIG. 59, taken from an end opposite that of FIG. 61.

FIG. 63A is a top view of an embodiment of a shale shaker and associated components of the system of FIG. 1, including a cuttings dryer.

FIG. 63B is a side view of the shale shaker and associated components of FIG. 63A.

FIG. 63C is a side view of the shale shaker and associated components of FIG. 63A.

FIG. 64A is a top view of an embodiment of one or more silos connected to the system of FIG. 1.

FIG. 64B is a side view of one of the silos of FIG. 64A connected to the system.

FIG. 64C is a section view of details of the electrical box of the silos of FIGS. 64A and 64B.

FIG. 64D is a section view of a portion of the silo of FIG. 64B.

FIG. 64E is a section view of the screw support of the silos of FIGS. 64A and 64B.

FIG. 65 is a perspective view of the skid plant air piping usable in the system of FIG. 1.

FIG. 66A is a perspective view of an air piping system, including air piping cement and water batcher/meter, usable in the system of FIG. 1.

FIG. 66B is a side view of an air piping assembly, including air piping cement and water batcher/meter, of the left hand drive paddle mixer for right hand drive paddle mixer mount, with inlet on right side and outlet to mixer on left side.

FIG. 66C is another side view of an air piping assembly, including air piping cement (2) and water batcher/meter, of a left hand drive paddle mixer for right hand drive paddle mixer mount, inlet on right side and outlet to mixer on left side.

FIG. 66D is another side view of an air piping assembly, including air piping cement and no water, left hand drive paddle mixer for right hand drive paddle mixer mount, inlet on right side and outlet to mixer on left side.

FIG. 66E is still another side view of an air piping assembly, air piping cement and no water batcher/meter, left hand drive paddle mixer for right hand drive paddle mixer mount, inlet on right side and outlet to mixer on left.

FIG. 67 is a schematic diagram of a planetary and horizontal shaft mixer interlock station with up to four cover switches and no oil pump.

FIG. 68A is a top view of a charge hopper assembly as may be used in the system for removing a liquid from a substrate of FIG. 1.

FIG. 68B is a side view of the charge hopper assembly of FIG. 68A.

FIG. 68C is an end view of the charge hopper assembly of FIG. 68A.

FIG. 69A is a top view of a receiving hopper skid assembly for holding the charge hopper assembly of FIG. 68A.

FIG. 69B is a side view of the receiving hopper skid assembly of FIG. 69A.

FIG. 69C is an end view of the receiving hopper skid assembly of FIG. 69A.

FIG. 70 is a cross-sectional view of a portion of a mixer discharge door with upper seal which may be included in the system of FIG. 1.

FIG. 71 is a table showing experimental results using the method for removing oil from an oil-contaminated substrate of the present invention, in one illustrative embodiment.

### DETAILED DESCRIPTION

Embodiments include removing a liquid component from a substrate. The liquid component may be water, oil, and/or hydrocarbons, for example. Product resulting from removing the liquid component from the substrate may include a dry substance and the removed liquid component, separated from one another. Generally, the liquid component may be removed by converting it to a gas, converting energy. Water-based mud or oil-based mud may be included in the substrate in some embodiments. Some other substrates may include soap slurries, furniture treatment slurries, paint slurries, etc.

Embodiments may generally relate to the treatment of an oil, water, or oil/water mixture-contaminated substrate. Any industrial slurry that is water or oil-based may be treated using the system and method herein.

The system and method herein may generally include taking bulk material through a chemical desorption process and separating various components from that material. The material may, in some examples, be a water-based or oil-based solid material or slurry. The gas recovery system may be used to separate oil from solids, water from solids, or oil and water from solids.

Embodiments may include a method and apparatus for treating, amending, and processing oil, water or oil and water-contaminated substrates such as oil field waste. The substrate may be pretreated with water and/or surfactant. The substrate may be mixed under low shear conditions with a base such as lime and a catalyst. Mixing may take place in a mixer reactor. In some embodiments, the substrate may be mixed with the base and catalyst at or near the same time, and in some embodiments, the base and catalyst may be premixed together before entering the mixer (reactor). The substrate may be mixed with the base for a few seconds, creating a heat. Next, the substrate is mixed with an acid such as a mineral acid, for example sulfuric acid. Mixing the substrate with the acid causes a reaction and creates a heat that is exothermic that vaporizes the oil, reaction products, and water. In some embodiments, recoverable constituents in the vapor can be condensed in a vapor collection system. The treated substrate may be essentially free of oil, may have controlled water content, and pH can be adjusted according to the use of the end dry product.

Embodiments include an apparatus and method for removing oil, water, or an oil/water mixture from an oil-contaminated (or water-contaminated or oil/water mixture contaminated) substrate. In one embodiment, a first mixture is formed when an oil-contaminated (or water-contaminated or oil/water mixture contaminated) substrate and a base such as an alkaline earth-containing compound or alkaline metal oxide are mixed, a second mixture is formed when the first mixture is mixed with an acid such as a mineral acid which may be a concentrated mineral acid in an amount effective to generate an exotherm to vaporize the oil (or water or oil/water mixture) and reaction products thereof, and a solid reaction product is recovered that is essentially oil-free. The substrate may be added into a mixer first, the base second, and the acid third in one embodiment. In other embodiments, the acid, base, and oil-contaminated (or water-contaminated or oil/water mixture contaminated) substrate are mixed together at or near the same time and a solid reaction product is recovered that is essentially oil-free (or water-free or oil/water mixture free). In other embodiments, a first mixture is formed when an oil-contaminated (or water-contaminated or oil/water mixture contaminated) substrate and an acid such as a mineral acid which may be a concentrated mineral acid are mixed together to obtain an acidified mixture, a second mixture is formed when the first mixture is mixed with a base such as a compound containing alkaline earth or an alkaline metal oxide in an amount effective to generate an exotherm to vaporize the oil and reaction products thereof, and a solid reaction product is recovered that is essentially oil-free (or water-free or oil/water mixture free). In other embodiments, the acid and base and mixed together at a low shear and then subsequently mixed with the oil-contaminated (or water-contaminated or oil/water mixture contaminated) substrate and a solid reaction product is recovered that is essentially oil-free (or water-free or oil/water mixture free). Any of the mixing may be accomplished under low shear conditions.

In some optional embodiments, the system is designed to be portable such that the system components may be supported on either a skid or a trailer having an axle and wheels. In some embodiments, the system and method of embodiments may be highly automated, and in some embodiments, the system and method may be scalable so that additional receiving bins, conveyors, material tanks, reactor bins, mixers, etc. may be added to an existing fluid separation system.

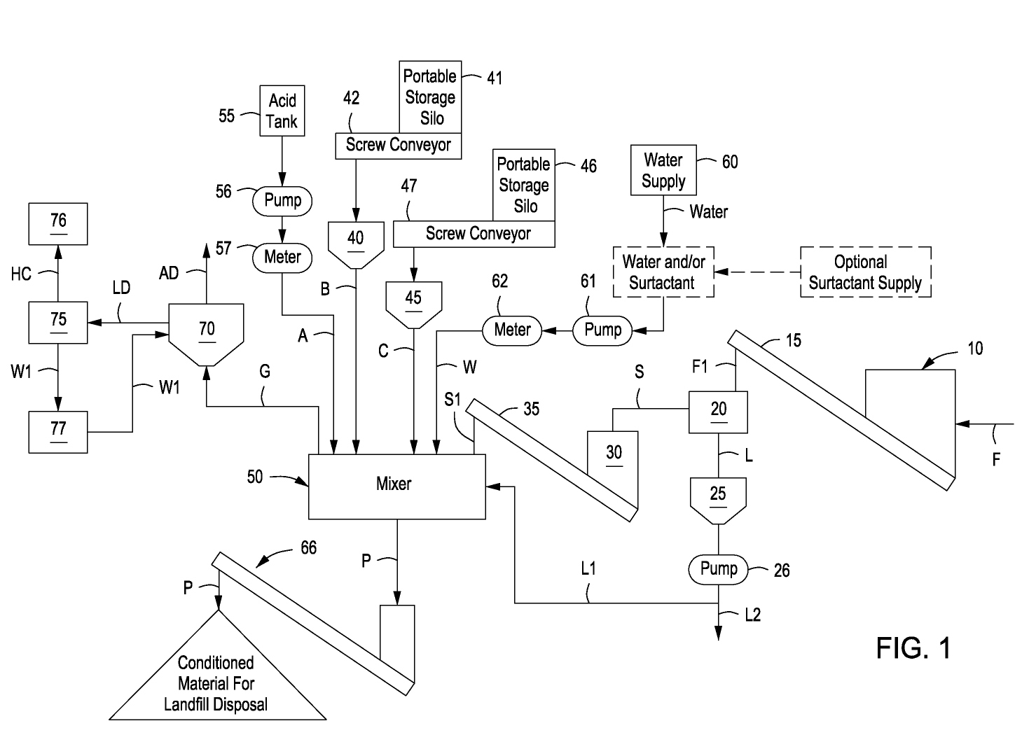

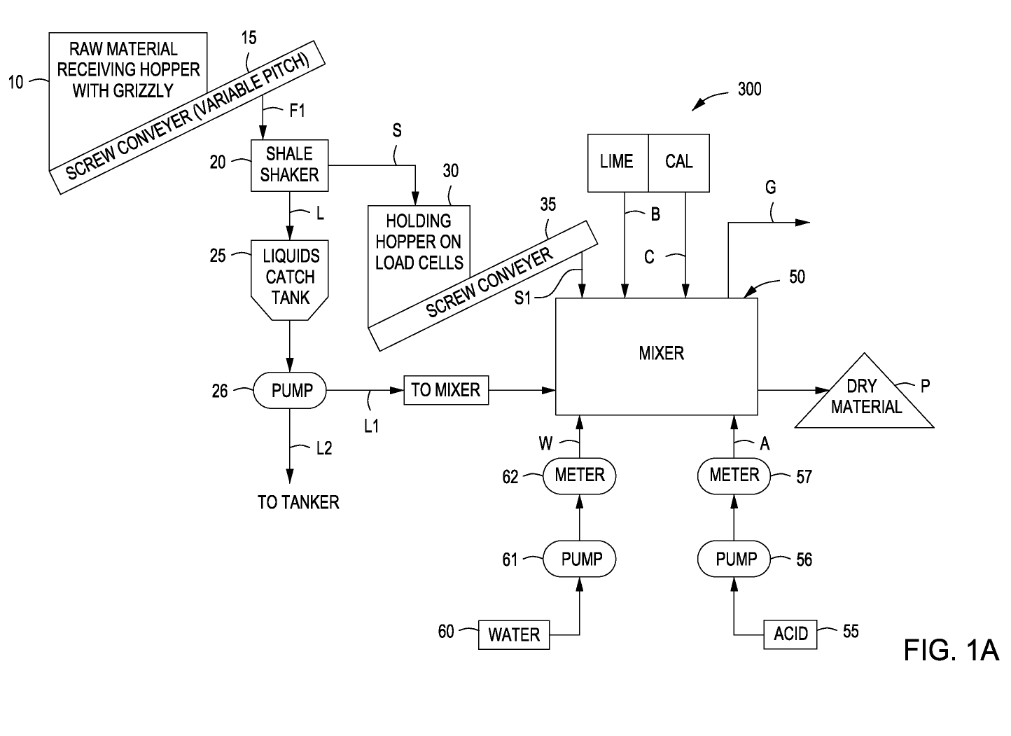

Apparatus, methods, and systems are shown in the attached drawings and described herein. As shown in the process flow diagram of FIG. 1, the system may include a raw material or feed F (e.g., an oil-contaminated substrate such as drill cuttings from oil well drilling operations, or a water-contaminated substrate or oil/water mixture contaminated substrate) receiving hopper 10 (or receiving bin) or other raw material or feed F receiving equipment.

The receiving bin 10 may be a receptacle configured to receive a contaminated substrate. The substrate may comprise chips of shale, sandstone, limestone or other rock matrix that has been broken up by a drill bit in a wellbore drilling process. This substrate may have been carried to the surface by means of a weighted drilling fluid. Accordingly, the substrate may also include bentonite and fine mud particles used as part of a drilling mud. Alternatively, the substrate may represent dirt, sand or other solid material that has settled at the bottom of a vessel or tank as part of a chemical process. In either event, the substrate may be contaminated with condensable hydrocarbons, which may include diesel or other oil as used in an oil-based drilling mud.

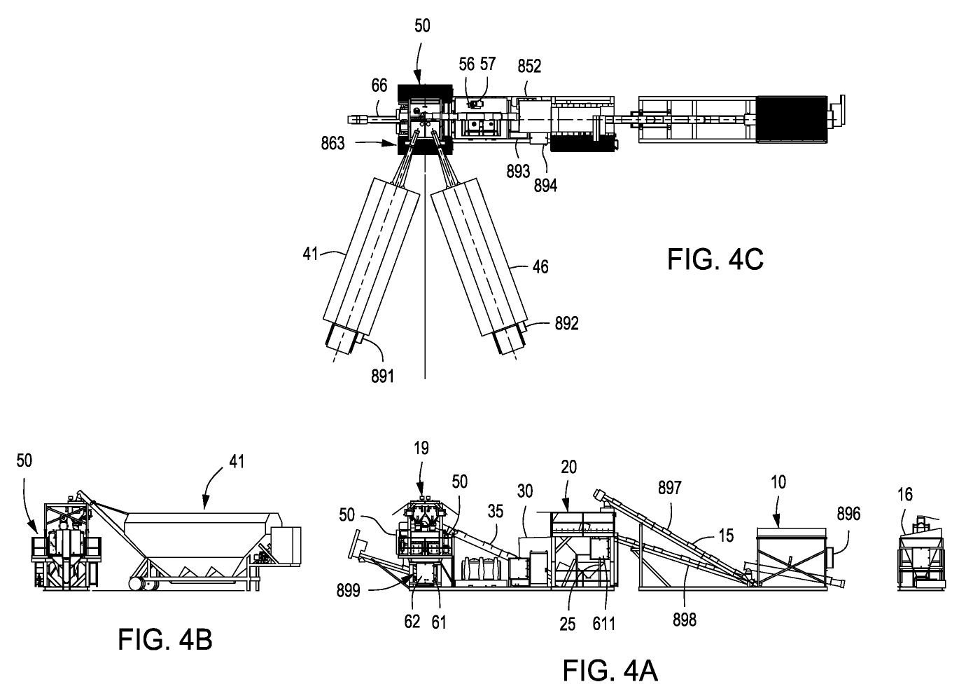

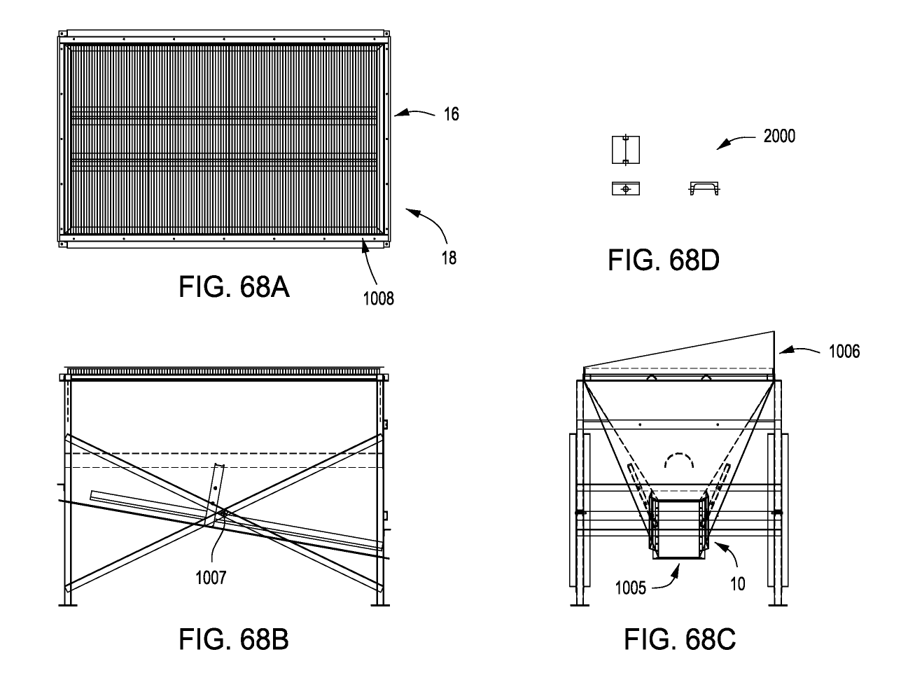

The hopper 10 may optionally include a device such as a grizzly screen 16 (see FIGS. 4A and 78A) or other screen for separating solids from the remainder of the feed F, preventing large solids from entering and jamming the auger. The raw material receiving hopper 10 and/or other hoppers or tanks may also optionally include a device such as a live bottom feeder 18 (see FIGS. 68A-88D and 89A-89C) for continuously, semi-continuously, or intermittently moving the raw material or feed F (or other material in other hoppers or tanks) within the hopper 10 or other hoppers or tanks to prevent its settling and/or sticking on surfaces in the hopper 10 or other hopper or tanks and for keeping the feed mixture (or other material in other hoppers or tanks) homogeneous. Any other method or device for continuously, semi-continuously, or intermittently moving the raw material or feed F within the hopper 10 to prevent its settling and/or sticking on surfaces in the hopper 10 and for keeping the feed F homogeneous may be utilized in lieu of or in addition to the live bottom feeder 18. The live bottom feeder 18 removes the requirement of a person physically unloading the hopper 10 and saves labor costs, increasing efficiency of the system and process. When the system is not in operation, the live bottom feeder(s) 18 may agitate to keep the material in the bottom of the container(s) from firming up and to keep the material in the container(s) homogeneous. One or more augers may be used to provide live bottom feed to the container or other portion of the system and may operate when the system is not in operation.

A first end of a material transporting device 15 such as a conveyor is disposed at or near an exit of the hopper 10 to transport filtered feed F1 exiting the hopper 10 into a liquid/solid separation device 20 for separating liquids and solids from one another. The material transporting device or conveyor 15 gravitationally receives the untreated substrate from the receiving bin 10, such as drilling mud returns. The conveyor 15 may be a screw conveyor, for example. A second end of the conveyor 15 is disposed at or near an inlet to the liquid/solid separation device 20. (In alternate embodiments, the raw material is deposited directly from an outlet of the receiving hopper or other storage unit into the liquid/solid separation device without the need for a conveyor or other material transporting device 15.) The material transporting device 15 may be a variable pitch screw conveyor, auger, or pump (as may the other material transporting devices at other locations in the system). The material transporting device 15 may deliver the untreated substrate to the liquid/solid separation device 20.

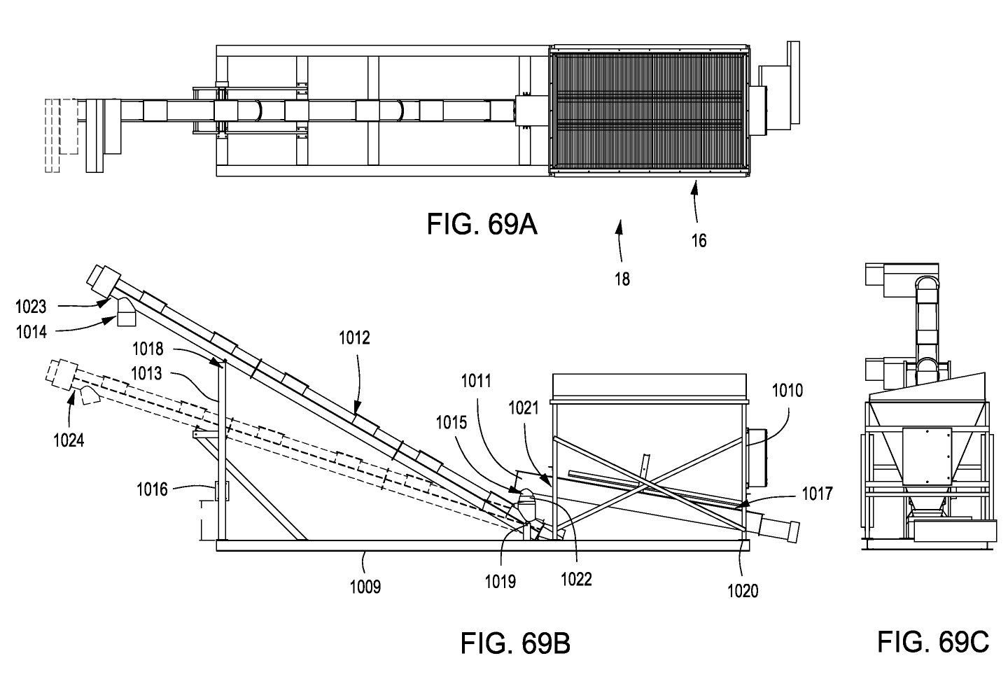

An embodiment of a receiving hopper skid assembly and associated components is shown in FIGS. 4A and 69A. The auger from the receiving hopper 10 may be laid down on the skid for easy transport and quick disconnect and lay down, as shown by the dotted line auger depicted in FIGS. 4C and 69B.

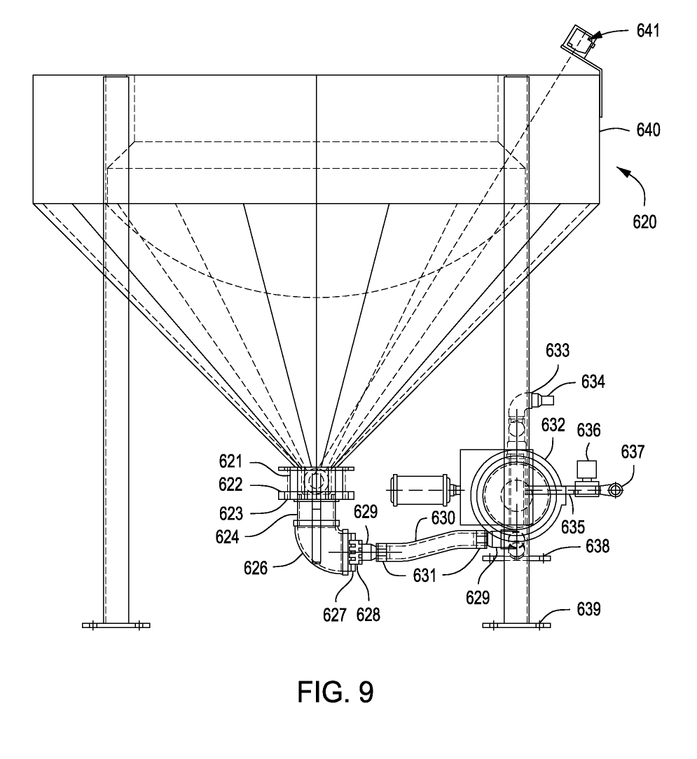

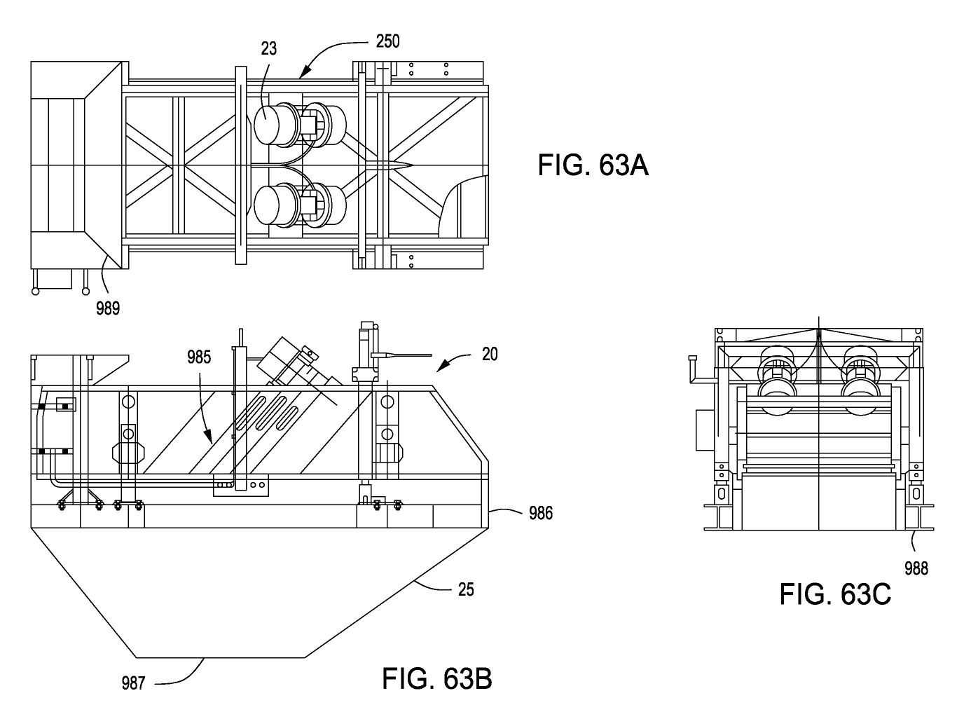

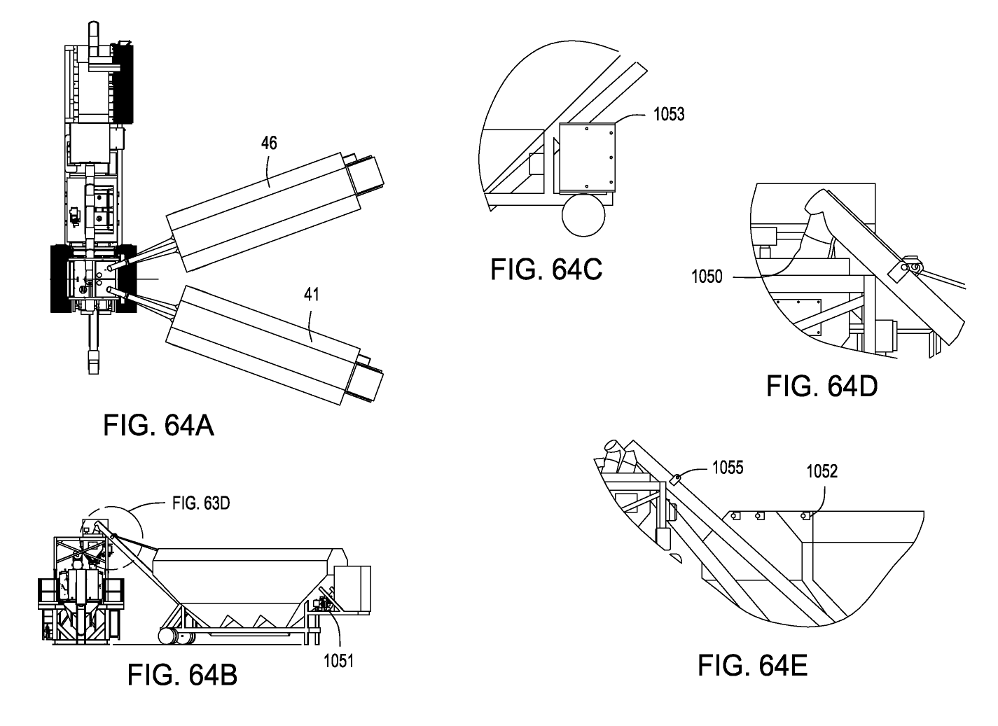

The liquid/solid separation device 20 may include one or more shale shakers, for example. Any other device or method for separating liquids and solids from one another may be used in lieu of or in addition to the shale shaker, including but not limited to a one or more centrifuges, one or more cones, time sedimentation, and/or chemical separation methods. The shaker or other separation device 20 produces more uniform, dryer solids S so that more hydrocarbons (and/or water or other liquids) may ultimately be recovered from the solids S. An example of a shale shaker 20 which may be utilized in embodiments, including a cuttings dryer, is shown in FIGS. 63B and 9. FIG. 63A shows the shaker cuttings dryer, while FIG. 9 shows a shaker chute assembly 24.

One or more motors 250 (for example two motors) with counterweight(s) that may be used to vibrate the shaker 20. The shaker may include a series of staggered screens (e.g., 660 mesh screens) that serve as sieves. The screens capture solid particles and fines while permitting condensed fluids to flow therethrough. Fluids may fall gravitationally through the screens and into a sump or liquids catch tank 25.

The shale shaker 20 may use a certain size screen such as, for example, one or more #60 mesh screens 985 angled uphill from 0 degrees to approximately 5 degrees, as shown in FIG. 63. The mesh screen 985 may be a four-panel, 34 square feet screening area in one example. One or more vibrators 23 may be utilized for vibrating the material in the shaker 20, including for example two non explosion proof, 3PH, 230/460V, 60 Hz, 1800 revolutions per minute (rpm) vibrators with 2.28 horsepower each, as shown in FIG. 63. An optional wedgelock system may allow for quick screen exchange. The cuttings dryer may be 4.0-7.0 high “G” force range adjustable in some embodiments. Shown in FIGS. 63A-63C are an inlet 989, solids discharge location 986 to conveyor hopper, liquids discharge location 987 to liquids tank which may be a 48 square inch opening, and I-beam supports 988 to mount.

FIG. 9 illustrates a shaker chute assembly 24 disposed underneath the shale shaker 20 to catch the liquids from the shaker 20. One or more pumps 11 such as a diaphragm pump, pancake pump, screw pump, and/or piston pump with, for example, two diaphragms, may be disposed at an outlet of the chute assembly 24.

The liquids catch tank 25 may be positioned for receiving liquids L exiting from the shale shaker 20, and a holding hopper 30 may be positioned for receiving solids S exiting from the shale shaker 20. Any other material holding device may be utilized in lieu of the holding hopper and/or liquids catch tank. The holding hopper 30 may be disposed on one or more load cells or other weighing devices for weighing the amount of solids material in the hopper 30. One or more pumps 26 may be disposed downstream from the liquids catch tank for pumping liquid into the mixer 50 and/or a tanker or other storage unit (not shown).

A material transporting device 35 may be positioned so as to receive solid materials exiting from an outlet of the holding hopper. The material transporting device 35 may be a conveyor such as a screw conveyor, for example, an auger, or a pump. (In alternate embodiments, the solids are deposited directly from an outlet of the holding hopper or other storage unit into a mixer 50 without the need for a conveyor or other material transporting device 15 or instead the solids are deposited directly from an outlet of the shale shaker 20 into the mixer 50 without the need for the holding hopper 30 and/or screw conveyor 35.)

A mixer 50 for mixing one or more materials together and producing a conditioned product which is substantially oil-free (or water-free, oil/water mixture free, or free of other liquid contaminants) is positioned downstream from the shale shaker 20 to receive the solids S1 from the screw conveyor 35. The mixer 50 is also positioned downstream from a base tank or batcher 40, an optional catalyst (e.g., calcium chloride) batcher 45, an acid tank 55, and a water and optional surfactant supply 60.

Supply tank 55 may contain an acid. The acid may be a mineral acid, for example a strong mineral acid such as sulfuric acid or a mineral acid such as hydrochloric acid, nitric acid, boric acid. The acid may instead be one or more mineral acids such as hydrogen halides and their solutions (hydrochloric acid, hydrobromic acid, hydroiodic acid), halogen oxoacids (hypochlorous acid, chlorous acid, chloric acid, perchloric acid, and corresponding compounds for bromine and iodine), fluorosulfuric acid, phosphoric acid, fluoroantimonic acid, fluoroboric acid, hexafluorophosphoric acid, chromic acid, or boric acid. The acid may instead be one or more non-mineral acids such as sulfonic acid, methanesulfonic acid or mesylic acid, ethanesulfonic acid or esylic acid, benzenesulfonic acid or besylic acid, p-Toluenesulfonic acid or tosylic acid, trifluoromethanesulfonic acid or triflic acid, polystyrene sulfonic acid or sulfonated polystyrene, carboxylic acid, acetic acid, citric acid, formic acid, gluconic acid, lactic acid, oxalic acid, or tartaric acid.

Any other storage device or method for the acid may be used in addition to or in lieu of the supply tank 55, and the supply tank 55 is merely exemplary. The supply tank 55 may be disposed on one or more load cells or other weighing devices for weighing the acid prior to its introduction into the mixer 50.

Optionally, the acid may be stored upstream of the supply tank 55 in a silo (not shown) such as a portable storage silo or any other storage device or method for storing and/or transporting and/or delivering acid to the mixer 50. A material transporting device (not shown) may be positioned so as to receive the acid exiting from an outlet of the silo (not shown) and deliver the acid to the tank 55. The material transporting device may be a conveyor such as a screw conveyor, for example. (In alternate embodiments, the acid is deposited directly from an outlet of the storage silo into the supply tank 55 without the need for the conveyor, or the acid is deposited directly into the mixer 50 from the storage silo and/or tank 55 with or without a conveyor.) One or more pumps 56 and one or more meters 57 may be disposed between the tank 55 and the mixer 50 to pump the acid stream A into the mixer 50 and meter the amount of acid A delivered into the mixer 50, respectively.

Supply tank 40 may contain a base. The base may be an alkaline earth or alkaline earth containing compound such as lime or an alkaline metal oxide. Any other storage device or method for the base may be used in addition to or in lieu of the supply tank 40, and the supply tank 40 is merely exemplary. The supply tank 40 may be disposed on one or more load cells or other weighing devices for weighing the base prior to its introduction into the mixer 50.

Optionally, the base may be stored upstream of the supply tank 40 in a silo 41 such as a portable storage silo or any other storage device or method for storing and/or transporting and/or delivering base to the mixer 50. A material transporting device 42 may be positioned so as to receive the base exiting from an outlet of the silo 41 and deliver the base to the tank 40. The material transporting device 42 may be a conveyor such as a screw conveyor, for example. (In alternate embodiments, the base is deposited directly from an outlet of the storage silo 41 into the supply tank 40 without the need for the conveyor, or the base is deposited directly into the mixer 50 from the storage silo 41 and/or tank 40 with or without a conveyor.) One or more pumps (not shown) and one or more meters (not shown) may be disposed between the tank 40 and the mixer 50 to pump the base B into the mixer 50 and meter the amount of base B delivered into the mixer 50, respectively. A baghouse with base B in it may be used to feed into the mixer 50 (and baghouses may optionally be used to feed other components into the mixer 50).

Optional batcher 45 may contain a multivalent metallic salt such as optional calcium chloride or other similar base or salt. The catalyst C may be a multivalent metallic salt or an ionic halide in some embodiments. The catalyst C such as calcium chloride or other similar base or salt may be added to the mixer 50 as a catalyst or enhancement to the base B such as lime, driving the temperature of the reaction higher to make the reaction more efficient. The calcium chloride may instead be any other salt which acts as a catalyst or enhancement to the lime or other base B or may be combined with other salts which perform these purposes. Any other storage device or method for storing the catalyst such as calcium chloride and/or other salt may be used in addition to or in lieu of the batcher 45, and the batcher 45 is merely exemplary. The batcher 45 may be disposed on one or more load cells or other weighing devices for weighing the catalyst such as calcium chloride and/or other salt prior to its introduction into the mixer 50.

Optionally, the catalyst such as calcium chloride and/or other salt may be stored upstream of the batcher 45 in a silo 46 such as a portable storage silo or any other storage device or method for storing and/or transporting and/or delivering the calcium chloride and/or other salt C to the mixer 50. A material transporting device 47 may be positioned so as to receive the catalyst such as calcium chloride and/or other salt exiting from an outlet of the silo 46 and deliver the catalyst such as calcium chloride and/or other salt to the batcher 45. The material transporting device 47 may be a conveyor such as a screw conveyor, for example, an auger, or a pump. (In alternate embodiments, the catalyst such as calcium chloride and/or other salt is deposited directly from an outlet of the storage silo 46 into the batcher 45 without the need for the conveyor 47, or the calcium chloride and/or other salt is deposited directly into the mixer 50 from the storage silo 46 and/or batcher 45 with or without a conveyor 47.) One or more pumps (not shown) and one or more meters (not shown) may be disposed between the batcher 45 and the mixer 50 to pump the calcium chloride and/or other salt C into the mixer 50 and meter the amount of calcium chloride and/or other salt C delivered into the mixer 50, respectively.

Water supply 60 supplies water to the mixer 50. Surfactant may optionally be mixed with the water supply 60 to cause the water to bond to the clay particles in the mixer 50, ultimately causing the reaction to take place in the mixer 50 efficiently and effectively. Instead of adding a surfactant/water mixture to the mixer 50, the surfactant may be introduced separately into the mixer 50 from the water supply 60 (in other words, it is within the scope of embodiments that the surfactant and water may be mixed prior to their introduction into the mixer 50 or may instead be introduced separately into the mixer 50). Any other type of soap or detergent may be used in lieu of or in addition to surfactant. The supply tank or other water supply and/or surfactant storage device may be disposed on one or more load cells or other weighing devices for weighing the water and/or surfactant prior to its introduction into the mixer 50.

Optionally, the water and/or surfactant may be stored upstream of the storage device in a silo (not shown) such as a portable storage silo or any other storage device or method for storing and/or transporting and/or delivering water and/or surfactant to the mixer 50. A material transporting device (not shown) may be positioned so as to receive the water and/or surfactant exiting from an outlet of the silo and deliver the water and/or surfactant to the tank or other storage device. (In alternate embodiments, the water and/or surfactant is deposited directly from an outlet of the storage silo into the supply tank or other storage device without the need for the material transporting device, or the water and/or surfactant is deposited directly into the mixer 50 from the storage silo and/or tank (or other storage device) with or without a material transporting device.) One or more pumps 61 and one or more meters 62 may be disposed between the tank or other storage device and the mixer 50 to pump the water and/or surfactant into the mixer 50 and meter the amount of water and/or surfactant W delivered into the mixer 50, respectively.

If surfactant is introduced into the mixer separately from the water, it may possess its own supply tank, meter(s), pump(s), portable storage silo, material transporting device, and/or load cell(s) separate from that of the water supply. Any storage device or method for the water supply and/or surfactant may be used including a supply tank.

Raw material storage may include an acid tank 55, water and/or surfactant tank, and silos for storage of base B and catalyst C such as calcium chloride or other salt. An auger or screw conveyor (or other material transport device) may transport raw materials from the silo.

In some embodiments, raw material transfer system components may include one or more conveyors, e.g., one or more screw conveyors, or one or more augers, or one or more pumping mechanisms such as one or more pumps. In alternate embodiments, the raw material transfer system used in any of the locations in the system and method may include one or more piston pumps or other pumps rather than one or more screw conveyors or augers. A heavy auger may move cuttings under the receiving bin or from the shaker to the mixer 50.

Components usable in the installation of the low profile silo(s) may include screw support weldments, brackets going to the silo(s), and a control mount box for mounting the controls for automating the silos and the remainder of the system. FIGS. 64A, 64B, 64C, 64D and 64E show top, side, and section views of embodiments of one or more silos connected to the system and method, including details of how the silo connects to the system such as detail of the electrical box and screw support. An example of components of the silo install may be as follows:

| Component or | | |
|---|---|---|
| Location No. | Quantity | Description |
| 46, 41 | 2 | 300 Barrel Portable Silo |
| 1050 | 2 | Boot 10 inches long |
| 1050 | 4 | Clamp |
| 1050 | 2 | Tube 10 inches diameter × 2 inches long |
| 1051 | 2 | 10 horsepower (HP) Blower Assembly |
| 1052 | 4 | Screw Support 1 |
| 1055 | 2 | Screw Support 2 |
| 1052 | 4 | Wire Rope |
| 1052 | 24 | ¼ inch U-Bolt |
| 1052 | 8 | ¼ inch Thimble |
| 1052 | 4 | Turn Buckle |
| 1053 | 2 | Control Panel Mount |
| 1054 | 2 | Box Mount |
| | 10 | flat lock (FL) (carriage head on bolt) ⅛ |
| | | inch × 2 inches × 4 inches (to weld on |
| | | incline screw for mounting conduit) |

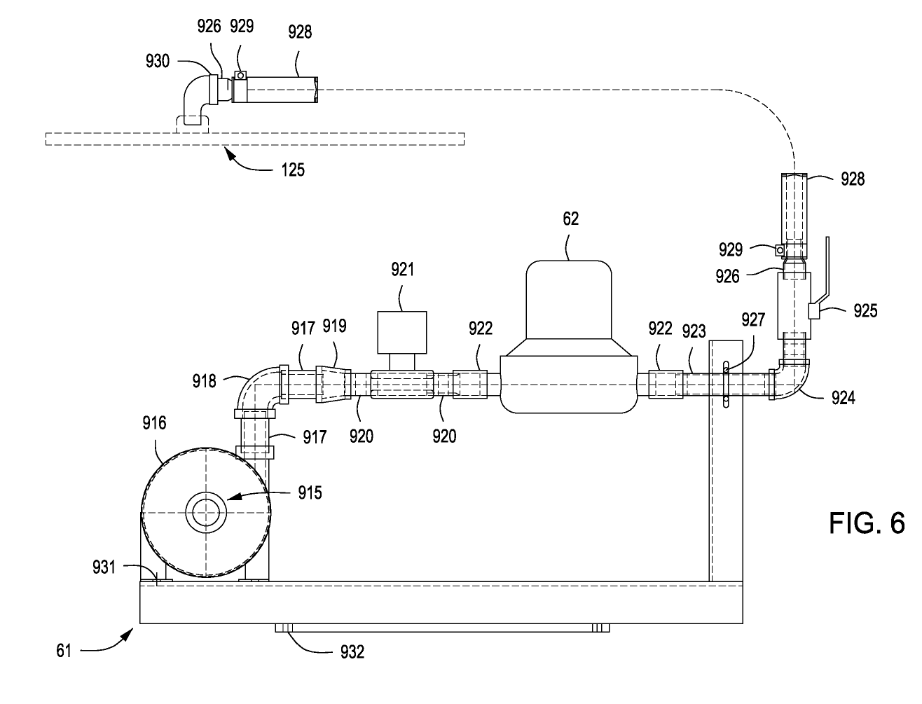

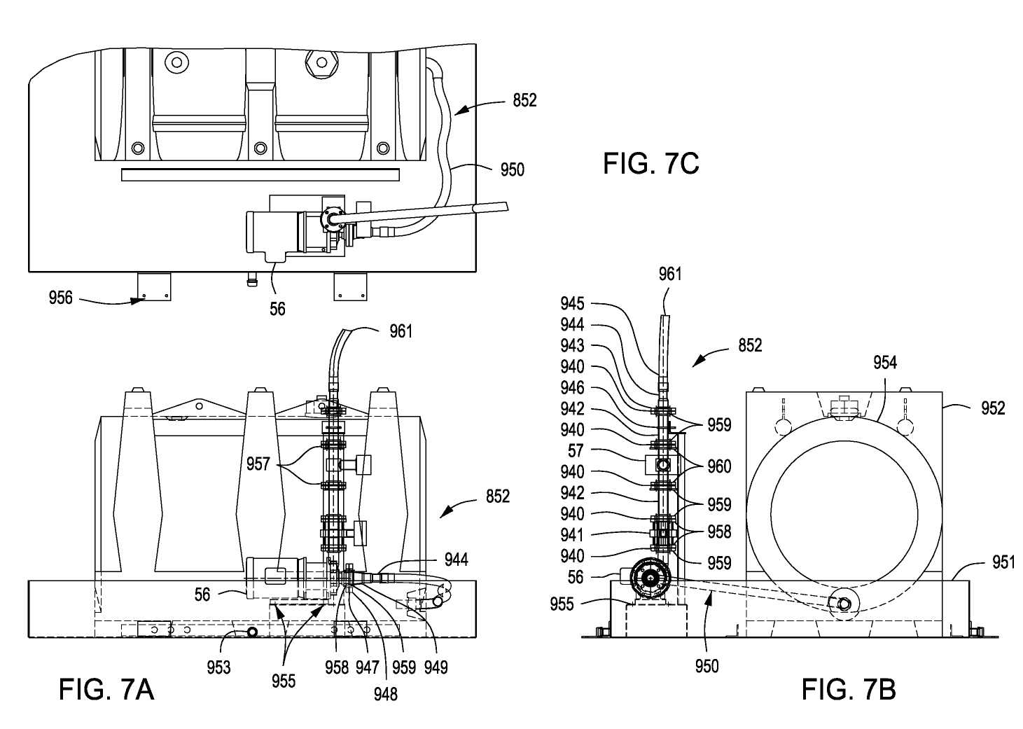

FIG. 6 shows an embodiment of a pump and water meter assembly for pumping and metering the water (and/or surfactant) into the mixer 50. FIGS. 7A, 7B, and 7C illustrate various views of an embodiment of a pump and acid meter assembly for pumping and metering the acid (e.g., mineral acid such as sulfuric acid) into the mixer 50.

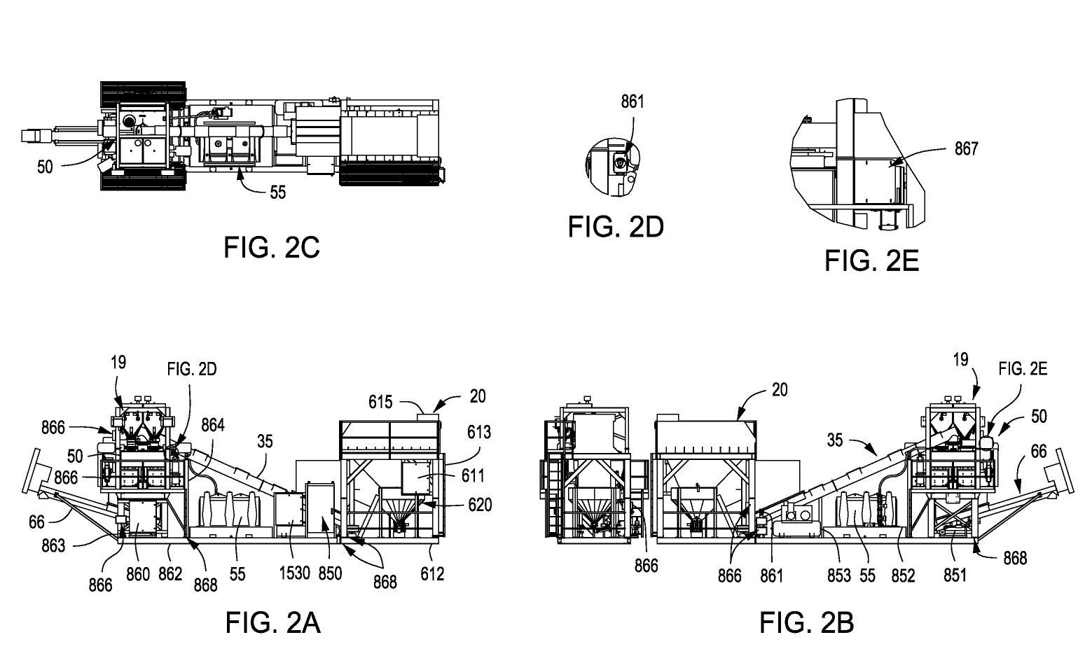

FIGS. 6 and 7A-7C show various perspective views of an example of a wet meter system for metering amounts of the wet components prior to their introduction into the mixer 50. Shown in FIGS. 6 and 7A-7C are a pump, which may be a diaphragm pump, for pumping the liquid stream(s) and a motor for the pump. FIGS. 7A, 7B, and 7C show an example of the acid pump. FIGS. 2B and 68 show an air compressor 853 (e.g., for operating the pneumatic valves) operable according to the pre-weigh for the silos (and other weighing points) and associated valves (e.g., gate valves which may be pneumatically operated).

The mixer 50 may be a batch mixer such as a twin shaft batch mixer. The mixer may be a dual shaft mixer or twin shaft mixer. The mixer 50 may be capable of mixing approximately 10 batches per hour. In an example, the mixer 50 may operate at approximately 70 revolutions per minute (RPM). The twin shaft mixer or dual shaft mixer may operate via batch style or semi-continuous style mixing.

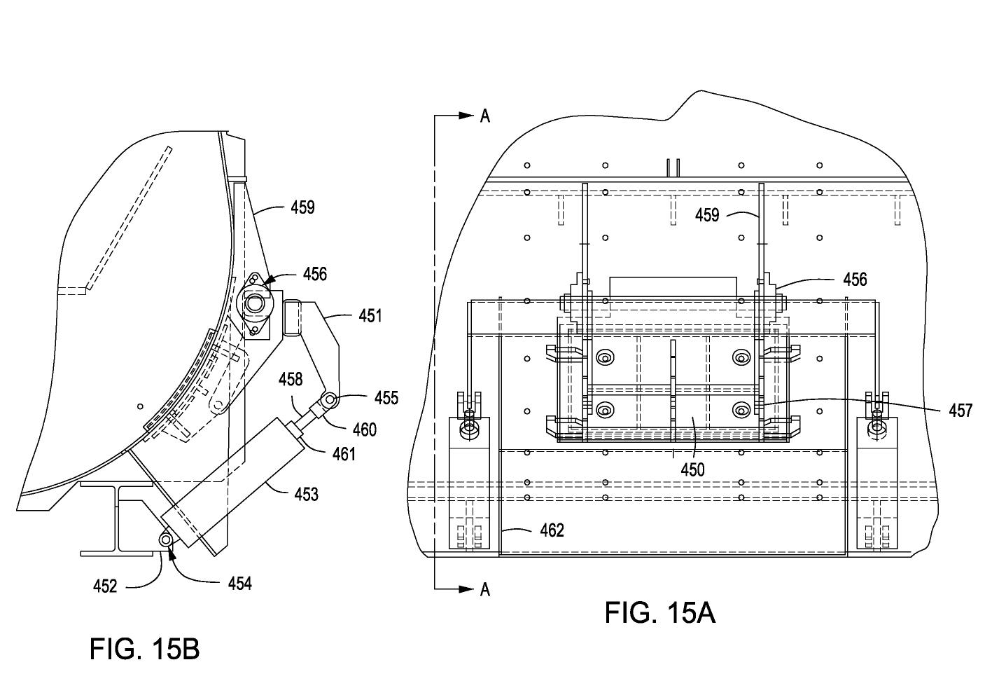

Drawings showing various views of an embodiment of the mixer 50 and its components are included as FIGS. 15-22. The mixer 50 makes solids behave as gases by using one or more paddles which move the material gently at a high volume, all of the time moving the material. The mixer may include two shafts 150, 151 with paddles disposed on them that interconnect. Each shaft 150, 151 has bearings on one end and a drive shaft on the other end (its drive end). In some embodiments, the pitch of the paddles on the shafts is set as larger and then smaller so that the blades/shafts do not have to work as hard to effectively mix the material in the mixer 50. Weir plates 135 may be included to keep the paddles as close as possible to the sides of the mixer.

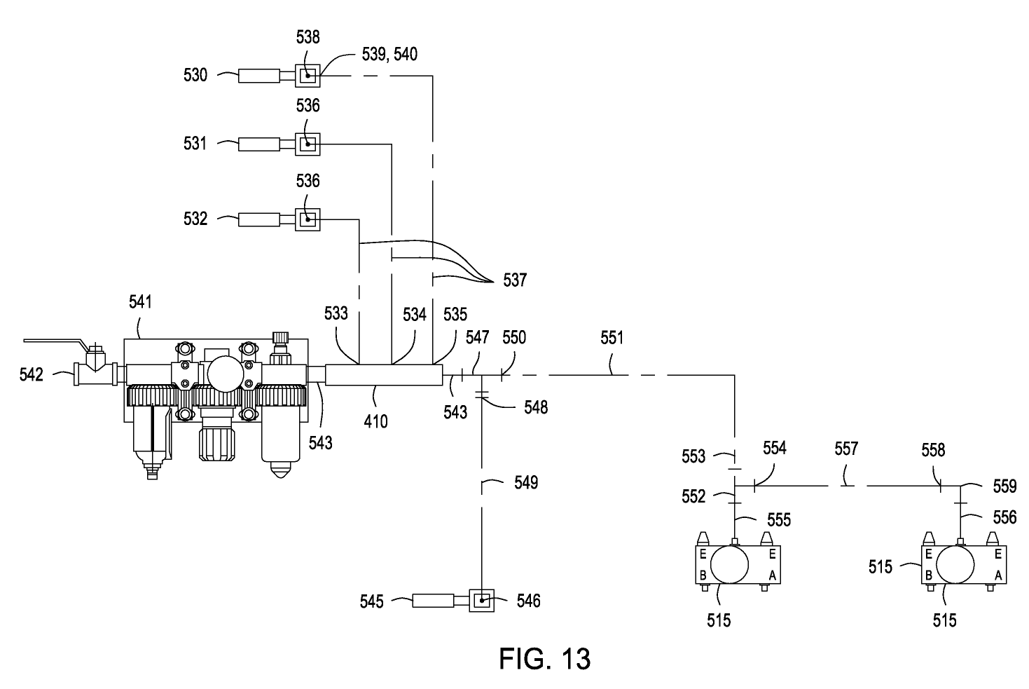

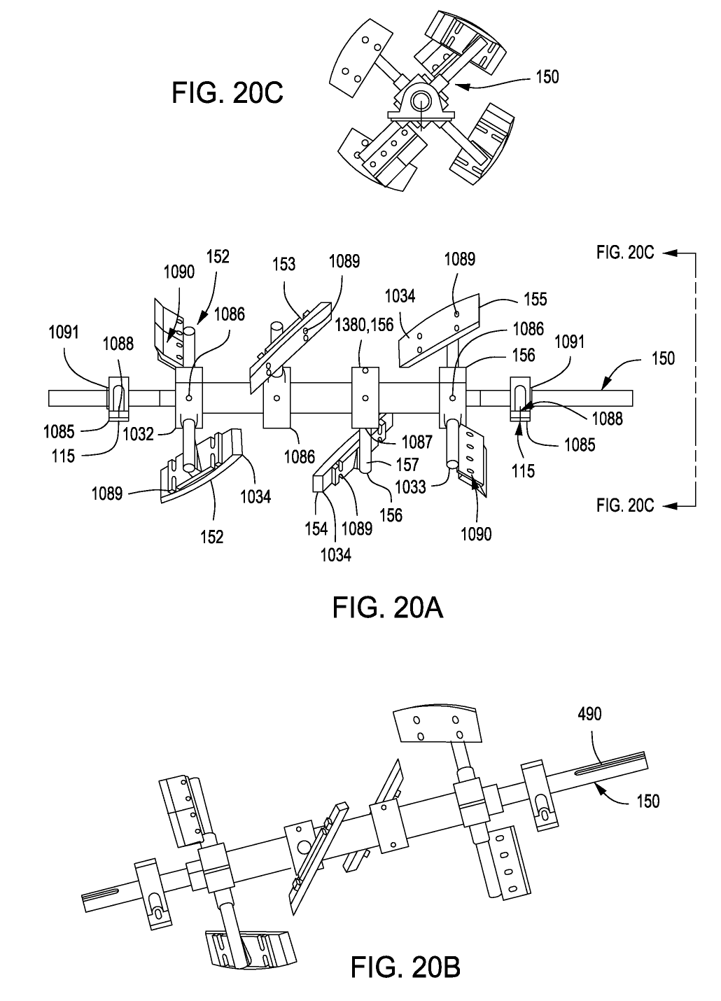

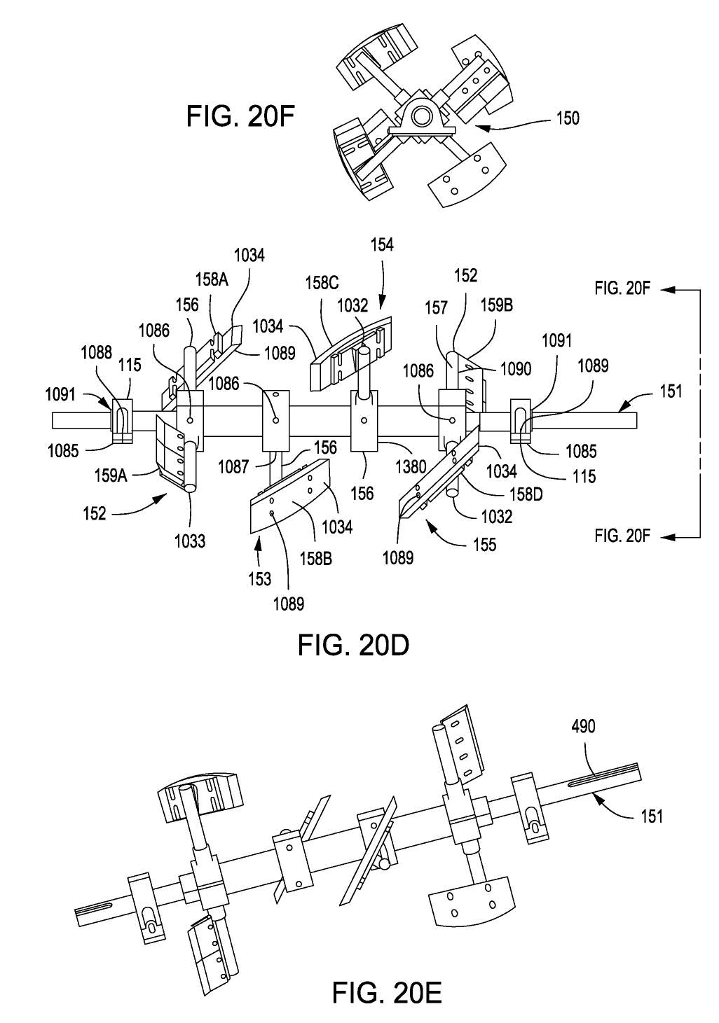

FIGS. 20A, 20B, 20C, and 20D show top, side, and perspective views of a main shaft assembly of the mixer of FIG. 13 as viewed from a drive side of the mixer. End, side, and perspective views of the main shaft left hand (LH) assembly and the main shaft right hand (RH) assembly are shown in FIGS. 20A-20F.

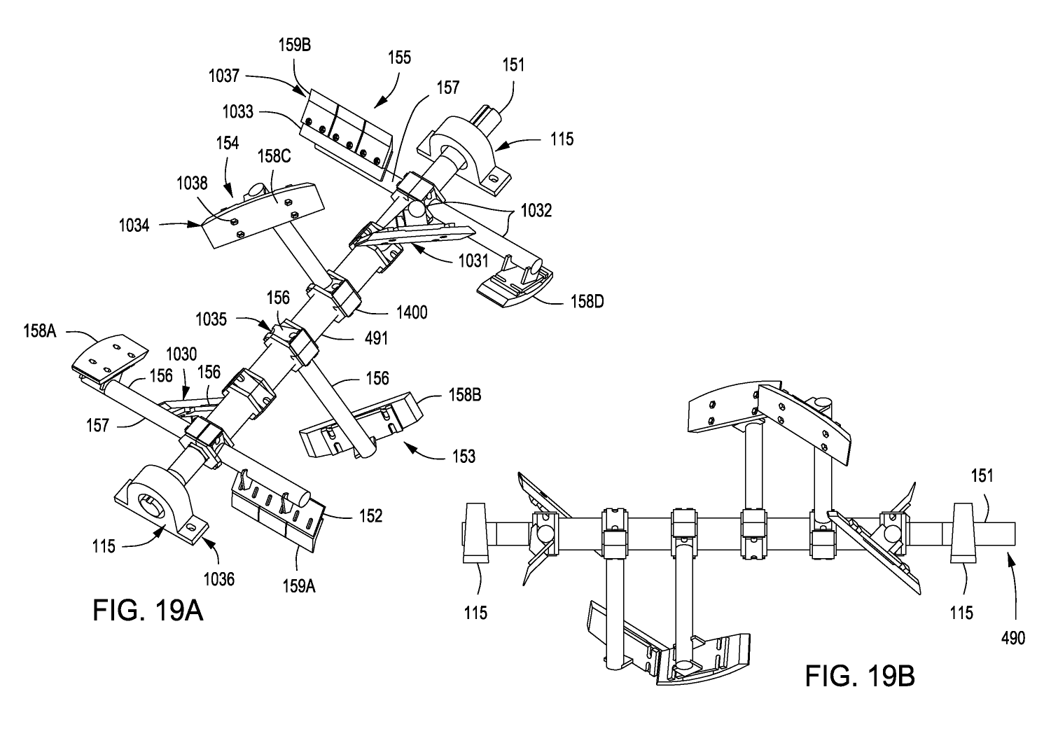

FIGS. 19A and 19B show side and perspective and side views of the right hand drive shaft 151 (the left hand drive shaft 150 is opposite). The drive end 490 of the main shaft 151 is shown in FIG. 19B. Bearings 115 (which may be 3 15/16-inch diameter or 3-inch diameter bearings) may be disposed at or near both ends of each of the shafts 150, 151. Paddles may include four paddles as shown in FIGS. 20A-20F spaced apart from one another along each main shaft 151, 152. The four paddles may include a first paddle 152, a second paddle 153, a third paddle 154, and a fourth paddle 155. Although four paddles are shown in FIG. 20A-20F and described herein, it is within the scope of embodiments that any number of paddles may be included on the shafts 150, 151. Each paddle 152, 153, 154, 155 may include one or more paddle arms 157 and one or more paddle blades 158A, 158B, 158C, 158D, 159A, 159B. The paddles 153 and 154 closest to the center of the length of the shafts 150, 151 may only have a half-arm with only one paddle 158C and 158B on the end of the half-arm. The paddles 152 and 155 closest to the ends of the shafts 150, 151 may have an arm with a paddle blade 159B, 158A on one end of the arm and a paddle blade 158D, 159A on the other end of the arm 157. The paddle blades 158A-D may be concave, and the paddle blades 159A, 159B may be scrapers for scraping material in the mixer 50 from the sides of the mixer 50 (thus, the paddles with the paddle blades 159A, 159B thereon may be called “scraper arms” and the blades 159A, 159B may be called “scraper blades”). Each paddle may include an arm clamp 156 for clamping each paddle arm 157 to the shaft 150, 151. The blades 158A, 158B, 158C, 158D, 159A, 159B may be easily removable, replaceable and/or repairable, reducing mixer and system downtime. The blades 158A, 158B, 158C, 158D, 159A, 159B are also built to last for a long period of time. The pitch of the blades 158A, 158B, 158C, 158D, 159A, 159B is an auger-setting pitch of larger then smaller to make the paddles work less hard. The two shafts paddles on them kneed the material in the mixer like bread.

FIGS. 19A and 19B show two additional paddles 1031 which may be included on each shaft 150, 151. Referring to FIGS. 19A and 19B, in an example which is not limiting of embodiments, the paddle blades 158A-D may include paddle casting, one or more hex head cap screws (HHCS) (e.g., twenty-four total ¾-10×2¾ inches), one or more lock washers (LWs) (e.g., twenty-four total ¾ inch LW), one or more washers (e.g., twenty-four total one-inch SAE hardened washers), and one or more heavy hex nuts (HHN) e.g., twenty-four total ¾-10 inches HHN); the paddle blades (or scraper blades) 159A-B may include one or more carriage bolts (e.g., twelve total ½×2½ inches carriage bolts), one or more lock washers (LWs) (e.g., twelve total ½ inch LW), one or more FW (e.g., twelve total ½ inch FW), and one or more have hex nuts (HHN) (e.g., twelve total ½-13 inches HHN); the arm clamps 156 may include one or more HHCS (e.g., twelve total HHCS), one or more lock washers (LWs) (e.g., a total of twelve LW), one or more HHN (e.g., a total of twelve HHN), and one or more washers (e.g., twenty-four total one-inch SAE hardened washers); and the bearings 115 may include one or more HHCS (e.g., eight total ⅞-9×3½ inches), one or more lock washers (LWs) (e.g., eight total ⅞ inch LW), one or more HHN (e.g., eight total ⅞-9 inches HHN), one or more flat washers (FWs) (e.g., eight total ⅞ inch SAE), one or more grease cups (e.g., two grease cups), and one or more bushings (e.g., two total ¼×⅛ inch bushings. A shaft cover 9 may optionally cover each shaft 150, 151. Following is a list of exemplary components shown in the main shaft assembly (right hand drive) of FIGS. 19A and 19B:

| Component or | | |
|---|---|---|
| Location Number | Quantity | Description |
| 151 | 1 | Main Shaft, 54XL Mixer |
| 156 | 3 | Paddle Arm Weldment, LH |
| 1032 | 3 | Paddle Arm Weldment, RH |
| 1400 | 4 | Arm Clamp Weldment |
| 152 | 1 | Scraper Arm Weldment, left hand (LH) |
| 1033 | 1 | Scraper Arm Weldment, right hand (RH) |
| 1034 | 6 | Paddle Casting |
| 159A-B | 6 | Scraper Blade |
| 491 | 5 | Shaft Cover |
| 115 | 2 | Bearing, 3 15/16 inches diameter |
| 1035 | 12 | hex head cap screw (HHCS), 1 - 8 × 8 - |
| | | ½, grade (GR.) 8 (in inches) |
| 1035 | 12 | lock washer (LW), 1 inch |
| 1035 | 12 | heavy hex nut (HHN), 1 - 8 (in inches) |
| 1036 | 8 | hex head cap screw (HHCS), ⅞ - 9 × |
| | | 3½ inches |
| 1036 | 8 | lock washer (LW), ⅞ inch |
| 1036 | 8 | heavy hex nuts (HHN), ⅞ - 9 (in inches) |
| 1036 | 8 | flat washer (FW), ⅞ SAE (in inches) |
| 1034 | 24 | hex head cap screw (HHCS), ¾ - 10 × |
| | | 2¾ inches |
| 1034 | 24 | lock washer (LW), ¾ inch |
| 1038 | 24 | flat washer (FW), ¾ inch |
| 1034 | 24 | heavy hex nut (HHN), ¾ - 10 (in inches) |
| 1037 | 12 | Carriage Bolt, ½ × 2½ inches |
| 1037 | 12 | lock washer (LW), ½ inch |
| 1037 | 12 | flat washer (FW, ½ inch |
| 1037 | 12 | heavy hex nut (HHN), ½ - 13 (in inches) |
| 1036 | 2 | Grease Cup |
| 1036 | 2 | Bushing, ¼ inch × ⅛ inch |
| 1034, 1035 | 24 | Washer, SAE Hardened, 1 inch |

Following is a list of exemplary components shown in the left hand main shaft assembly (weight may be 943 pounds) of FIGS. 20A, 20B, 20C, and 20D (same for right hand):

| Component or | | |
|---|---|---|
| Location Number | Quantity | Description |
| 150, 151 | 1 | Main Shaft |
| 115 | 2 | Bearing, 3 inch diameter |
| 1085 | 2 | Bearing Spacer |
| 156 | 2 | Paddle Arm Weldment, right hand (RH) |
| 1380 | 2 | Arm Clamp, Model 21/30 Mixer |
| 152 | 1 | Scraper Arm Weldment, left hand (LH) |
| 1034 | 4 | Paddle Casting |
| 1032 | 2 | Paddle Arm Weldment, LH |
| 1033 | 1 | Scraper Arm Weldment, RH |
| 159A-B | 4 | Scraper Blade |
| | 3 | Tube 5½ OD × ¼ W × 10¼ inches |
| 1086 | 4 | HHCS, 1 - 8 × 6½ GR 8 (in inches) |
| 1086, 1087 | 8 | Lock Washer, 1 inch |
| 1087 | 4 | HHCS, 1 - 8 × 6½ GR 8 (in inches) |
| 1086, 1087 | 4 | Nut, Heavy Hex, 1 -8 (in inches) |
| 1088 | 4 | HHCS, ¾ - 10 × 4 (in inches) |
| 1088, 1089 | 20 | Lock Washer, ¾ inch |
| 1088, 1089 | 20 | Nut, Heavy Hex, ¾ - 10 (in inches) |
| 1089 | 16 | HHCS, ¾ - 10 × 3 (in inches) |
| 1088, 1089 | 20 | Flat Washer, ¾ inch |
| 1090 | 8 | Carriage Bolt, ½ - 13 × 2½ inches |
| 1090 | 8 | Flat Washer, ½ inch |
| 1090 | 8 | Lock Washer, ½ inch |
| 1090 | 8 | Nut, Heavy Hex, ½ - 13 (in inches) |
| 1091 | 2 | Grease Cup |

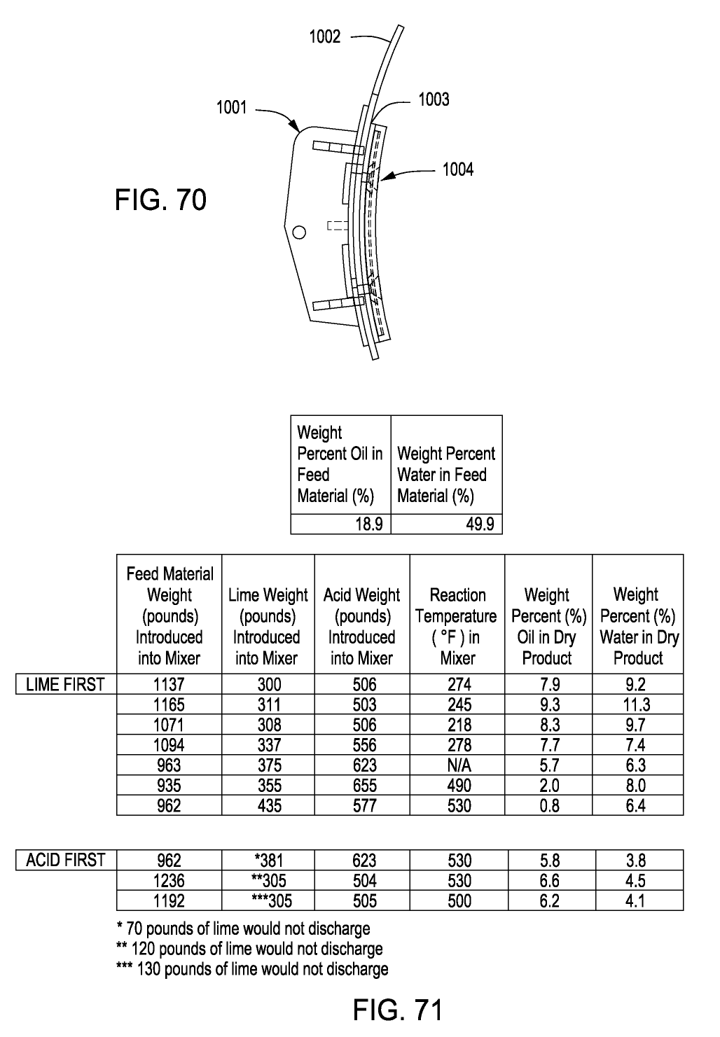

A mixer discharge door assembly with upper seal is shown in FIG. 15A, and a portion of the mixer discharge door assembly with upper seal is shown in FIG. 15B and FIG. 70. The mixer discharge door assembly may include the following in an example which is not limiting of embodiments: a discharge door subassembly 450, discharge lever arm weldment 451, one or more cylinder anchors 452 (e.g., two cylinder anchors), one or more cylinders 453 (e.g., two air-powered or pneumatically-powered cylinders such as 4 bore×12 stroke), one or more rod boot assemblies 458 (e.g., two rod boot assemblies), a discharge chute weldment 462, one or more plates 459 (e.g., ½-inch×4 15/16 inch×17 3/16 inch plate), and one or more hose clamps 460 (e.g., two 1/20 inch to 29/32-inch hose clamps) and hose clamps 461 (e.g., two 1¼ inch to 1½ inch hose clamps). Additionally, the mixer discharge door assembly may include at or near location 456 one or more bearings (e.g., 1½ inches diameter bearings), one or more lock washers (LWs) (e.g., ½ inch LWs), and one or more hex head cap screws (HHCS) (e.g., ½ inch-13×1¼ inch HHCS); at or near location 455 one or more clevis rods (e.g., ¾-16 with ¾-inch pin), cotter pins (e.g., ⅛-inch diameter×1¾ inch low grease bearing (LG)), and washer SAEs (e.g., ¾-inch washer SAEs); at or near location 454 one or more cylinder pins (e.g., ¾-inch cylinder pins), cotter pins (e.g., ⅛-inch diameter×1¾ inch LG bearing), and washer SAEs (e.g., ¾-inch washer SAEs); and at or near location 457 one or more HHCS (e.g., ¾-inch-10×2 inch HHCS) and one or more locknuts (e.g., ¼-inch-10). Following is a list of exemplary components of the discharge door assembly with upper seal (e.g., Model 54DD XL) shown in FIGS. 15A and 15B:

| Component or | | |
|---|---|---|
| Location Number | Quantity | Description |
| 450 | 1 | Discharge Door Subassembly Mod 54DD |
| | | XL |
| 451 | 1 | Discharge Lever Arm Weldment Mod |
| | | 54DD XL |
| 452 | 2 | Cylinder Anchor |
| 453 | 2 | Cylinder, Air 4-inch Bore × 12 Stroke |
| 454 | 2 | Cylinder Pin ¾ inch |
| 455 | 2 | Clevis Rod, ¾ - 16 with ¾ inch Pin |
| 454, 455 | 2 | Cotter Pin, ⅛ inch diameter × 1 - ¾ inch |
| | | LG long |
| 454, 455 | 12 | Washer SAE, ¾ inch |
| 458 | 2 | Rod Boot Assembly |
| 462 | 1 | Discharge Chute Weldment |
| 457 | 2 | hex head cap screw (HHCS), ¾ inch - |
| | | 10 × 2 inch |
| 457 | 2 | Locknut, ¾ inch - 10 |
| 459 | 2 | Plate, ½ inch × 4 - 15/16 inch × 17 - 3/16 |
| | | inch |
| 456 | 2 | Bearing, 1½ inch diameter |
| 456 | 4 | lock washer (LW), ½ inch |
| 456 | 4 | hex head cap screw (HHCS), ½ inch - |
| | | 13 × 1 - ¼ inch |
| 460 | 2 | Clamp, Hose ½ inch to 29/32 inch |
| 461 | 2 | Clamp, Hose 1 - ¼ inch to 1 - ½ inch |

Following is a list of exemplary components of the discharge door assembly with upper seal (e.g., Model 54DD XL) shown in FIG. 70:

| Component or | | |
|---|---|---|
| Location Number | Quantity | Description |
| 1001 | 1 | Rear Door Weldment |
| 1002 | 1 | Discharge Door Seal |
| 1003 | 1 | Shim |
| 1004 | 1 | Drum Liner (e.g., weir plates) |
| 1004 | 4 | flat head machine screw (FHMS), ⅜ - |
| | | 16 × 2 - ¼ inch |
| 1004 | 4 | LHW (a washer), ⅜ inch |
| 1004 | 4 | flat washer (FW), ⅜ inch |
| 1004 | 4 | heavy hex nut (HHN), ⅜ - 16 inch |

A mixer charge conveyor assembly may be included in the system to remove the dry material from the mixer area once the dry material is discharged from the mixer 50. With this belt conveyor added to the auger, the dry material can be moved further away from the mixer 50.

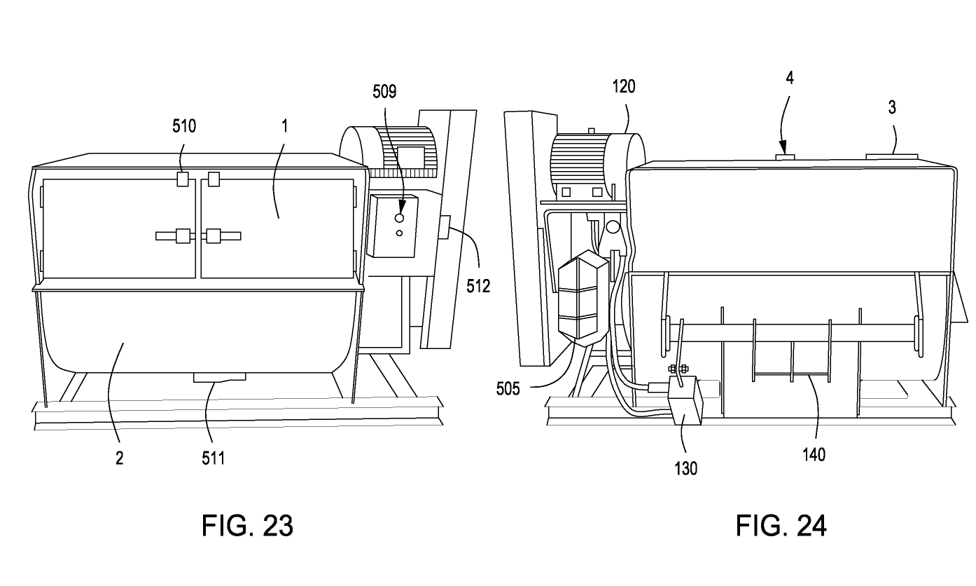

FIGS. 23-30 show other aspects of the mixer 50. FIG. 23 shows a front side of the mixer, including a mixing tank 2, mixer cleanout doors 1, mixer safety interlock box 509, tank drain 511, optional warning horn or alarm 512, and mixer cleanout door safety switch(es) 510.

FIG. 24 shows a back side of the mixer 50, including one or more drive motors 120, one or more transmissions 505, discharge door 140 (which may be pneumatically operated), and discharge door air cylinder 130.

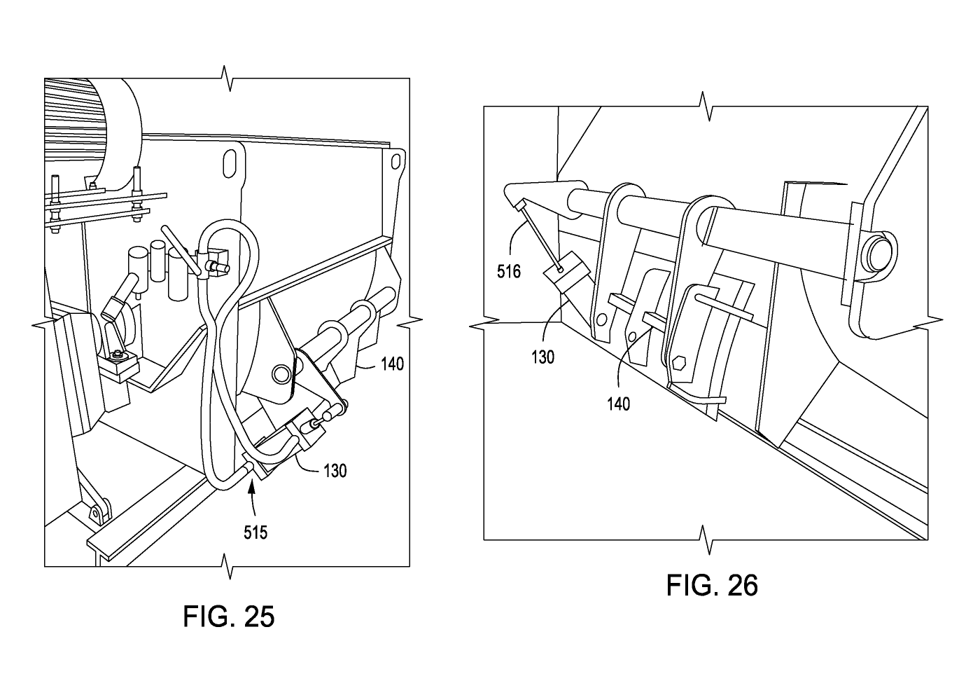

FIG. 25 shows the discharge door air cylinder 130 and a discharge door shutoff valve 515 on the cylinder 130, which valve 515 may be closed when servicing the air operated discharge door 140.

FIG. 26 shows the discharge door 140, piston/cylinder assembly 130, and an air rod clevis 516. The discharge door 140 may be adjusted for open or close operation and for compensation for wear.

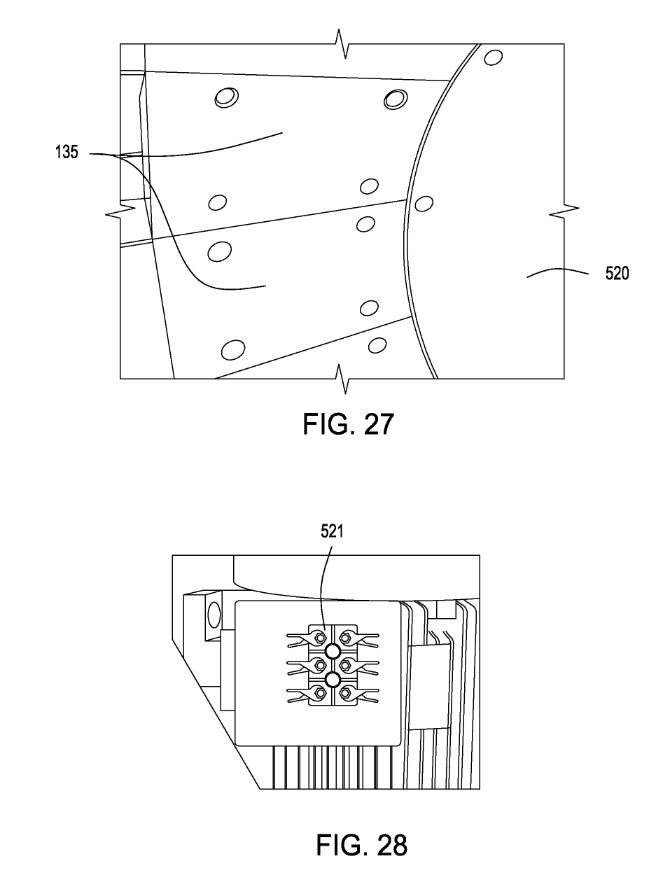

FIG. 27 shows optional drum liners or weir plates 135 and one or more end liners 520 which keep one or more paddles of the mixer 50 as close as possible to the side walls of the mixer 50. The drum liners and end liners may be extremely long wearing.

FIG. 28 illustrates an embodiment of an electrical box 521 of the mixer 50. The connection wiring should be of proper size to ensure against drops in voltage which would reduce the torque available and overheat the motor or activate the thermal protection in the starter.

FIG. 29 shows an embodiment of a drive assembly of the mixer 50, including a drive belt 522, which tension may be adjusted as needed by using adjuster bolts 1040 which may be located on the base of the motor 50.

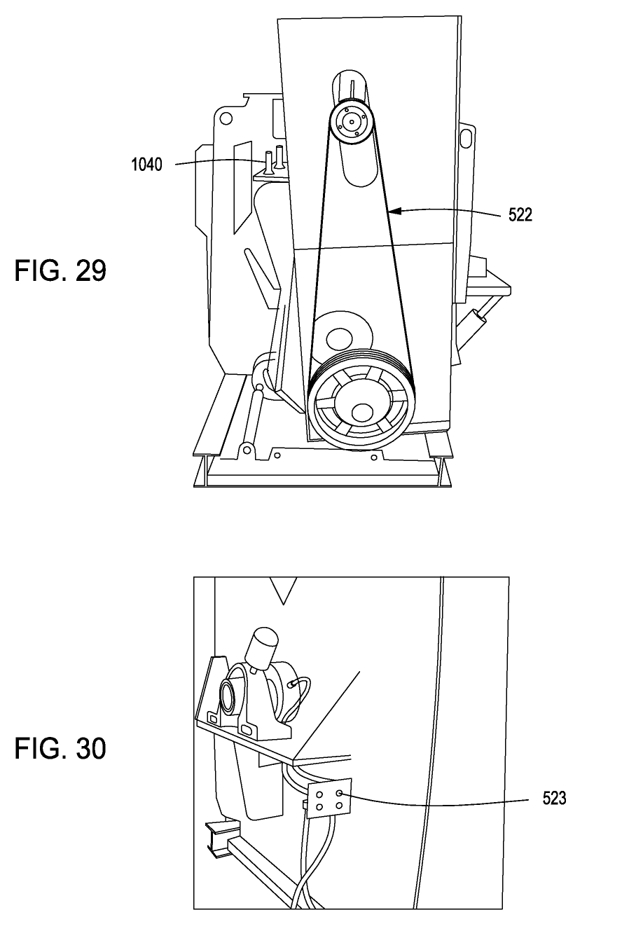

FIG. 30 illustrates shaft and seal bearings 523, which may be greased periodically, e.g., using Velox #3 every 2-3 hours, to prevent grout from entering the seal area and prevent damage to the main shaft. In some embodiments, auto-lube may be used for greasing the shaft seals 523. Also shown in FIG. 30 is a bearing grease cup 524 which may be periodically filled with grease, such as Multipurpose #2 grease.

The mixer 50 may have one or more mixer access doors 1 to allow easy access to the inside of the mixer 50 for cleanout, repair, viewing, manipulation of its contents, etc. Easy access to the interior of the mixer 50 decreases downtime of the system.

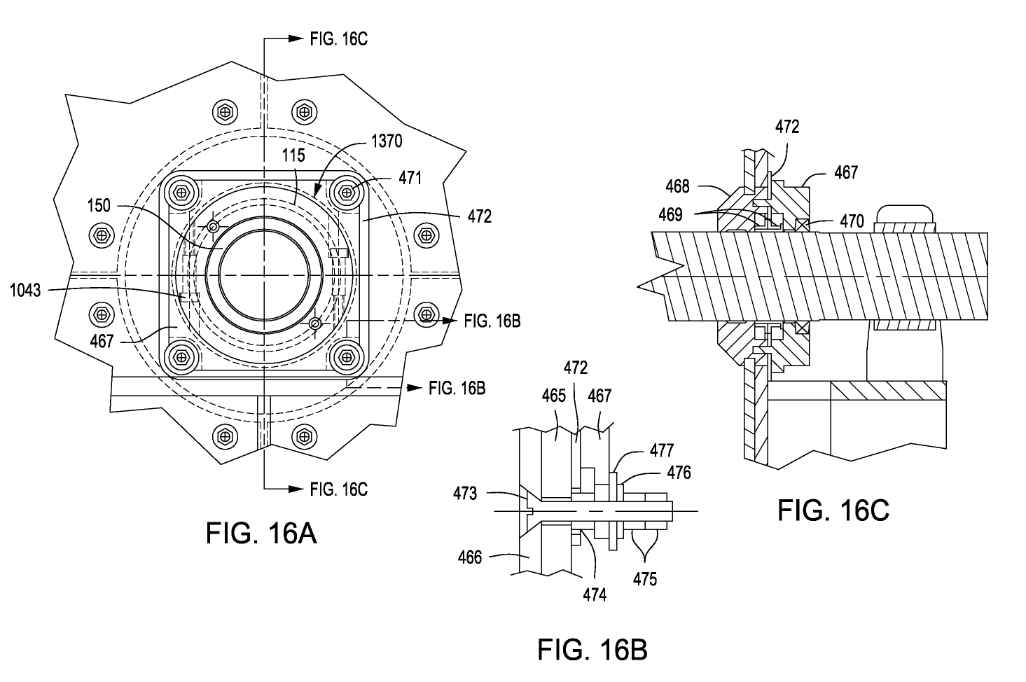

FIGS. 16A, 16B, and 16C show top, side, and section views of a cross-sectional portion of the mixer 50 of FIG. 1. Shown in FIGS. 16A, 16B, and 16C are a shaft 150 and bearing 115 of the mixer 50. A mixer wall 465 of the mixer chamber and a liner 466 are shown in FIGS. 16A-16C. In one example shown in FIG. 16A-16C which is not limiting of embodiments, the mixer 50 may include one or more (e.g., two) flanged stationary collars 467, one or more (e.g., two) shaft collars 468, a face seal 469 (e.g., caterpillar type), a split lip seal 470, and washers 476 and 477 (also washers may be located at location 471). Following is a list of exemplary components and materials of the mixer shown in FIG. 16A-16C:

| Component or | | |
|---|---|---|
| Location Number | Quantity | Description |
| 467 | 2 | Flanged Stationary Collar |
| 468 | 2 | Shaft Collar |
| 469 | 1 | Face Seal - Caterpillar Type dual face |
| | | (DF) |
| 470 | 1 | Split Lip Seal |
| 474, 471 | 12 | Nut, Hex, Hvy, ⅜ - 16 NC (nut |
| | | countersink) (inches) |
| 475 | | ⅜-inch jam nuts |
| 1043 | 4 | shoulder bolt alloy (shoulder course) SCR |
| | | ½ inch × 1½ long × ⅜ - 16 NC (nut |
| | | countersink) |
| 473, 471 | 4 | SCR (shoulder course), Flat head (HD) |
| | | Cap ⅜ - 2½ long (in inches) |
| 472 | 1 | Flanged Gasket |
| 476, 471 | 4 | Washer, Flat ⅜ inch |
| 477, 471 | 4 | Washer, Flat ½ inch |
| 1370 | 1 | Silicone Tube |

Following are example assembly notes relating to the mixer:
1.) All seal halves to be assembled with silicone sealant in seams and on mounting faces.
2.) Install face seal 469 over shaft before installing bearing.
3.) Between tank wall and shaft bearing install shaft collar halves 468 over shaft with shoulder bolts loosely then slide through tank wall on shaft until it hits square section on shaft. Install seal liners in grooves in shaft collars and bolt to tank wall (torque to 40 feet/lbs.). NOTE: For access to bolt heads, rotate shaft collar halves until shoulder bolts are positioned between end wiper and mixer arm before final tightening.
4.) Position shaft collars 468 with 0.003/0.005 gap between seal and collar groove and torque shoulder bolts to 45 feet/lbs. (make sure gap is equal between halves).
5.) Install one half of face seal 469 into shaft collar 468 with flange toward end of shaft.
6.) Install flange gasket 472 over liner bolts 473 and nuts 474.
7.) Bolt stationary collar halves 467 together over shaft with shoulder bolts 1043 and torque to 45 feet/lbs, install other half of face seal 469 into stationary collar with flange so that face seal flanges mate (these surfaces must be lubricated before assembly).
8.) Install stationary collar 467 over liner bolts 473 and install washers 476, 477, nuts 474, tighten nuts and back off one half turn (0.031). Hold nut and run second nut (as jam) tight on first nut.
9.) Install grease system, fittings and hoses, apply grease 475 through lubrication system before starting mixer for first time by running pump until grease begins to appear around the shaft collar inside the mixer.

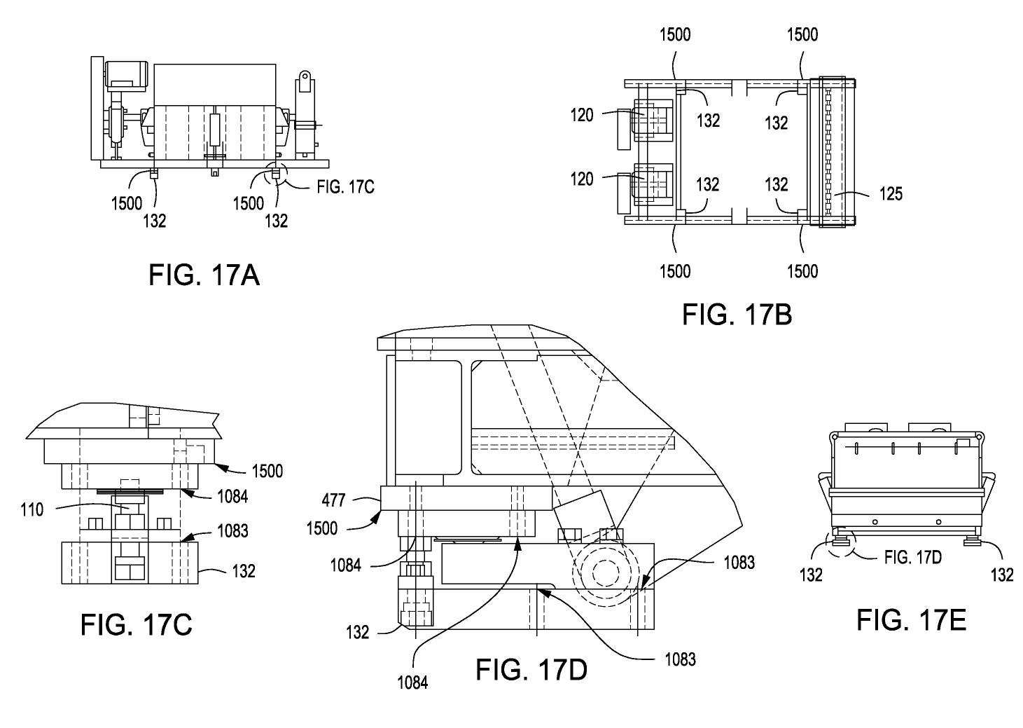

One or more motors operatively connected to the mixer 50 may drive the mixer 50, and one or more timing mechanisms operatively connected to the mixer 50 such as timing gears may keep time for the mixer 50. FIGS. 17A, 17B, 17C, 17D, and 17E show top, side, end, and section views of the mixer 50, including one or more motors 120, e.g. electric motors, which may drive the mixer 50, four load cells 132 for weighing material in the mixer 50 (any number of load cells may be used for this purpose, and four load cells are merely an exemplary amount), one or more plates 477, and one or more timing gears 125 in an oilfield box which may keep time for the mixer 50. Example components which may be included in the mixer, in particular the load cell assembly of the mixer (which may be twinshaft) include the following:

| Component or | | |
|---|---|---|
| Location Number | Quantity | Description |
| 1500 | 4 | Plate, ¾ × 5 × 5 inches (in inches) |
| 132 | 1 | Weigh Module - Set of 4 EP Load Cells |
| 1084 | 16 | HHCS, ⅜ - 16 UNC × 1 - ½ (in inches) |
| 1083 | 16 | HHCS, ⅜ - 16 UNC × 2 - ½ (in inches) |
| 1084, 1083 | 32 | lock washer (LW), ⅜ inch |
| 1083 | 16 | flat washer (FW), ⅜ inch |
| 1083 | 16 | Nut, ⅜ - 14 UNC (in inches) |
| 1084 | | Fixed Pin |

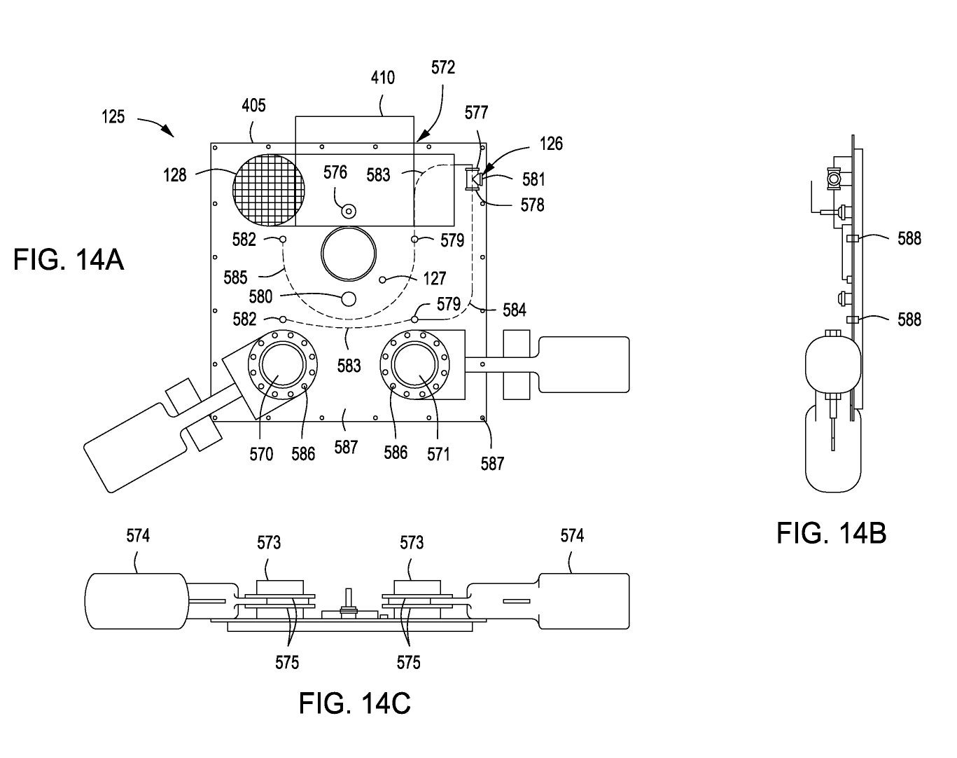

FIG. 14A-14C shows a mixer housing such as a mixer cover assembly 125 for use with the mixer 50 of FIG. 13. Shown in FIG. 14A-14C are a connection point 126 in the mixer cover assembly for the acid (e.g., mineral acid such as sulfuric acid) pump and a connection point 127 for the water (and optionally surfactant) pump. The mixer cover assembly 125 may include a vent 128 therein.

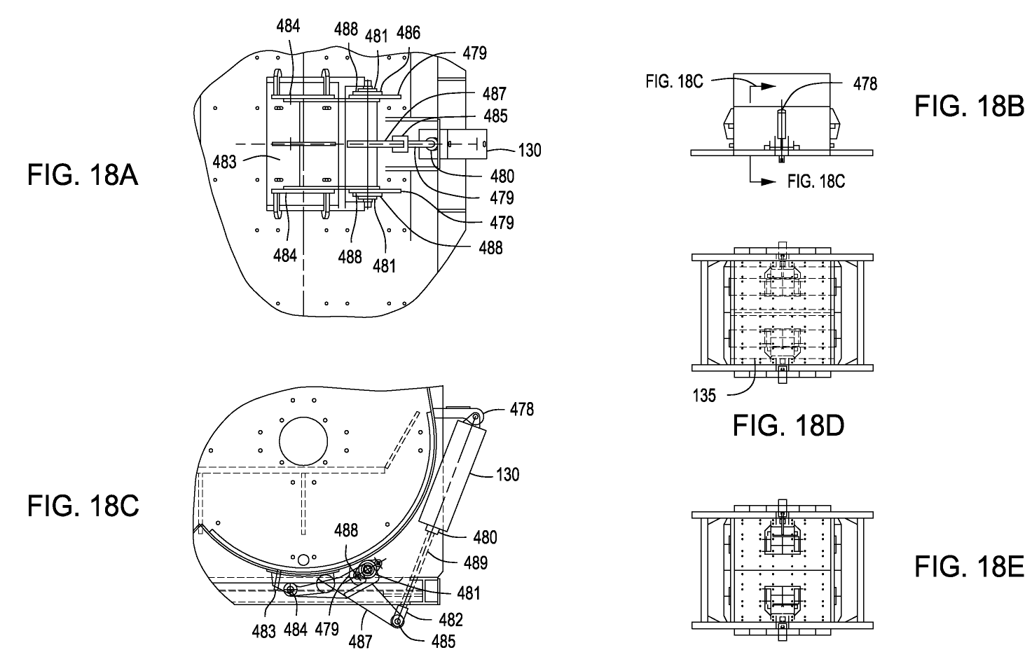

FIGS. 18A-18E show top, side, end and section views of a mixer of FIG. 1 and its bottom cleanout door assemblies. The cleanout door may include one or more discharge doors 140 with one or more drive mechanisms for opening and closing the door(s) 140. The drive mechanism may be a piston/cylinder assembly 130 for opening and closing the door which may be powered by air, for example. An exemplary air-powered cylinder for the piston/cylinder assembly 130 may be 4¼ inch bore and 12 stroke. The mixer 50 may have one or more weir plates 135 which keep one or more paddles (see below) of the mixer 50 as close as possible to the side walls of the mixer 50.

In an example which is not limiting of embodiments, as shown in FIGS. 18A-18E, the mixer 50 may include one or more plates 479 (e.g., four plates) and 478 (e.g., 2 plates); one or more cylinder pins (e.g., two ¾-inch cylinder pins), clevis rods (e.g., two clevis rods), and one or more cotter pins (e.g., 2 cotter pins) at or near locations 485; one or more (e.g., two) rod boot assemblies; hose clamps 482 and 480; one or more (e.g., two) bottom cleanout door lever arm weldments 487; one or more bearings 481 (e.g., four 1-inch flange two bolt bearings); discharge door with upper seal 483; HHCS and lock nuts 484; and lock washers and HHCS 488.

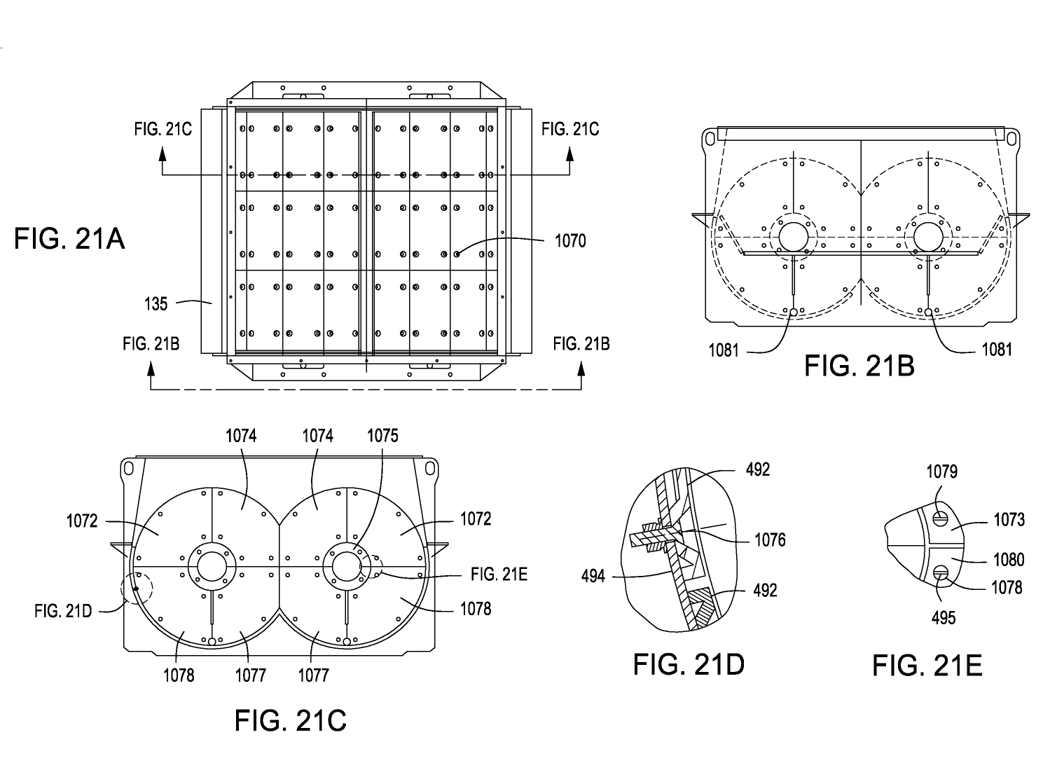

FIGS. 21A-21E show various views of a liner assembly and timeshaft of the mixer 50. Weir plates 135 are shown in FIGS. 21A-21E, as well as two mixers connected together and end plates of the mixer. In an example which is not limiting of embodiments, liners 492 may be spaced apart along the tank wall 494 and secured to the tank wall using one or more bolts 495 in partially drilled holes in the weir plates. Weir plates are secured to the sides of the mixer 50, for example using bolts. An example of components of a liner assembly of a twinshaft mixer is as follows:

| Component or | | |
|---|---|---|
| Location Number | Quantity | Description |
| 492, 1070 | 20 | Drum Liner |
| 1072, 1073 | 4 | End Liner ¼-inch Section-PL |
| | | (plate), ⅜ × 10⅝ side outer) |
| | | (in inches) |
| 1074, 1073 | 2 | Plate, ⅜ inch × 14¾ inch × |
| | | 10⅝ inches (in inches) |
| 1074, 1073 | 2 | Plate, ⅜ inch × 14¾ inch × |
| | | 10⅝ inches (in inches) |
| 1075 | 8 | Seal Liner Plate |
| 1075 | 8 | Gasket |
| 1070, 1076 | 112 | flat hex head screw (FHHS) ⅜ - |
| | | 16 × 1 - ½ (in inches) |
| 1072, 1074, 1075 | 96 | flat hex head screw (FHHS) ⅜ - |
| 1077, 1078, 1079 | | 16 × 1 - ¼ (in inches) |
| 1070, 1079, 1074, 1075, | 208 | Flat Washer, ⅜ inch |
| 1072, 1078, 1077, 1076 | | |
| 1070, 1079, 1074, 1075, | 208 | Washer, Lock Hvy ⅜ inch |
| 1072, 1078, 1077, 1076 | | |
| 1070, 1079, 1074, 1075, | 208 | Nut, Heavy Hex, ⅜ - 16 (in |
| 1072, 1078, 1077, 1076 | | inches) |
| 1080, 1078 | 2 | End Liner ¼ Section-PL, ⅜ × |
| | | 8⅝ S0 (in inches) |
| 1080, 1078 | 2 | End Liner ¼ Section-PL, ⅜ × |
| | | 10⅝ S0 (in inches) |
| 1080, 1077 | 2 | Plate, ⅜ × 14¾ × 8⅝ (in |
| | | inches) |
| 1080, 1077 | 2 | Plate, ⅜ × 14¾ × 8⅝ (in |
| | | inches) |
| 1081 | 4 | Pipe Cap, 1 - ½ (in inches) |

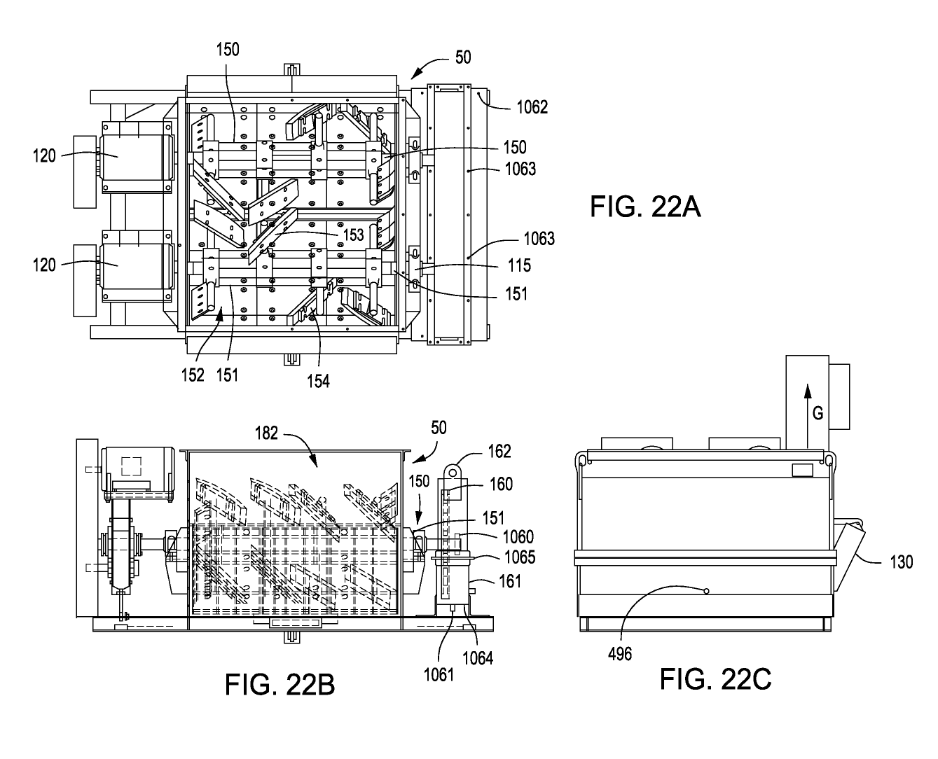

FIGS. 22A, 22B, and 22C show top, side, and end views of the mixer 50, with FIGS. 22A and 22B showing an inside of the mixer 50 including the paddles, shafts 150, 151, bearings 115 that drive gears, cylinders (e.g., air or hydraulic) which open the gate of the mixer, the vents, and the motors 120 (which may be variable speed motors) at the end of the drive shafts 150, 151. Also shown in FIGS. 22A-22C is a timing assembly including the lower timing box gear housing 161, the timing gear 160, upper timing box gear housing 162, and other associated components. Optional sight glass 496 may be included to allow viewing into the mixer 50 when it is closed/sealed. In some embodiments, each arm clamp 156 may be locked onto its respective shaft by, for example, two rod caps and four bolts. The relative positions of the paddles 152-155 circumferentially around the shaft 150, 151 may be changed by loosening one or more bolts in the arm clamp 156 of that particular paddle to be positionally changed. Where the shafts 150, 151 extend through the mixer walls may be sealed so that the mixer 50 interior chamber may be sealed with a heat resistant seal. Gas or vapor G exits through the top of the mixer 50 as shown in FIGS. 22A-C. The mixer 50 has a reaction chamber 182 therein where the reactions take place. Referring to FIGS. 22A-22C, an example of components that may be included with the mixer, in particular the mixer shaft timing assembly, are as follows:

| Component or | | |
|---|---|---|
| Location Number | Quantity | Description |
| 161 | 1 | Lower Timing Box Gear Housing |
| 160 | 2 | Timing Gear |
| 162 | 1 | Upper Timing Box Gear Housing |
| 1060 | 2 | Bushing 3 inch |
| 1060 | 2 | Key ¾ × ¾ × 5⅜ inches |
| 496 | 1 | Sight Glass ¾ inch |
| 1061 | 1 | Pipe Plug ¾ inch |
| 1062 | 4 | Nut ½ - 13 (in inches) |
| 1063 | 18 | Nut ⅜ - 16 (in inches) |
| 1062 | 4 | lock washer (LW) ½ inch |
| 1063 | 18 | lock washer (LW) ⅜ inch |
| 1062 | 4 | hex head cap screw (HHCS) ½ - 13 × |
| | | 1½ inches |
| 1063 | 18 | HHCS ⅜ - 16 × 1¼ inches |
| 1064 | 120L | Mobile SHC 624/Benz Syntech 460 |
| | | (oiling system for monitoring oil) |
| 1065 | | RTV room temperature vulcanizing (RTV) |
| | | elastomer sealant, which may be a silicone |
| | | sealant |

FIGS. 22A and 22B show the shafts 150, 151 with the paddles within the mixer 50 and the open area 182 above the shafts 150, 151 and paddles. The open area 182 exists to allow the material in the mixer 50 that is moved by the paddles to move upward within the mixer 50 into the open space 182 to form one or more plumes of material in the open space 182. FIG. 22C shows an end view of the mixer 50.

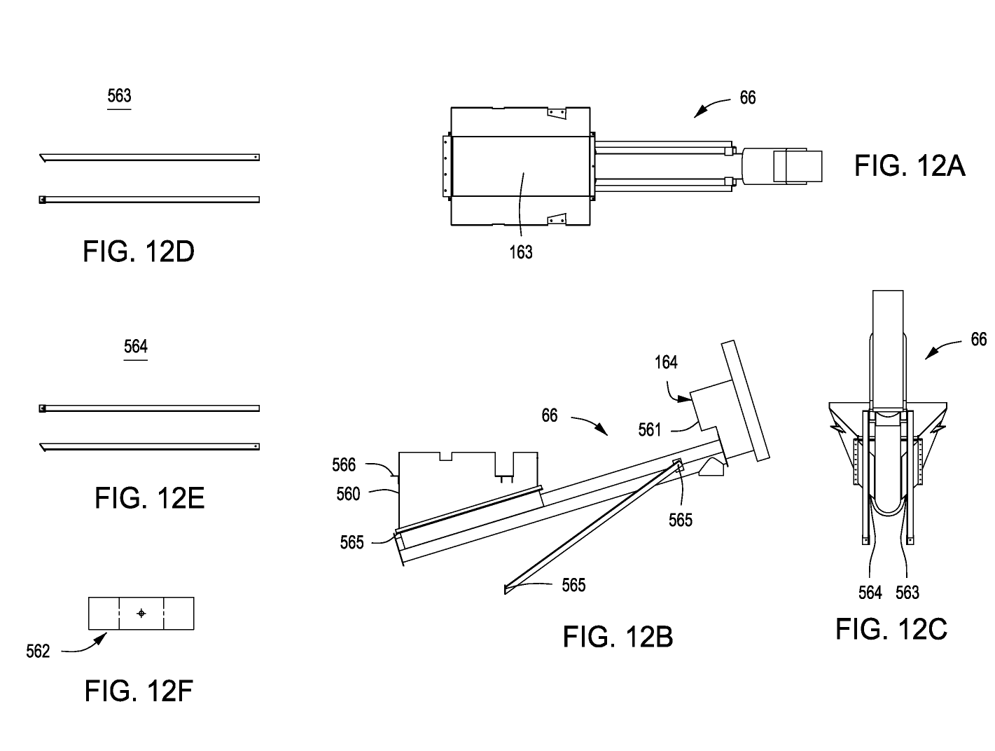

FIGS. 12A-12F show top, side, and end views of a mixer discharge screw assembly and its associated components for use with the mixer 50 of embodiments. A tank or hopper 163, e.g. a mixer discharge screw hopper, may be located under the mixer 50 to catch the dry material P discharged from the mixer 50. An auger or screw conveyor 66 with a drive motor 164 may carry the product P to its next destination (e.g., disposal at, for example, a landfill). Also shown in FIGS. 12A-F are details of the various parts such as screw supports.

A mixer 50 may be utilized in embodiments of the system and method. The mixer 50 may have a discharge door 140 or discharge gate and a piston/cylinder assembly 130 for opening and closing the door 140. The door 140 may be used to discharge product upon operation of the piston/cylinder assembly 130. One or more motors may be mounted on the mixer 50.

Inside the mixer 50 may be the shafts 150, 151, arms extending from the shafts 150, 151, and paddles extending from the arms, and Weir plates 135 and associated bolts in an embodiment. The mixer 50 may include bearings and gears, where oil may keep the gears lubricated. An inside of the gear box may include timing gears and other associated components. Gear housing may protect the gears from wear and tear by housing the gears therein.

FIGS. 14A, 14B, and 14C illustrate the cover of the mixer 50. Water W, base B, calcium chloride C, and/or acid A may be added to the mixer 50 through the holes in this mixer cover assembly. FIG. 14A shows the mixer cover assembly 125 including the lid 405, manifold 410, discharge vent 128, catalyst entry location 570, base entry location 571, and connection point 127 for water and/or surfactant pump system, connection point 126 for acid pump system. In an example that is not limiting of embodiments, the following may be included with the mixer cover assembly: cover weldment 572, inlet flange adapters 573 (e.g., two 10-inch inlet flange adapters), one or more knifegate valves 574 (e.g., two 10-inch pneumatic knifegate valves), one or more pipe flange gaskets 575 (e.g., four 10-inch pipe flange gaskets), one or more spray nozzles 588 (e.g., four 1-inch stainless steel spray nozzles), male NPT camlock fitting 581 (e.g., one two-inch stainless steel male NPT camlock fitting), one or more fitting tees 579 (e.g., two 1-inch fitting tees stainless steel), one or more fittings 582 (e.g., one-inch 90 degree stainless steel fittings, three total), and one or more hose assemblies 583 (e.g., two 27-inch hose assemblies), 584 (e.g., 38-inch hose assembly), and 585 (e.g., 54-inch hose assembly). Included at or near location 578 may be one or more pipe caps (e.g., 2-inch pipe caps) and one or more fittings (e.g., straight stainless steel 1 inch fittings), included at or near location 577 may be one or more bushings (e.g., two 2-inch×1-inch stainless steel bushings) and one or more fittings (e.g., one-inch 90 degree stainless steel fittings), included at or near location 576 may be an infrared temperature transmitter and one or more pipe caps (e.g., two 2-inch pipe caps), included at or near location 586 may be one or more one or more HHCS (e.g., forty-eight ⅞-9×1½ inch HHCS) and one or more lock washers (LWs) (e.g., forty-eight ⅞-inch LWs), and included at or near location 587 may be one or more HHCS (e.g., sixteen ⅜-16×1½ inch HHCS), lock washers (LWs) (e.g., sixteen ⅜-inch LW), nuts (e.g., sixteen ⅜-16 inch nuts), and room temperature vulcanizing (RTV) elastomer sealant, which may be a silicone sealant. Measurements are in inches unless otherwise specified.

The mixer may operate under low shear mixing conditions in one embodiment. One measurement of shear in mixing is power per unit mass of material being mixed, and for an example of the method of embodiments a maximum of approximately 40 horsepower (HP) per approximately 2000 pounds to approximately 3000 pounds of material is used, which corresponds to only 0.013 to 0.02 HP per pound of material. High shear mixing typically involves a relatively small high shear, very high rpm rotor/stator device to accomplish the mixing. The mixer 50 of embodiments may be a horizontal mixer, where the material is relatively slowly folded together.

The paddles of the mixer 50 promote a homogeneous mix independent of particle size and density of the ingredients. The mixer 50 may give low shear forces but allow for a rapid mix with the speed and amount of batches per hour. Some example specifications for the mixer 50 include the following (all numbers may be approximate):
Range: 15 to 30 cubic feet or a maximum input weight of 3,500 pounds per batch
Drives: (2) 20 HP-480 Volt, 3pH, 60 hertz
Capacity: Up to 10 batches per hour (depending on recipe and configuration of the unit)
Shaft speed: 70 revolutions per unit (RPM)
Mixing paddle tip speed: 11 feet/second

The mixer 50 ultimately separates the conditioned material P from the hot gases and volatile organic compounds (VOCs) G. The conditioned material P may optionally be transported to another location such as a landfill at which the conditioned material P may be disposed. The transporting of the conditioned material P may be via a material transporting device 66, which may be a conveyor such as a screw conveyor, and/or other transportation device or method.

One or more scrubbers 70 or condenser/scrubber devices may be used to capture the hot gases and/or VOCs G from the mixer 50 via condensation quenching and cooling. Output from the scrubber 70 includes the clean air discharge AD and liquid discharge LD comprising oil and water. An oil/water separating device 75 discharges oil HC to storage, for example in storage tank 76, and water W1. The water W1 may optionally be recycled back into the scrubber 70. The water W1 may optionally be stored in a storage device such as a storage tank 77.

Ultimately, the scrubber process involves capturing vapors and transferring them to a condensation column or in another process. Non-condensed gases are emitted, and oil and water are collected. Residual feed material is discharged for use or disposal elsewhere.

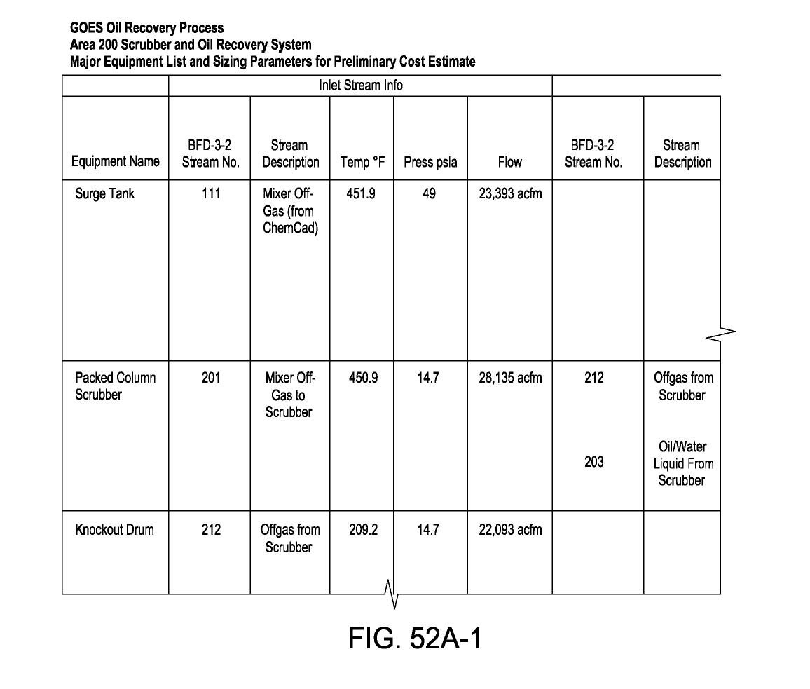

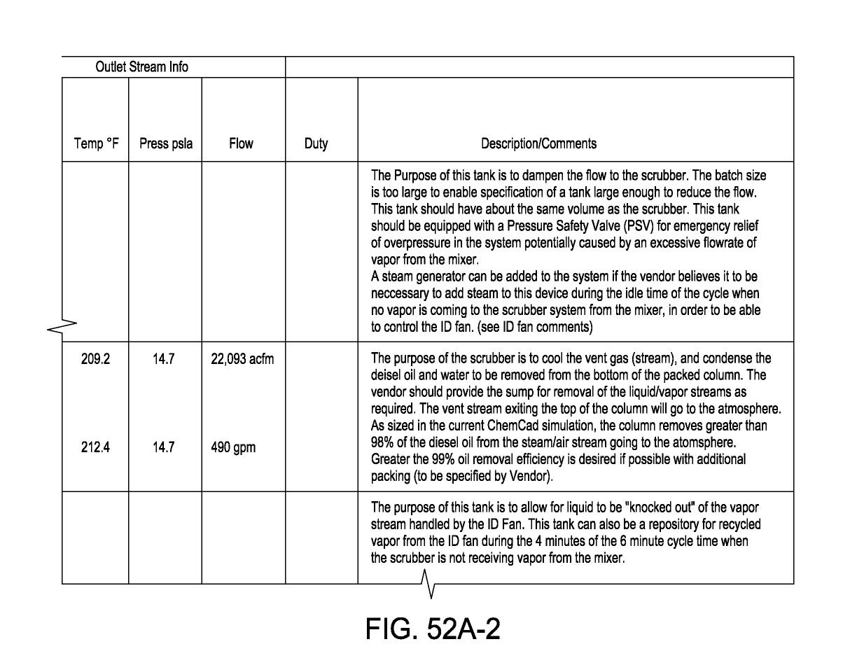

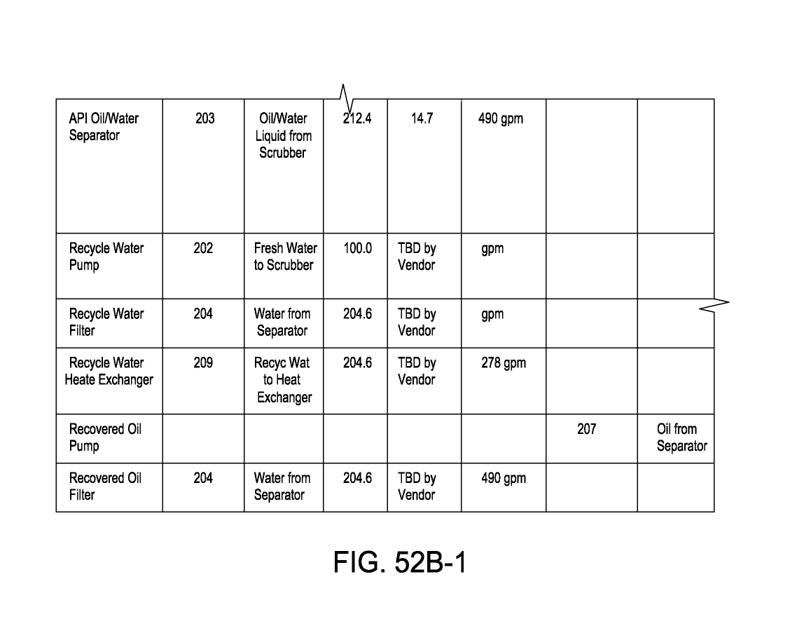

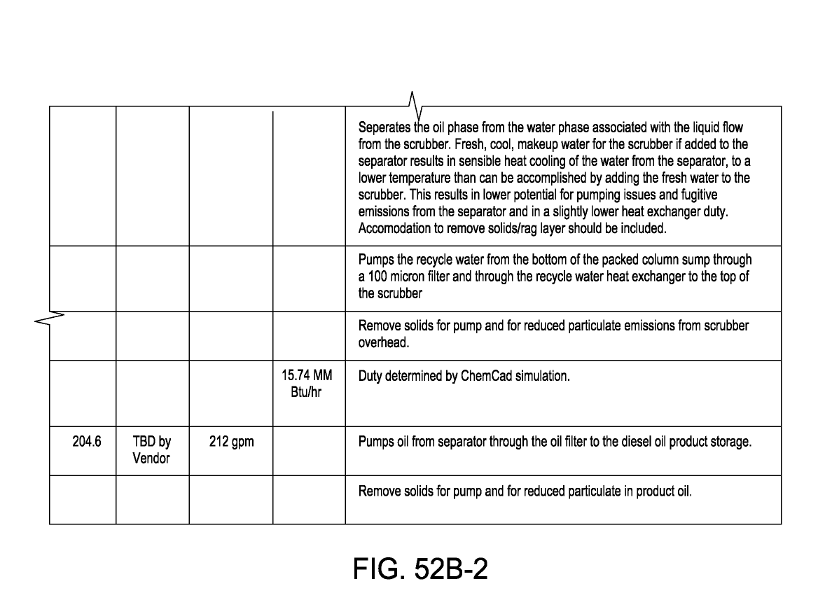

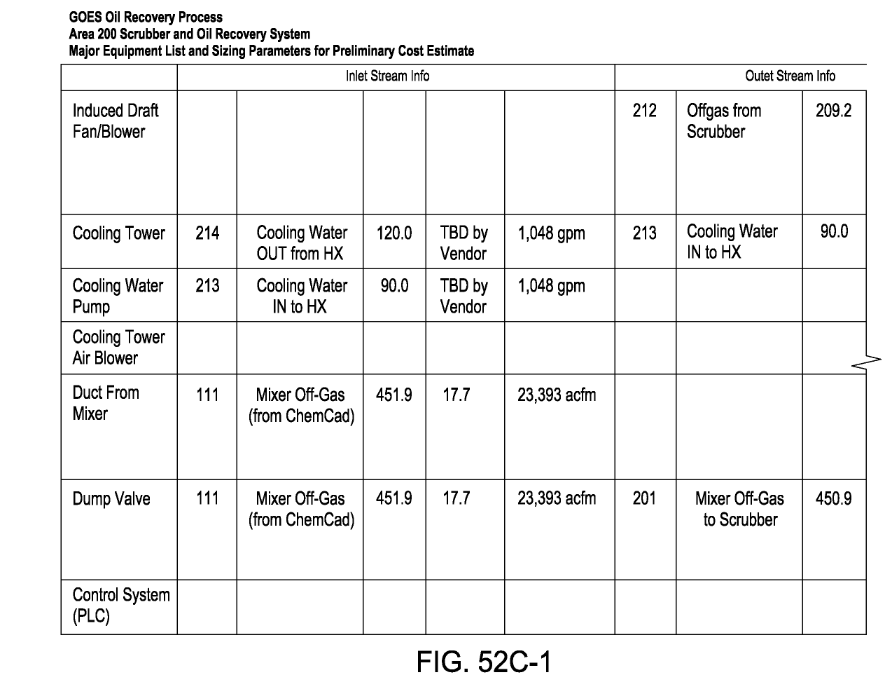

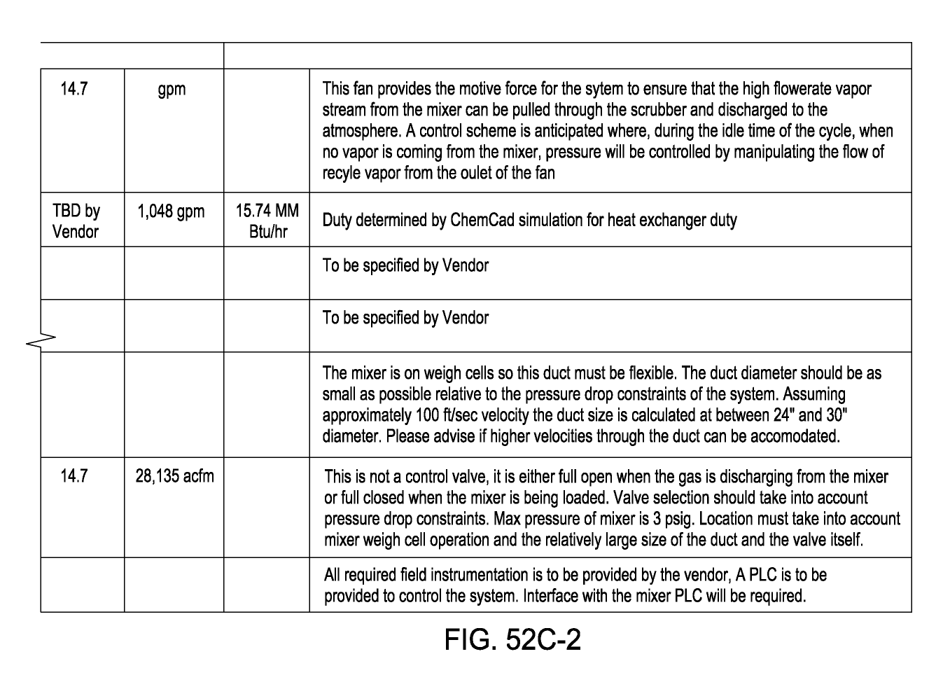

FIGS. 52A-1, 52A-2, 52B-1, 52B-2, 52C-1, and 52C-2 show some components, parameters, and description of condensing and air pollution control equipment such as a scrubber capable of use in the gas and oil recovery system and method of embodiments.

FIGS. 2A, 2B, 2C, 2D, and 2E show a portion of the system of FIG. 1, including shaker components described in more detail in relation to FIG. 9 and the mixer 50 and its feed components. The shaker assembly 615, shaker chute assembly 620, shaker starter box 611, shaker platform assembly 613, control panel 850, mixer charge screw starter box 1530, mixer feed screw and hopper assembly 35, acid tank 55, 2-cement weigh batcher assembly (which may be 18 cubic feet each in one example), air compressor 853, pump and acid (e.g., sulfuric acid) meter assembly 852, pump and water (and/or surfactant) meter assembly 851, mixer skid weldment 862, shaker skid weldment 612, mixer stand and access platform 863, screw support weldment 864, mixer discharge screw assembly 66, emergency stop (e-stop) bracket 861 are shown in FIGS. 2A-E. In some examples, isolator mounts (e.g., 20 total) and junction box plates (e.g., 6 total) may be located at or near location(s) 866, an interlock box bracket 867 may be disposed on the mixer assembly, and at or near location 868 may be located one or more hex head cap screws (e.g., 88 total ¾ inch×2 inch hex head cap screws), ¾ inch lock washers (e.g., 88 total), and ¾ inch hex nuts (e.g., 88 total).

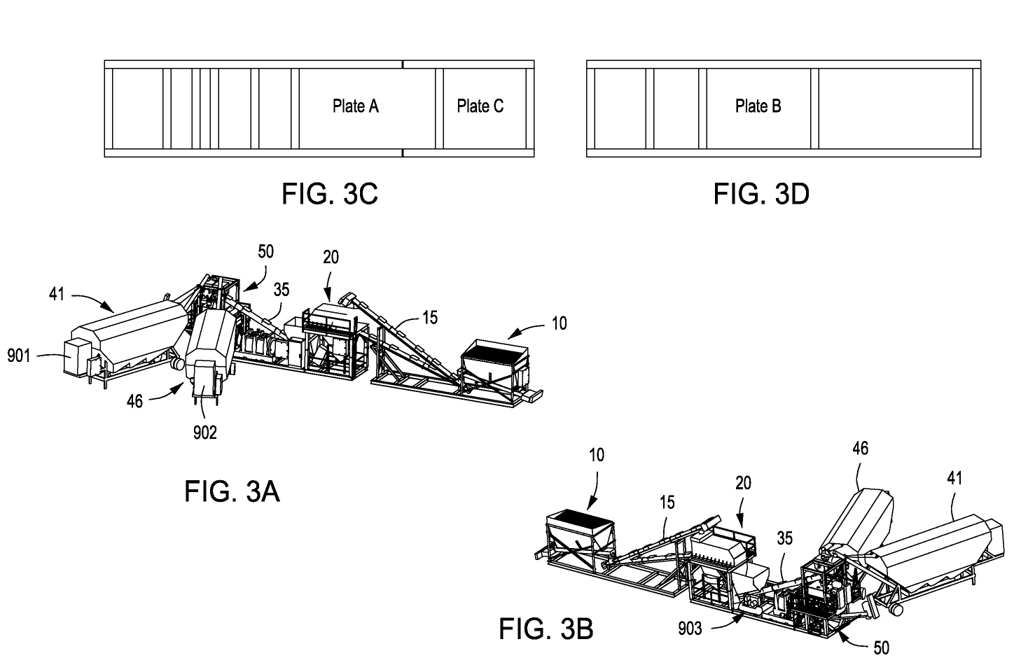

FIGS. 3A, 3B, 3C, and 3D show a portion of the system of FIG. 1, including feed tanks of components to be introduced into the mixer. The base tank 41 and catalyst tank 46 may in examples not limiting of embodiments be weatherproof tanks that can make the dry product flow by bags that expand and contract. Bag collection houses 901, 902 may optionally be included to collect dust when the raw product is loaded. An optional acid hookup 903 may be included as shown to allow the acid supply to be hooked up (e.g., acid supply via tanker and/or trailer). Foundation Plates A and B are also shown in FIGS. 3C and 3D. Foundation Plate A may include the mixer and screws, and the mounting baseplate may be approximately 8 feet by approximately 24 feet, 8 inches. Foundation Plate B may include the receiving hopper and screws, and the mounting baseplate may be approximately 8 feet by approximately 28 feet, 7 inches. Foundation Plate C may include the shaker support, and the mounting baseplate may be approximately 8 feet by approximately 10 feet, 11 inches.

FIGS. 4A, 4B, and 4C show top views and side views of portions of the system of FIG. 1. FIG. 4C shows the grizzly top 16 of the receiving hopper 10, which may be removable for cleanout. In one example which is not limiting of embodiments, the batch size may be 3,500 pounds per batch or 30 cubic feet, whichever comes first. In an example which is not limiting of embodiments, approximately 10 batches per hour may be accomplishable using the system. The scrubber system may require 90 cubic feet of air in some embodiments, which is not limiting of embodiments. At or near location 899 may be a mixer 50, compressor, acid pump, water meter pump, mixer discharge screw, and motor starter panel. One or more screw conveyors 15 from the receiving hopper 10 may be moveable to location 898, for example, for shipping of the system and may have a screw cleanout access area 897, as may any or all of the other conveyors of the system. The shaker hopper 30 may have a capacity of approximately 80 cubic feet. Shaker starter box or starter panel 611, liquid storage tank with pump 25, water meter 62 and pump 61, weigh batcher 19, receiving hopper screw motor starter panel 896, silo motor starter panels 891, 892, mixer feed screw motor starter panel 893, multi-motor starter 894 (which may be a 480 volt multi-motor starter in one example, and a personal computer may be moved within 25 feet of this location for communication), E-250 batch control at or near the mixer feed screw motor starter panel 893, air compressor 852, portable silos 41 and 46 (which in one example each may be a 300-barrel silo), acid pump 56 and meter 57, mixer feed conveyor 35, shale shaker 20, mixer discharge screw conveyor 66, mixer access platform 863, and mixer 50 are shown in FIGS. 4A-4C.

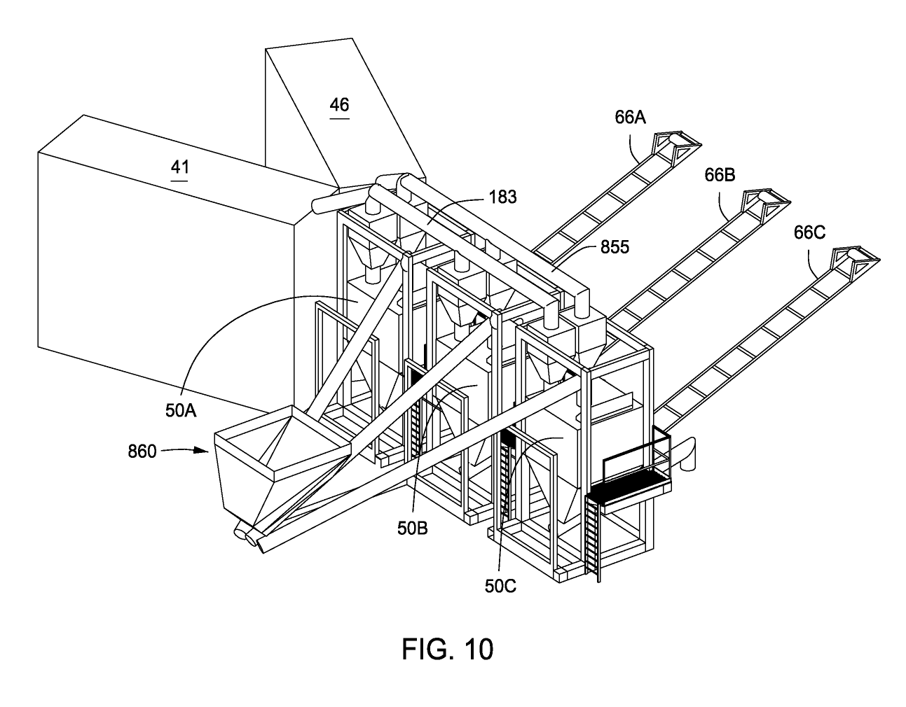

Referring to FIG. 4A-4C, it is within the scope of embodiments to add multiple mixers to the same gas cleaning and oil recovery equipment or scrubber 70 to handle more volume. Like Lego's, the shaker 20 may be taken out of the line, fittings may be quickly attached to the mixer, and the system with multiple mixers may be up and running within one day. Up to 12 mixers are contemplated in some embodiments. FIG. 10 shows three mixers 50A, 50B, and 50C added to the same gas cleaning and oil recovery equipment. The shown system in FIG. 10 may be in some examples a 54 ton/hour unit. The mixers 50A, 50B, 50C in FIG. 10 could be doubled so that six or more mixers may be hooked up to the same gas cleaning and oil recovery system or scrubber.

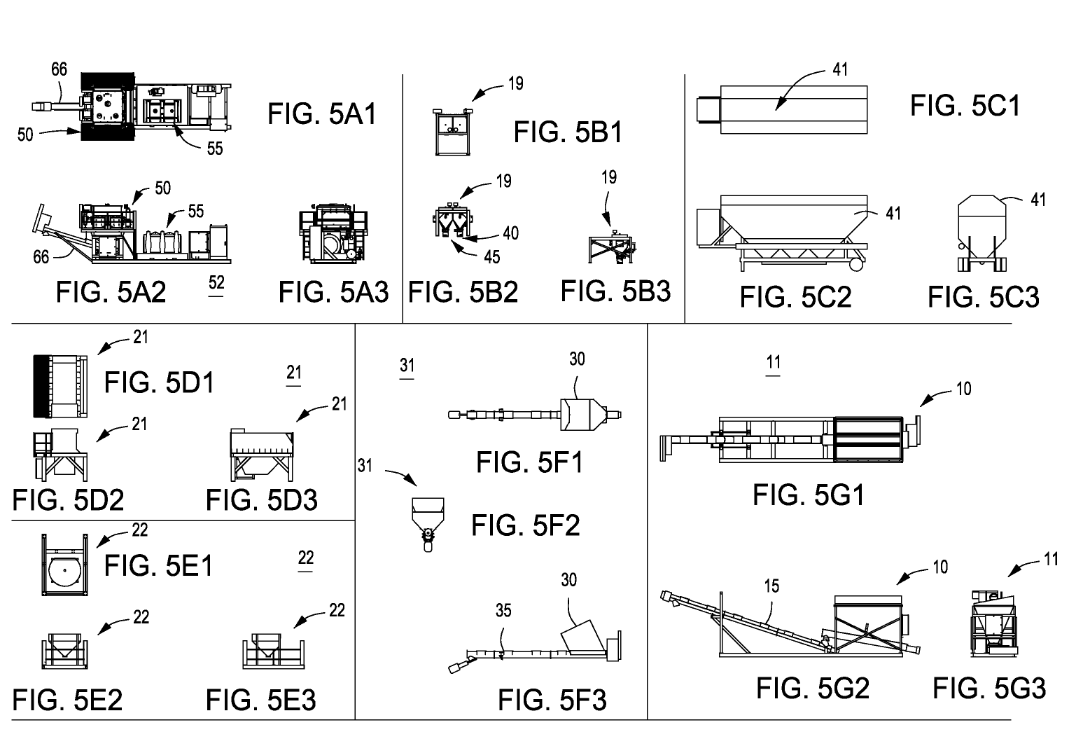

FIGS. 5A1, 5A2, 5A3, 5B1, 5B2, 5B3, 5C1, 5C2, 5C3, 5D1, 5D2, 5D3, 5E1, 5E2, 5E3, 5F1, 5F2, 5F3, and 5G1, 5G2, and 5G3 show various system components, including top, side, and end views of the mixer skid assembly 52 for the mixer 50 shown in FIGS. 5A1, 5A2, and 5A3. The mixer units are placed on skids of the skid assembly 52 so that they may be easily and quickly added and removed when needed and highly transportable and mobile.

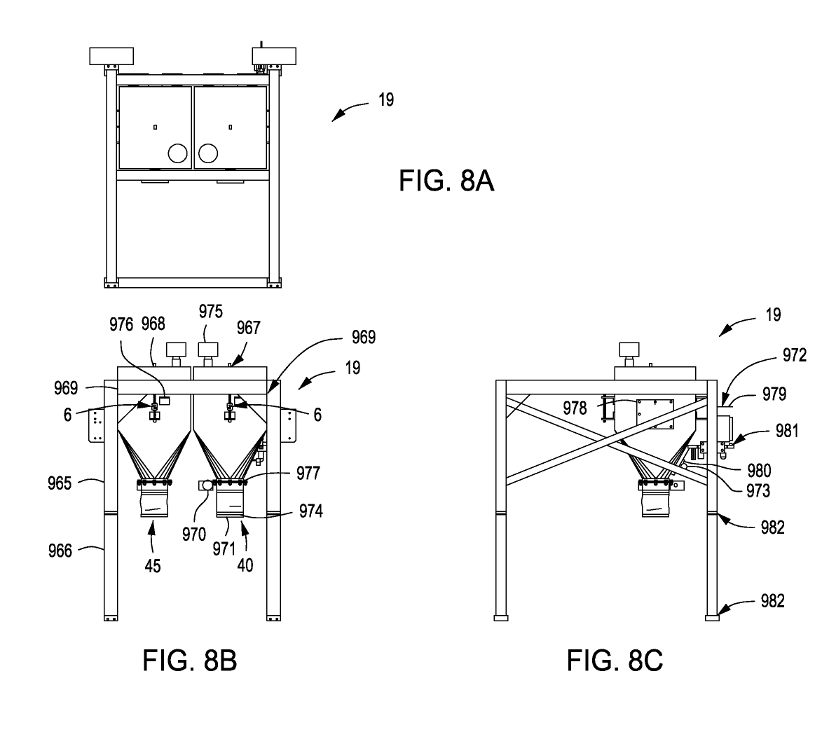

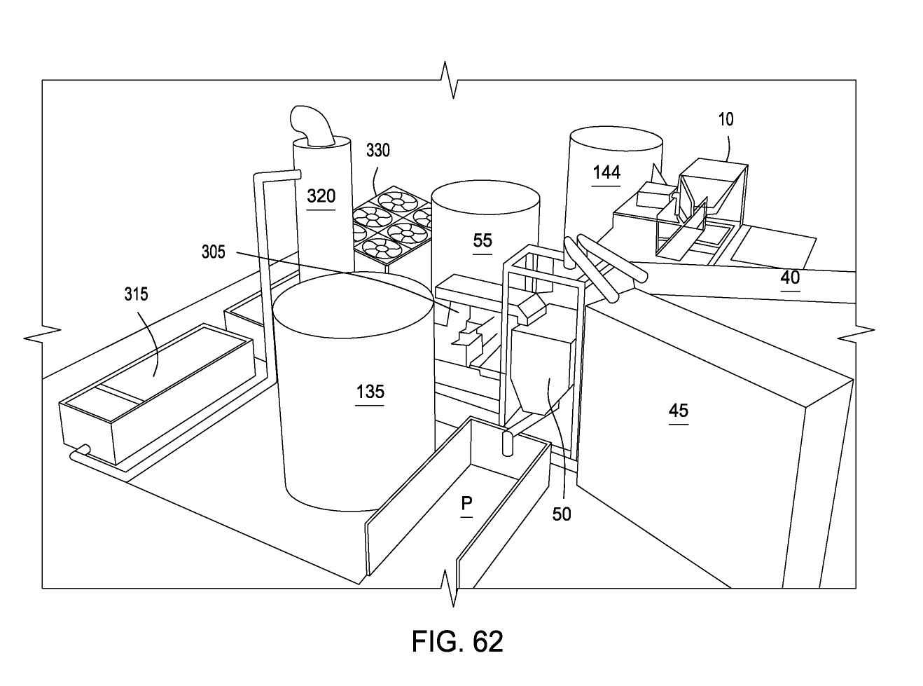

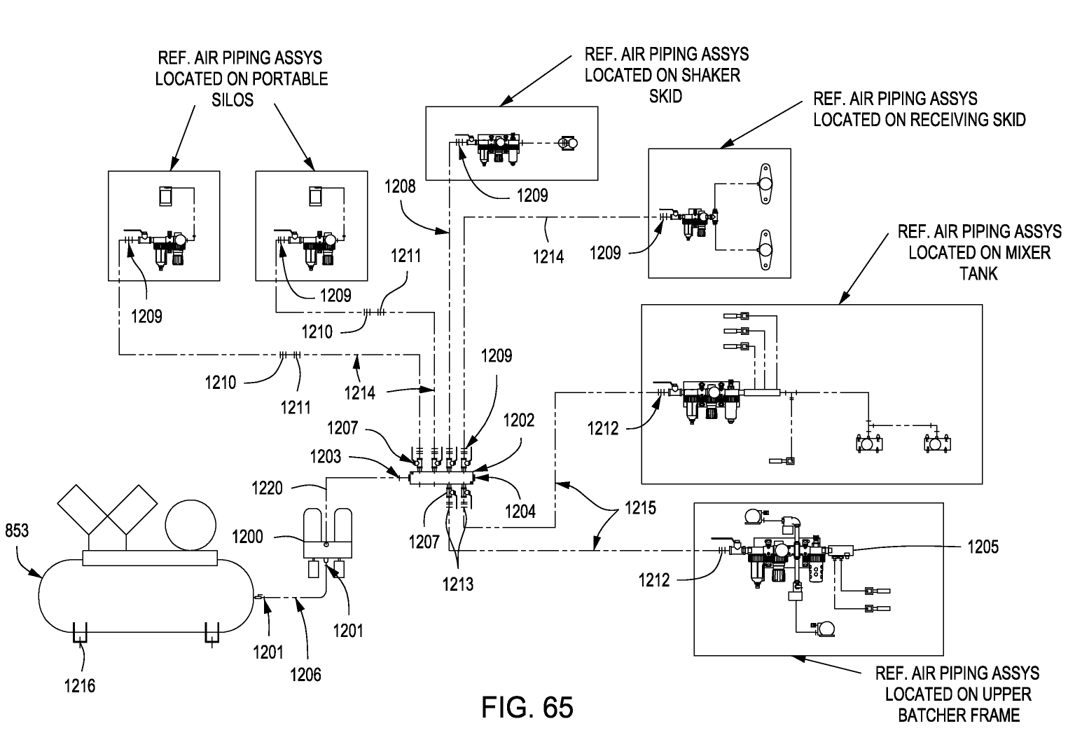

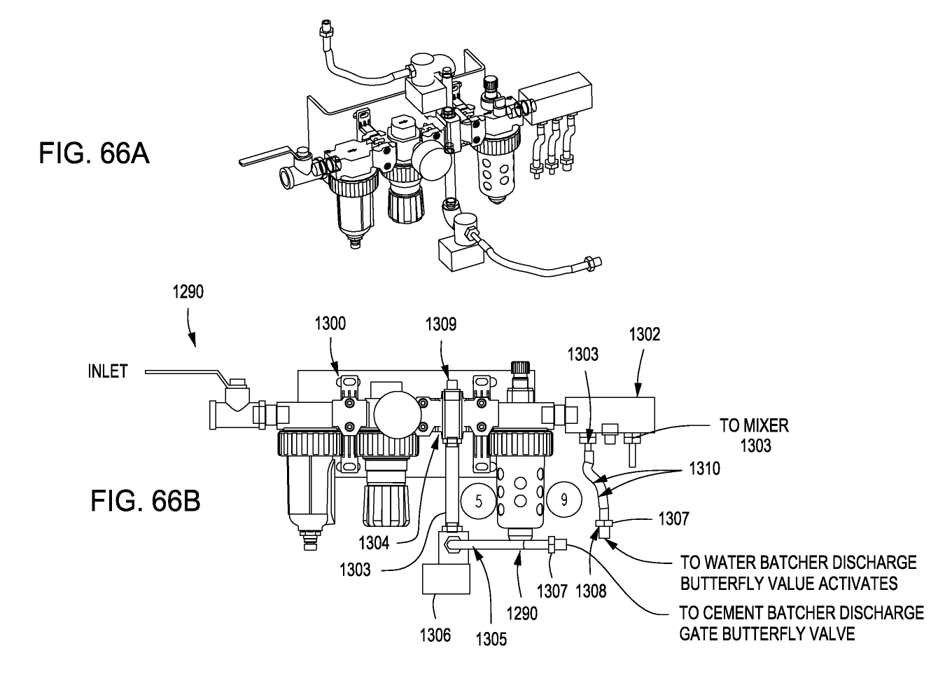

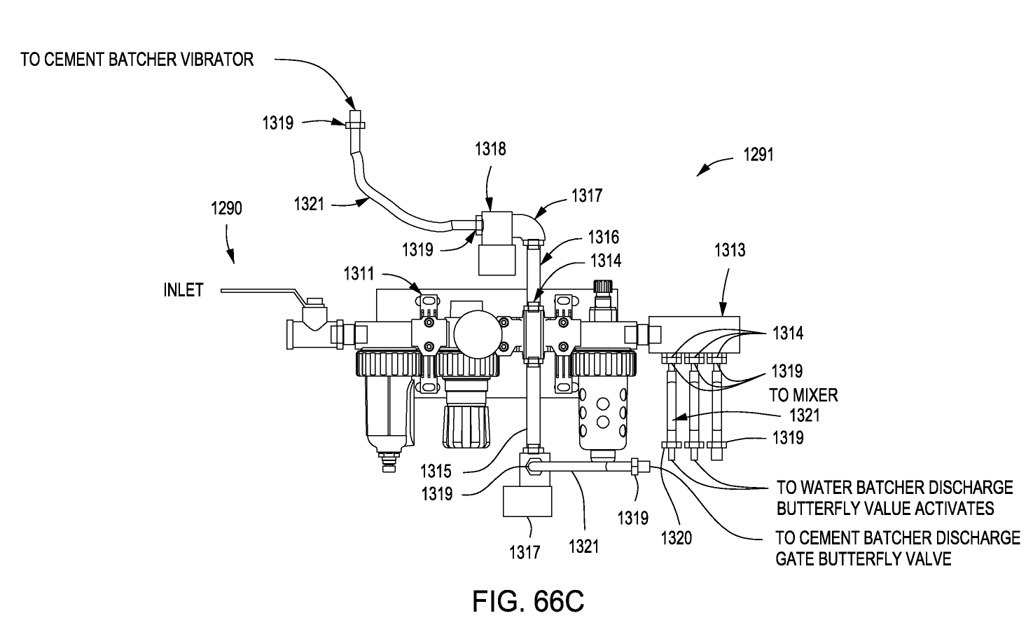

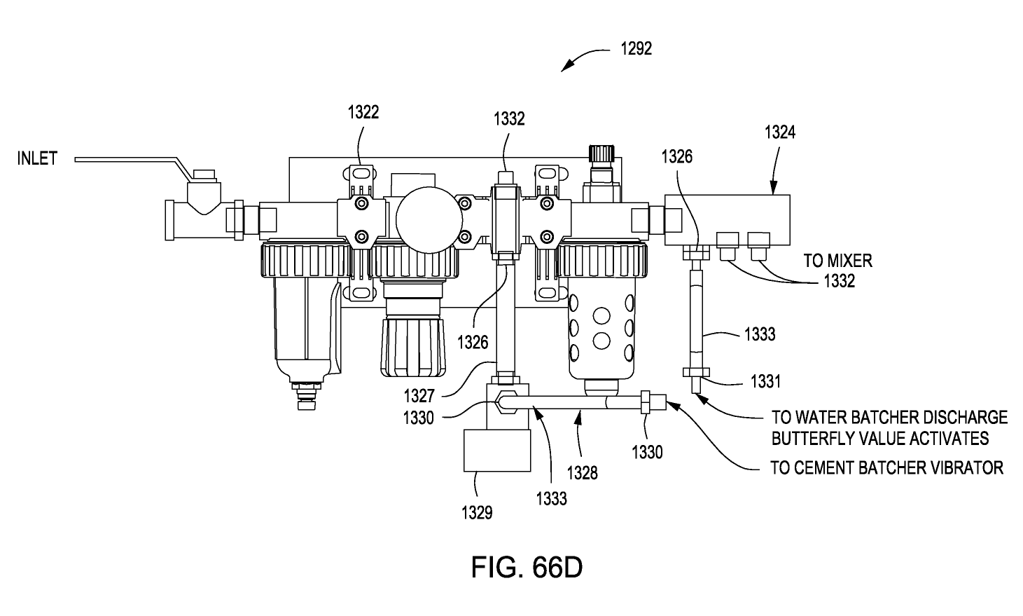

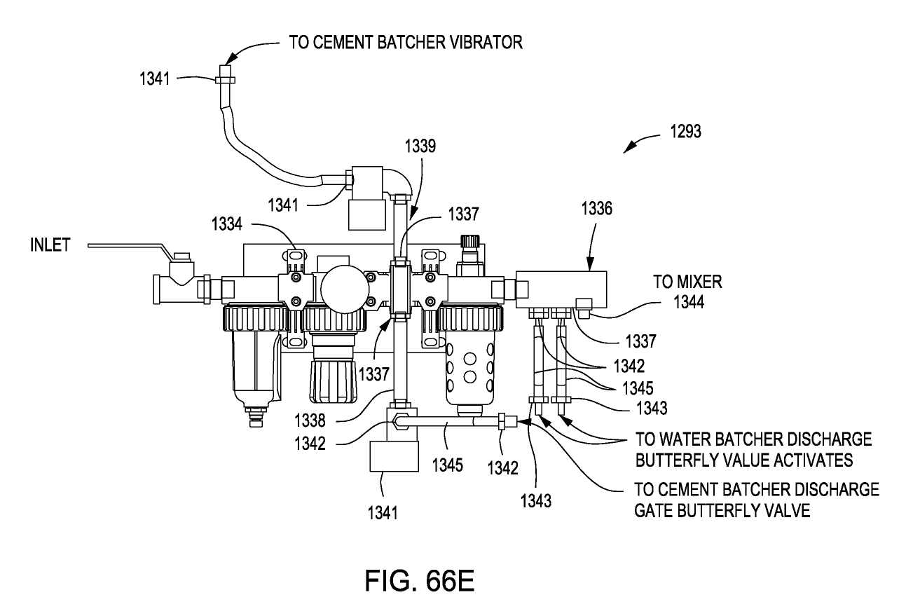

Also illustrated in FIGS. 5B1, 5B2, and 5B3 are top, side, and end views of an alternate embodiment of a batcher assembly 19 which may include the base batcher or tank 40 and the catalyst (e.g., calcium chloride or salt) batcher or tank 45 suspended within one structure 19, the batcher assembly 19 for dispensing the salt or calcium chloride C and the base B into the mixer 50. FIGS. 8A, 8B, and 8C also show side, top, and end views of the batcher assembly 19 and its components. A load cell assembly 6 in each batcher 45, 40 of the batch assembly 19 is shown in FIG. 8B which may be utilized for weighing material disposed in each batcher prior to its introduction into the mixer 50, a portion of the automated system and method of some embodiments for determining amount of material needed, weighing the material, and introducing the material into the mixer 50. FIGS. 65 and 66A-66E show various perspective views of a dry meter system 215 for metering amounts of components of the batcher assembly 19. The batcher assembly 19 may be used as the batcher assembly 300 of FIG. 1A. An example of skid plant air piping components (see FIG. 62) is as follows:

| Component or | | |
|---|---|---|
| Location Number | Quantity | Description |
| 853 | 1 | Air Compressor 15 HP |
| 1200 | 1 | Air Dryer 120 V |
| 1201 | 2 | Combination Nipple ¾ inch |
| 1202 | 1 | Manifold |
| 1203 | 1 | Nipple ¾ inch × 2 inch |
| 1204 | 1 | Pipe Plug ¾ inch |
| 1205 | 1 | Pipe Plug ½ inch |
| 1206 | 96″ | Hose ¾ inch |
| 1206 | 2 | Hose Clamp |
| 1207 | 6 | Ball Valve ½ inch |
| 1208 | 3 | Hose Assembly ½ inch × 25 feet |
| 1211, 1209, 1212 | 12 | Male Coupler ½ inch MNPT × ½ inch |
| 1209, 1210, 1212 | 12 | Female Coupler ½ inch FNPT × ½ inch |
| 1211, 1210, 1209 | 12 | Bushing ½ inch × ⅜ inch |
| 1220 | 1 | Str. Elbow 90 degree ¾ inch |
| 1214 | 3 | Hose Assembly ½ inch × 50 feet |
| 1207 | 6 | Nipple ½ inch × 1½ inch |
| 1212 | 4 | Fitting ½ inch MNPT × ½ inch hose |
| 1215 | 720″ | Hose ½ inch |
| 1215 | 4 | Hose Clamp ½ inch |
| 1216 | 4 | Nut ½ - 13 (in inches) |
| 1216 | 4 | lock washer (LW) ½ inch |
| 1216 | 4 | HHCS ½ - 13 × 1¾ inch (in inches) |

Following are examples of components of air piping for cement and water batcher or water meter or water meter and no water batcher/meter or with no mixer (see FIGS. 66A, 66B, 66C, 66D and 66E):

### Air Piping (1) Cement & (1) Water Batcher/Meter (e.g., 24 V DC)

| Component or | | |
|---|---|---|
| Location Number | Quantity | Description |
| 1300 | 1 | Air Line Filter, Regulator & Lubricator |
| | | Assembly |
| 1301 | 1 | Nipple ½ inch × 1 - ½ inch long |
| 1302 | 1 | 3 Station Manifold |
| 1303 | 3 | Bushing, ⅜ inch × ¼ inch |
| 1304 | 1 | Nipple, ¼ × 4 inches |
| 1305 | 1 | ¼ inch diameter Street Elbow 90 Degrees |
| 1306 | 1 | 2-Way Solenoid Valve (24 V DC) |
| 1307 | 5 | Hose Barb, ¼ inch Hose |
| 1308 | 1 | Fitting ¼ inch inner diameter (ID) × ⅛ - |
| | | 27 Pipe inches) |
| 1309 | 2 | Pipe Plug ⅜ inch |
| 1310 | 250 | ¼ inch outer diameter (OD) Hose |
| 1310 | 6 | ¼ inch Hose Clamp |

### Air Piping (1) Cement & (1) Water Batcher/Meter 1290

| Component or | | |
|---|---|---|
| Location No. | Quantity | Description |
| 1300 | 1 | Air Line Filter, Regulator & Lubricator |
| | | Assembly |
| 1301 | 1 | Nipple ½ inch × 1 - ½ inch long |
| 1302 | 1 | 3 Station Manifold |
| 1303 | 3 | Bushing, ⅜ inch × ¼ inch |
| 1304 | 1 | Nipple, ¼ inch × 4 inch |
| 1305 | 1 | ¼ inch diameter Street Elbow 90 Degrees |
| 1306 | 1 | 2-Way Solenoid Valve |
| 1307 | 5 | Hose Barb, ¼ inch Hose |
| 1308 | 1 | Fitting ¼ inch ID × ⅛ - 27 Pipe (in inches) |
| 1309 | 2 | Pipe Plug ⅜ inch |
| 1310 | 250 | ¼ inch OD Hose |
| 1310 | 6 | ¼ inch Hose Clamp |

### Air Piping (2) Cements & (1) Water Batcher/Meter 1291

| Component or | | |
|---|---|---|
| Location Number | Quantity | Description |
| 1311 | 1 | Air Line Filter, Regulator & Lubricator |
| | | Assembly |
| 1312 | 1 | Nipple ½ inch × 1 - ½ inch long |
| 1313 | 1 | 3 Station Manifold |
| 1314 | 5 | Bushing, ⅜ × ¼ (in inches) |
| 1315 | 1 | Nipple, ¼ × 4 (in inches) |
| 1316 | 1 | Nipple, ¼ × 3 (in inches) |
| 1317 | 2 | ¼ inch diameter Street Elbow 90 Degrees |
| 1318 | 2 | 2-Way Solenoid Valve |
| 1319 | 8 | Hose Barb, ¼ inch Hose |
| 1320 | 2 | Fitting ¼ inch ID × ⅛ - 27 Pipe |
| | | (in inches) |
| 1321 | 300 | Hose, ¼ inch ID |
| 1321 | 10 | Clamp, Hose ¼ inch |

### Air Piping (1) Cement & (No) Water 1292

| Component or | | |
|---|---|---|
| Location Number | Quantity | Description |
| 1322 | 1 | Air Line Filter, Regulator & Lubricator |
| | | Assembly |
| 1323 | 1 | Nipple ½ inch × 1 - ½ inch long |
| 1324 | 1 | 3 Station Manifold |
| 1326 | 3 | Bushing, ⅜ inch × ¼ inch |
| 1327 | 1 | Nipple, ¼ inch × 4 inches |
| 1328 | 1 | ¼ inch diameter Street Elbow 90 Degrees |
| 1329 | 1 | 2-Way Solenoid Valve |
| 1330 | 5 | Hose Barb, ¼ inch Hose |
| 1331 | 1 | Fitting ¼ inch inner diameter (ID) × ⅛ - |
| | | 27 Pipe inches) |
| 1332 | 3 | Pipe Plug ⅜ inch |
| 1333 | 200 | ¼ inch outer diameter (OD) Hose |
| 1333 | 4 | ¼ inch Hose Clamp |

### Air Piping (2) Cement & (No) Water Batcher/Meter 1293

| Component or | | |
|---|---|---|
| Location Number | Quantity | Description |
| 1334 | 1 | Air Line Filter, Regulator & Lubricator |
| | | Assembly |
| 1335 | 1 | Nipple ½ inch × 1 - ½ inch long |
| 1336 | 1 | 3 Station Manifold |
| 1337 | 4 | Bushing, ⅜ inch × ¼ inch |
| 1338 | 1 | Nipple, ¼ inch × 4 inches |
| 1339 | 1 | Nipple, ¼ inch × 3 inches |
| 1340 | 2 | ¼ inch diameter Street Elbow 90 Degrees |
| 1341 | 2 | 2-Way Solenoid Valve |
| 1342 | 6 | Hose Barb, ¼ inch Hose |
| 1343 | 2 | Fitting ¼ inch ID × ⅛ - 27 Pipe |
| | | (in inches) |
| 1344 | 1 | Pipe Plug ⅜ inch |
| 1345 | 300 | Hose, ¼ inch ID |
| 1345 | 8 | Clamp, Hose ¼ inch |

In an example which is not limiting of embodiments, the batcher assembly may include a cement batcher stand weldment 965, a stand leg extension 966 for each leg of the weldment, two cement batcher weldments 967 and 968 (which may be 18 cubic feet each), plates 969 (which may be 3/16×12×15 inches), one or more butterfly valves 970 (for example a two 10-inch butterfly valves), one or more canvas boots 971 (for example 34.5 circumference×10-inch length), one or more summing box mounts 972, one or more ball vibrators 973, one or more hose clamps 974 (for example one or more 1½-inch DIA-12-inch DIA), one or more air intake filters 975 (e.g., 195 CFM 2½-inch connection), and air piping 981 (e.g., (2) cement and (NO) water batcher/meter). At or near location 976 may be one or more SAE washers (e.g., ½ inch SAE washers), one or more HHCS (e.g., ½×2¾ inches HHCS), one or more lock nuts (e.g., ½-inch lock nuts), and one or more hex nuts (e.g., ⅝-inch hex nuts). At or near location 977 may be one or more SAE washers (e.g., ½-inch), one or more HHCS (e.g., ½-13×1½ inches), one or more lock washers (e.g., ½-inch lock washers), and one or more nuts (e.g., ½-13 inch heavy hex nuts). At or near location 978 may be one or more lock washers (e.g., ⅜-inch lock washers), one or more hex nuts (e.g., ⅜-inch hex nuts), and one or more rubber sponge strips. At or near location 979 may be summing box isolator mounts, conduit hangers, C-claps, and lock nuts (e.g., ¼-inch lock nuts). At or near location 980 may be one or more lock washers (e.g., ⅜-inch lock washers) and one or more HHCS (e.g., ⅜-16×1½ inches HHCS). At or near locations 982 may be one or more HHCS (e.g., ¾×2 inches HHCS), one or more lock washers (e.g., ¾-inch lock washers), and one or more hex nuts (e.g., one or more ¾-inch hex nuts).

Referring to FIGS. 8A, 8B, and 8C, example components of the cement weigh batcher assembly (each batcher 18 cubic feet, for example) for storing and dispensing the base B and/or catalyst C are as follows:

| Component or | | |
|---|---|---|
| Location Number | Quantity | Description |
| 965 | 1 | Cement Batcher Stand Weldment |
| 966 | 4 | Stand Leg Extension |
| 967 | 1 | Cement Batcher Weldment - 18 cubic feet |
| 968 | 1 | Cement Batcher Weldment - 18 cubic feet |
| 969 | 2 | Plate, 3/16 × 12 × 15 inch |
| 6 | 6 | Load Cell Assembly .5K |
| 970 | 2 | Butterfly Valve, 10 inches |
| 971 | 2 | Canvas Boot - 34.5 inch circumference × |
| | | 10 inches long |
| 972 | 2 | Summing Box Mount |
| 973 | 2 | Ball Vibrator |
| 974 | 4 | Hose Clamp, 2½ inch diameter - 12 inch |
| | | diameter |
| 980 | 18 | Lock Washer, ⅜ inch |
| 980 | 4 | HHCS, ⅜ - 16 × 1½ inch |
| 976, 977 | 28 | SAE Washer, ½ inch |
| 977 | 16 | hex head cap screw (HHCS), ½ - 13 × |
| | | 1½ inch |
| 977 | 16 | Lock Washer, ½ inch |
| 977 | 16 | Nut, Heavy Hex, ½ - 13 inch |
| 975 | 2 | Air-Intake Filter 195 CFM 2 - ½ inch |
| | | Connection |
| 981 | 1 | Air Piping (2) Cement & (No) Water |
| | | Batch/Meter |
| 976 | 6 | ½ × 2¾ inch HHCS |
| 976 | 6 | ½ inch Lock Unit |
| 976 | 6 | ⅝ inch Hex Nut |
| 978 | 16 | ⅜ inch Hex Nut |
| 982 | 32 | ¾ × 2 inch HHCS |
| 982 | 32 | ¾ inch Lock Washer |
| 982 | 32 | ¾ inch Hex Nut |
| 979 | 8 | Summing Box Isolator Mount |
| 979 | 4 | Conduit Hanger |
| 979 | 4 | C-Clamp |
| 979 | 8 | ¼ inch Lock Nut |
| 978 | 120 | Rubber Sponge Strip |

FIGS. 5C1, 5C2, and 5C3 further show top, side, and end views of a silo such as silos 41 and 46. Top, side, and end views of the upper shaker skid assembly 21 and the lower shaker skid assembly 22 for the shale shaker 20 are shown in FIGS. 5D1, 5D2, 5D3 and 5E1, 5E23, and 5E3, respectively. FIGS. 5F1, 5F2, and 5F3 also illustrate top, side, and end views of a mixer charge screw/hopper assembly 31 which includes the holding hopper 30 and screw conveyor 35. The receiving hopper skid assembly 11 top, side, and end views showing the receiving hopper 10 and the screw conveyor 15 are illustrated in FIGS. 5G1, 5G2, and 5G3.

The method, as shown in the attached FIG. 1 process flow diagram, includes introducing the feed F (e.g., an oil-contaminated substrate such as cuttings from oil well drilling operations, or a drilling mud/cuttings mixture that may contain water, oil such as diesel oil, and soil/metal solids) into the liquids/solids separation device 20 such as a shaker, centrifuge, or cone. (The feed may instead be separated into liquids and solids via chemical separation or time sedimentation). The feed F may optionally be placed in the receiving hopper 10 prior to its entering the shaker 20 and either introduced directly from the receiving hopper into the shaker 20 or transported into the shaker 20 using the material transporting device (e.g., the screw conveyor 15). Prior to its introduction into the shaker or other liquids/solids separation device, the feed F may be moved within the cuttings receiving hopper 10, for example using a live bottom feeder 18 and/or conveyor, pump, or auger, to keep the feed mixture homogeneous.

When a receiving hopper 10 is utilized, a grizzly screen 16 of the receiving hopper 10 may separate solids from the remainder of the feed F, preventing large solids from entering and jamming the auger/screw conveyor 15. The optional live bottom feeder 18 (see FIGS. 78-79) (or other device for moving the feed F within the hopper 10) in the receiving hopper 10 may continuously, semi-continuously, or intermittently move the raw material or feed F within the hopper 10 to prevent its settling and/or sticking on surfaces in the hopper 10 and to keep the feed mixture homogeneous. The live bottom feeder 18 or other similar device removes the requirement of a person physically unloading the hopper 10 and saves labor costs, increasing efficiency of the system and process.

The liquids/solids separation device 20 separates the liquids L in the feed F from the solids S in the feed F to make the solids S stream dryer and more uniform, enhancing oil recovery ultimately. A shaker screen of the shaker 20 may prepare and size the feed material as needed. The solids S may optionally enter into the holding hopper 30 which may be on one or more load cells and then travel via the material transporting device 35 into the batch mixer 50 which may be on one or more load cells. In other embodiments, the solids S are introduced directly from the shale shaker 20 into the mixer 50 or directly from the holding hopper 30 into the mixer 50. Ultimately, the solids S exit the liquids/solids separation device 20 and are introduced into the mixer 50. The one or more load cells may be used to weigh material within the holding hopper 30 and within the mixer 50.

The liquids/dirty oil stream L exiting the liquids/solids separation device may optionally be introduced into the mixer 50 as a separate stream or may instead be disposed of. In some embodiments, the first portion L1 of the liquids/dirty oil stream is introduced into the mixer 50, while the second portion L2 of the liquids/dirty oil stream is sent to a tanker or otherwise disposed of. The pump(s) 26 may be used to increase pressure to pump the liquids/dirty oil stream L to its intended location.

Solids S, base B, and acid A are introduced into the mixer 50, in some embodiments in that order. Also, optionally, a catalyst C such as calcium chloride or other salt and water and/or surfactant W are introduced into the mixer 50. In some embodiments, the base B (e.g., lime) is introduced first into the mixer 50 along with the solids S (or before or after the solids S), the base B added in an amount effective to generate an exotherm to vaporize the oil and reaction products thereof. Optionally, catalyst C such as calcium chloride or any kind of salt may be added to the mixer 50 and/or optional water and/or surfactant W. The optional surfactant may be added to make the water bond to clay particles so that the reaction takes place efficiently and effectively, and the calcium chloride or other salt may be added as a catalyst C or enhancement for the lime or other base B to drive the temperature higher in the mixer 50 and make the reaction more efficient. If calcium chloride or other salt C is added to the mixer 50, it should be added around the same time as the base B because the calcium chloride or other salt C is a catalyst or enhancement for the lime or other base B to drive the temperature higher in the mixer 50 and make the reaction more efficient. (The calcium chloride or salt C creates a chloride gas, but it is all caught in the scrubber 70.) In the embodiment shown in FIG. 1A in particular, the base B and calcium chloride C may be mixed together prior to their entering the mixer 50. The acid A (e.g., mineral acid such as sulfuric acid) may be introduced into the mixer 50 after adding the base B and/or calcium chloride C. Of course, any other order of addition of the components into the mixer 50 is within the scope of embodiments.

The acid A may be added slowly to the water W or base B so that the resulting solution will not heat up too fast to violently boil the solution, potentially throwing out hot acid. The water should vaporize in the mixer 50 and carry the organic overhead with it without expanding so fast that it carries the acid A and particulate over with it to the scrubber 70.

The acid A, base B, catalyst C, and/or water and/or surfactant W may be stored in their respective storage silos 41, 46, (not shown) and/or their respective tanks or batchers 55, 45, 40, 60 (and transported via their respective material transporting devices (not shown), 47, 42) and may be metered via their respective meter(s) 62, 57, (not shown) and pumped into the mixer 50 via their respective pumps (not shown), 56, 61. The storage silos 41, 46, (not shown) allow safe handling of the materials such as catalyst C and base B.

The storage silos 41, 46, (not shown) handle the materials in bulk, pre-weighing everything, e.g. via one or more load cells, before it enters the mixer 50. The amount of material may be automatically added according to computer processing and computer software calculations and communications with the system and material adding components of the system.

FIG. 1A shows an alternate embodiment for a system for removing a liquid from a substrate. The difference between FIG. 1 and FIG. 1A is that the base B and catalyst C such as calcium chloride or other salt are part of a batcher assembly, and the base B and catalyst C are dispensed from the batcher assembly. The base B and catalyst C may be in different hoppers or different compartments to segregate the components from one another in the batcher assembly. Another difference in the embodiment of FIG. 1 and the embodiment of FIG. 1A is that the positioning of the inlets of the components B, C, Si, W, and A is different. The positioning of the components B, C, Si, W, and A and their inlets and delivery and storage devices to the mixer 50 in FIGS. 1 and 1A is not limiting of embodiments and does not designate order of addition of the components of the mixture into the mixer 50, as any positioning of the components and their inlets and delivery and storage devices is within the scope of embodiments and the different orders of addition of components which are contemplated are disclosed herein.

In FIG. 1A, like components of the system and method to FIG. 1 are designated with like numbers. Although not shown in FIG. 1A, it is within the scope of embodiments to include the following components and their possible substitute components and methods of using as described herein in relation to FIG. 1: portable storage silo 41 and 46, material transport devices 42, 47, and 66, further treatment of the gas through the scrubber and other associated process and system components shown in FIG. 1, and optional surfactant addition to the mixer 50. Any of the components and methods of FIGS. 1 and 1A may be interchangeable, and the description herein where sensible relates to components, systems, and methods, of both FIGS. 1 and 1A.

In the embodiment shown in FIG. 1A, the base B and catalyst C may be introduced into the mixer 50 first (prior to the acid A addition) and at the same time using an auger, and the acid A may be pumped into the mixer 50 and not augered into the system (closed to dry discharge).

The adding of materials into the mixer and the rest of the system and method is automated so that computers and software determine the amount needed of the added components to produce the desired result and direct the addition of that amount of the components from the material adding devices or from other locations. Load cell(s) may pre-weigh all of the components and materials prior to their introduction into the mixer or other devices of the system, and full controls permit automatic control of the entire process. All of the valves of the system may be automated and receive communications from the computer processor and/or computer software to manipulate the amount of material allowed through the valves. The system is programmable via the computer processor and computer software to determine parameters and amounts of material components needed, to weigh the material components, and to manipulate system equipment to introduce that amount of needed material.

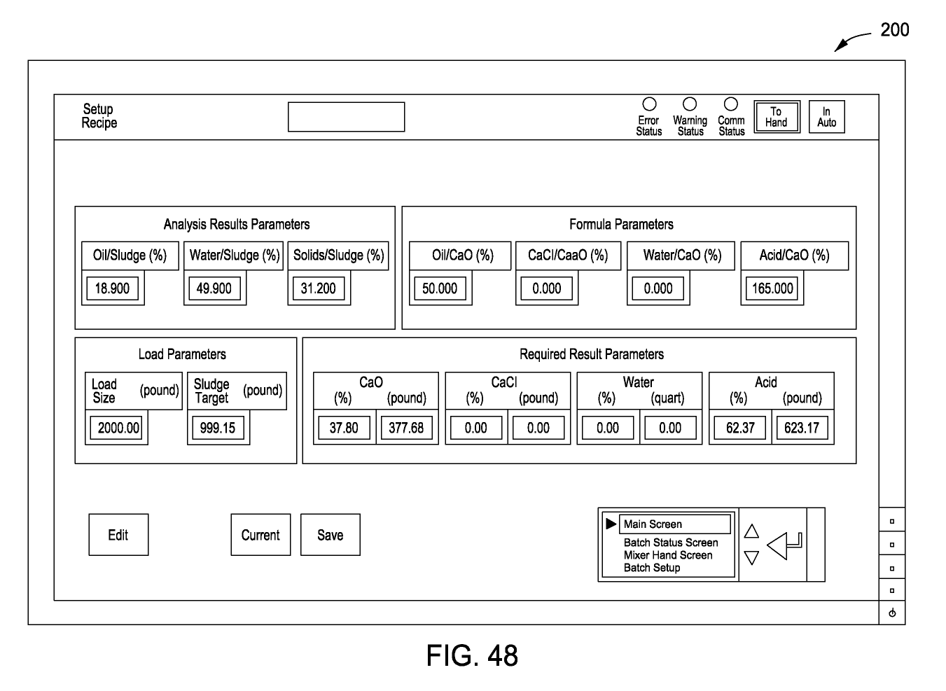

Portions of a control system and its components usable with the system and method of embodiments for automating the system is shown in FIGS. 48-49 and 60-61. A control panel 850 allows for control of the system and may include an emergency shutoff of the system.

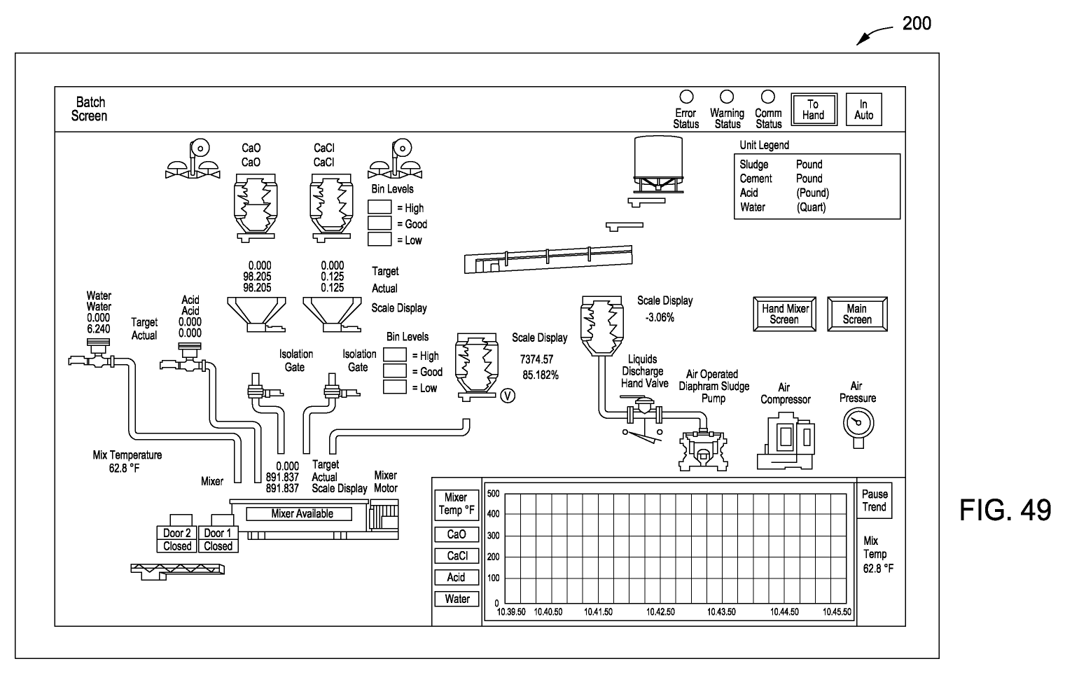

FIGS. 48 and 49 show a display 200 which shows information from the computer processor and from various points in the system. The display may in some embodiments allow touch screen manipulating of the parameters and amounts by the user. In other embodiments, a keyboard or other information inputting device may be used by the user to manipulate parameters and amounts. The computer processor and software calculate amount of components needed according to real-time data which is gathered at various points in the system and communicate the amount of components needed to various points in the system, and then the system responds by adding that amount of the components.

The load cell(s) which may be included in the system are weighing scales which may be used for pre-weighing components prior to their introduction into the mixer 50 or other portions of the system, or for weighing the contents of equipment in the system. For example, the load cells may be used for pre-weighing the base B and/or catalyst C such as calcium chloride. In some embodiments, the mixer 50 also is located on load cells for weighing mixer contents. In some embodiments, the shaker hopper or holding hopper 30 is located on load cells for weighing its contents.

Within the mixer 50, paddles move the material within the mixer 50 gently at a high volume, all of the time moving the material, thereby making solids behave as gases. In some embodiments, the paddles move at a speed of approximately 70 revolutions per minute (rpm). The pitch of the paddles on the shafts is set as larger and then smaller so that the blades/shafts do not have to work as hard to effectively mix the material in the mixer. Optional Weir plates keep the paddles as close as possible to the sides of the mixer 50.

Raw air entered into the reaction cools the temperature, and temperature drives the reaction and separation in the mixer 50. Therefore, introduction of air into the mixer 50 is disadvantageous. In embodiments of the method and system, the mixer 50 is sealed air tight to prevent the introduction of air into the mixer, and the material is not removed until the reaction is completed (batch process). The mixer 50 may be operated at positive pressure of approximately three pounds pressure to approximately five pounds pressure.

The mixer 50 as designed is capable of moving a high volume of product and gives full control of the end product because the process may be stopped at any point and if necessary the mixer repaired. The mixer blades 158 are easily replaceable if needed.

The reaction in the mixer 50 takes a clay particle, and the acid and base double the size of that particle and peptize the particle so that oil and gas break off. Solids create a gas when the paddles operate within the mixer 50, and that gas is carried off. The mixer 50 makes solids behave as a gas.

If the need or desire arises to stop the process for repair or other reason, the mixer 50 may be stopped, allowing full control of the end product P. Additionally, the mixer blades 58 and liner inside the mixer 50 are built to last longer than current options, insulated, and easier to repair or replace, resulting in less downtime and better quality product.

The mixer 50 may be run until there is optimum recovery, in part due to it being a batch or semi-continuous process. After the process within the mixer 50 is completed, the essentially oil-free (or water-free or oil/water mixture-free) product P (the conditioned dry product) is discharged from the mixer 50 and may be reused or disposed of on site or at a landfill.

The liquid/gas product is treated and oil recovered for reuse by capturing the hot gases and VOCs G using, for example, the scrubber 70, discharging the clean air and separating the oil and water from the liquid discharge using an oil/water separator. In some embodiments, all of the gas from the mixer 50 exits into the scrubber 70 so that no gas is discharged into the atmosphere prior to its treatment in the scrubber 70. Condensation quenching and cooling occurs in the scrubber 70.

Output from the scrubber 70 includes the clean air discharge AD and liquid discharge LD comprising oil and water. The oil/water separating device 75 discharges oil HC to storage, for example in storage tank 76 and water W1. The water W1 may optionally be recycled back into the scrubber 70. The water W1 may optionally be stored in a storage device such as a storage tank 77. Resulting from the system and method of embodiments are a conditioned material product P and a clean oil product HC.

Ultimately, the scrubber process involves capturing vapors and transferring them to a condensation column or in another process. Non-condensed gases are emitted, and oil and water are collected. A water cooler and washing column(s) may be utilized to recover water and oil. The scrubber cleans air from the washing columns prior to its discharge into the environment. Residual feed material is discharged for use or disposal elsewhere.

The combination of the condenser/scrubber, mixer, and batch system (or semi-continuous feed system) of embodiments allows for essentially zero discharge into the atmosphere of undesirable substances.

The system of embodiments allows multiple mixers to be added to the system and hooked up to the same gas cleaning and oil recovery system or scrubber 70 with little system downtime. Multiple fittings may be added to the shaker 20 and the multiple mixers may be hooked up to the system to allow processing of more raw feed F in multiple mixers. In this way, the system may be added to and subtracted from like Lego's according to the processing needs.

In some embodiments, the feed material F may be run through an optional oil/water separator to produce a consistent dry solids S stream. The augers or conveyors may be built to withstand heavy loads and liquid loads.

In an embodiment of the method, base B (such as lime) is mixed with a drilling mud/cuttings mixture that contains water, oil such as mineral oil and/or diesel oil, and soil/metal solids to form a first mixture, and then acid A (such as sulfuric acid or another mineral acid) is mixed with that first mixture. The mixing of the base B, acid A, and water W generates heat to produce steam to remove the oil from the solids and produce a relatively dry calcium sulfate/solids mixture containing less than one percent oil. The calcium sulfate stabilizes the silica containing solids so as to render them non-leachable for metals and oil and thus suitable for use as a binder/filler material and/or for disposal in a landfill. The diesel oils, mineral oils, oils, and/or organic contamination is/are co-distilled with water overhead from the mixer M, and diesel oil, mineral oil, or oil is recovered from the overhead vapor stream by direct contact condensation and scrubbing in a packed scrubber column. Heat is generated in the process by the mixing of the acid A (e.g., sulfuric acid) and base B (e.g., lime) with the water W and by the reaction of the sulfuric acid A with lime B to form calcium sulfate. The heats of mixing (solution) of both acid A and base B with water W are exothermic, as is the reaction of acid A with base B. Heat in the mixer 50 from the chemical reaction is utilized to vaporize oils and waters. The condenser/scrubber device 70 recovers the diesel oil, mineral oil, mineral spirits, or oil for reuse. The relative amounts of acid A, base B, water W and/or optional surfactant to be mixed with solids containing different amounts of diesel oil, mineral oil, mineral spirits, or oil to generate the required heating to drive off the oil for recovery in the scrubber may be predicted by simulation software such as ChemCad simulation software. In the scrubber process, vapors are captured for treatment in another process and residual feed material is discharged for use or disposal.

Diesel fuel properties are addressed by ASTM D 975—Standard Specification for Diesel Fuel Oils, which covers the seven grades of diesel fuel oil suitable for various types of diesel engines. This specification prescribes the required diesel fuel properties and sets the limits and requirements for the values of these properties. The D 975 specification lists the minimum mandatory requirements needed to guarantee acceptable performance for the majority of users and recognizes some EPA requirements to reduce emissions.

With the North American introduction of Ultra Low Sulfur Diesel (ULSD), electrically conductivity may be important because species that promote conductivity are removed by the hydrotreating required to reduce sulfur to 15 ppm. Lower sulfur fuels tend to have lower conductivity. Additives such as static dissipater additives can be added to fuels to increase the conductivity and thus dissipate static charge.

The results of the testing indicate that the system and method of embodiments produces fuel oil likely to meet requirements for fuel properties of engine grade diesel fuel oils. It is expected that the values of the Flash Point and 90%-Recovery-Distillation-Temperature will increase upon full scale plant production. If sulfur is found to exceed the limit in oil recovered from the process and system of embodiments, mixing with ULSD oil with a sulfur concentration below 15 ppm may bring the sulfur content down to acceptable levels. (For road use, the sulfur content must be below 15 ppm or 0.0015 weight percent.)

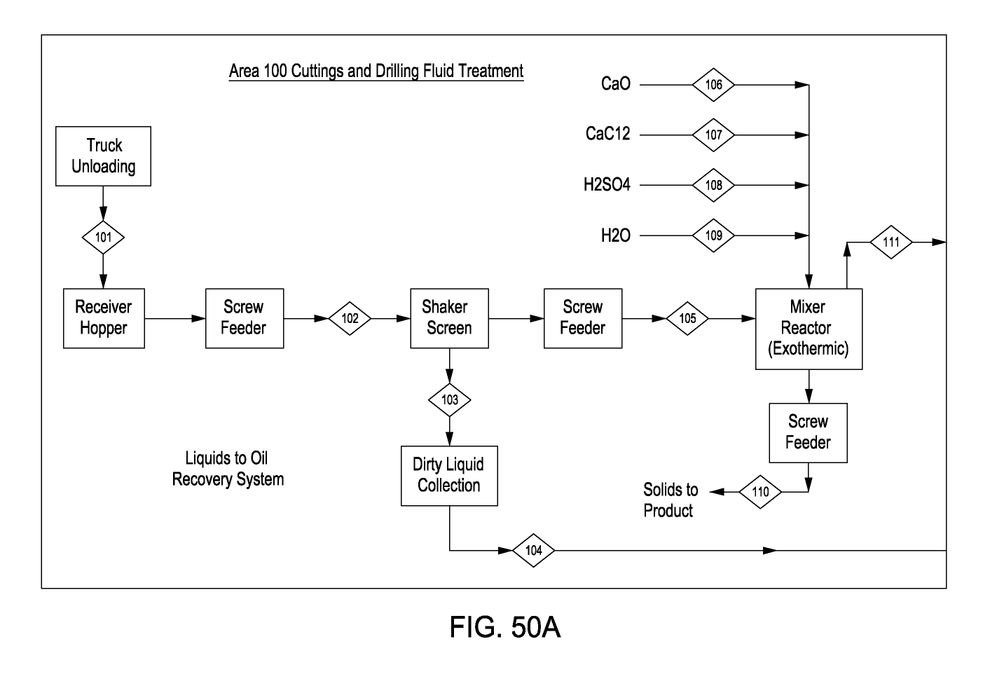

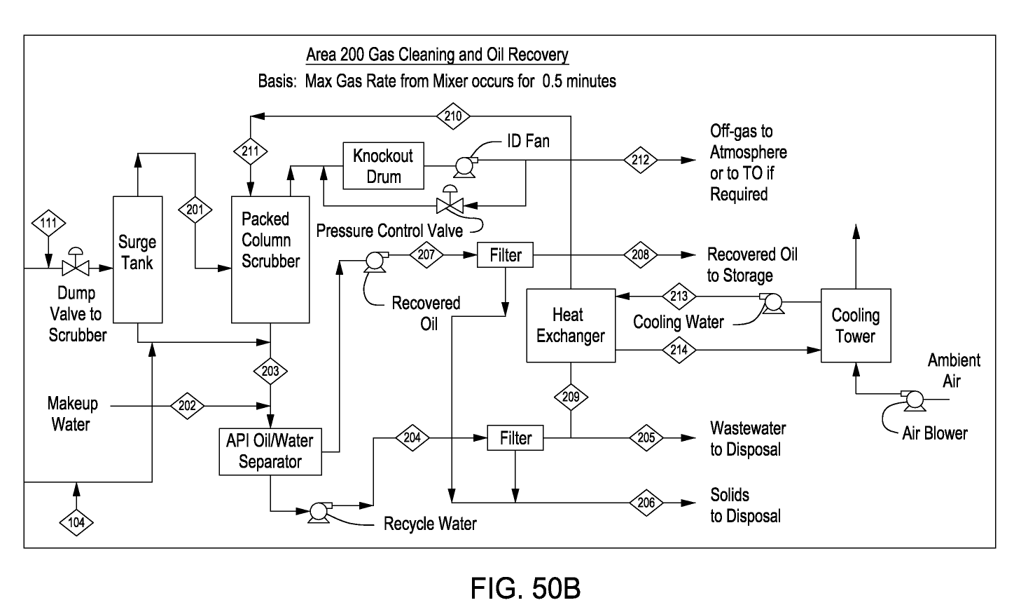

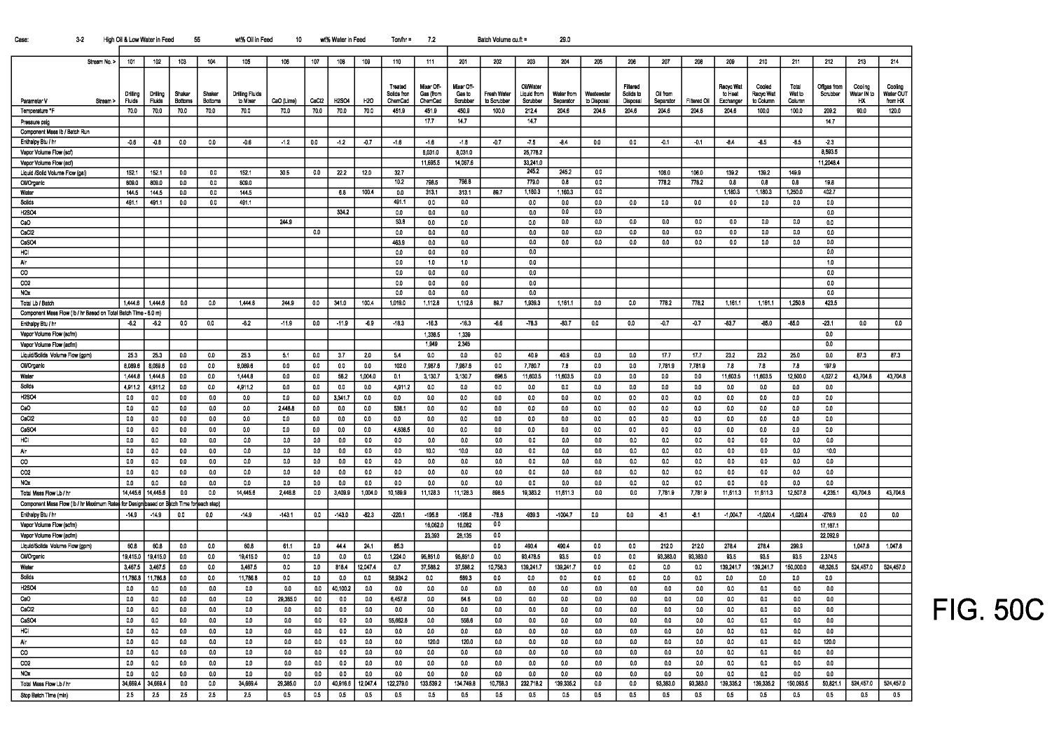

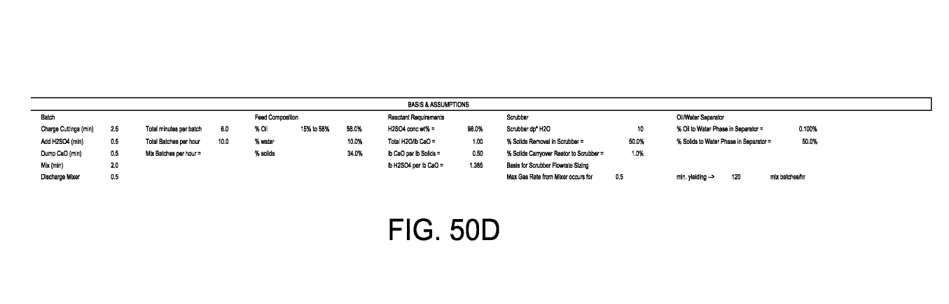

FIGS. 50A, 50B, 50C, and 50D show a first embodiment of a block flow diagram of the system of FIG. 1 with mass and heat balance summary in an example of embodiments.

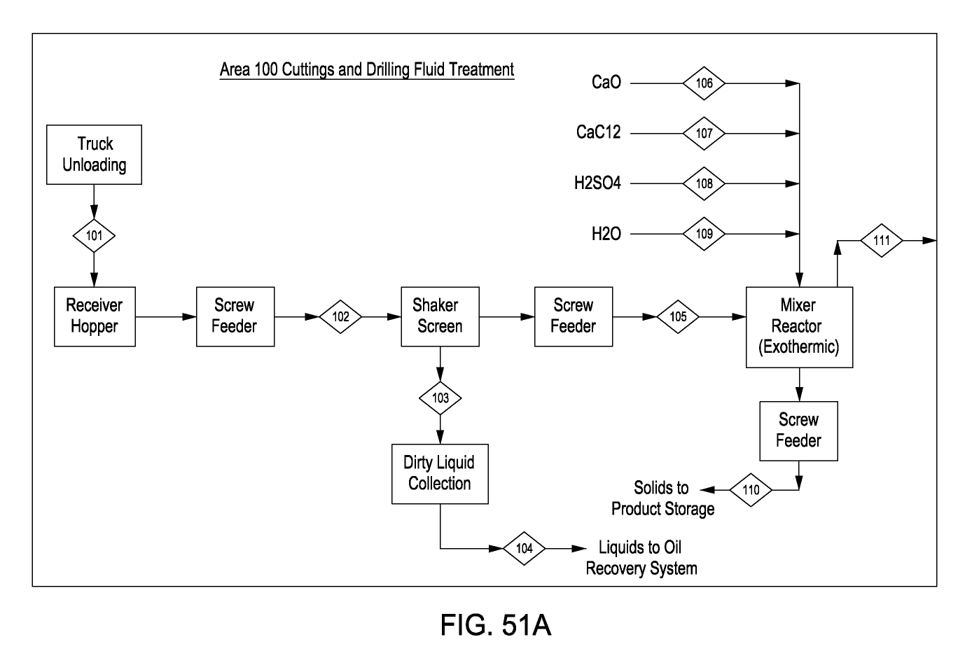

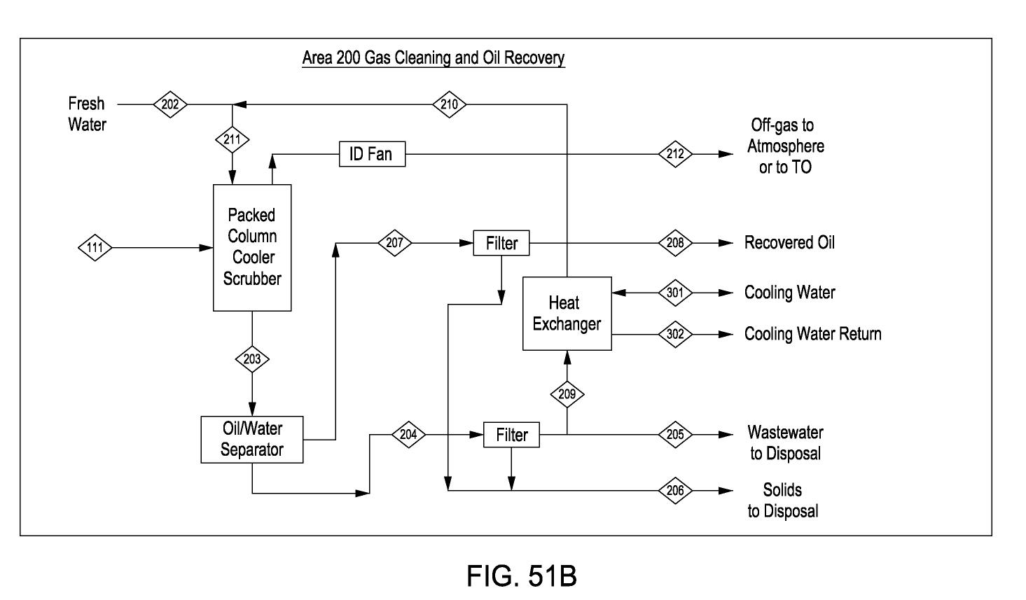

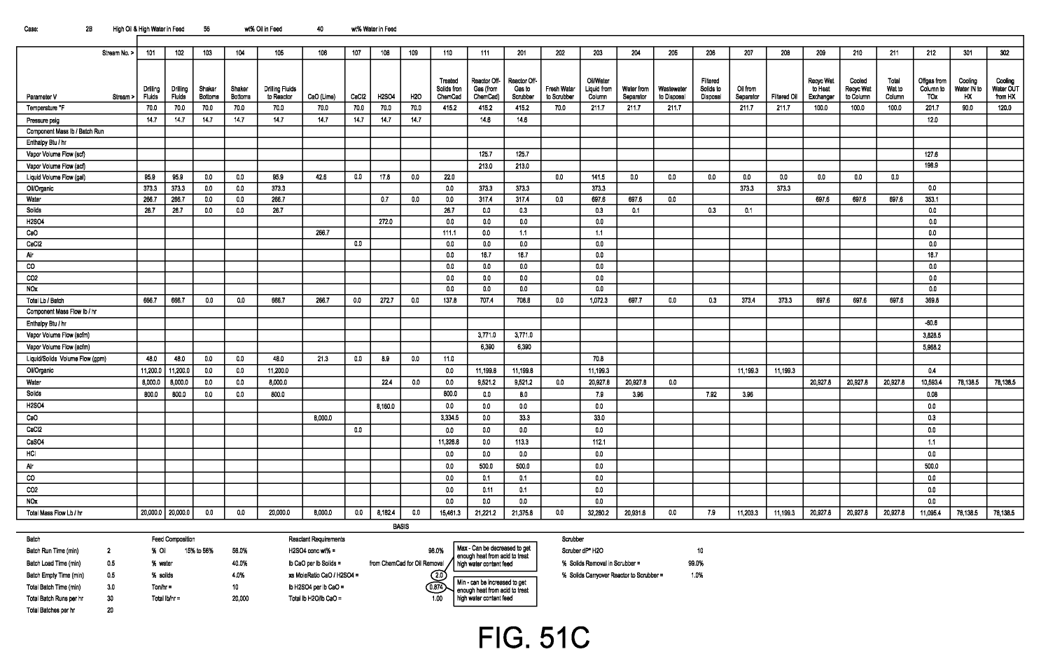

FIGS. 51A, 51B, and 51C show a second embodiments of a block flow diagram of the system with mass and heat balance summary in examples.

In some embodiments, the rate of rotation of the mixer shaft(s) may be approximately 120 revolutions per minute (rpm). The two shafts of the mixer may have the capability to rotate in opposite and similar directions. Temperatures in the mixer 50 should reach at least 212 degrees Fahrenheit or at least 300 degrees Fahrenheit in some embodiments, and the catalyst C may be used to help the mixer 50 to attain those temperatures. Insulation of the mixer 50 may be required to limit heat loss.

In an alternate embodiment, the shale shaker 20 may be eliminated and all of the material that would be introduced into the shaker 20 is introduced into the mixer 50.

In an example which is not limiting of embodiments, oil drillings decontamination may be accomplished by chemically boiling off oils. Incoming materials may include liquid oil drillings sludge at 128 pounds/cubic foot bulk density and one pint to one quart oil per 3,500 pound load, calcium, lime, sulfuric acid, and optionally water and/or solids. The mixer 50 may have 10 built in mix designs and may be 3500 pounds per load using gross weight limit. Ingredients for the mixer may be based on percentage of the full load, percent by weight in the following approximate percentages: 15% lime, 10% calcium, 12% acid, and the remainder partially dewatered sludge. In some embodiments, approximately 40% of the liquid is removed prior to entering the mixer 50. The liquid may be sold as low grade fuel oil and may contain some water.

In an example which is not limiting of embodiments, the efficiency of the evaporation is dependent upon the amount of water in the remaining sludge. It may take a lot of energy to boil off the water, and until the water is boiled off, the temperature may not exceed 212 degrees Fahrenheit. If the temperature does not reach at least 300 degrees Fahrenheit, oil may not be evaporated, and this temperature should be maintained while the scrubber extracts the oil vapor. The maximum oil allowed in the processed material may be 10%.

In an example which is not limiting of embodiments, the receiving hopper (e.g., sludge receiving hopper) may have one source hopper with a sludge input capacity of 20.875 tons per hour (TPH) and a 10-ton water level of 128 pounds per cubic foot. The receiving hopper may discharge to a live bottom screw conveyor. The receiving hopper may be leakproof. The hopper may include a vibrator to move the material disposed therein.

In an example which is not limiting of embodiments, a one inch grizzly with the opening of ¾ inch to four inch (or a grizzly with larger openings) may be used in the receiving hopper. In some embodiments, a vibrator or other mechanism for making the grizzly vibrate may be used and it may be self-cleaning.

In an example which is not limiting of embodiments, the live bottom screw of the sludge receiving hopper may be a full flight 9 inch screw running at approximately 43 rpm, approximately 334 cubic feet per hour at approximately 125 pounds per cubic foot, may be reversing with a momentary reverse button to unplug the screw, and may have constant speed across the line starter. Based on speed, the screw may not completely discharge highly viscous material, and highly viscous material may run to discharge without the need of an auger until the discharge point is higher than the bottom of the screw. A flexible joint may allow the tip of the screw conveyor to be dropped low enough so that it does not have to be removed from the bin for transport.

In an example which is not limiting of embodiments, the receiving hopper incline screw conveyor may be fed by the horizontal screw conveyor at 334 cubic feet per hour at 125 pounds per cubic foot and may be a twelve inch screw running at approximately 70 rpm (the rate may be limited to the capacity working limit of the target screen shaker). The incline screw conveyor discharges to the shale shaker and may be a full flight screw with no hanger bearings 32 foot section, the screw openings for cleanout looking like hanger-bearing access but with no bearing (if the hatch is removed, the liquid could flow out until the hopper level is below the screw opening). The screw conveyor may be non-reversing (no material agitation to keep it in suspension), at constant speed (across the line starter), rated at up to 21 tons per hour. If sludge is 21 tons per hour and 40% water is removed, 60×21=12 tons/hour dewatered sludge (20%-40% of water may be removed).

In an example which is not limiting of embodiments, the slower the raw material is fed to the shaker 20, the liquid and fine solids acting as a liquid are removed. The auger/screw conveyor to the shaker 20 may in some embodiments have variable speed. The shaker 20 may have an in-feed hopper, allowing checking of the level of material in the hopper and adjusting of the rate or turning of the screw on or off based on the level in the hopper. One or more sensors may optionally be used to sense load level of the shaker and turn off or slow down the auger if the material reaches a certain level. Inspection covers may have approximately 0.5 psi per foot of liquid head pressure.

In an example which is not limiting of embodiments, the shale shaker 20 may be fed by a receiving hopper incline screw. The shale shaker 20 may discharge to a sludge solids hopper and liquid storage tank. The shaker may be rated at approximately 402 cubic feet per hour at approximately 125 pounds per cubic foot. The shaker may be an approximately 6,000 pound shaker vibrating on rubber isolators. The shaker is responsible for dewatering the incoming sludge. Theoretically, it will remove about 20-40% by weight of the incoming liquid, which rate may change significantly with the varying liquid content of the input material. The screening function separates the sludge into two separate containers. The solids storage container may have a significant amount of moisture. The shaker may have 21 ton per hour rated input capacity (gross) which varies with the amount of liquid content in the sludge. The shaker may have dual vibratory shaker motors that are 480 VAC 3-phase motors which may turn in opposite directions. The motor feed cables may be identical, and the reverse is accomplished at motor leads. The motors may have high flex, high strand count power cord connections; quick disconnects for removal from the skid. The shaker may be cleaned by washing with a pressure washer and scraping (e.g., by hand).

In an example which is not limiting of embodiments, the liquid storage tank from the shale shaker receives water and oil from the shaker. The liquid storage tank may be a 750 gallon storage tank with 100 cubic feet capacity. Removing 40% of the liquid by weight of the incoming fluid using the shaker at 21 TPH input rate results in 16,800 pounds per hour of liquid removal. At 8.34 pounds per gallon, 33.6 gallons per minute of liquid would be removed using the shaker, so the tank may have to be drained up to 3 times per hour, e.g., via a gravity drain. In some embodiments, the liquid discharge could be further refined and sold as very low grade fuel oil. A level indicator may be used with the liquid storage tank to prevent spillage, and a partial containment pan may be used to hold a portion of the tank contents. The tank may have a pump to provide liquid recirculation. The tank may be pressure washed to clean it.

In an example which is not limiting of embodiments, a shale shaker solids surge hopper captures de-watered solids and may be an 80 cubic foot surge hopper. It may have a 10,240 pound capacity at 128 pounds per cubic foot, assuming the same density after dewatering. Approximately 37% of the mix weight may be added ingredients and approximately 63% of 3500 pounds is dewatered sludge resulting in 2205 pounds/batch. The shaker solids hopper may hold almost 5 batches, and the input rate may be 60%×21 TPH=25,200 pounds per hour, resulting in 11.4 loads per hour. The solids hopper may be supported on two load cells with the screw support supplying the third support point. The weight measured by the load cells gives an indication of the capacity in the hopper. The capacity is based on the density and angle of repose. A batch auger which may be non-reversing may be part of the live bottom 80 cubic foot hopper, and the hopper may have a bolted access hatch in its side. A 12 inch slide gate at the end of the auger with a gate full open limit switch (ideally the gate is much larger than the auger diameter) may be included to provide accurate cutoff, isolation for pressurization of mixers, and/or inhibit exhaust through the empty screw and hopper. A desired batch rate may be 2205 pounds in 60 seconds, and the screw capacity may be 30 TPH or 60,000 pounds per hour.

In an example which is not limiting of embodiments, the base B (e.g., quick lime) may have the following properties (all values approximate): bulk density of 55-60 pounds per cubic foot, highly corrosive, very reactive, burns at contact, chemically reacts with water to dry load, chemically reacts with acid to heat load, and adjusts load pH, and 300 barrel 1200 cubic feet source silo. The base B silo may be charged by a fill pipe and discharge to horizontal cement screw conveyor. The base silo trailer may be emptied by a discharge incline screw supported by mixer skid frame. The base (lime) trailer may have a 10 hP Fugi style aeration blower with 3 phases mounted on the silo trailer behind a dust collector with a quick disconnect and bypass solenoid. The dust collector may manually discharge to the ground, has an air operated bin shaker used during fill, hand valve controls 80 psi compressed air, and pressure relief to atmosphere. The base (lime) trailer may also have an aeration solenoid with Hand-Off-Auto control, a single solenoid that controls all 24 air pads concurrently, empty sections discharging most of the air, and aeration air discharging through the dust collector. If no aeration is added, the silo may breathe through the dust collector.

In an example which is not limiting of embodiments, the base silo trailer may have a horizontal batch screw conveyor extending therefrom with live bottom from three points on the trailer, a jam gate at each discharge point, a discharge to an incline screw conveyor (incline running may be prerequisite to run horizontal screw), 5 HP TEFC across the line starter, motor mounted at charge end, and quick disconnect 480 VAC. The incline batch screw conveyor may be charged from the horizontal screw conveyor on the trailer and discharge to cement weigh hopper for the base B, 15 HP TEFC across the line starter, motor mounted at discharge end, and quick disconnect 480 VAC.

In an example which is not limiting of embodiments, the calcium chloride or other salt C silo trailer may be a 300 barrel 1200 cubic feet source silo charged by fill pipe and discharging to the horizontal cement screw conveyor. The trailer may be emptied by discharge incline screw supported by frame which needs to be removed. The catalyst silo may include an electric solenoid with a timer and pressure relief to the atmosphere. The catalyst C trailer may have a 10 hP Fugi style aeration blower with 3 phases mounted on the calcium chloride silo trailer behind a dust collector with a quick disconnect and bypass solenoid. The catalyst C (e.g., calcium chloride) trailer may also have an aeration solenoid with Hand-Off-Auto control, a single solenoid that controls all 24 air pads concurrently, empty sections discharging most of the air, and aeration air discharging through the dust collector. If no aeration is added, the silo may breathe through the dust collector.

In an example which is not limiting of embodiments, the calcium chloride silo trailer may have a horizontal batch screw conveyor extending therefrom with live bottom from three points on the trailer, a jam gate at each discharge point, a discharge to an incline screw conveyor (incline running may be prerequisite to run horizontal screw), 5 HP TEFC across the line starter, motor mounted at charge end, and quick disconnect 480 VAC. The incline batch screw conveyor may be charged from the horizontal screw conveyor on the trailer and discharge to cement weigh hopper for the calcium chloride C, 10 HP TEFC across the line starter, motor mounted at discharge end, and quick disconnect 480 VAC.

In an example which is not limiting of embodiments, a weigh hopper for the base B may include a Rice Lake 355 scale instrument to weigh only the base B. Rapid discharge is highly desirable to increase the exothermic peak temperature. Rapid heating will create pressure in the mixer, which could affect the scale readings if the reaction is near instantaneous. Ideally the scale is empty before the exothermic reaction starts. The weigh hopper may be charged from the base (lime) screw conveyor and may discharge to the mixer, may have a 15 cubic foot capacity (15%×3500 pounds=525 pounds), a single solenoid discharge valve, gate closed limit switch, and vibrator solenoid. Section #2 of the weigh hopper may be charged from the calcium chloride screw conveyor and discharge to the mixer, may have a 15 cubic foot capacity (10%×3500 pounds=250 pounds), single solenoid discharge valve, gate closed limit switch, and vibrator solenoid.

In an example which is not limiting of embodiments, a weigh hopper for the catalyst C may include a Rice Lake 355 scale instrument to weigh only the catalyst C. Rapid discharge is highly desirable to increase the exothermic peak temperature. Rapid heating will create pressure in the mixer, which could affect the scale readings if the reaction is near instantaneous. Ideally the scale is empty before the exothermic reaction starts. The weigh hopper may be charged from the catalyst C (e.g., calcium chloride or salt) screw conveyor and may discharge to the mixer, may have a 15 cubic foot capacity (10%×3,500 pounds=350 pounds), a single solenoid discharge valve, gate closed limit switch, and vibrator solenoid.

In an example which is not limiting of embodiments, with respect to the weigh hopper dust collectors, the batcher may be vented to the atmosphere through filter cartridge. Any backpressure may affect weighing due to pressure or vacuum in the mixer. The mixer and cement weigh hoppers may basically be sealed except for the discharge to the mixer door and the scrubber vent.

In an example which is not limiting of embodiments, the sulfuric acid A may have the following properties (all numbers are approximate): concentration of 98%, pH −1.5, density of 15.371 pounds per gallon, specific gravity of 1.8437, and viscosity that is similar to honey at cooler temperatures. The acid A storage tank may be a 500 gallon storage tank.
12%×3500=420 pounds=1 gal/16 pounds X=26.25 gallons per batch 500/26.25=19 batches
desired 1-batch/10 minutes=190 minutes=3 hours of operation
   The tank should be protected from water. Acid pumps may need a backup pump or quick change out from the wear of the acid. The acid pump may be a centrifugal pump that is 5 HP 3 phase, mounted on the main mixer skid, has a check valve, ball valve and solenoid, has a flow rate of 60 gallons per minute, and an air pressure transport limit under 40 psi. The acid feed equipment may have 2 inch all Teflon lined piping and mag flow meter. In other embodiments, acid may feed directly from a full transport trailer. Viscosity of the acid may vary dramatically with temperature. With a flow meter, the liquid must be heated in conditions where the acid thickens. Temperature may greatly accelerate the corrosive nature of the acid. The purest acid is desirable for feeding into the mixer to allow the reaction in the mixer to work and prevent corrosion. The acid meter may have an open-collector sinking output requiring a sourcing input card—a desired rate is 60 seconds to add 26 gallons, and 100 counts allows 1% resolution at 100 quarts. A rate is about 1.7 quarts/second, but addition rate will vary with temperature and head pressure. Acid could be added during sludge charge to improve the throughput, similar to water addition in a Dustmaster.

In an example which is not limiting of embodiments, if sludge solids are to be purged, the loads may not come out as perfect increments of 3,500 pounds. It may be possible to proportion the mix based on available sludge.

In an example which is not limiting of embodiments, the mixer weigh batcher may be charged from the sludge screw, cement scales, and acid meter and discharge to the holding hopper. The mixer weigh batcher may have dual solenoid discharge doors and a two gate closed limit switch. The mixer may be supported on 4 tank load cells (may be lockable for transport) with RiceLake 355 scale instrument, summing box, and batch and discharge filtering. A mixer temperature sensor may include infrared sensor option 0-500 degrees Fahrenheit and may be used to define minimum oil evaporation temperature and changes in moisture. When temperature starts to fall, the exothermic reaction is almost complete. The percent of dry material combined with temperature determines the efficiency of the dewatering system. An objective of the process is to evaporate oils out of the sludge, which requires enough heat to evaporate the liquids and the oil. The vapors are captured and condensed by the scrubber, and the remaining material should be a dry powder and the resultant pH of the vapors and the solids should be near neutral.

In an example which is not limiting of embodiments, the mixer may include 72 revolutions per minute (RPM) paddles synced together by bull gears. Dual motors may start concurrently, and the mixer may be part of the main skid. The incoming bulk density may be 128 pounds per cubit foot, containing about 40% liquids at 64 pounds per cubic foot. The remaining wet material may be very dense. After processing, the bulk density of the solids may be about 70 pounds per cubic foot, which appears to be about half of the density of the wet material. Therefore, 2205/70=31 cubic feet, assuming that all of the incoming sludge is solid and that the lime and calcium do not contribute to the volume. The mixer spinning at approximately 72 rpm will super-aerate the powder into dust, which will greatly increase the chance of the scrubber picking up the material and reversing the separation. The scrubber inlet should not be near the center. The mixer may have 2-20 HP starters and 2 confirm contacts. Motor speed of the mixer may be determined by separate belts and sheaves. Unless perfectly matched and tightened, one motor may carry the brunt of the load, and motor slippage may help to balance the load. The mixer may have two cleanout doors on each side, or mixer access cover doors. Mixer pressure could release gases or automatically trip the mixer to turn it off. The peak temperature attainable by the exothermic reaction may be approximately 400 degrees Fahrenheit.

In an example which is not limiting of embodiments, following is a charge scenario (order of acid and base addition may be reversed):
Verify mixer empty.
Verify doors closed and running.
Batch sludge to mixer approximately 2 minutes for 2205 pounds.
Verify scrubber running before starting acid.
If partial batch, recalculate targets based on net weight.
Acid may be added as a proportion relative to net sludge weigh in the mixer. Acid and water in the sludge will increase its corrosive properties and start an exothermic reaction. Mixer shell could be at approximately 400 degrees from previous batch.
Acid addition at approximately 60 gallons/minute should take a maximum of 30 seconds.
Acid is distributed throughout the sludge.
Batch lime and calcium chloride batch after proportional target has been established
Verify scrubber running before starting lime, calcium addition.
If both solid is ready for discharge and the acid mix timer has expired, both materials are discharged concurrently.
The reaction with the lime in some embodiments is almost instantaneous. The material may need to empty in 2 seconds or less. If discharge is over this time period, steam and sludge could be blown into the cement weigh batchers.
The empty open time for the scales must be minimal. Gates should close rapidly.
The mixer temperature may be monitored for operator tuning only.
The mix time is run to completion.
While mixing, the exothermic reaction is boiling off the liquids and oil. They will begin to condense as soon as they hit cooler temperatures of the duct and outside air.
This is basically a still. The process is complete when the exothermic reaction stops.

In an example which is not limiting of embodiments, mixer discharge doors may include two doors controlled by one dual solenoid per door, each door having its own closed limit switch. Bottom-drop doors may seal without rubber seals, and any seal should be impervious to sulfuric acid, lime, calcium, and 400-degree temperatures. Doors may not be over center latched. If air pressure fails, door will open, and e-stops will stop electrical on the complete plant. Inching may be impossible. The door may not close once material starts to discharge. The doors could lift the mixer if pushing on the material in the hopper. If the auger fails to move the material fast enough, the doors may pick up material at the top of the stack and may not close completely.

In an example which is not limiting of embodiments, a mixer target hopper may be charged by bottom-drop doors and discharged by live bottom screw auger. If the mixer is washed, wet material may clog the hopper discharge screw. For this reason, a belt or drag conveyor may work best at this location. Approximately 10 miles per hour mixer paddle tip speed may whip material horizontally. The screw conveyor may be a 15 horsepower (HP) screw conveyor.

In an example which is not limiting of embodiments, an air compressor may be a 10 HP air compressor mounted on the main skid and controlled from the main control panel (e.g., Igersol Rand) with E-stop from the main panel. The air compressor may have its own starter and a 110 VAC dryer may be run from power panel.

In an example which is not limiting of embodiments, the scrubber may be connected to the mixer vent and have a vent butterfly via a valve at the mixer where the scrubber connects to open and close at certain temperatures. It may have a single solenoid, full open limit switch, and/or full closed limit switch. The scrubber should be running as a permissive to start the mixer charge and lime and calcium addition, run required from programmable logic controller (PLC) and run confirm from the scrubber. Scrubber power requirements may be 3-phase, 110 VAC.

In an example which is not limiting of embodiments, control hardware may include NEMA 4 control with Allen-Bradley Control Logix processor L32E PLC and 15-inch color touch screen in control cabinet, for example. HMI and E-stop could be located anywhere. The system may require Ethernet cable and two DC E-stop wires. Controls could have hardwired connections mounted on the main trailer and a heater in the control panel. In some embodiments, the control system may track and record a history of all work within the running of the plant.

In an example which is not limiting of embodiments, the power panel may be required to power the following equipment: 15 HP sludge receiving hopper horizontal REV screw, 15 HP sludge receiving hopper incline screw, two 2.28 HP shale shaker motors, 25 HP shale solids live bottom screw, 5 HP horizontal screw for base B, 15 HP incline screw for base B, 10 HP aeration blower for base B, 5 HP horizontal screw for calcium chloride or salt C, 15 HP incline screw for calcium chloride or salt C, 10 HP aeration blower for calcium chloride or salt C, 5 HP acid pump, two 20-HP mixer motors, 15 HP mixer hopper discharge screw, 10 HP air compressor, 0.5 HP air compressor dryer 110vac single phase, scrubber power, and control power from stepdown transformer.

Some example equipment which may be used in the method and system of embodiments may include the following: silos and truck receiving bins may be Schwing Bioset, Inc. sliding frame storage systems (e.g., sliding frame live bottom silos, truck loading silos, intermediate storage silos, etc.) and truck receiving systems; concrete pumps may be used with live bottom feeders instead of augers/screw conveyors (e.g., using a Schwing Bioset, Inc. concrete pump); biosolids processing and handling solutions from Schwing Bioset, Inc. including sludge pumps, bioset process, container wagon, fluid bed dryer; piston pumps, sludge screw feeders models SD 250, 350, 500, bioset pumps, valves, pumping, conveying, and storage technology may be from Schwing Bioset, Inc. also. Other examples of equipment which may be used in the system and method of embodiments includes a 1998 VE 500 bbl Frac Tank for storing finished water/oil, 1991 Sunshine 6000 gal food grade iso for acid storage, 2011 bulk new dot 407 for storing acid, 1984 HEL for acid storage, 1995 Brenner liquid storage tank for acid storage, 1985 stainless insulated stainless steel tanker for acid storage, and/or 2012 southern frac 500 bbl v-bottom storage tank.

Examples of specifications and parameters and sizing of a truck receiving storage bin, push floor discharger, twin auger screw feeder, piston pump, hydraulic power unit, local control panel, and other components of a system and method of embodiments include the following (numbers and materials are merely exemplary and not limiting of embodiments). For the truck receiving storage bin, quantity: one (1); material of construction: A36 carbon steel; process material: oil well field cuttings; process material maximum particle size: ¼ inch; bin interior dimensions: 10 feet wide×30 feet length×8 feet sidewall height; bin overall height (sidewall and supports): 11 feet. The scope of the truck receiving storage bin may include the following:
1. The rectangular bin may be self-supporting with carbon steel support legs and framing complete with base plates drilled for anchors. The rectangular bin may be fabricated with all necessary cross bracing and reinforced members.
2. Bin floor and sidewalls may be fabricated from A36 carbon steel plate. Sidewall thickness may be ¼ inch minimum and the floor thickness may be ½ inch minimum.
3. Support legs may be provided to elevate the rectangular bin and push floor assembly to approximately 3 feet above ground level.
4. Ladder and railings may be provided by others.
5. The bin may be opened top equipped with bar screen spaced 10 inches on center located approximately 1 foot below the top of the bin sidewall. A bolted section bar screen allows access.
6. The floor may be furnished with one (1) opening, flanged for bolted connection of the twin screw feeder and one 8 inch blind flange.
7. Storage bin may be factory surface prep and finish painted as follows:
   Interior: surface prep SSPC-SPIO;
   First Coat: Tnemec 446 Perma-Shield MCU, 8-10 mils DFT;
   Second Coat Tnemec 446 Perma-Shield MCU, 8-10 mils DFT.
   Exterior: surface prep SSPC-SP6,
   First Coat: Tnemec L69 Hi-Build Epoxoline II, 3-5 mils DFT,
   Second Coat Tnemec L69 Hi-Build Epoxoline II, 3-5 mils DFT
   Third Coat Tnemec 73 Endura-Shield, 3-5 mils DFT.
8. Storage bin may require on-site assembly by the installing contractor. On-site assembly includes installation, erection, and field touchup painting. No field welding is required.

For the push floor discharger, quantity may be two (2). The scope of the push floor discharger may include the following:
1. The push floor discharger assembly may include a rectangular shaped frame driven by a double-acting hydraulic cylinder.
2. During operation, the rectangular shaped frame moves back and forth along the bin floor, feeding material into the bin discharge outlet.
3. The push frame weldment may be fabricated from A36 carbon steel. The push frame may be prime painted only with no additional finish coating necessary.
4. The push floor discharger assembly may include one (1) each of the following items: hydraulic cylinder, extension shaft, clevis and pin stuffing box seal with auto-greasing.
5. The hydraulic cylinders may include two (2) proximity switches to direct flow of oil. Field wiring to the local control panel may be completed by others.
6. The push floor discharger components may require on-site assembly by others.

For the twin auger screw feeder, quantity: one (1); model: SD 250; inlet dimensions: 17 inches×96 inches; flights: 9.6 inches in diameter; material of construction: A36 Steel. The scope of the twin auger screw feeder may include the following:
1. The twin-screw auger assembly may be equipped with a three position actuating lever to control the auger (FORWARD/STOP/REVERSE), and this lever may be located on the hydraulic power unit.
2. The twin-screw feed auger transition may be furnished with a pressure transducer to automatically control the screw feeder speed. A local LED pressure display may be included at the screw feeder.
3. May include flexible connector for receiving cuttings from the truck receiving bin.

For the piston pump, in some examples, quantity: one (1); model: KSP 10 V(K); design flowrate: 10 gallons per minute (GPM) (adjustable—based on 50% pumping of 6 minute cycle time); design pressure: 1000 PSI (adjustable); pumping stroke length: 19.7 inches [500 millimeters (mm)]; diameter—material cylinders: 6 inches [150 mm]; diameter—hydraulic cylinders: 3.5 inches [90 mm]; cylinder ratio: 2.78; diameter—suction poppets: 4.9 inches [125 mm]; diameter—discharge poppets: 3.9 inches [100 mm]; and diameter—discharge outlet: 3.9 inches [100 mm]. The scope of the piston pump may be as follows:
1. The piston pump may be a hydraulically driven, twin-cylinder, reciprocating piston type pump equipped with poppet valves.
2. The piston pump may be equipped with a single discharge outlet. An adapter to the pipeline may be furnished at the discharge outlet, and may consist of a quick-connect coupling, 4 inch spool piece, 2 inch pressure bleed valve, and 4 inch ANSI 150# flange.
3. One (1) 4 inch ball valve may be supplied to isolate the piston pump for maintenance.
4. The piston pump water box may have 1 inch connections for water supply and 1½ inches for overflow/drain line. Water lines and valves may be supplied by installing contractor.
5. Maintenance Mode Controls may be factory mounted at the piston pump. Maintenance Mode Controls may include a MAINTENANCE MODE ON/OFF switch, FORWARD/OFF/REVERSE SWITCH, PUMP JOG pushbutton, and EMERGENCY STOP pushbutton. Field wiring to the Control Panel shall be completed by installing contractor.

For the hydraulic power unit, in one example, quantity: one (1); model: 230 L-50 hp; reservoir size: 60 gallons; motor size: 50 HP; hydraulic pump (piston pump): Rexroth A 11VO40; hydraulic pump (screw feeder): Rexroth A11VO40; hydraulic pump (push floor): constant volume gear type; electrical service: 480 Volt/3 Phase/60 Hertz. The scope of the hydraulic power unit may include the following:
1. Rexroth axial piston pumps may be supplied to drive the separate hydraulic circuits for the piston pump and screw feeder. Push floor may be driven by a constant volume gear pump.
2. A premium efficient, TEFC motor may be supplied.
3. Recirculating hydraulic oil conditioning loop may include the following:
A constant volume hydraulic pump.
A water-cooled heat exchanger with water supply and drain connections.
Shutoff valves (water piping and drain piping beyond the shutoff valves may be furnished by the installing contractor).
Thermostatically controlled valve to regulate water flow.
4. Premium efficient, TEFC motor may be supplied.
5. Power unit may include initial fill of oil, pressure gauge, pressure switch, relief valves, clean-out cover, and combination temperature and sight gauges.
6. Hydraulic tubing and hoses to connect equipment may be included.
Carbon steel seamless hydraulic tubing may be supplied in nominal 20 foot lengths. Others shall field cut to fit.
Schwing Bioset may supply all fittings required for installation.
Flexible hose connections 4 feet long may be provided at equipment to isolate vibration.
Hydraulic tubing and fittings may be installed and painted by others.
All supports for the hydraulic tubing may be supplied by others.
7. The anchor bolts may be installed by others.
8. A full-voltage motor starter may be furnished by Schwing Bioset and factory mounted in the local control panel mounted on the power unit.

For the local control panel, quantity may be one (1). The scope of the local control panel may include the following:
1. Local control panel enclosure may be NEMA 4X, 304 stainless steel, mounted on the hydraulic power unit.
2. Schwing Bioset PLC may be used to control all panel functions.
3. The local control panel closure may be used to control and/or monitor the following equipment:
   One (1) Push Floor Discharger
   One (1) Hydraulic Power Unit
   One (1) Piston Pump
   One (1) Twin-Screw feeder
4. Schwing Bioset standard analog input and output devices may be provided.
5. Motor starter for hydraulic power unit may be included.

During commissioning, the hydraulic oil filters may be changed out after the first 50 hours of hydraulic power unit operation. The spare part of one set of hydraulic oil filters may be furnished for this purpose.

Scope of supply summary includes the following in an example not limiting of embodiments: truck receiving storage bin: one (1); push floor discharger: two (2); twin auger screw feeder (SD 250): one (1); piston pump KSP 10V (K): one (1); hydraulic power unit Model 230-50 HP: one (1); local control panel: one (1); spare parts: one (1) lot; special tools: one (1) set; field service: one (1) lot (see above).

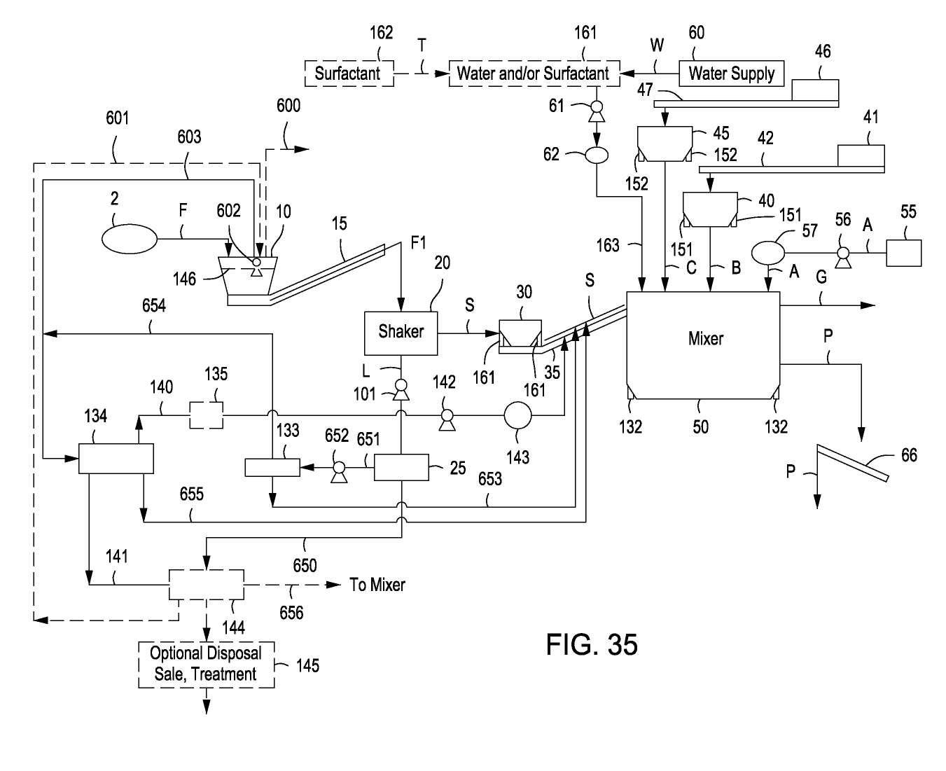

FIG. 35 shows a flow diagram of an embodiment of a system and method for removing a liquid component from a raw material or substrate or feed F to produce a dry product P. The liquid component may be oil or any hydrocarbons. The raw material feed F may be oil-contaminated sludge, sludge, emulsions, liquids, and other similar substances. In some exemplary embodiments, water in the raw material may range from 0 to approximately 60 weight percent. In some exemplary embodiments, oil in the raw material may range from 0 to approximately 90 weight percent. In some exemplary embodiments, solids in the raw material may range from 0 to 100 weight percent.

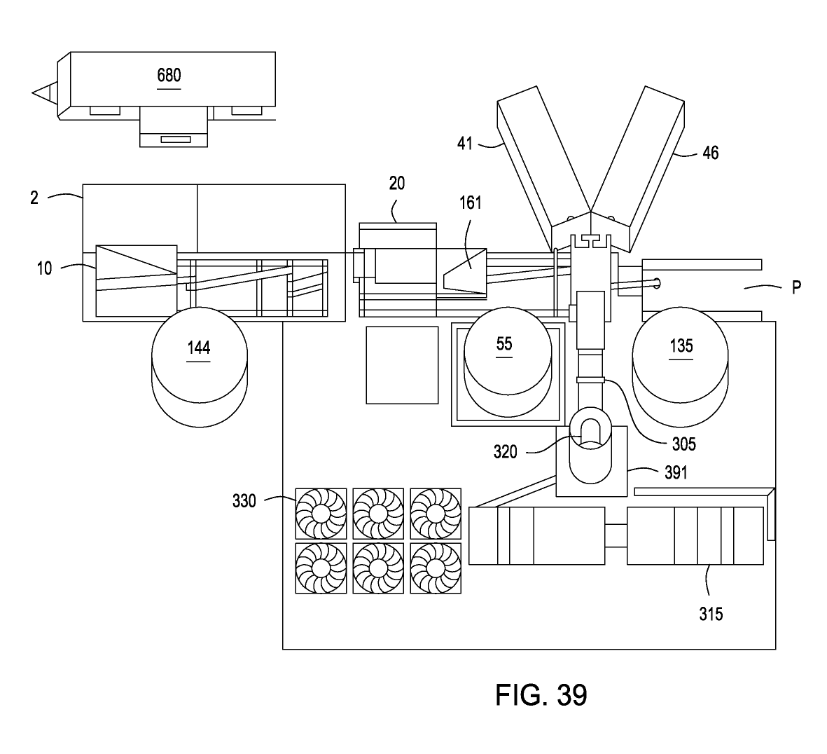

The system may include a substrate or raw material treatment section and gas cleaning and oil (or other liquid in the substrate) recovery section. FIG. 39 shows a top view of a system and method of embodiments showing one example of a layout of the equipment included in the system.

The substrate or raw material treatment section of the system may include a receiving pit 2 or receiving bin for receiving the raw material feed F and a receiving hopper 10 or receiving bin. The substrate feed F may be delivered to the system directly from the drilling rig, by truck tanker or other vehicle, by roll off box, by a dump truck, trackhoe, or any other equipment and method for delivery of a substrate or feed F known to those skilled in the art. In one example embodiment, an excavator may unload material onto a concrete pad. The receiving hopper 10 or receiving bin may be disposed downstream of the receiving pit 2. The receiving hopper 10 is optional and could be replaced with a live bottom tank which moves the substrate feed within the tank to provide a generally homogeneous feed, a track hoe for loading the substrate feed directly into the shaker 20 or mixer reactor 50 from the track hoe, or a barge at the site receiving cuttings from the wellbore. The receiving hopper may also or instead be replaced by a pump directly to the mixer 50 or shaker 20.

The receiving pit 2 may be approximately 6 feet deep in one example, although any depth of the receiving pit 2 is within the scope of embodiments. An excavator may be used to move feed material F into the receiving bin 2.

The receiving hopper 10 may include a screen 146 which may be located at a top portion of the hopper to filter out the larger materials in the feed F and prevent them from entering the hopper 10. The screen 146 may be a grizzly screen in one embodiment. Additionally, the receiving hopper 10 may include a live bottom feeder for moving material to ensure a homogeneous feed from the receiving hopper 10. Optionally, the receiving hopper 10 may be a mobile receiving bin.

An optional shaker 20, which may be a shale shaker, may be used to receive the feed from the receiving hopper 10 and separate the thicker substrate stream S from the generally liquid stream L, which may include dirty oil, water, and/or some solids. The shaker 20 may include one or more staggered mesh screens therein, for example one or more 660 mesh screens. In one embodiment, slanted screens in the shaker 20 which are staggered (the slanted screens may be instead be a flat screen in other embodiments) may vibrate in the shaker and cause the material on the screens to move forward. The shaker 20 may include one or more motors which may vibrate the screens, causing solid particles and fins to advance along the screens as sludge, which is eventually delivered to the mixer reactor 50.

An embodiment of the shaker 20, including a shaker assembly 615, a shaker chute assembly 620, a shaker platform assembly 615, a shaker skid weldment 612, and a shaker starter box 611, is shown in FIGS. 2A and 4A, and the shaker chute assembly 620 is shown in FIG. 9. The shaker chute assembly 620 may include one or more butterfly valves 621 (which may be a 4 W handle butterfly valve) with a connector which cable. One or more pipe flanges 622 (e.g., 4-inch NPT threaded pipe flanges) and associated components 623 such as hex head cap screws (HHCS) (e.g., eight ⅝-11 inch UNC×4½ inches HHCS), one or more lock washers (LW) (e.g., eight ⅝ inch LW), and nuts (e.g., eight ⅝-11 inch UNC nuts). (UNC stands for Unified Screw Threads Coarse.) One or more nipples 624 (e.g., 4 SCH 40×4 in inches) may operatively connect to the one or more pipe flanges 622, and a pipe elbow 626 (e.g., 4×90 degrees (DEG)) may operatively connect to the one or more nipples 624. A bushing 627 (e.g., a 4-2½ inch bushing) and hex bushing 628 (e.g., a 2½×1½ inches hex bushing) may be between the one or more nipples 624 and a combination nipple 629 (e.g., a 1½ inch combination nipple). Another combination nipple 629 may be disposed on the other side of a hose clamp 631 (e.g., two total 1½ inch diameter-2¼ inch diameter hose clamp) and hose 630 (e.g., 1½-inch inner diameter (I.D.) hose (total 14 hoses)). One or more pumps such as pump 632 may be operatively connected to the hose 630, e.g., via the combination nipple 629 and hose clamp 631. In some examples, the pump 632 may be a piston pump or screw pump. Operatively connected to the pump 632 may be an elbow 633 (e.g., a 1¼ inch×90 degree street elbow) and combination nipple 634 (e.g., a 1¼ national pipe thread (NPT) combination nipple); and a nipple 635 (e.g., a ¾ inch×5¾ inch nipple), valve such as a solenoid valve 636 (e.g., a ¾ inch solenoid valve), and an elbow 637 (e.g., a ¾-inch diameter street elbow, 90 degrees). Also operatively connected to the pump 632 at location 638 may be one or more hex head cap screws (HHCS), e.g., four ⅜-16UNC×1¾ inch HHCS, one or more flat washers (FW) (e.g., four ⅜ inch FWs), one or more lock washers (LWs), e.g., four ⅜-inch LWs, and nuts (e.g., four ⅜-16UNC nuts (in inches)), and operatively connected to the pump 632 at location 639 may be one or more HHCS, e.g., sixteen ¾-10UNC×2 HHCS, one or more lock washers (LWs), e.g., sixteen ¾ inch LWs, and one or more nuts, e.g., sixteen ¾-10UNC nuts (unless stated otherwise, units are in inches). Shaker chute weldment 640 may have a laser probe and associated laser cord, washers (e.g., two 10-24UNC), locknuts (e.g., two 10-24UNC), and screws (e.g., two 10-24UNC×2¾ inch screws) operatively connected at or near location 641 (unless stated otherwise, units are in inches). The laser probe is used for level indication.

A conveyor 15 (e.g., a screw conveyor) or auger or a pumping mechanism such as one or more pumps may be used to transport the feed F from the receiving hopper 10 to the shaker 20. The conveyor or auger 15 may be replaced with a pumping mechanism such as a pump (e.g., piston pump) with a manifold to spread the material out.

The shaker 20 is optional, and may either be replaced by a different liquid/solid separator known to those skilled in the art or may be eliminated from the system. In some embodiments, the shaker 20 may be replaced by one or more centrifuges or with other pre-mixer liquids removal devices. The shaker 20 may be used for consistency to make a uniform feed for flowing into the mixer reactor 50. In some embodiments, the shaker 20 may be included in the system but may be bypassed or not used if no liquid/solid separation is needed (possibly with a bypass stream around the shaker 20 from the feed F to the mixer 50). An advantage of the system of embodiments is that it is not always necessary to separate liquids and solids from one another prior to introducing them into the mixer reactor 50, unlike other systems. The function of the shaker 20 or other liquid/solid separation device is to add consistency to the feed into the mixer 50, or to make a uniform feed flowing into the mixer 50.

A liquids catch tank 25, which may be a sludge tank or hopper, may be used to at least temporarily store the liquids stream L. A pumping mechanism such as one or more pumps 101 may be located between the shaker 20 and the liquids catch tank 25 to pump the liquid stream L from the shaker 20 to the liquids catch tank 25.

An optional shaker hopper 30 may be disposed downstream from the shaker 20 for batching of material into the mixer 50. The shaker hopper 30 may receive the thicker substrate S from the shaker 20 and stores the sludge or thicker substrate S from the shaker 20 for the mixer 50. The hopper 30 may be a funnel to reduce the amount of material entering the mixer reactor 50 as compared to the amount of material exiting the shaker 20.

The shaker hopper 30 (which may also be termed a pre-weigh bin) may be disposed on one or more weighing devices such as one or more load cells or scales 131 to weigh material disposed in the shaker hopper 30. The shaker hopper 30 may be triggered by the level in the shaker hopper 30, as calculated by the weight measured by the one or more load cells or scales 131. The shaker hopper 30 may be configured to turn on when a certain level in the shaker hopper 30 is reached by the sludge material in the shaker hopper 30, as determined by the weight measured by the load cells or scales 131. Once the shaker hopper 30 material reaches a certain predetermined, programmed weight, as measured by the load cells or scales 131, the shaker hopper 30 (and everything else, or other components, in the system) may turn off or may slow down its delivering of materials into the mixer 50. The shaker hopper 30 may cut off the system so that the auger 35 can catch up when a certain weight level in the pre-weigh bin is reached. The weight measurements may be communicated to the computer processor via hardwiring or wireless communication. The computer processor may then communicate, hardwired or wirelessly, with the shaker hopper 30 to turn it on, turn it off, or increase or decrease its material delivery speed to the mixer 50.

A conveyor or auger 35 (or instead a pumping mechanism such as one or more pumps), for example a screw conveyor, may be disposed between the shaker hopper 30 and the mixer reactor 50 to transport material to the mixer reactor 50 from the shaker hopper 30. The conveyor or auger 35, which may be a screw conveyor, may be reversible, e.g., reversible in its screw operation, to agitate materials transportable by the conveyor or auger 35 when they are not being moved by the conveyor/auger 35 or fed to the mixer 50. (In an alternate embodiment, the shaker hopper 30 may be eliminated and the thicker substrate stream S may be transported (e.g., via conveyor, auger, or pumping mechanism such as one or more pumps) directly from the shaker 20 to the mixer reactor 50.)

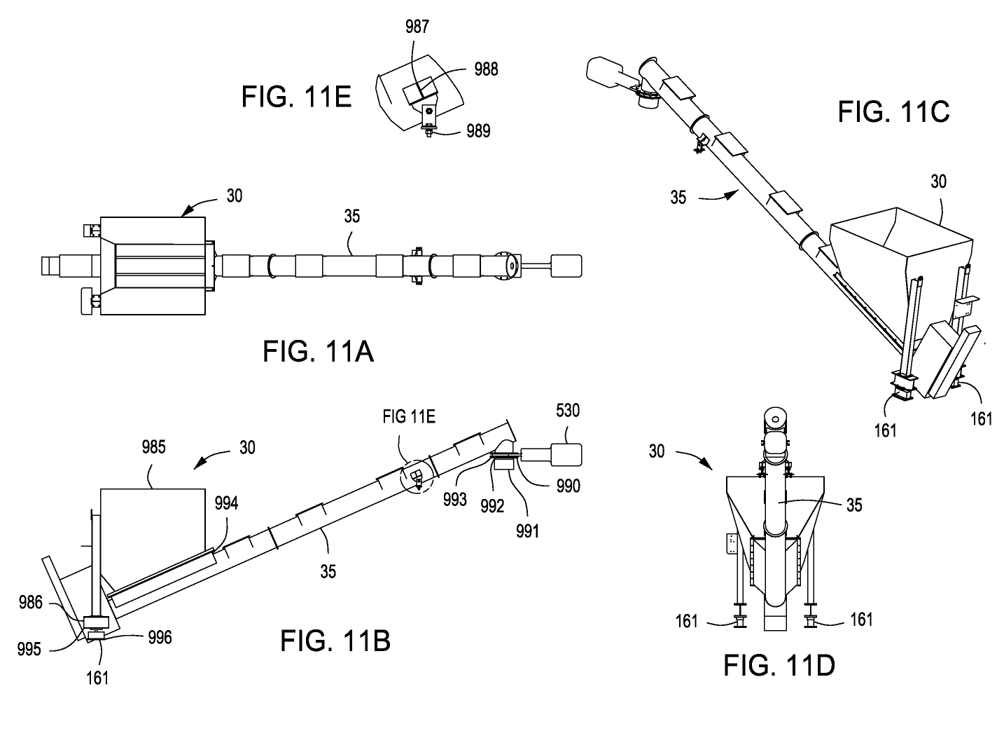

FIGS. 11A, 11B, 11C, 11D, and 11E show an embodiment of the mixer feed screw and hopper assembly, which may include the shaker hopper 30 disposed on load cells 161, the mixer feed screw conveyor 35, and a knifegate valve 530 on the mixer feed screw conveyor 35 for selectively allowing substrate S into the mixer 50. In an example which is not limiting of embodiments, the mixer feed screw conveyor 35 may a 12 inch mixer feed screw conveyor, the load cell(s) 161 may be one or more (e.g., two) 10K load cells, and the knifegate valve 530 may be a pneumatically activated 12-inch knifegate valve. In an example which is not limiting of embodiments, the mixer feed screw and hopper assembly may include a mixer feed screw hopper weldment 985, one or more (e.g., two) W8×31×17 (in inches) bolts 986, one or more PL 987 (plate) (e.g., two ¼×7×7½ inch PL bolts), one or more PL 988 (plate) (e.g., two ¼×3¾×3¾ inch PL bolts), one or more (e.g., two) A-frame bracket assemblies 989, a pipe weldment 990, a gum rubber boot 991 (which may be a 12¾ inch inner diameter×7 inch gum rubber boot), and clamps 992 (e.g., two clamps). The mixer feed screw and hopper assembly may also include at or near location 993 one or more hex head cap screws (HHCS) (e.g., twenty-four ⅞-inch×2-inch HHCS) and one or more lock washers (e.g., twenty-four ⅞-inch lock washers); at or near location 994 one or more HHCS (e.g., eighteen ½ inch×1½ inch HHCS), one or more lock washers (e.g., eighteen ½-inch lock washers), and one or more hex nuts (e.g., eighteen ½-inch hex nuts); at or near location 995 one or more threaded rods (e.g., eight ¾ inch×13¾ inch threaded rods), one or more lock washers (e.g., 40 total ¾-inch lock washers), and one or more hex nuts (e.g., 40 total ¾-inch hex nuts); and at or near location 996 one or more lock washers (e.g., ¾-inch lock washers), one or more hex nuts (e.g., ¾-inch hex nuts), and one or more HHCS (e.g., 24 total ¾×2½-inch HHCS).

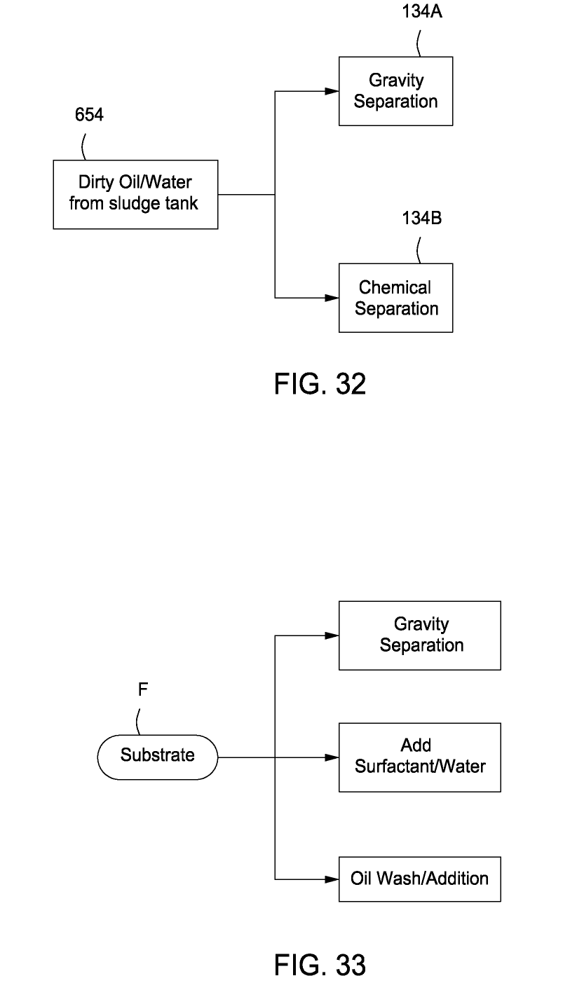

The system may include a dirty oil/water separation tank 134 for separating oil and water from one another. In one embodiment, the dirty oil/water separation tank 134 is a settling tank where materials settle and the oil (or other liquid in the substrate) and water separate from one another by settling. In an embodiment, the dirty oil/water separator 134 may be an open-top bin that holds fluid in a static condition, and where upon settling, oil may be skimmed off from the top of the bin while water is siphoned off of the bottom of the bin. Separation may be by gravitational separation and may in some embodiments be quickly accomplished. As illustrated in FIG. 32, the dirty oil/water separator 134 may use gravity separation 134A or chemical separation 134B (e.g., polymer flocculent) to separate the dirty oil 140, gray water 141, and/or fractional solids 655 from one another.

In lieu of the dirty oil/water separation tank 134, any type of device for separating oil and water from one another which is known to those skilled in the art may be a part of the system of embodiments and perform the purpose of the oil/water separation tank 134 of separating the oil and water from one another. An optional dirty oil tank or diesel tank 135 may be included in the system for at least temporarily storing dirty oil in the system, for example storing dirty oil 140 from the dirty oil/water separation tank 134 prior to its entry into the mixer reactor 50. A pumping mechanism such as one or more pumps 142 may be included in the system to pump the dirty oil 140 into the mixer reactor 50 or some other desired location in the system. One or more metering mechanisms such as one or more flow meters 143 may be included for metering the amount of dirty oil entering the mixer 50 from the dirty oil tank 135.

The dirty oil 140 which may be stored in a dirty oil or diesel tank 135 may be metered into the mixer 50 as shown in FIG. 35 and/or may undergo further treatment for sales such as filtration and/or chemical flocculation, and/or may be sold as is or disposed of. Treated dirty oil 140 may go to recovered oil (dirty oil recovery) and may be sold. The dirty oil tank 135 or dirty oil hopper may have a level sensor, such as a laser-type level sensor, that acts as an eye to see the dirty oil level in the dirty oil tank 135. In addition to or in lieu of the level sensor, the dirty oil hopper 135 may be on load cells (not shown) which operate and communicate with the computer processing system in much the same way as the shaker hopper load cells 161 operate and communicate. The sensor and/or load cell(s) may be used to help determine the level of dirty oil in the dirty oil or diesel tank 135 to allow the processor to communicate with the metering device 143 how much dirty oil to allow to be sent to the mixer 50 or other portion of the system or other location.

Additionally, the system may include a separating apparatus or separator 133 for separating the substrate from the liquids. For example, the separation performed by the separator 133 may be by gravity/gravitational separation or chemical separation (e.g., polymer flocculent or chemical flocculation), or by filtration or flocculation, and may be a gravity separator or chemical separator known to those skilled in the art for separating a substrate from liquid. Examples of the separator 133 may be a blender and/or polymer flocculation.

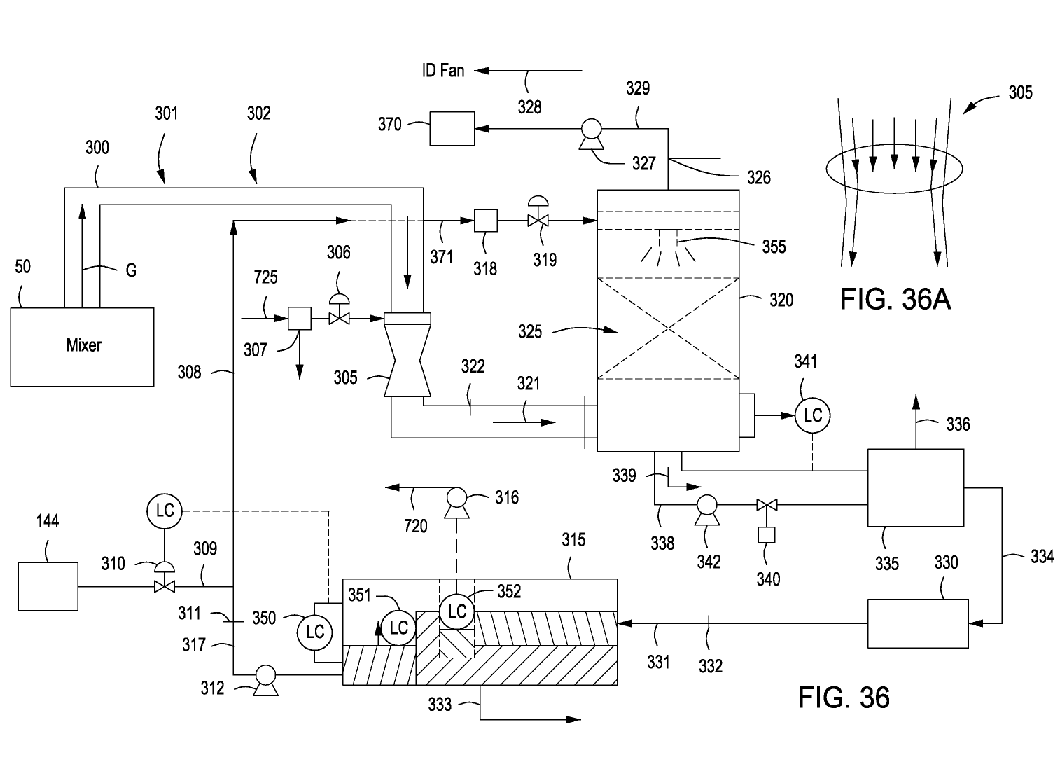

The system may include an optional water tank such as a gray or dirty water tank 144 for at least temporarily housing water, sometimes termed “gray water,” in the system, for example the gray water 141 exiting the dirty oil/water separator 134, from the receiving pit 2, from the shaker system, and/or from the gas condenser. FIG. 36 shows the gray water tank 144 and some possible inlet and outlet streams into and from the tank 144. (Although not shown, optionally, storm water and rain could also be added to the water tank 144.) Water exiting from the gray water tank may optionally be sent for further optional treatment 145 such as filtration and/or flocculation, may be sent into the mixer reactor 50 as a water source, may be sent into the receiving pit 2 or live bottom feeder, or may exit the system for disposal or sale.

In an alternate embodiment, a live bottom feeder and an auger or pump may be a part of the system in lieu of the receiving pit 2, receiving hopper 10, shaker 20, shaker hopper 30, and associated conveyors, pumps, etc. A screen may optionally be added to the live bottom feeder to filter out the larger materials much as the screen does in the receiving hopper 10 of other embodiments.

In one embodiment, in lieu of the receiving pit 2, receiving hopper 10, and associated conveyors, pumps, etc., a receiving bin such as a truck receiving bin may be utilized with a live bottom feeder or live bottom tank, such as a push floor system manufactured by Schwing Bioset, Inc. A truck receiving bin may having a push floor rectangular bunker design with two or more hydraulically-driven push frames that reciprocate along the bunker floor (the live bottom) may be included with the system. Cylinder action pushes or pulls the material toward either end of the bin or the center of the bunker, depending on site requirements. The truck receiving bin may be capable of accommodating side-dump trailers and multiple trucks unloading at the same time, and may be located at or below grade. Optional covers, which may be vacuum covers, for the truck receiving bin contain odors and prevent rain, snow, and other materials from falling into the bunker. The pitch of the push floors may be arranged such that the bunker discharge may be located anywhere in the truck receiving bin. Either a sliding frame or push floor design may be used for the truck receiving bin. The truck receiving bin with live bottom feeder in lieu of the other feeder components shown in FIG. 35 is much more compact than the multiple feeder components that are shown in FIG. 35 for which the truck receiving bin may be substituted. To perform the separation of the solids or thicker substrate S and the liquids L (e.g., dirty oil, water, and some solids mixed in the liquids), one or more pumping mechanisms such as one or more pumps may be added to this embodiment of the system in lieu of the shaker 20, shaker hopper 30, and associated pumps and other associated components. The one or more pumps may for example be one or more piston pumps such as Schwing Bioset piston pumps.

In another embodiment, in lieu of the receiving pit 2, receiving hopper 10, and associated conveyors, pumps, etc., one or more intermediate storage silos may be utilized with a live bottom feeder, such as a push floor system manufactured by Schwing Bioset, Inc. The intermediate storage silo(s) may be sized to store a few hours to a few days of material and allow storage of an inventory of material, while also allowing for interruptions in material production without impacting the next treatment process. A piston pump and sliding frame may be driven by one or more power packs, and the piston pump may be directly connected to the floor of the silo to maximize storage capacity and minimize overall height of the silo. A uniform draw down of material may be provided by first in/first out construction of the silo, and the silo(s) may include multiple discharge locations to provide design flexibility. The silo walls may be vertical to provide a low profile storage bin and eliminate the possibility of material bridging and/or arching. The intermediate storage silo(s) with live bottom feeder in lieu of the other feeder components shown in FIG. 35 is much more compact than the multiple feeder components that are shown in FIG. 35 for which the intermediate storage silo(s) may be substituted. To perform the separation of the solids or thicker substrate S and the liquids L (e.g., dirty oil, water, and some solids mixed in the liquids), one or more pumping mechanisms such as one or more pumps may be added to this embodiment of the system in lieu of the shaker 20, shaker hopper 30, and associated pumps and other associated components. The one or more pumps may for example be one or more piston pumps such as Schwing Bioset piston pumps. The one or more pumps may uniformly remove free water and oil from the live bottom feeder tank, and dirty oil could flow to the dirty oil/water separator 134.

Load cell(s) or other weighing devices on the receiving hopper 20, the intermediate silo(s), or the truck receiving bin(s) with the live bottom feeder in it may weigh material in the receiving hopper 20, the intermediate silo(s), or the truck receiving bin(s) and communicate that weight with the computer processor. Computer software may be used to determine when no feed F is being added to the receiving hopper 20, the intermediate silo(s), or the truck receiving bin(s), and the processor may be used to communicate with the live bottom feeder wirelessly or through a wired connection to turn the live bottom feeder on to stop bridging of the feed material in the receiving hopper 20, the intermediate silo(s), or the truck receiving bin(s) (and if feed material F is being added to the receiving hopper 20, the intermediate silo(s), or the truck receiving bin(s), the live bottom feeder may be turned off).

Whether the live bottom feeder with the pumping mechanism and/or auger or conveyor are included with the system or the receiving pit 2, receiving hopper 10, shaker 20, and shaker hopper 30 are included with the system, the substrate material S eventually flows to a mixer 50. An optional dust control cover may be included between the hopper 30 and mixer 50. The mixer reactor 50 may be disposed on one or more weighing devices such as one or more load cells or scales 132 for weighing the material in the mixer 50 and communicating that weight with the system processor.

The mixer reactor 50 may be a dual shaft mixer as shown and described in relation to FIGS. 16A-22C. Although it is within the scope of embodiments that one shaft or more than two shafts may be included with the mixer 50, dual shafts appear to perform most effectively in embodiments. The mixer 50 was described herein in relation to FIGS. 10 and 15A-30, in particular. In one example which is not limiting of embodiments, the mixer 50 may be a one ton per hour unit. In an example which is not limiting of embodiments, batches may be delivered to the mixer in 6-minute cycles.

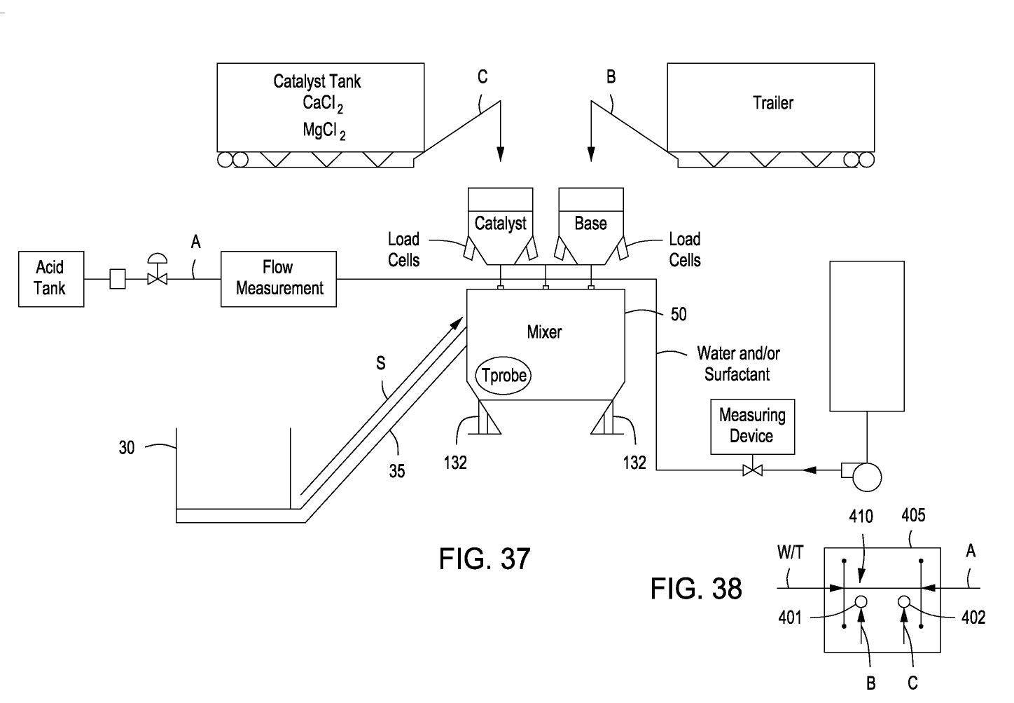

As shown in FIGS. 35 and 37-39, substrate S, base B, catalyst C, acid A, optional water W, and optional surfactant may be capable of flow into the mixer 50. The base B may be stored in a base tank 40, hopper, or batcher and/or a base storage silo 41 or trailer. The base storage silo 41 may optionally have one or more sensors to determine volume of material in the base storage silo 41. A conveyor or auger 42 or pneumatic pump may be disposed between the base storage silo 41 and the base tank 40. The base tank may optionally be disposed on one or more weighing devices such as one or more load cells or scales 151 for weighing the material in the base tank 40 and communicating that weight with the system processor. Optionally, the base storage silo 41 or base storage container may have an axle and wheels and may be pulled as a trailer behind a truck. The containers may also include air hoses and a pump for aerating the solid material from underneath, the air causing the solid material in the trailer to flow like a fluid.

The base B may be, for example, an alkaline metal oxide (or alkaline metallic oxide), hydrated alkaline metal oxide, one or more alkaline earth-containing compounds (or alkaline earth metal containing compounds), lime, or calcined calcium carbonate. The base may be a moderate to strong base. Examples of the base B include calcium oxide (CaO), gunpowder lime, quicklime or burnt lime, pulverized quicklime, and/or unslaked lime, or a caustic base such as potassium hydroxide (KOH) or sodium hydroxide (NaOH). In one example, the base B is 100 mesh Pulverized quicklime which may be from Mississippi Lime Company which may also be used for example in the steel flux, construction and environmental, water treatment, pulp and paper, and wastewater treatment industry. The broadly used term lime connotes calcium-containing inorganic materials, which include carbonates, oxides and hydroxides of calcium, silicon, magnesium, aluminum, and iron predominate, such as limestone. The base may include calcium sulfide, calcium hydroxide, beryllium oxide, magnesium oxide, strontium oxide, and/or barium oxide.

The catalyst C may be stored in a catalyst tank 45, hopper, or batcher and a catalyst storage silo 46 or trailer. The catalyst storage silo 46 may optionally have one or more sensors to determine volume of material in the catalyst storage silo 46. Optionally, the catalyst storage silo 45 or catalyst storage container may have an axle and wheels and may be pulled as a trailer behind a truck. The containers may also include air hoses and a pump for aerating the solid material from underneath, the air causing the solid material in the trailer to flow like a fluid. A conveyor or auger 47 or pneumatic pump may be disposed between the catalyst storage silo 46 and the catalyst tank 45 to transport the catalyst from catalyst storage silo 46 or trailer to the catalyst tank 45, hopper, or batcher. The catalyst tank 45 may optionally be disposed on one or more weighing devices such as one or more load cells or scales 152 for weighing the material in the catalyst tank 45 and communicating that weight with the system processor. The optional catalyst C may be a multivalent metallic salt, calcium chloride (CaCl₂), magnesium chloride (MgCl₂), and/or other similar base(s) or salt(s) or metallic salt(s). The calcium chloride C or other similar base, salt, or metallic salt may be added to the mixer 50 as a catalyst or enhancement to the base B such as lime, driving the temperature of the reaction higher to make the reaction more efficient. The calcium chloride may instead be any other salt which acts as a catalyst or enhancement to the lime or other base B or may be combined with other salts which perform these purposes. In some examples, the catalyst C may be calcium fluoride, calcium bromide, calcium iodide, beryllium chloride, magnesium chloride, strontium chloride, barium chloride, and/or radium chloride.

Optional batcher 45 may contain a catalyst such as calcium chloride (CaCl₂) and/or other similar base or salt. The calcium chloride C and/or other similar base or salt may be added to the mixer 50 as a catalyst or enhancement to the base B, driving the temperature of the reaction higher to make the reaction more efficient. The calcium chloride may instead be any other salt which acts as a catalyst or enhancement to the lime or other base B or may be combined with other salts which perform these purposes. Any other storage device or method for the calcium chloride and/or other salt may be used in addition to or in lieu of the batcher 45, and the batcher 45 is merely exemplary.

Optionally, the calcium chloride and/or other salt may be stored upstream of the batcher 45 in a silo 46 such as a portable storage silo or any other storage device or method for storing and/or transporting and/or delivering the calcium chloride and/or other salt C to the mixer 50. A material transporting device 47 may be positioned so as to receive the catalyst such as calcium chloride and/or other salt exiting from an outlet of the silo 46 and deliver the calcium chloride and/or other salt to the batcher 45. The material transporting device 47 may be a conveyor such as a screw conveyor, for example. (In alternate embodiments, the calcium chloride and/or other salt is deposited directly from an outlet of the storage silo 46 into the batcher 45 without the need for the conveyor 47, or the calcium chloride and/or other salt is deposited directly into the mixer 50 from the storage silo 46 and/or batcher 45 with or without a conveyor 47.) One or more pumps (not shown) and one or more meters (not shown) may be disposed between the batcher 45 and the mixer 50 to pump the calcium chloride and/or other salt C into the mixer 50 and meter the amount of calcium chloride and/or other salt C delivered into the mixer 50, respectively.

Although the base tank 40 and the catalyst tank 45 are shown as two separate tanks in the system shown and described in FIG. 35, in an alternate embodiment either an additional tank with base B and catalyst C mixed therein may be included with the system or only one tank with base B and catalyst C mixed therein may be included with the system. The base B and catalyst C may be premixed prior to their introduction into the mixer 50.

One or more piston and cylinder assemblies may optionally be included with the base B and/or catalyst C delivery system to add the base B and/or catalyst C into the mixer 50 faster in one embodiment. The one or more piston and cylinder assemblies may also optionally be used to mix the base B and catalyst C together prior to the base and catalyst entering the mixer 50, so that the base B and catalyst C are introduced into the mixer 50 at the same time, already mixed together.

In another optional alternate embodiment, a concrete pump or other similar pump with a live bottom feeder may feed straight into the mixer 50.

The acid A may be a moderate to strong acid such as a mineral acid, for example a strong mineral acid such as sulfuric acid or a mineral acid such as hydrochloric acid, nitric acid, or boric acid. The acid may instead be a mineral acid such as one or more hydrogen halides and their solutions (hydrochloric acid, hydrobromic acid, hydroiodic acid), halogen oxoacids (hypochlorous acid, chlorous acid, chloric acid, perchloric acid, and corresponding compounds for bromine and iodine), fluorosulfuric acid, phosphoric acid, fluoroantimonic acid, fluoroboric acid, hexafluorophosphoric acid, chromic acid, or boric acid. The acid may instead be a non-mineral acid such as sulfonic acid, methanesulfonic acid or mesylic acid, ethanesulfonic acid or esylic acid, benzenesulfonic acid or besylic acid, p-Toluenesulfonic acid or tosylic acid, trifluoromethanesulfonic acid or triflic acid, polystyrene sulfonic acid or sulfonated polystyrene, carboxylic acid, acetic acid, citric acid, formic acid, gluconic acid, lactic acid, oxalic acid, or tartaric acid.

The acid may be stored in the supply tank 55, which may be fluid-sealed. In some embodiments, the acid tank is a corrugated, polycarbonate tank. Any other storage device or method for the acid may be used in addition to or in lieu of the supply tank 55, and the supply tank 55 is merely exemplary. The supply tank 55 may be disposed on one or more weighing devices such as one or more load cells for weighing the acid prior to its introduction into the mixer 50 and communicating the weight to the system processor.

Optionally, the acid may be stored upstream of the supply tank 55 in a silo (not shown) such as a portable storage silo or any other storage device or method for storing and/or transporting and/or delivering acid to the mixer 50. One or more fluid lines and/or pumps may be included with the acid tank 55 to transport the acid A from the acid tank A to the top of the mixer reactor 50. One or more pumps 56 and one or more measuring devices such as one or more meters 57, for example one or more magnetic flow meters, may be disposed between the tank 55 and the mixer 50 to pump the acid stream A into the mixer 50 and meter the amount of acid A delivered into the mixer 50, respectively. (In alternate embodiments, the acid is deposited directly from an outlet of the storage silo or other acid storage unit into the mixer 50 without the need for the supply tank 55.) The acid meter 57 may be used to meter into the mixer 50 an amount of acid A calculated by a computer processing system. The acid meter 57 may be, in one embodiment, a Magnetoflow meter or pulsating meter, which may be used to count the acid A. The one or more pumps 56 may be well oversized with a header so that the acid A may be pumped into the mixer 50 extremely fast, e.g., in seconds, so that the acid A makes the fastest contact with the material in the mixer 50 when it is added. The acid A may be delivered by the truckload to the system site by a truck or other vehicle.

FIGS. 7A and 7B show a pump and acid (e.g., sulfuric acid) meter assembly, and FIG. 7C is a section view of the pump and acid meter assembly. In an example which is not limiting of embodiments, the pump and meter assembly 852 may include the pump 56 and meter 57 (which may be a 2-inch 150-pound magnetoflow meter). Additionally, in an example which is not limiting of embodiments, the pump and acid meter assembly 852 may include one or more pipe gaskets 940 (e.g., five 2-inch pipe gaskets), ball valve 941 (e.g., lined 2-inch ball valve flanged with actuator), spools 942 (which may be two 2-inch stainless steel pipe W classification fitting two (2) 150-pound flanges 8 feet length), pipe flange 943 (which may be a 2 national pipe thread (NPT) stainless steel), camlocks 944 (which may be two 2-inch NPT male×2-inch camlock stainless steel), hose 945 (which may be 2-inch hose for sulfuric acid suction), U-bolt 946 (e.g., U-bolt 2-inch pipe), pipe gasket 947 (which may be 2½-inch pipe gasket), pipe flange 948 (which may be 2½ inch NPT stainless steel), reducing bushing 949 (which may be 2½-inch×2-inch stainless steel), hose 950 (which may be a 2-inch hose for sulfuric acid suction (−W(1)STR, (1)90 FIT), tank weldment 951, megatainer 952 (e.g., container 55), caps 953 (for example two 1½-inch caps), hold down straps 954 (e.g., two), one or more HHCS 959 (which may be sixteen ⅝-11UNC×2½-inch stainless steel (in inches)), and support plates 957. Located at or near location 956 may be one or more HHCS (for example ½-13UNC×1½-inch), one or more lock washers (LWs) (for example ½-inch LW), and nuts (½-13UNC in inches). Located at or near location 958 may be one or more lock washers (LWs) (for example twenty-eight ⅝-inch stainless steel LWs) and one or more nuts (for example twenty-eight ⅝-11UNC stainless steel (in inches)). At or near location 955 may be one or ore HHCS (for example four ⅝-11UNC×1¼ inches stainless steel (in inches)), one or more flat washers (FWs) (which may be twelve ⅝-inch stainless steel FWs), one or more lock washers (LWs) (for example ⅝-inch stainless steel), and one or more nuts (for example ⅝-11UNC stainless steel). Located at or near location 960 may be one or more lock washers (LWs) (for example ⅝-inch stainless steel), one or more flat washers (FWs) (which may be ⅝-inch stainless steel), and one or more hex head cap screws (HHCS) (which may be eight ⅝-11×3 316 stainless steel HHCS (in inches)). Located at or near location 956 may be one or more HHCS (e.g., eight ½-13UNC×1½ HHCS), one or more lock washers (LWs) (e.g., eight ½-inch LWs), and one or more nuts (e.g., eight ½-13 UNC nuts). Unless otherwise specified, dimensions in this paragraph may be in inches.

The mixer cover 405 is operatively connected to an end 961 of the pump and meter assembly 852 to allow acid introduction into the mixer 50. A manifold may be included with the system to selectively distribute acid A across the top of the mixer reactor 50. The acid tank 55 shown in FIGS. 7A-C may be replaced with a bulk tank in some embodiments.

Water W and/or surfactant(s) T are stored separately or together for eventual entry into the mixer 50. Water supply 60 may be a separate tank or other storage unit for storing water for supplying to the mixer 50 or may be gray water tank 144 (or may include gray water tank 144 along with another water supply storage tank 60). Surfactant T may be stored in its own optional surfactant tank 162 or other storage unit. Surfactant T may optionally be mixed with the water W, for example in water and/or surfactant tank 161 or other storage unit, to cause the water to bond to the clay particles in the mixer 50, ultimately causing the reaction to take place in the mixer 50 efficiently and effectively. Of course, water W alone may be added to the mixer 50 or surfactant T by itself may be added to the mixer 50 by bypassing the water and/or surfactant tank 162 or other storage unit.

Instead of adding a surfactant/water mixture to the mixer 50, the surfactant T may be introduced separately into the mixer 50 from the water W (in other words, it is within the scope of embodiments that the surfactant and water may be mixed prior to their introduction into the mixer 50 or may instead be introduced separately into the mixer 50). The surfactant T may be a soap, such as a dishwashing soap such as Dawn® dishwashing liquid (Dawn® is a registered trademark of The Procter & Gamble Company of Cincinnati, Ohio), or another type of dishwashing liquid, soap, or detergent, or any other surfactant known to those skilled in the art which would cause the water to bond to the clay particles in the mixer 50. The water and/or surfactant supply tank 161 or other water supply and/or surfactant storage device may be disposed on one or more load cells, scales, or other weighing devices for weighing the water and/or surfactant prior to its/their introduction into the mixer 50.

Optionally, the water and/or surfactant may be stored upstream of the storage device in a silo (not shown) such as a portable storage silo or any other storage device or method for storing and/or transporting and/or delivering water and/or surfactant to the mixer 50. A material transporting device (not shown) may be positioned so as to receive the water and/or surfactant exiting from an outlet of the silo and deliver the water and/or surfactant to the tank or other storage device. (In alternate embodiments, the water and/or surfactant is deposited directly from an outlet of the storage silo into the supply tank or other storage device without the need for the material transporting device, or the water and/or surfactant is deposited directly into the mixer 50 from the storage silo and/or tank (or other storage device) with or without a material transporting device.) One or more pumps 61 and one or more measuring devices such as one or more flow meters 62, for example one or more magnetic flow meters, may be disposed between the tank or other storage device and the mixer 50 to transport the material or pump the water and/or surfactant into the mixer 50 and meter the amount of water W and/or surfactant T delivered into the mixer 50, respectively.

If surfactant T is introduced into the mixer 50 separately from the water, each may possess its own supply tank, meter(s), pump(s), portable storage silo, material transporting device, and/or load cell(s) separate from that of the water supply. Any storage device or method for the water supply and/or surfactant may be used including a supply tank.

In one embodiment, a manifold such as the one shown in FIG. 38 may be included with the system and attached to the mixer 50 to allow the water W and/or surfactant T to be added to the mixer 50 quickly and in a controlled manner.

Batches may be delivered to the mixer 50 in six-minute cycles, and the mixer feed conveyor 35 may operate intermittently to produce batch or semi-continuous operation of the system and method.

The mixer 50 may include a sealed container or bin having two rotating shafts 150 and 151 therein opposed from each other with specially designed paddles, each existing at an angle with respect to a central axis of the shaft on which the paddle is located, Although two shafts are located in the mixer 50 shown and described herein (which is why it may be termed a “dual shaft mixer” or “twin shaft mixer”), it is within the scope of embodiments that only one shaft or more than two shafts may be included with the mixer. The shafts 150, 151 may have one or more seals where they meet the mixer 50 (e.g., at or near the shaft ends) to keep pressure in the mixer 50 and prevent air from blowing out of the mixer 50.

Each of the paddles is placed at an angle with respect to the shaft 150, 151 (pitch) on which it is located. The angle is decided by how efficiently the chemicals in the mixer 50 make contact with the raw materials that are being added into the mixer 50. The process of deciding the angle of each paddle may be by trial and error.

In some embodiments, the one or more paddles and one or more shafts 150, 151 are made of the same material as the paddles and shafts in a typical cement mixer, but the angle of the paddles with respect to the shafts 150, 151 and the speed at which the paddles and shafts are operated may be different.

The mixer 50 may have a variable speed drive to allow the shafts to rotate at varying speeds. The mixer 50 may be capable of sealing to provide a sealed chamber or container and designed to operate under a positive pressure of up to approximately 5 psi.

The mixer 50 may include a reaction chamber 182, which may also be termed an upper chamber, above the shafts 150, 151, e.g. at the top of the mixer 50 in which one or more reactions within the mixer 50 may take place. The moving paddles upon rotation of the shafts on which they are located make the solids in the mixer 50 act as a gas (e.g., aerating the solids), and the goal is for the reactions to take place in one or more clouds at the top of the mixer in the chamber 182 (and for the materials to not descend down the mixer 50 below the upper chamber 182 and off the side of the shafts/paddles).

The paddles attached to the shaft assist in the exothermic vaporization reaction in the mixer 50. The paddles may rotate at approximately 150 RPMs to approximately 200 RPMs. The paddles mix the sludge and the chemical reactants, thereby helping the desired exothermic reaction. In some embodiments, the paddles are not impellers and do not push sludge and chemical reactants towards an outlet end; rather, the paddles aerate the sludge by pushing sludge material back up towards the top of the reactor 50 into the upper chamber 182. This means that the paddles actually resist the natural flow of the sludge (and other components) as it is dropped into the reactor and moves gravitationally to the bottom of the reactor 50.

Optionally, a pH measuring device such as a pH strip or pH tester may be included with the mixer 50 to measure the pH in the mixer 50 and determine how much acid A to add to the mixer 50 to reach a target pH. Also, a temperature probe or other temperature measuring device may be disposed in the mixer 50 for measuring the temperature in the mixer 50. The dump time of the product P may be determined by the temperature in the mixer 50, as measured by the temperature probe.

In some examples which are not limiting of embodiments, the mixer 50 may have a capacity of approximately 29 cubic feet to approximately 35 cubic feet. The mixer 50 loading may be accomplished in from approximately 10 seconds to approximately 30 seconds, in some examples which are not limiting of embodiments. The material may be moved out of the mixer 50 in from approximately 10 seconds to approximately 30 seconds, in some examples which are not limiting of embodiments.

At ambient conditions, water will generally boil at 212° F., but the boiling point of fuel oil tends to be greater than 300° F. Fuel oil is a condensable fluid made of long hydrocarbon chains, particularly alkanes, cycloalkanes and aromatics. It is believed that the fuel oil being driven off in the reactor will be primarily diesel, and will not boil until the temperature in the reactor generally reaches about 320° F. Between 212° F. and 320° F., water may carry some hydrocarbon molecules with it in the vapor phase.

The mixer lid or top 405, shown in FIG. 38, may include a base entry location 401 at which the base B is capable of being introduced into the mixer 50 via gravity from the base hopper or base tank 40 and a catalyst entry location 402 at which the catalyst C is capable of being introduced into the mixer 50 via gravity from the catalyst hopper or catalyst tank 45.

The mixer lid 405 and valves leading to the mixer 50 are capable of sealing the mixer 50 closed so that the mixer 50 is airtight and may operate under approximately 5 pounds pressure when the lid 405 and valves are closed. One or more valves such as knife gate valves, e.g., one or more air knife gate valves (the knife gate having piston/cylinder operation), may be used on the lid 405 of the mixer 50 and one or more butterfly valves may be used with the mixer 50 to provide an airtight seal of the mixer 50 and allow selective introduction of materials into the mixer 50. The one or more air knife gate valves may include a knife gate valve at the base entry location 401 and a knife gate valve at the catalyst entry location 402, at or near the lower ends of the base hopper 40 and the catalyst hopper 45. The knife gate valve at the base entry location 401 may be operable and manipulatable to open when it is desired to introduce base B into the mixer and may be operable and manipulatable to close when it is desired to prevent base B from entering the mixer 50 and/or provide an airtight seal of the mixer 50. Similarly, the knife gate valve at the catalyst entry location 402 may be operable and manipulatable to open when it is desired to introduce catalyst C into the mixer 50 and may be operable and manipulatable to close when it is desired to prevent catalyst C from entering the mixer 50 and/or provide an airtight seal of the mixer 50. The knife gate valves selectively allow material to gravitationally enter the mixer 50 through the entry locations 402 and/or 403. Although in some embodiments the valves at the entry locations 402, 403 are knife gate valves, it is within the scope of embodiments that any other types of valve(s) or other device(s) capable of selectively introducing base B and/or catalyst C into a device such as the mixer 50 which are known to those skilled in the art may be included with the system instead of the knife gate valves, including any other types of valve(s) or other device(s) capable of selectively introducing base B and/or catalyst C into a device such as the mixer 50 which are capable of providing an airtight seal on the mixer 50 or other similar device.

In alternate embodiments, only one material entry location or hole may be located in the lid 405, and in other embodiments, more than two material entry locations or holes may be located in the lid 405 for allowing material therethrough into the mixer 50. In alternate embodiments, the catalyst C and base B may be premixed and enter the mixer 50 through only one entry location or hole through the lid 405 of the mixer 50, whether or not one, two, or more entry locations or holes are located in the lid 405.

A manifold 410 may be disposed at the top of the mixer 50 as shown in FIG. 38 to allow selective delivery of the water W and/or surfactant T and acid A into the mixer 50. The manifold may allow water W, surfactant T, and/or acid A to selectively flow from one pipe into multiple ports in the lid of the mixer 50. Water W and/or surfactant T may flow into the manifold 410 from one pipe and acid A may flow into the manifold from another pipe as shown in FIG. 38. The manifold helps to distribute the water W, surfactant T, and/or acid A evenly.

FIG. 13 illustrates an air piping assembly for the mixer 50 which includes one or more knifegate valves, including a knife gate valve 530 on the mixer feed conveyor 35, which may be used to allow selective delivery of the substrate feed S into the mixer 50, and knife gate valves 531 and 532 on the mixer cover 405, which may be used to allow selective delivery of the base B and the catalyst C into the mixer 50. In an example which is not limiting of embodiments, the knifegate valve 530 may be a 12-inch knifegate valve and the knifegate valves 531 and 532 may be 10-inch knifegate valves. The manifold 410 or liquid distributor which may allow delivery of the water and/or surfactant as well as the sulfuric acid materials which are introduced into the mixer is shown in FIG. 13. (Where a manifold is defined as a transition point, the base, catalyst, and feed material may each have its own manifold to allow each component's delivery to the mixer. The manifold(s) may be for allowing delivery into the mixer of the base and catalyst from their respective silos.)

In one example which is not limiting of embodiments, the manifold 410 may be a three-station manifold having a first station 533, a second station 534, and a third station 535. The first station 533 may connect to the knifegate valve 532 (e.g., 10-inch knifegate valve) on the mixer cover 405 to the manifold 410 and the second station 534 may connect to the knifegate valve 531 (e.g., 10-inch knifegate valve) on the mixer cover 405 to the manifold 410 using, for example, fittings 536 (e.g., three) which may include, for example, ¼-inch National Pipe Thread (“NPT”)×⅜-inch hose, hoses and hose clamps (e.g., twelve total hose clamps), e.g., along the dotted lines 537, which may include, for example (example is not limiting of embodiments), 480 inches of ⅜-inch hose, and fittings at or near the stations 533 and 534, for example (example is not limiting of embodiments) ⅜-inch NPT×⅜-inch hose (e.g., five total). The third station 535 may connect the knifegate valve 530 on the mixer feed screw conveyor 35 to the manifold 410 using a similar hose clamp and hose 537 described in relation to the knifegate valves 531 and 532 along the shown dotted lines, a male coupler 538, a female coupler 539, and a fitting 540. The following are examples of these components: the male coupler 538 may be ¼-inch×¼-inch Male National Pipe Thread (“MNPT”), the female coupler 539 may be ¼-inch×⅜-inch Female National Pipe Thread (“FNPT”), and the fitting 540 may be ⅜-inch NPT×⅜-inch hose (e.g., five total).

The air piping system may include a filter/regulator/lubricator assembly 541 having an air inlet 542, which may be for example (example is not limiting of embodiments) a ½-inch NPT air inlet. Connecting pieces such as nipples 543 (e.g., two ½-inch nipples) and 544 (e.g., two ½-inch×2½-inch nipples) may be used to operatively connect the filter/regulator/lubricator assembly 541 to the manifold 410 (via nipple 543) and to operatively connect other parts of the air piping assembly to the manifold 410 (via nipple 543) including, e.g., a butterfly valve 545 of the acid A system and solenoid valves 515 for the discharge doors 140 of the mixer 50. In one example, the nipples 543 and 544 may be ½-inch nipples.

A pipe tee 547, which may be a ½-inch pipe tee, may be connected to the manifold 410 via the nipple 543 and allow operative connection of the manifold 410 and air piping system to the butterfly valve 545 to allow for selective delivery of the acid A into the mixer 50. Connecting the butterfly valve 545 to the pipe tee 547 may be a bushing and fitting 548 (in one example which is not limiting of embodiments, the bushing may be ½-inch×⅜-inch and the fitting may be ⅜-inch NPT×⅜-inch hose) and a hose clamp and hose 549 (in one example which is not limiting of embodiments, the hose may be ⅜-inch hose). The butterfly valve 545 on the sulfuric acid system (which may be a 2-inch butterfly valve) may include a fitting 546, which may include, for example, ¼-inch NPT×⅜-inch hose. Although not shown, the water W and/or surfactant T delivery system (which may include one or more butterfly valves to allow for selective delivery of the water W and/or surfactant T to the mixer 50) may be connected in much the same fashion to the air piping assembly as the acid A delivery system.

A fitting 550, which may include a ½-inch NPT×½-inch hose, a hose clamp and hose 551, which may include a ½-inch hose, and fitting 553, which may include a ½-inch NPT×½-inch, may operatively connect the pipe tee 547 to pipe tee 552. The pipe tee 552 may be operatively connected to the one of the discharge door solenoid valves 515, for example using one or more nipples 555 (in one example, the nipple may be ½-inch by 2.5-inch). The pipe tee 552 may be operatively connected to the other discharge door solenoid valve 515 using a fitting 554 (e.g., ½-inch NPT×½-inch hose), hose clamp and hose 557 (e.g., ½-inch hose), a fitting 558 (e.g., ½-inch NPT×½-inch hose), an elbow 559 (e.g., 90 degree ½-inch elbow), and one or more nipples 556 (in one example, the nipple may be ½-inch by 2.5-inch).

FIG. 6 shows an example pump and water meter assembly which may be included as the pumping mechanism 61 and meter 62. In one embodiment, the pump 61 and meter 62 may be used for the water and/or surfactant stream, and in other embodiments, the pump 61 and meter 62 may be used for the water stream and an additional pump and meter similar to the pump 61 and meter 62 may be used for a separate surfactant stream which may enter the mixer 50. The pump 61 may be used to add pressure to the water and/or surfactant stream 163 to allow its travel into the mixer 50, and the meter 62 may be used to meter in the amount of water and/or surfactant 163 allowed into the mixer 50. In one example which is not limiting of embodiments, the meter 62 may be a 1-inch water meter.

A pump inlet 915 is shown in FIG. 6, which may in some examples be a 1½-inch female national pipe thread (FNPT) inlet to which a suction hose may be connected. Shown in FIG. 6 is an example pump (number 61) and water meter (number 62) assembly (which may also supply surfactant to the mixer along with water) which is not limiting of embodiments. The pump and water meter assembly may include a mounting base weldment 916, nipples 917 (which may be two short 1¼ inches×2½L), an elbow 918 (which may be 1¼ inches×90 degrees), a reducing coupling 919 (which may be 1¼ inch×1 inch), nipples 920 (which may be three 1 inch×2 inches nipples), a solenoid valve 921 (e.g., one-inch), couplings 922 (e.g., two 1-inch couplings), a nipple 923 (which may be pipe long 1×6 inch length), elbow 924 (which may be 1 inch×90 degree), ball valve 925 (which may be a 1-inch ball valve), combination nipples 926 (which may be two 1-inch combination nipples), U-bolt with nut 927 (which may be ¼-20NC×1-inch pipe), hose 928 (which may be 1-inch inner diameter water hose rated at 250 psi), two single bolt clamps 929, and elbow street 930 (which may be 1 inch). At or near location 931 may be hex head cap screws (HHCS) (which may be four ⅜-16UNC×1¼ inches HHCS), one or more lock washers (LWs) (which may be four ⅜-inch LWs), and one or more nuts (which may be four ⅜-16UNC in inches). At or near location 932 may be hex head cap screws (HHCS) (which may be four ½-13UNC×1¾, in inches), one or more lock washers (LWs) (which may be four ½-inch LWs), and nut (which may be four ½-13UNC in inches). The dotted lines 125 represent the mixer cover 405 at which the water and/or surfactant supply is connected to deliver water and/or surfactant to the mixer 50 and show the elbow 930 which may in one example be used to connect the water and/or surfactant supply to the mixer cover 405.

An optional material handling unit 66 such as a screw conveyor, belt conveyor, flat belt conveyor, pneumatic conveyor, or other type of conveyor or pneumatic pump may be disposed outside the mixer 50 to transport the treated material P or generally dry product (e.g., conditioned material or gypsum) which exits from the mixer 50 to its desired location, e.g., into an optional storage hopper to load out. The material handling unit 66 may be a mixer discharge screw assembly as shown and described in relation to FIGS. 12A-F. The screw conveyor for the mixer discharge screw assembly 66 may be, in one example which is not limiting of embodiments, a 15-horsepower (HP), 12-inch screw conveyor which is 14 inches long.

FIGS. 12A, 12B, and 12C show an example mixer discharge screw assembly which may be used in the system and method of embodiments and an optional mixer discharge screw hopper 163 to catch dry material exiting from the mixer 50, and FIGS. 12D, 12E, and 12F are weldment and part details of the mixer discharge screw assembly. In an example which is not limiting of embodiments, the mixer discharge screw assembly may include an auger/conveyor 66 and its drive motor 164 (e.g., a 12-inch screw, 14 inches long, with 15 HP drive motor 164), a mixer discharge screw hopper weldment 560, plate (PL) 562 (which may be, for example, two ¼×4×13 (in inches) PLs), and one or more screw supports 563 and 564. Also included at or near locations 565 may be one or more HHCS (e.g., 26 total ½×1½-inch HHCS (in inches)), one or more lock washers (e.g., twenty-six total ½-inch lock washers), and one or more hex nuts (e.g., 26 total ½-inch hex nuts) and also included at or near location 566 may be one or more HHCS (e.g., eight ¾×2¼-inch HHCS (in inches)), one or more lock washers (e.g., eight ¾-inch lock washers), and one or more hex nuts (e.g., eight ¾-inch hex nuts). All measurements are in inches unless otherwise specified in this paragraph.

The system may include a gas cleaning and oil (or other liquid in the substrate) recovery section (or vapor collection system) for recovering vapor or gases generated from the mixer 50, condensing the recovered vapor, and exhausting non-condensed vapor or gases to the atmosphere. The gas cleaning and oil (or other liquid in the substrate) recovery section may be for recovering vapor generated from the mixer 50, scrubbing the recovered vapor, and optionally exhausting non-condensed gases to an optional thermal oxidizer or other gas cleaning device, and then exhausting clean air into the atmosphere. The gas cleaning and oil (or other liquid in the substrate) recovery section may be for gas/vapor collection and condensation to ultimately produce separated streams of clean air (e.g., for exhausting to the atmosphere), water (e.g., for reuse or sale), and oil (e.g., for sale).

Hood height from mixer to scrubber is critical to keep solids out and minimize oil level in the dry product. This height maximizes oil recovery.

A scrubber of the gas cleaning (or other liquid in the substrate) recovery system may include one or more Venturi scrubbers, one or more packed columns, one or more oil/water separators, and one or more cooling devices such as one or more chillers. The scrubber may be mobile in some embodiments.

FIG. 36 shows an embodiment of the gas cleaning and oil (or other liquid in the substrate) recovery section of the system and method of embodiments. This gas cleaning and oil recovery section exists to treat the gas to acceptable levels for release to the atmosphere and recover the liquid component(s) for reuse and/or sale. The embodiment of the gas cleaning and oil (or other liquid) recovery section shown in FIG. 36 is merely exemplary, and it is within the scope of embodiments to include other gas cleaning and oil recovery components known to those skilled in the art or other gas cleaning and oil recovery components disclosed herein in the gas cleaning and oil recovery section.

For reference, FIG. 36 shows the mixer 50 of FIG. 35 and the gas G exiting from the mixer 50. The portion of the system and method of embodiments which includes the substrate treatment section as well as all of the entering and exiting streams from the mixer 50 are not shown in FIG. 36, but the gas cleaning and oil (or other liquid in the substrate) recovery section shown in FIG. 36 may be included and used with the system and method shown in FIG. 35 as the gas cleaning and oil recovery component.

The gas cleaning and oil recovery section may include a Venturi scrubber 305 or Venturi; a packed tower 320, packed column, packed scrubber, or packed column scrubber; filtration unit 335, cooling device 330 such as an air cooler, a chiller with a heat exchanger, a fin fan, a refrigerator and/or a cooling tower with a heat exchanger; and a clean oil/water separator 315. The system may also optionally include a thermal oxidizer 370 to incinerate with an open flame (or any other pollution control device known to those skilled in the art to treat) any substances as needed before they are discharged to the atmosphere, e.g., with a big burner. The thermal oxidizer 370 or other pollution control device may be included in the system as insurance to make sure that the substances discharged to the atmosphere meet regulations and/or specifications.

An induced draft (ID) fan 328 or centrifugal blower may be included with the system to treat vapor stream 329 which exits the packed tower 320 or other condenser prior to its entry into the optional thermal oxidizer 370 or other pollution control equipment or other treatment or its venting to the atmosphere, which vapor stream 329 may include the non-condensables, including the non-condensable residual water vapor and/or oil vapor particulate matter. The ID fan 328 is for treatment of the noncondensables 329 from the packed tower 320.

The optional pollution control equipment may include a thermal oxidizer 370. Any thermal oxidizer or other pollution control equipment for treating gas to allow its release to the atmosphere which is known to those skilled in the art may be used as the pollution control equipment of embodiments.

The system may include one or more filtration devices for performing filtration 335 by filtering out solids. In one example, the one or more filtration devices may include one or more cyclones, one or more hydrocyclones, or any other device which uses centrifugal force to remove the solids from a stream. In another example, the one or more filtration devices may include a self-purging filter which collects solids on the outside of the screen and has scrapers to push the solids down. In yet another example, the one or more filtration devices may include one or more gravitational separation tanks.

Optionally, one or more additional scrubbers (not shown) may be included in the system after the ID fan but before the thermal oxidizer 370, if the thermal oxidizer 370 is present in the system, to capture most or all of the “lights” still present in the vapor stream 329.

The oil and water that is included in the gas G which is boiled off and exits the mixer 50 may be condensed by any type of condenser. In one embodiment, the Venturi scrubber 305 and the packed tower 320 perform the condensing function, working together to condense this oil and water. In other embodiments, one piece of equipment or more than two pieces of equipment may be utilized to condense the gas G instead of the two pieces of equipment of the scrubber 305 and packed tower 320.

The Venturi scrubber 305 is part of a vapor recovery system and may act as a condenser by speeding up the flow of gas, cooling down the gas by evaporation, and condensing the gas. Like air conditioning, the Venturi scrubber 305 forces water contact with the gas and chills at the same time. The Venturi scrubber 305 cools off the gas G and removes particulate from the gas before it gets to the packed tower 320 by creating vortexes in the Venturi 305. The Venturi scrubber 305, which works as an expansion valve to cause condensation of vapor components, helps meet the goal to cool the gas as inexpensively and quickly as possible.

The Venturi scrubber 305 is sized to a certain vortex to perform its condensing function adequately and efficiently. In some embodiments, the vortex may be approximately 30 inches to approximately 16 inches to adequately and efficiently perform this function. In one embodiment, the flow through the Venturi scrubber 305 increases to from 250 feet per second to 300 feet per second (all values may be approximate) at the vortex (this example embodiment is not limiting of embodiments). Flow of 200 gallons per minute may be entering the Venturi scrubber 305 (values may be approximate), although any flow rate is within the scope of embodiments.

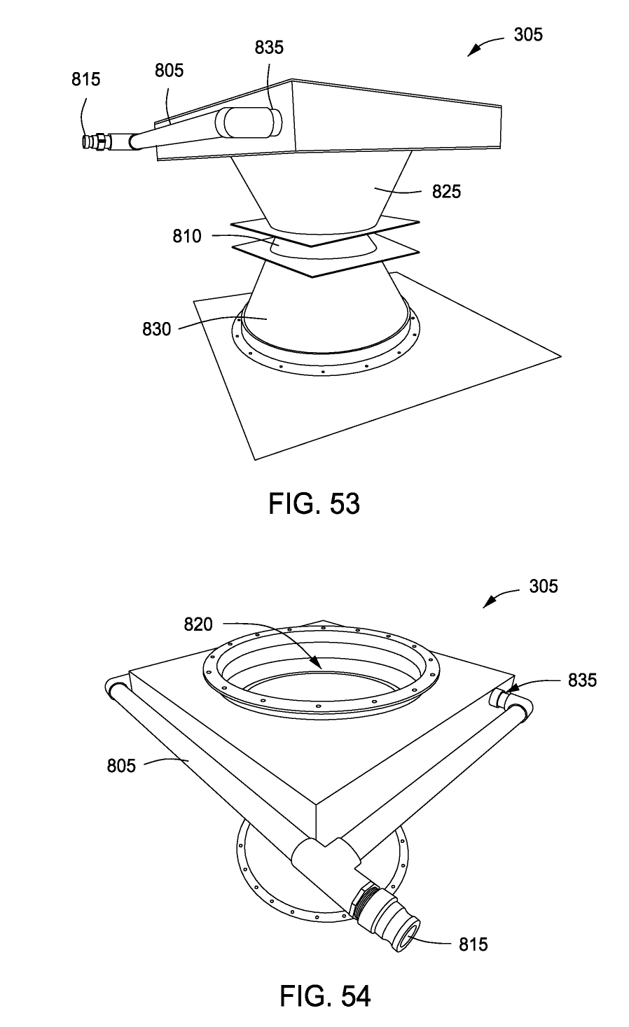

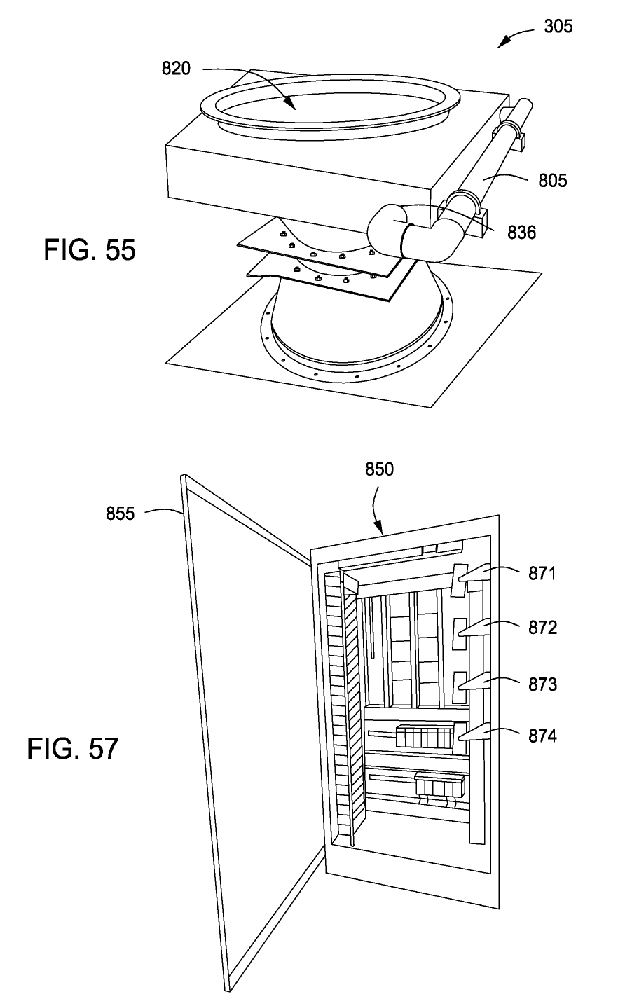

FIGS. 53-55 show an example of a Venturi scrubber 305 which may be included in the system of FIG. 1. The Venturi scrubber 305 includes three sections: a converging section 825, a throat section 810, and a diverging section 830. In one embodiment, the Venturi scrubber 305 may be adjustable in diameter or length to accommodate variable gas flows through the Venturi scrubber 305 and to get the right velocity of gas through the Venturi scrubber 305. In this embodiment, the throat section 810 may be removable from the converging section 825 and diverging section 830 to allow the connecting between the diverging and converging sections of throat sections of different sizes according to the gas flow and velocity of the gas through the Venturi scrubber 305; as such, the inner diameter and/or length of the throat section 810 is adjustable. The throat section 810 may be connected to the converging section 825 and diverging section 830 using one or more bolts or other connecting members.

The throat section 810 may be made larger or smaller in inner diameter (and/or length) by changing out different size throat sections and connecting the upper end of the new throat section to the lower end of the converging section 825 and connecting the lower end of the new throat section to the upper end of the diverging section 830 (e.g., using one or more fasteners). The diverging section 830 may also be made larger or smaller in inner diameter and/or the vortex changed by changing out and replacing the diverging section 830 and connecting the new diverging section to the lower end of the throat section 810. The converging section 825 may also be made larger or smaller in inner diameter and/or the vortex changed by changing out and replacing the converging section 825 and connecting the new converging section to the upper end of the throat section 810. Any other Venturi scrubber which is adjustable in size which is known to those skilled in the art may be substituted for the Venturi scrubber shown and described herein.

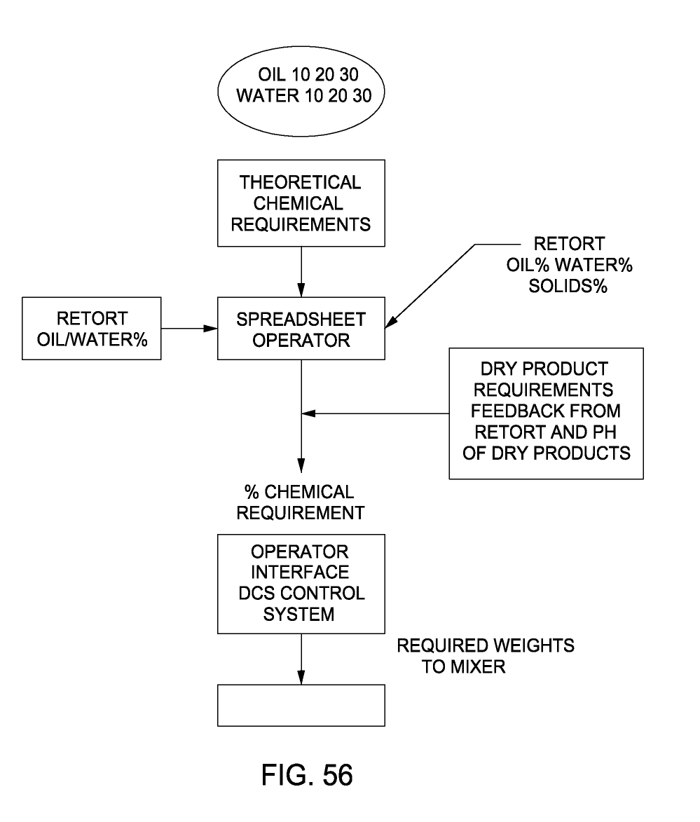

Inside the Venturi scrubber 305 may be one or more baffles to allow water to flow evenly in the scrubber 305. One or more pipes or other fluid delivery systems such as one or more manifolds or one or more pipes 805 may be included at the top of the Venturi scrubber 305 to deliver and distribute the water 306 flowing into the Venturi 305, and these pipes may be split off from one another to allow attaining of a generally even flow of water into the Venturi scrubber 305. Additionally, one or more vapor delivery manifolds may connect the mixer 50 to the Venturi scrubber 305 opening 820 to deliver the gas or vapor G from the mixer 50 to the Venturi scrubber 305. One example of water distribution into the Venturi 305 is shown in FIGS. 56-58, where water may be delivered into the Venturi scrubber 305 using a first fluid delivery location 835 where the fluid delivery pipe 805 connects to the Venturi scrubber 305 and a second fluid delivery location 836 where the fluid delivery pipe 805 connects to the Venturi scrubber 305. Connection to the water supply to the Venturi scrubber 305 may be made at connection point 815 in the piping system. One or more pipe connecting pieces may connect the manifold or pipe(s) to the Venturi scrubber 305 and the Venturi scrubber 305 to the packed column 320.

In the Venturi scrubber 305, the inlet gas (or vapor) stream G enters the converging section at the Venturi opening 820 and, as the area decreases in the Venturi scrubber 305, gas velocity increases in accordance with the Bernoulli equation. Although liquid 725 may be introduced at the throat 810 in some embodiments, in the Venturi scrubber 305 shown in FIGS. 53-55, the fluid 725 is introduced at or near the entrance to the converging section 825. The inlet gas, forced to move at extremely high velocities in the small throat section 810, shears the liquid from its walls, producing an enormous number of very tiny droplets. Particle and gas removal occur in the throat section 810 as the inlet gas stream mixes with the fog of tiny liquid droplets. The inlet stream then exits through the diverging section 830, where it is forced to slow down. One or more connecting pieces, e.g., one or more pipes, may connect the Venturi scrubber 305 to the packed column 320 to deliver the fluid stream 321 exiting from the bottom of the Venturi scrubber 305 to the packed tower 320.

The venturi quench in a process of embodiments is a device that has to be designed with enough liquid spray potential, gas handling potential, and pressure drop (e.g., from 3 to 10 inch water column (w.c.)) to intimately mix the cooled recycle water spray with the hot gases coming from the mixer enough so that the gas/liquid mixture is initially cooled to an equilibrium temperature below the bubble point of the mixture (approximately 209° F. in this case). This temperature reduction is required so that the remaining oil in the gas stream can be condensed and separated from the steam/air stream in the subsequent packed quench device. In one embodiment, the design for the venturi throat is from 200 feet/second to 250 feet/second (values may be approximate).

In lieu of or in addition to the Venturi scrubber 305, one or more cyclones may be included in the system.

The packed column or packed tower 320 includes packing material 325 (which may be helical, plastic packings in one example) therein and a water distribution system which may include a water distribution spout 355 (e.g., a showerhead) for distributing water 371 into the packed tower 320. The spout 355 may be located at or near the top of the packed tower 320 and may allow the water to distribute downward and outward from the spout 355 into the packed tower 320, for example injecting water in a circle. In one embodiment which is merely exemplary, the water distribution device 355 may be a big showerhead which may shoot water out at approximately 600 gallons per hour. The water 371 in the packed tower 320 is contacted with the gas 321 in the packed tower 320. The packed tower 320 in one exemplary embodiment may be approximately six feet wide with packing material, although any dimensions of the packed tower 320 which allow the packed tower 320 to perform its function in the system are within the scope of embodiments, and this example dimension is not limiting of embodiments. Although any packing material which performs the function of the packed tower 320 which is known to those skilled in the art is within the scope of embodiments, in one example Elex 300 packing material may be included in the packed tower 320. The packing material disperses the fluids in the packed column 320. The system may include an optional platform 391 for supporting the packed column 320 thereon. In some examples not limiting of embodiments, the packed column 320 is a 24-foot separation column.

The gas cleaning and oil recovery section is a closed loop system including the packed tower 320 or cooling tower that water 355 trickles down, the cooling/refrigerating portion (e.g., air cooler, chiller, or cooling tower)) and the heat exchanger through which water goes through and cools down (included with cooling 330), and the cooling water 371 from the oil/water separator that goes to the scrubber/packed tower 320.

The one or more cooling devices 330 (or chiller) may include one or more air coolers, chillers with a heat exchangers, fin fans, refrigerators and/or cooling towers with heat exchangers. The cooling device 330 may be used to decrease the temperature of the stream 334 which contains mostly oil and water and possibly some sludge, in some embodiments to ambient temperature or below.

The clean oil/water separator 315 may separate the oil and water by gravity. (The clean oil/water separator 315 may be, in some embodiments, the same as or similar to the oil/water separating device 75). The clean oil/water separator 315 may be in one example an oil/water separator tank or other separating device for separating oil and water from one another. FIG. 36 illustrates a clean oil/water separator tank 315 which uses level control 350, one or move valves 310, and one or more pumps 316 to control the level of oil and water in the clean oil/water separator 315. The clean oil/water separator 315 may be a three-phase separation device, where oil is the top layer, water is the middle layer, and sediment solids the bottom layer. Only the oil/water interface is level controlled by metering off oil to recovered oil storage. Solids level may be controlled intermittently. A water bleedoff may be controlled to control the level in the scrubber. In some examples which are not limiting of embodiments, the clean oil/water separator may be approximately 26 feet in length and approximately 7 feet in width.

The gas cleaning and oil recovery system may be disposed on a skid.

In alternate embodiments of the system, more than one mixer 50 may be hooked up to the system. All of the mixers may be connected to the same gas cleaning and recovery system (or in yet other embodiments, multiple gas cleaning and recovery systems may be added to the system and hooked up to one or more of the mixers). In one example, up to six mixers may be added to the system. Although the same pre-mixer delivery system may be used, it is also possible to hook up additional pre-mixer substrate delivery systems to one or more of the mixers (e.g., shakers, etc.). Either the same material delivery systems for the base, catalyst, water and/or surfactant, and acid may be hooked up to the additional mixers (e.g., hooked up to additional manifolds and additional mixer lids) or additional material delivery systems may be added to the system and operatively connected to the additional mixers.

FIG. 10 shows one example of a system with multiple mixers. In this example embodiment, a first mixer 50A, second mixer 50B, and third mixer 50C may be included in the same system. Each mixer 50A, 50B, 50C is its own modular unit and may be removed from the system and optionally replaced by another mixer easily by just hooking up the new mixer to a raw material distribution manifold 860 which distributes and delivers substrate feed S into the mixers 50A, 50B, 50C. A base delivery system 183 for delivering the base B from the base storage silo 41 to the mixers 50A, 50B, 50C may be hooked up to the lid of each mixer 50A, 50B, 50C much like the base tank or silo is hooked up to the lid of the single mixer 50, e.g., via a pipe or manifold. A catalyst delivery system 855 for delivering catalyst C to the mixers 50A, 50B, 50C may be hooked up to the lid of each mixer 50A, 50B, 50C much like the catalyst tank or silo is hooked up to the lid of the single mixer 50, e.g., via pipe or manifold. The base and catalyst delivery systems may include the same valving systems, e.g., knifegate valves and butterfly valves, at each of the lids of the mixers 50A, 50B, 50C to selectively deliver base and catalyst to the mixers 50A, 50B, 50C while maintaining pressure in the mixers 50A, 50B, 50C when the appropriate valves are closed. The acid tank or other acid source may be hooked up to the lid of each of the mixers 50A, 50B, 50C in much the same way that the acid tank is hooked up to the mixer 50 in a single mixer configuration, with the same fluid delivery system including valving system for each mixer 50A, 50B, 50C. The water and/or surfactant tank or other water source may be hooked up to the lid of each of the mixers 50A, 50B, 50C in much the same way that the water tank or other water source is hooked up to the mixer 50 in a single mixer configuration, with the same fluid delivery system including valving system for each mixer 50A, 50B, 50C. One or more material transporting devices such as one or more conveyors 66A, 66B, 66C may transport the product P from each of their respective mixers 50A, 50B, 50C to a location. The one or more material transporting devices may be one or more belt conveyors or one or more pneumatic conveyors, for example. In one example, the product P could be sucked up into one or more silos from the one or more material transporting devices. The system shown in FIG. 10 may be a 54 ton per hour unit, for example. Optionally, the mixers 50A, 50B, 50C could be doubled to be six mixers. Optionally, one or more mixers could be added at the end of the material transporting devices to add moisture to the product material so that it is not as fine and does not blow around as easily.

Several pumps are shown in the figures, and pumps may be utilized as needed in the system for moving and adding pressure to the material to be moved. In some embodiments, one or more piston pumps may be utilized for pumping the thicker materials such as the substrate. One or more diaphragm, centrifugal, rotary, and/or screw pumps may be utilized for pumping the water or other liquids.

Instead of the augers and/or conveyors of the system disclosed herein, one or more pumps such as one or more pneumatic pumps may be included with the system. Types of conveyors or augers which may be included with the system are drag, screw, and/or pneumatic.

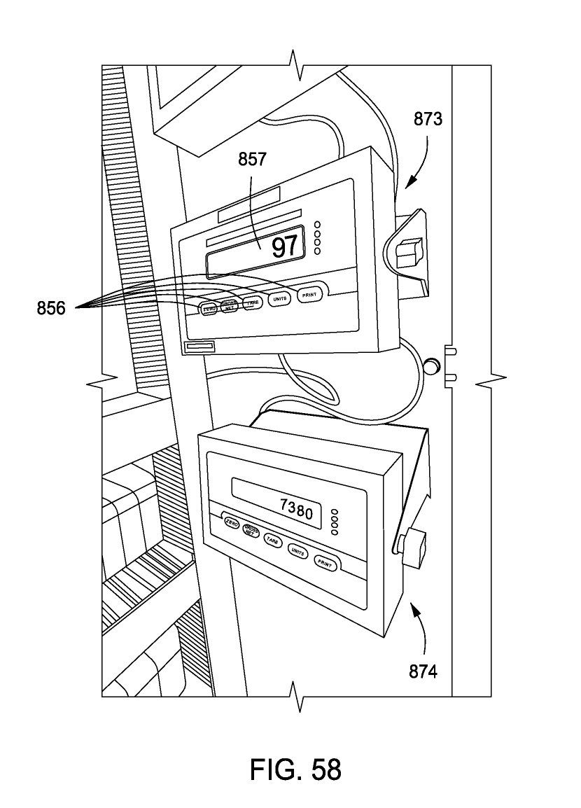

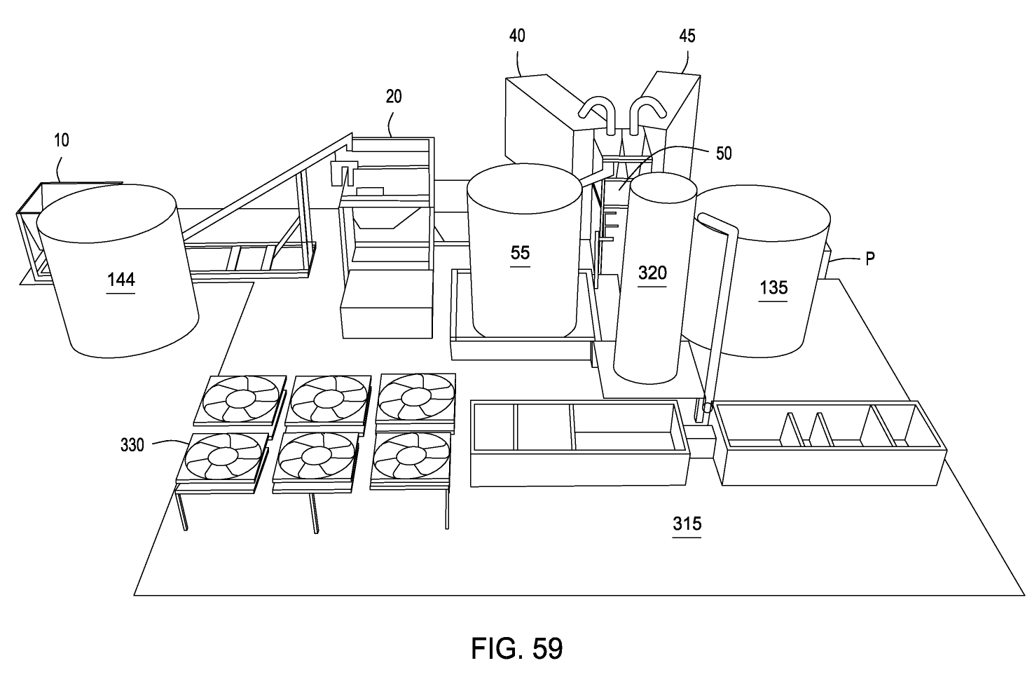

The system and method may include a control system, including a control panel 850 (see FIGS. 57 and 58) which acts similar to an integrated circuit. The control panel 850 may contain switches that are electrically connected to various valves (such as solenoid valves), meters, and other control devices in the system. The control panel may in one example be a product provided by Allen-Bradley, an electrical supply company out of Milwaukee, Wis. that is affiliated with or owned by Rockwell Automation, Inc. The Allen-Bradley control panel is controlled through operational software. Using the software, an operator may input the oil level (or ratio) and the water level (or ratio) by weight in the sludge, as well as a desired amount of dry end product. The control system then delivers the chemical reactants into the mixer 50 in appropriate volumes automatically. The operator may adjust the pH and moisture content of the dry end product through software input of these amounts.

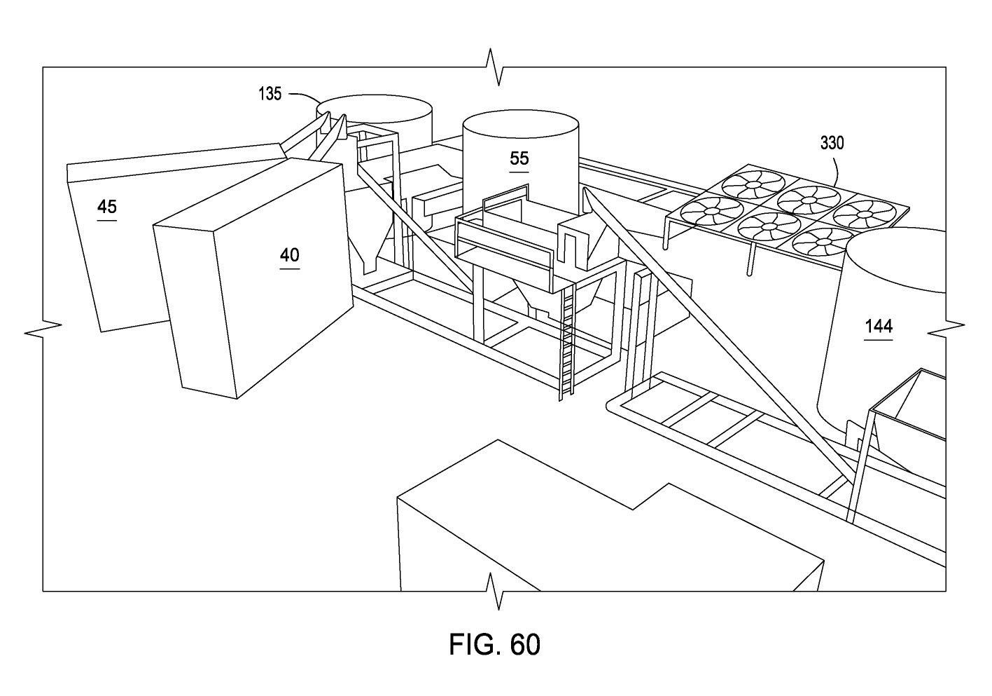

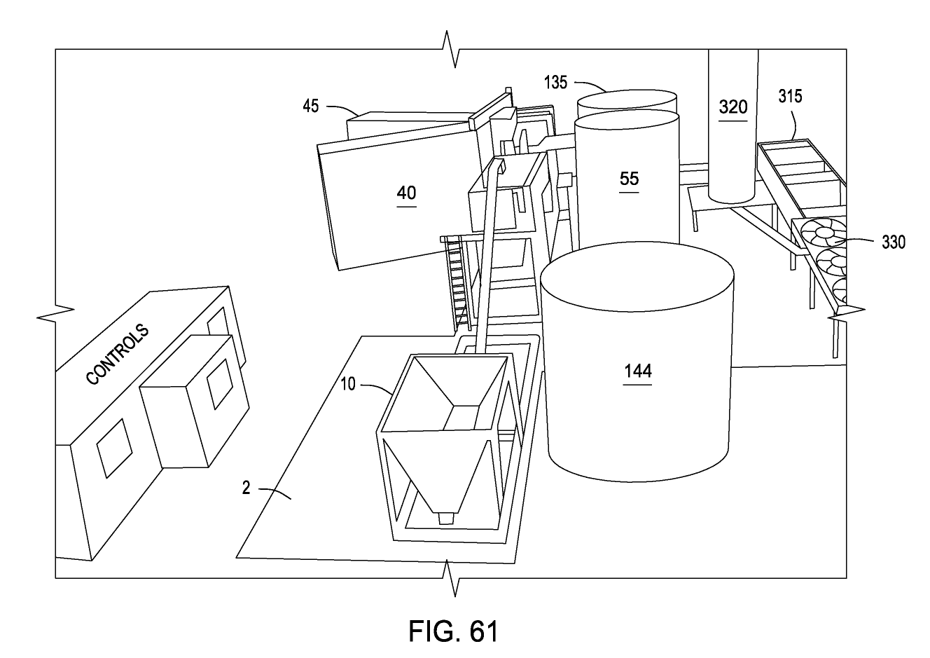

The control panel 850 (see FIGS. 60 and 61), which may be an Allen Bradley Logix 5000 control panel in one example, may be located anywhere in the system, but in one embodiment is located at the shale shaker 20. The control panel 850 may include one or more indicators such as one or more digital weight load cell indicators, an indicator for each component which may be fed into the mixer 50, for example a water tank indicator 871 for the water tank, a base (e.g., calcium oxide) indicator 872 for the base weigh batcher or base tank, a catalyst (e.g., calcium chloride) indicator 873 for the catalyst (e.g., calcium chloride) weigh batcher or catalyst tank, and a sludge source indicator 874 for the sludge source holding hopper. In one example, the indicators may be from System Scale Corp. in Little Rock, Ark. or Van Buren, Ark. The one or more indicators may indicate weight of components and may include one or more buttons 856 on the indicators for manipulating what is displayed on the digital display 857 (e.g., the number showing the weight may be displayed on the display 857).

A server or computer hardware system or central processing unit (CPU) may be electrically connected (e.g., via electrical wires or wireless connection) to multiple sensors at various points in the system, for example one or more augers/conveyors, the shaker, one or more doors of the mixer 50, the top of the mixer 50 at the component entry locations, etc. A computer processing system or CPU may electrically communicate with the one or more sensors, for example to manipulate turning the system and its equipment components on and off and opening and closing valves and doors. In one embodiment, a Universal Serial Bus (USB) port may be used to electrically connect the plant to the operation house. Programming equipment, hardware, and software may be any type known to those skilled in art.

A distributed control system (DCS) may be used as the operator interface to control the system and method of embodiments. The DCS may be programmed (and may include software such as Programmable Logic Control (PLC) software, e.g., Allen Bradley RX Logic 5000 PLC software) to calculate the required amounts (weights) of components to add to the mixer 50 to obtain the dry product P with the desired properties and weight percents of components, within the limits of the volume of materials the mixer 50 is capable of holding.

The DCS may include a simulator, or a robust calculator of what happens when you add and take away things or change up parameters in the process. The simulator may be made using numbers generated by testing what happens when things change in the system and method (e.g., weight percents of feed components into the mixer 50, temperature, pressure, etc.). The simulator may involve interpolating from a spreadsheet having the values input into the spreadsheet which were obtained by the testing of changing things in the system and method. The physical and chemical requirements obtained from testing may be the inputs in the spreadsheet. ChemCad may be used for the interpolation numbers from the spreadsheet (ChemCad or CHEMCAD is chemical process simulation software of Chemstations, Inc. of Houston, Tex.)

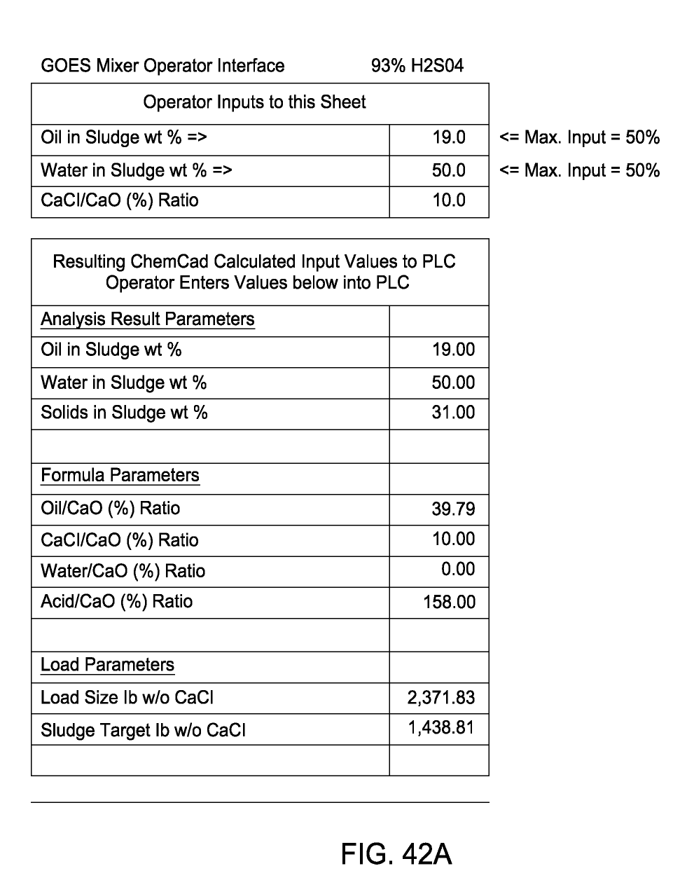

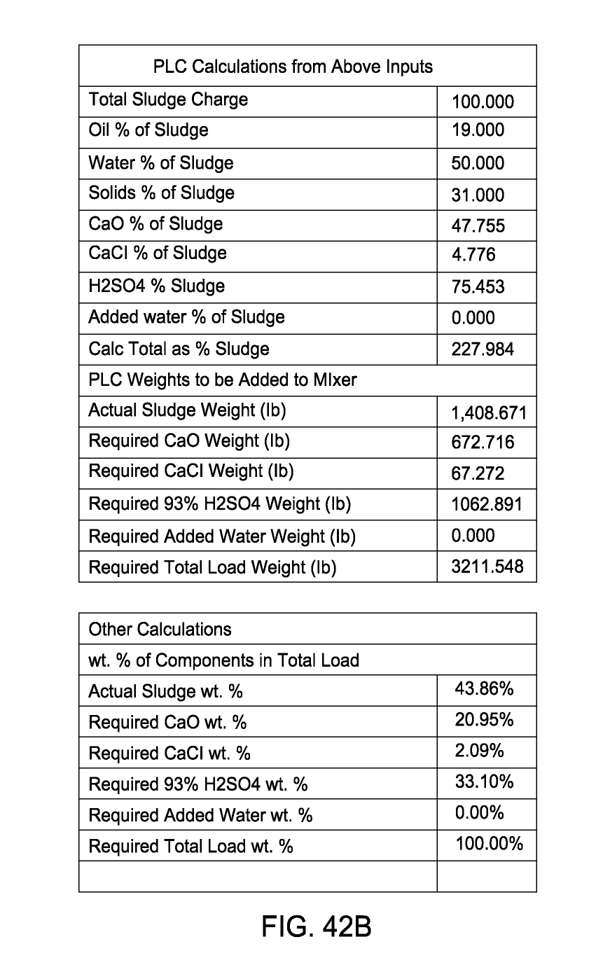

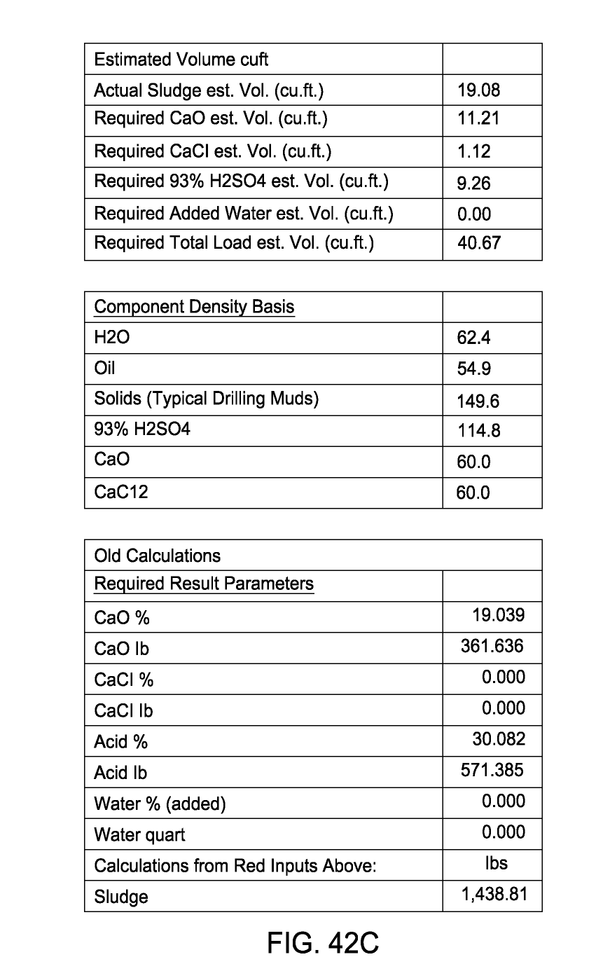

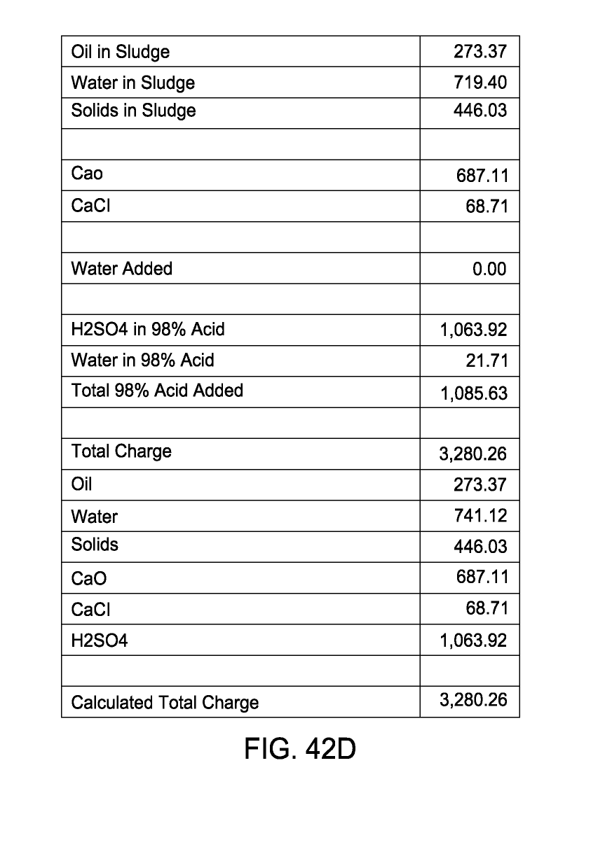

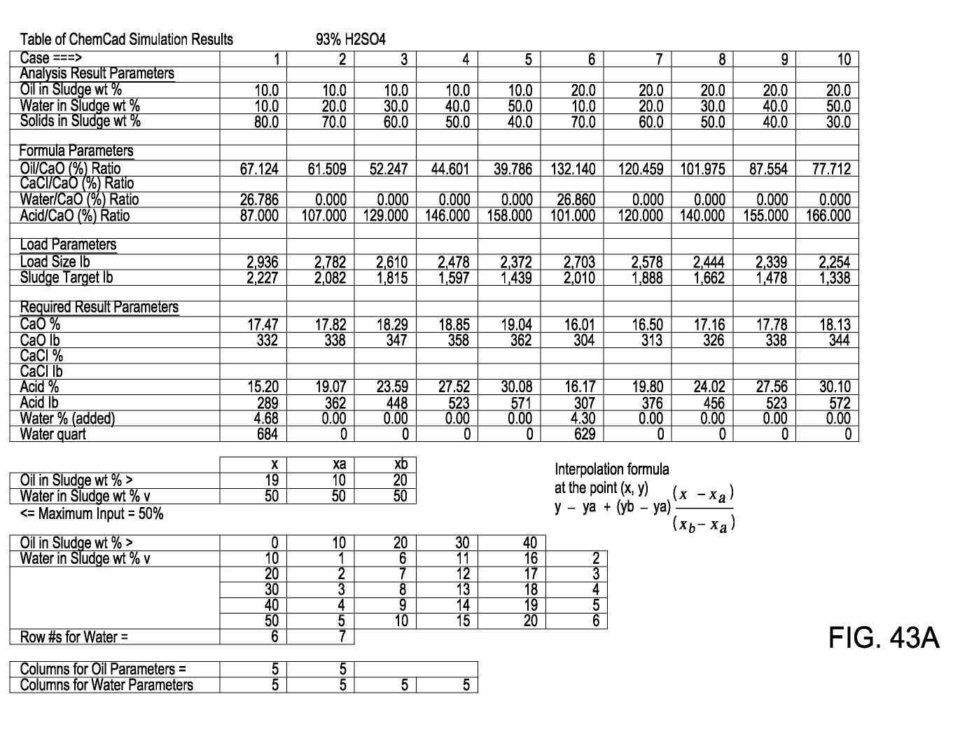

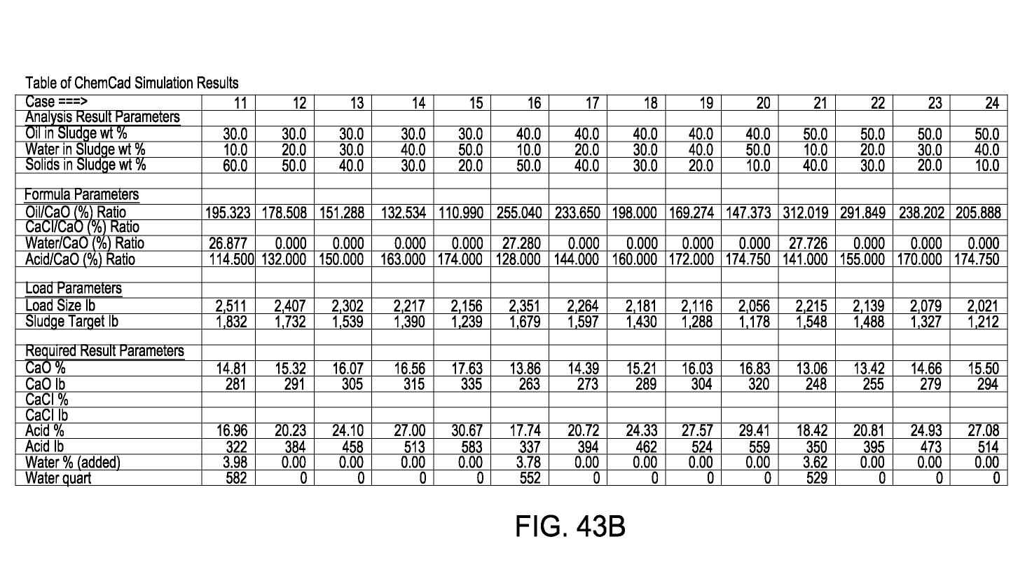

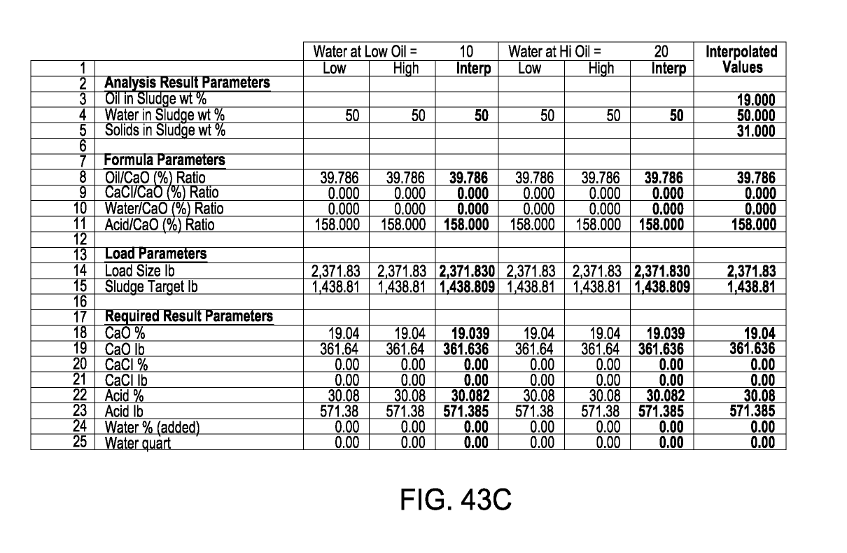

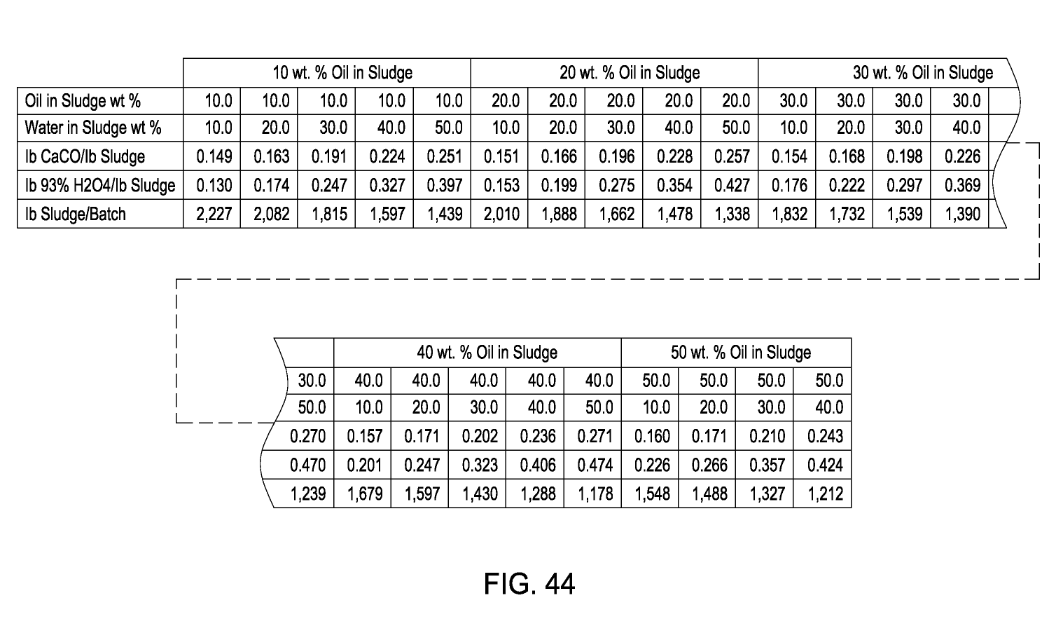

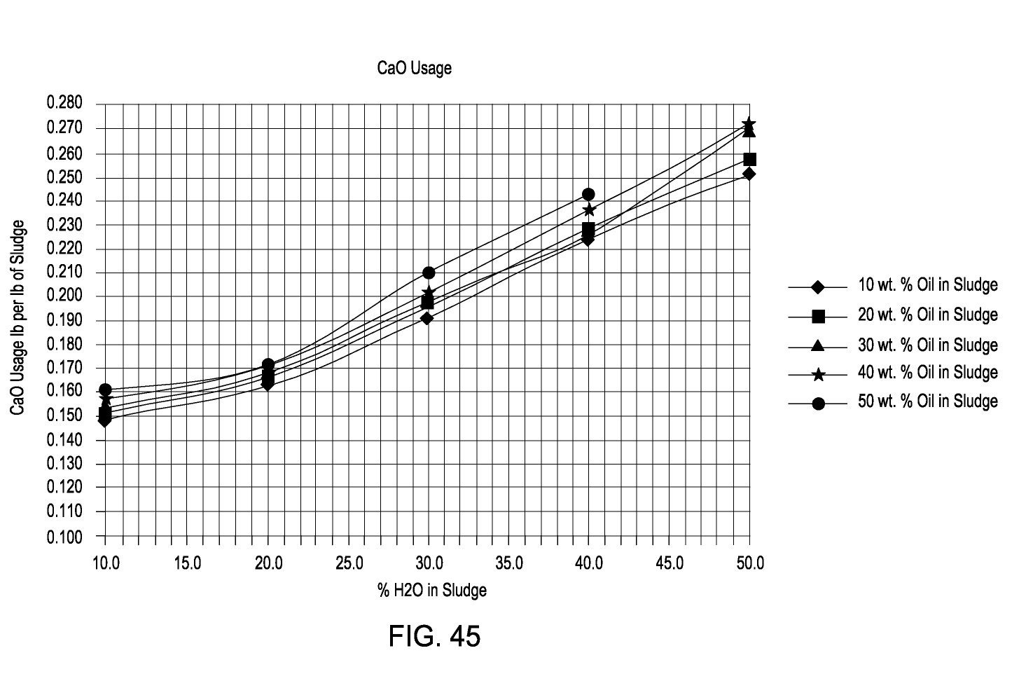

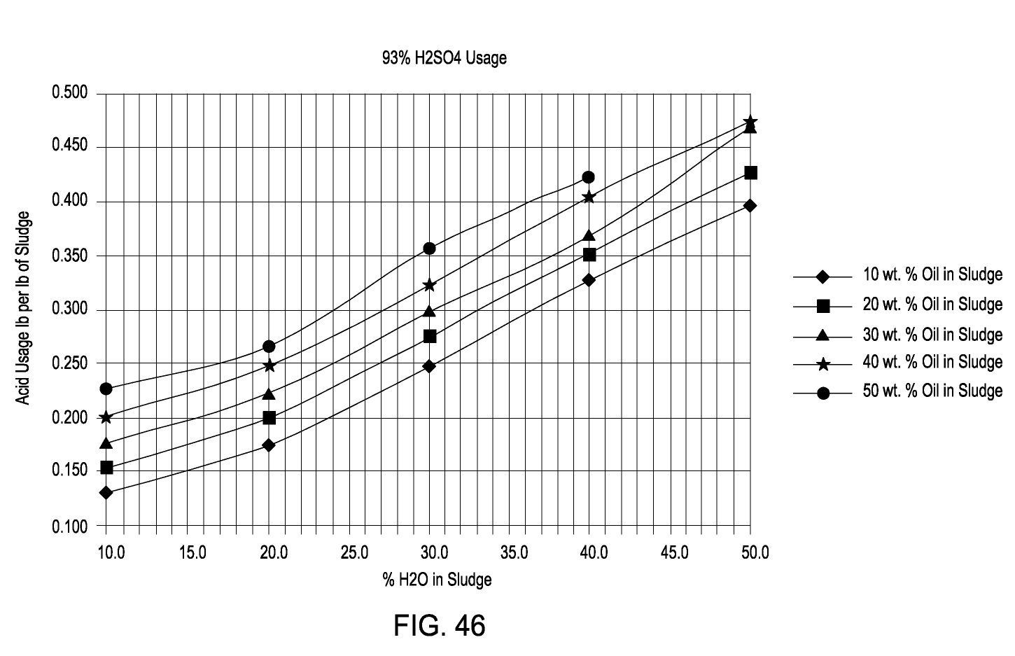

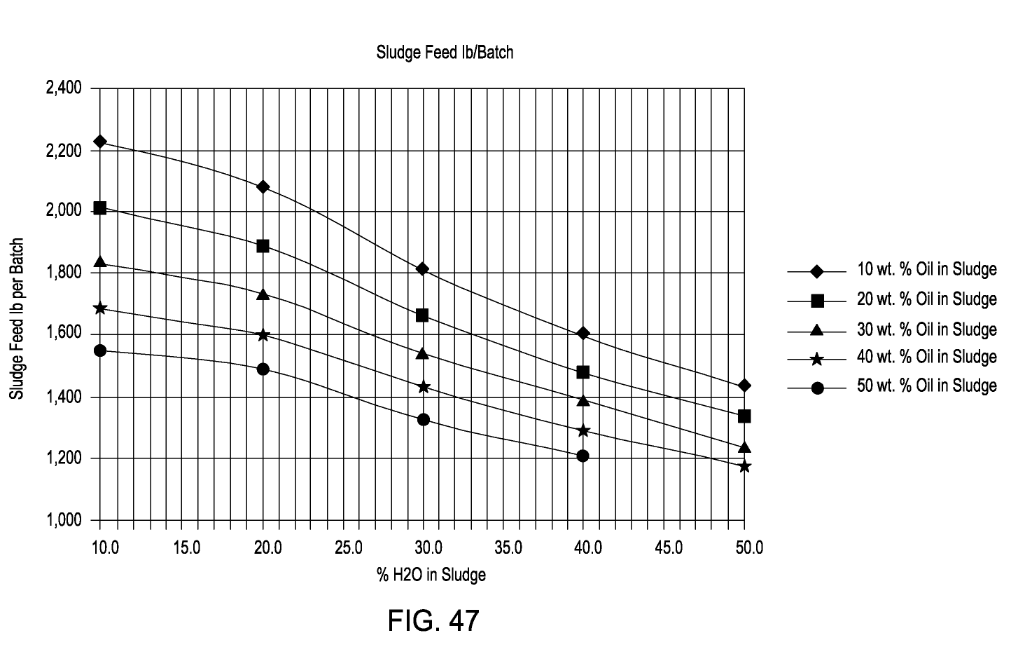

FIGS. 42A-42D, FIGS. 43A-43C, and FIGS. 44-47 show a mixer operator interface, resulting ChemCad Calculated Input Values to PLC, PLC Calculations from above Inputs, and Other Calculations, a Table of ChemCad Simulation Results, CaO Usage graph, H2SO4 usage graph, and sludge feed per pound batch graph in one example. Using the program, the oil and water weight percent obtained from the sample 600 may be input into a program (in the two spots on the sheet of FIG. 42A which are next to oil in sludge wt % and water in sludge wt % in “Operator Inputs to This Sheet” and “Analysis Result Parameters”). Using the empirical values from the spreadsheet having the results of the testing done with different weight percents of oil and water and the ratio of base and catalyst needed with those weight percents to produce the desired dry product P and interpolating values if necessary, the operator may determine the ratio of base to catalyst that is needed to add to the mixer 50 and input it into the spreadsheet for the CaCl/CaO (%) Ratio. Based on these inputs, ChemCad then calculates the input values to the PLC and the operator enters those values into the PLC. The “Formula Parameters” portion of the sheet shown in FIG. 42A includes input from the simulation interpolation of the testing at various parameters and values, for example in the spreadsheet. The “Load Parameters” are calculated based on the volumes and densities of the chemicals so that the volume in the mixer 50 is not larger than the mixer 50 is capable of supporting. Total batch volume (by weight) in the mixer 50 may be entered by the operator. PLC software may be calibrated initially based on density of the average substrate feed. Ultimately, the volume of the reactor 50, the weight percents of components in the substrate feed, and theoretical calculations from the simulations determine the weight percents of feed components which will be added to the mixer 50.

Measurements of the dry product P sample component weight percents and pH may be taken, and trial and error tweaking of component amounts and other values may be undertaken to produce the desired dry product P component weight percents and product P pH. Product P pH may be adjusted by adjusting acid/base ratio.

The values calculated from the programming may be sent to the system wirelessly or via electrical hardwiring to the various control mechanisms in the system, e.g., valves, pumps, conveyors, meters, piston/cylinder assemblies, components for turning equipment on and off, etc. to control the system's operation using those calculated values.

FIG. 59 is a flow diagram illustrating how an embodiment of the control system determines required weight percents of components to feed into the mixer of the system and method of embodiments. A simulation of the system and method of embodiments was performed at periodic (e.g., 10%, 20%, 30%, etc.) oil weight percents and water weight percents of the raw material feed F to obtain product material and other values, determining estimated theoretical chemical requirements in the process. When the sample 600 of the raw material feed F (and/or the sample of the dry product P) is taken, these oil and water percentages (and optionally pH) of the raw material feed F (and/or the dry product P) are entered by the operator into the spreadsheet, and using the simulation values, interpolation is performed on the sample values to find a percent chemical requirement. The operator interface and the DCS control system determine and communicate the required weight percents and weights of the feed components or mixer inputs into the mixer 50. Mixer inputs are the substrate feed including oil, water, and solids; water and/or surfactant; base, catalyst (operator input), and acid.

FIGS. 48 and 49 illustrate an example computer screen display showing the input parameters (FIG. 48) and plant parameters (FIG. 49). FIG. 48 shows an example computer display screen that is displayed on a computer display upon input and calculations of the parameters into the spreadsheet shown in FIGS. 42A-D, 43A-C, and 44-47. FIG. 49 shows an example computer display screen that is displayed on a computer display which shows operating values of the system and method of embodiments and may show these values in real time, as measured by the measuring devices (e.g., valves, meters, sensors, load cells, etc.) strategically located throughout the system and calculated, if necessary, using a computer processing system.

Although some of the values are entered manually by looking at a spreadsheet of tested values, it is within the scope of embodiments that these values may be automatically generated by the computer processor and software.

With the PLC, the operator can set how long each material is added into the mixer 50.

Optionally, the system may include a mobile office having an operation house for an operator, a lab, and an office for personnel.

FIG. 59 is a top perspective view of the system of FIG. 1.

FIG. 60 is a perspective view of the system of FIG. 59, taken from an opposite side.

FIG. 61 is another perspective view of the system of FIG. 59, taken from an end.

FIG. 62 is still another perspective view of the system of FIG. 59, taken from an end opposite that of FIG. 61.

An embodiment of a charge hopper assembly is shown in FIGS. 68A, 68B and 68C, and section view of the component 2000 is shown in FIG. 68D. Following are exemplary components which may be associated with the charge hopper assembly (measurements in inches unless otherwise specified):

| Component or | | |
|---|---|---|
| Location Number | Quantity | Description |
| 1005 | 1 | Charge Hopper Weldment |
| 1006 | 1 | Receiving Hopper Grate Weldment |
| 1007, 2000 | 2 | C3 × 4.1 × 3 |
| 1007 | 2 | HHCS, ½ - 13 × 4½ inches |
| 1008 | 24 | ½ × 1 - ¼ inch hex head cap screw |
| | | (HHCS) |
| 1007, 1008 | 26 | ½ inch Lock Washer |
| 1007, 1008 | 26 | ½ inch Hex Nut |

An embodiment of a receiving hopper skid assembly is shown in FIGS. 69A, 69B, and 69C. Following are exemplary components which may be associated with the receiving hopper skid assembly (measurements in inches unless otherwise specified):

| Component or | | |
|---|---|---|
| Location Number | Quantity | Description |
| 1009 | 1 | Receiving Hopper Skid Weldment |
| 1010 | 1 | Charge Hopper Assembly |
| 1011 | 1 | 9 inch Screw Conveyor 15 HP |
| 1012 | 1 | 12 inch Screw Conveyor Modification |
| 1013 | 1 | Screw Support Weldment |
| 1014 | 1 | Gum Rubber Boot, 12½ inch inner |
| | | diameter (I.D.) × 10 inches |
| 1015 | 1 | Rubber Boot - ¼ inch thick (THK) w/ |
| | | Transition × 11 Inch long |
| 1016 | 1 | Single J-Box Meeting Plate |
| 1017 | 20 | ½ × 1 - ¼ inch hex head cap screw |
| | | (HHCS) (in inches) |
| 1017 | 20 | ½ inch Lock Washer |
| 1017 | 20 | ½ inch Hex Nut |
| 1018, 1020 | 34 | ¾ inch × 2 inch hex head cap screw |
| | | (HHCS) |
| 1018, 1019, 1020 | 36 | ¾ inch Lock Washer |
| 1018, 1019, 1020 | 36 | ¾ inch Hex Nut |
| 1017 | 1 | Caulk |
| 1019 | 2 | ¾ inch Flat Washer |
| 1014, 1015 | 3 | Band IT Clamp |
| 1014, 1015 | 132 | ¾ inch Band IT |
| 1021 | 1 | Vibrator Install |

Also shown in FIG. 69B is a location 1022 where the boot may be unhooked for transporting, as well as a batching position 1023 and a lowered transportation position 1024 for the screw conveyor in this example.

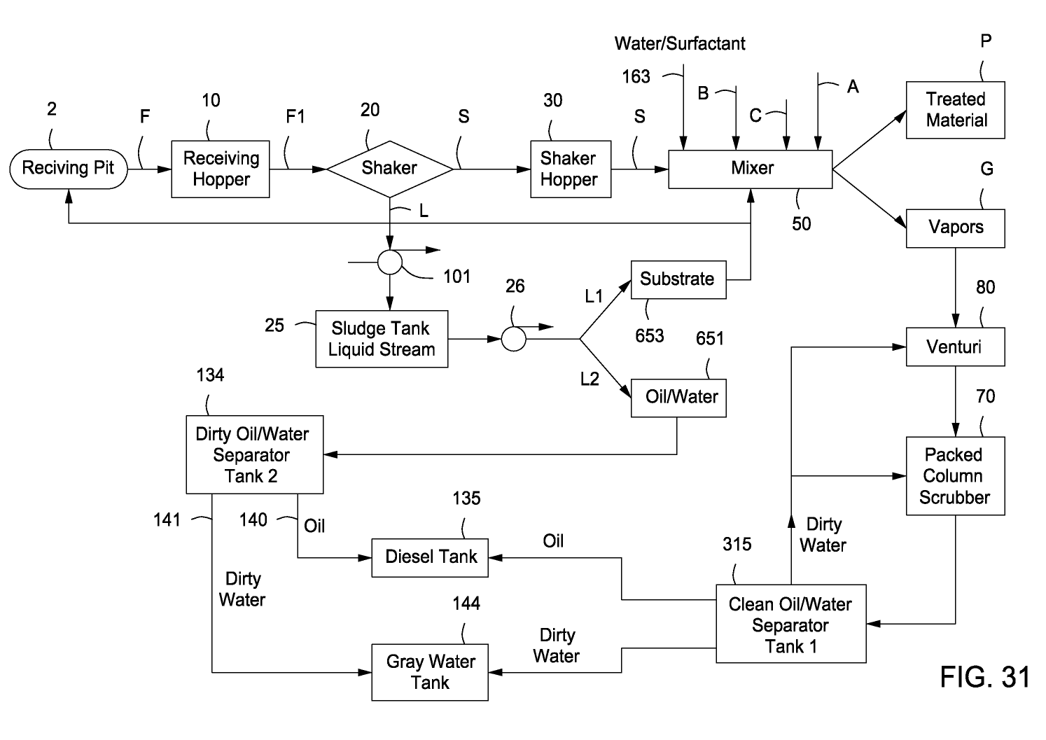

In operation, substrate treatment of the raw material or feed material is performed using the substrate treatment system. A flow diagram of some components, operations, and flow from and into these components and operations of the substrate treatment section of the system and gas cleaning and oil (or other liquid in the substrate feed) recovery section of the system is shown in FIG. 31. Additionally, a flow diagram of the substrate treatment section of the system is shown in FIG. 36, while a flow diagram of the gas cleaning and oil (or other liquid in the substrate feed) recovery section of the system is shown in FIG. 36.

The substrate or raw material or feed material F is transported to the receiving pit 2, for example directly from the drilling rig, by truck tanker or other vehicle, by roll off box, by a dump truck, by excavator, or by any other equipment and method for delivery of a substrate or feed F known to those skilled in the art. In one embodiment, the receiving pit 2 may be a trackhoe, moving into a live bottom feeder.

A certain amount of water is required for the method to work. Once the substrate is delivered, an optional sample of the substrate may be taken and analyzed, for example in an onsite lab 680 (see FIG. 39), to identify the properties of the sample including weight percent of oil, water, and solids (and possibly other weight percents) in the sample 600. The sample 600 may be taken at any time, including in the delivery vehicle or its original location, from the receiving pit 2, and/or from the receiving hopper 10. These weight percents may be used to determine whether water needs to be reduced, e.g., by pumping water out from the receiving pit 2 and/or receiving hopper 10, or if water and/or surfactant needs to be added to the receiving pit 2, receiving hopper 10, or at another point in the system.

Substrate or raw material feed F is moved from the receiving pit 2 into the receiving hopper 10, where an optional screen 146 may filter out the some of the solids. Optionally, the sample 600 of the contents of the receiving hopper 10 may be taken from the receiving hopper 10 and analyzed to determine the weight percent of oil (or other liquid in the substrate) and water in the sample. The sample 600 may be analyzed using a retort in which the sample 600 is cooked (substrate may be cooked off by an oven) to disclose weight percents of the oil (or other liquid component) and water. Because the sample 600 contains oil (or other liquid in the substrate), water, and solids, the weight percent of solids in the sample 600 may be determined by adding the weight percents of oil and water together and subtracting the sum total of the weight percents of oil and water from 100%. Of course, the sample 600 provides a good estimate of the weight percents of the oil, water, and solids which exist in the receiving hopper 10. Although any number of samples 600 may be taken at any time in embodiments, in an example which is not limiting of embodiments, a sample 600 is taken once per day of system operation.

Once the sample 600 is analyzed and the weight percents of oil, water, and solids determined, the weight percent of water in the sample 600 helps determine whether water and/or surfactant and/or oil, needs to be added to the receiving hopper 10 or if water and/or oil needs to be removed from the receiving hopper 10 to provide the desired end product P with the desired oil (or other liquid component) weight percent (and possibly also with the desired water weight percent in the final product P, if the amount of water is a specification of the final product P which needs to be achieved). The sample 600 also may be used to determine whether water, surfactant, and/or oil needs to be added to the receiving hopper 10 to create the desired reaction in the mixer 50.

If water needs to be added to the receiving hopper 10, water 601 may optionally be added to the receiving hopper 10 from the gray water tank 144 or other water storage unit or water source, as needed to provide the desired end product P with the desired oil and/or water content and to create the desired reaction in the mixer 50. Surfactant T may also optionally be added from the surfactant tank T or from any other surfactant storage unit or surfactant source, as needed to provide the desired end product P with the desired oil and/or water content and to create the desired reaction in the mixer 50. In some embodiments, surfactant T and water W may be added separately into the receiving hopper 10, but in other embodiments, water W and surfactant T may be added into the receiving hopper 10 already mixed, for example from the water and/or surfactant tank 161 or other water and surfactant storage unit or water and surfactant supply source.

If oil needs to be added to the receiving hopper 10, oil may optionally be added to the receiving hopper 10 from the optional oil tank 135 or other oil storage unit or water source. Oil wash and/or oil addition are options for adding oil to the receiving hopper 10. In some embodiments, the oil may be added to the receiving hopper 10 in the form of diesel, mineral spirits, and/or lighter fuel. Whether oil wash/addition is needed may be determined by the amount of oil in the material feed F, which may be determined by visual inspection and product quality.

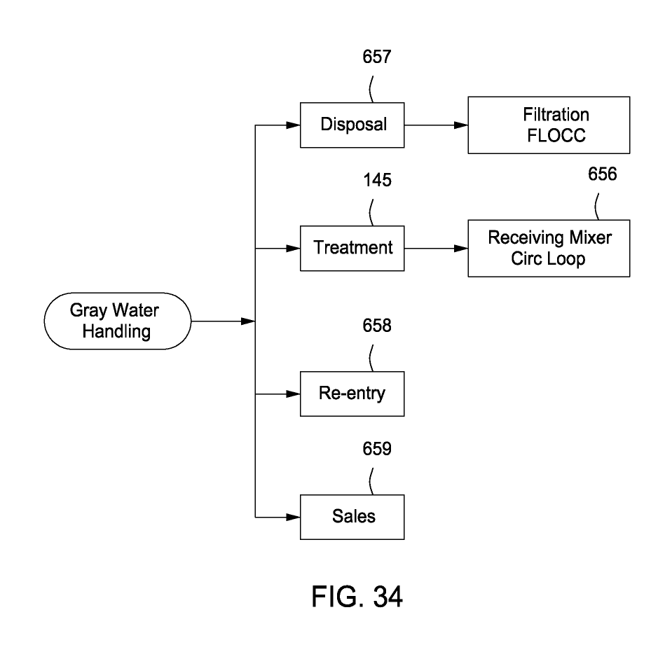

On the other end of the spectrum, if there is more water and/or oil in the sample 600 than is needed in the receiving hopper 10 to provide the desired end product P with the desired oil (or other liquid component in the substrate feed F) and/or water content and to create the desired reaction in the mixer 50, excess water and/or oil (or other liquid component present in the substrate feed F) 603 may be removed from the receiving hopper 10, for example by using one or more pumping mechanisms such as one or more pumps 602 to pump the excess water and/or oil 603 out of the receiving hopper 10. If water is removed from the receiving pit 2 or receiving hopper 10, two streams are created, including a dirty water stream that may be sent to the dirty oil/water separator 134 and a thicker substrate stream. The excess water and/or oil 603 may ultimately arrive in the dirty oil/water separation tank 134 (or other oil/water separation device) for further treatment to allow its possible re-entry into the system. Whether or not the excess water and/or oil 603 stream enters the dirty oil/water separation tank 134, the stream may undergo gravity separation to separate the oil and water from one another. If the water and/or oil stream 603 is moved to the dirty oil/water separator 134, the oil/water separator 134 may separate the gray water and/or oil stream 603 into three streams: oil 140 (which may optionally be moved to the optional dirty oil tank 135, and dirty oil from the dirty oil tank may be placed in the mixer reactor 50 at an appointed time), gray water 141 (which may optionally be moved to the optional gray water tank 144, and gray water from the gray water tank 144 may be sold, treated, pretreated for National Pollutant Discharge Elimination System discharge or for sending to an approved water treatment facility, re-used, and/or disposed of as shown in FIG. 34), and substrate 655 (which may be sent to the mixer reactor 50 at an appointed time).

In determining whether water, surfactant, and/or oil needs to be added or removed from the receiving hopper 10 to obtain the desired end product P with the required or desired weight percentages of these components as well as to provide the desired reaction in the mixer 50, some guidelines may be followed in some embodiments. Generally, at least five percent water is needed for the reaction to take place in the mixer 50. If the sample 600 contains over approximately 10 weight percent of water, additional water and/or surfactant may not be needed in the receiving hopper 10 for the reaction to take place in the mixer 50. Ideally, the sample 600 may contain approximately five percent to approximately ten percent water. Although just water may be added and not surfactant under some conditions, surfactant may be need under some conditions to serve as a binding agent of the oil to the water.

Although in some embodiments the water, surfactant, and/or oil is added, as needed, into the receiving hopper 10, it is also within the scope of embodiments to add the additional water, surfactant, and/or oil into the mixer 50 instead of into the receiving hopper 10. Whether these components may be added at the mixer 50 rather than at the receiving hopper 10 is determined by the weight percent of oil in the sample 600.

FIG. 33 shows some different options for treating the substrate feed F in the receiving hopper 10 (or other storage device), including gravity separation, adding surfactant and/or water to the substrate, and/or oil wash/addition.

In some embodiments, the receiving hopper 10 may include a live bottom feeder, which may in one example be a variable speed live bottom feeder, which may be programmed to operate when no material is being added into the receiving hopper 10 to prevent bridging of the material in the receiving hopper 10. The computer processor and/or software may determine (via some sort of communication, wireless or wired, from a sensing (of level) device or weighing device (of material in the hopper 10) on the hopper 10) when no material is being added to the receiving hopper 10.

Once the weight percents of the oil, water, and solids are manipulated to the desired amounts in the receiving hopper 10, the material F1 in the receiving hopper 10 may be transported into the shale shaker 20, for example using one or more conveyors, augers, or pumps 15. The receiving hopper 10 is optional and could be replaced with a live bottom tank which moves the substrate feed within the tank to provide a generally homogeneous feed, a track hoe for loading the substrate feed directly into the shaker 20 or mixer reactor 50 from the track hoe, or a barge at the site receiving cuttings from the wellbore. Additionally, the shale shaker 20 is optional and may be bypassed if it is not needed (e.g., the thicker substrate F1 may go directly into the dirty oil/water separator 134 from the receiving hopper 10 or receiving pit 2).

The shaker 20 is may be used to remove water from the substrate F1. The shaker 20 creates two streams, a thicker stream S and a liquid stream L. The thicker stream S in placed into a hopper 30, which may be a funnel to reduce or batch the amount of substrate material S added to the mixer 50, that may have one or more weighing devices such as one or more load cells 161 or scales under the hopper 30. The one or more weighing devices 161 may cause the shaker 20 to turn off once it reaches the programmed weight. The liquid stream L from the shaker 20 may be placed into a liquids catch tank/hopper 25, sent to an optional substrate/oil-water separator 133, and then sent to the dirty oil/water separator 134. An evaluation of the water level of dirty liquid L in the dirty liquid tank/hopper 25 may be performed, and some or all of the water in the dirty liquid tank 25 may possibly be pumped off and optionally sent to the water treatment plant or dirty oil/water separator 134 and then optionally sent to the optional gray water tank 144, then may be sold for reuse, treated, reused in the system or process, and/or disposed of. The remaining oil may be sent to the reactor (mixer) 50 on demand or at an appointed time. This portion of the system and method is described in more detail below and herein.

In the shale shaker 20, the material F1 may be vibrated on screens, e.g., slanted screens, to move the material F1 forward. The material F1 is separated into two streams from the shaker 20, including the thicker substrate (e.g., solids) S which may flow into the shaker hopper 30 or other storage and/or substrate S dispensing unit and the liquids L (which may include dirty oil, water, and some solids) which may flow into the liquids catch tank 25 or sludge tank or hopper. One or more pumps 101 may be used to pump the liquids L into the liquids catch tank 25.

From the liquids catch tank 25, water 650 may flow out of the liquids catch tank 25 into the optional gray water tank 144, while oil, water, and/or substrate in stream 651 may flow into the separator 133. Stream 651 may be flowed into the separator 133 using one or more pumps 652. The one or more pumps 652 may be turned on and off by the level in the liquids catch tank/hopper 25, which level may be determined by one or more level sensors disposed in the hopper 25 which communicate with the processor. The separator 133 may be used to separate the substrate/solids 653 from the oil and water 654.

The substrate 653 may be cleaned out and optionally be added to the mixer 50, for example with the substrate feed S. (Although not shown, the substrate 653 may, instead of or in addition to being added to the mixer 50, be added to the receiving hopper 10.) The oil/water stream 654 may be introduced into the dirty oil/water separation tank 134, e.g., along with the optional excess oil and water stream 603 from the receiving hopper 10.

The dirty oil/water separation tank 134 may, e.g., by gravity separation 134A and/or chemical separation 134B (see FIG. 32), separate the dirty oil, gray water, and fractional solids from one another, resulting in dirty oil stream 140, gray water stream 141, and fractional solids 655.

Fractional solids 655 may optionally enter the mixer 50, for example with the substrate feed S. Dirty oil stream 140 may flow into the optional dirty oil tank 135 and may optionally ultimately flow into the mixer 50, e.g., for example with the substrate feed S (in some embodiments, the dirty oil 140 does not have to be stored in the dirty oil tank 135 and may flow into the mixer 50 directly). In some embodiments, the dirty oil 140 may be stored and possibly sold without flowing it into the mixer 50 (or a portion of the oil 140 may be stored and possibly sold and a portion of the oil 140 may be flowed into the mixer 50). One or more pumps 142 and one or more meters 143 may be used to pump the dirty oil 142 into its desired location (e.g., the mixer 50) and to meter the amount of dirty oil 142 flowed into the desired location (e.g., the mixer 50). Gray water stream 141 may be flowed into the optional gray water tank 144 or to any other location needing water in the system, including to the mixer 50 as a water source.

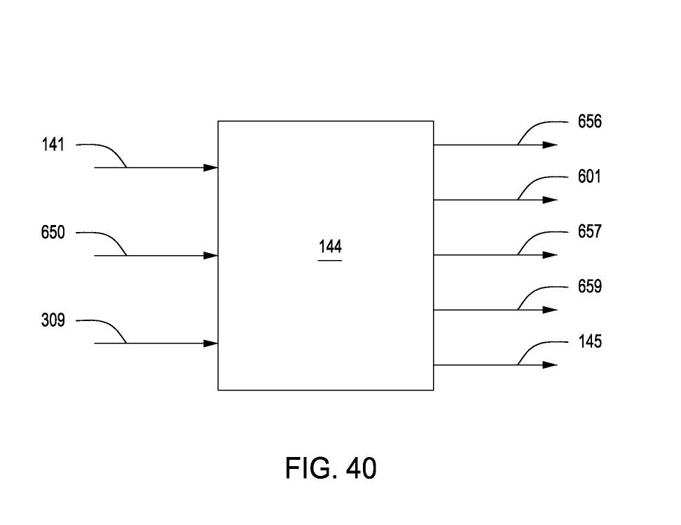

Gray water from the water tank 144 may ultimately be flowed to the mixer 50 (via optional water stream 656) and/or to the receiving hopper 10 (via optional water stream 601). FIG. 34 shows options for the gray water handling, for example handling of the water from the gray water tank 144. The gray water may be sent for disposal 657; treatment 145, for example using filtration or flocculation; re-entry 658 into the system, for example in the receiving mixer circulation loop 656 or into the receiving hopper 10 via water stream 601; and/or sales 659. FIG. 40 also shows options for gray water streams which may enter and exit the gray water tank 144 (or other storage unit for water). Gray water going into the gray water tank 144 may be from the dirty oil/water separator 134, the shaker system (for example from the liquids catch tank), and/or from the gas condenser system, for example from the clean oil/water separator 309 (see FIG. 36). Water from the gray water tank may be used in the mixer 50 (water stream 650), in the receiving hopper 10 and/or live bottom feeder (e.g., if the live bottom feeder is used in lieu of the receiving hopper 10), and/or may be sold 659, disposed of 657, and/or treated 145 (for example filtration of flocculation).

The thicker substrate S in the shaker hopper 30 may be flowed into the mixer 50 in a controlled fashion, as determined by the weight of the material in the shaker hopper 30, as measured by the one or more weighing devices such as the one or more load cells 161. The shaker hopper 30 may be used for batching of the material S into the mixer 50. The weight measured by the load cells 161 indicates the level of material S in the shaker hopper 30. After the load cells 161 measure the weight in the shaker hopper 30, this weight can be correlated to the level of material in the hopper 30 when software is calibrated based on the density of the average substrate feed F. The level of the shaker hopper 30 fills up to supply the mixer reactor 50. The measured weight from the load cells 161 is communicated (e.g., by hardwired electrical wiring or wirelessly through electrical signal) to the computer processing system, which communicates with the substrate delivery system (e.g., one or more valves, conveyors, augers, and/or pumps) of the shaker hopper 30 to allow the material S to flow into the mixer 50 once the desired level of material S in the shaker hopper 30 is reached.

Alternatively or in addition to the one or more load cells 161 on the shaker hopper 30, the one or more load cells 132 on the mixer 50 may be used to batch material from the shaker hopper 30. In some embodiments, the shaker 20 and shaker hopper 30 are bypassed in the method or may not even be included in the system (for example, when the live bottoms feed receiving bin option is included with the system as an option instead of or in addition to the shaker 20 and shaker hopper 30). In these instances, the load cells 132 may weigh substrate material S which is present in the mixer 50, communicate that weight with the computer processing system (e.g., by hardwired electrical wiring or wirelessly through electrical signal) to determine the amount of substrate material S needed to reach a certain desired level in the mixer 50. The processor may then communicate with the substrate material S delivery system (e.g., one or more valves, conveyors, augers, and/or pumps) to allow the desired amount of substrate material S to flow into the mixer 50 (for example, from the receiving bin with live bottoms feed). Even when the shaker 20 and shaker hopper 30 are used in the system, the mixer 50 load cells 132 may be used to determine the amount of substrate S to add to the mixer 50 (back end measuring) instead of using the load cells 161 of the shaker hopper 30 (front end measuring).

In some embodiments, the receiving pit 2, receiving hopper 10, and conveyor, auger, and/or pump 15 may be replaced or operation of this equipment bypassed by a live bottom feeder with a material transporting device such as a pump, conveyor, or auger, so that feed F from the live bottom feeder is pumped or conveyed directly into the shaker 20. In other embodiments, the receiving pit 2, receiving hopper 10, conveyor, auger, or pump 15, shaker 20, shaker hopper 30, and conveyor, auger, or pump 35 may be replaced or operation of this equipment be bypassed by the live bottom feeder with a material transporting device such as a pump, conveyor, or auger. The live bottom feeder may include a screen therein for filtering out materials. The sample 600 may be taken from feed F in the live bottom feeder to determine whether oil and/or water needs to be added to the live bottom feeder, and one or more load cells on the mixer 50 may be used for batching of the feed material F into the mixer 50.

In an example which is merely exemplary and not limiting of embodiments, if the contents of the receiving hopper 10 or live bottom feeder includes greater than approximately 10 percent water, the contents may be sent to the shaker 20, and if the contents do not include greater than approximately 10 percent water, the shaker 20 may be bypassed. In some embodiments, bypassing the shaker 20 involves sending some or all of the material in the receiving hopper 10 or live bottom feeder directly into the dirty oil/water separation tank 134, and in some embodiments, bypassing the shaker 20 involves sending some or all of the material in the receiving hopper 10 or live bottom feeder directly into the mixer 50.

When any of the augers or conveyors of the system are not feeding material, they may optionally reverse to agitate materials.

The mixer operates when the one or more drive motors or other shaft-powering mechanisms cause the shafts 150, 151 to rotate. The shaft 150 may rotate in an opposite direction from the shaft 151 to produce the most efficient and effective reaction and mixing results (the opposite direction rotation may help with the mixing), so that one shaft rotates clockwise and one shaft rotate counterclockwise. (However, it is also within the scope of embodiments that both shafts 150, 151 may rotate in the same direction.) The moving paddles upon rotation of the shafts on which they are located make the solids in the mixer 50 act as a gas, and the goal is for the reactions to take place in one or more clouds at the top of the mixer in the chamber 182 (and for the materials to not descend down the mixer 50 below the upper chamber 182 and off the side of the shafts/paddles). A first plume or cloud of oil and water may form in the reaction chamber 182 when (or after) the base B and/or catalyst C enter the mixer 50 (after the substrate feed F and optional water W and/or surfactant S enter the mixer 50). A second reaction plume or reaction cloud may form in the reaction chamber 182 when (or after) the acid A is added to the mixer 50 (after the base B and/or catalyst C are added to the mixer 50). The mixer 50 is pressurized so that when it is sealed, the mixer 50 runs air tight at positive pressure. The paddles are designed at angle(s) with respect to the shafts and moved at a speed fast enough to create the mushroom or plume upon addition of the base B and then the acid A. In some embodiments, the shaft(s) 150, 151 may rotate at 200 revolutions per minute (rpm) or less under low shear conditions, and in some embodiments the shaft(s) 150, 151 may rotate at around 160 rpm. The paddles may have wide blades to allow for slow rotation.

Substrate feed S may be introduced to the mixer 50 first, e.g., by using the one or more conveyors 35 (or one or more pneumatic pumps in alternate embodiments). The substrate feed S may optionally include substrate 653, solids 655, and/or dirty oil 140 from other locations in the system (the substrate 653, solids 655, and/or dirty oil 140 may be added into the mixer 50 separately from or together with the substrate feed S).

To add substrate S to the mixer reactor 50, one or more specially designed valves, such as a knifegate valve 530 such as that shown in FIG. 13, may be manipulated to open long enough to allow the substrate S into the reactor mixer 50 and close as soon as the proper weight of substrate S in the mixer 50 is reached. The knifegate valve 530, as well as all of the other valves shown and described herein, may be operated by the computer processing system and software, which may use the weight percents from the one or more samples of the product P and feed F to determine how much substrate S to add to the mixer 50 and to open and close the valve 530. The communication between the valve (and other valves in the system) and the mixer 50 may be electrically wired or wireless. In some embodiments, the valve 530 may open after the reactor 50 is turned on and before the transfer conveyor, auger, or pump 35 begins to move material S to the reactor 50 from the shaker hopper 30.

The shaker hopper 30 or pre-weigh bin may receive the drill cuttings or substrate or feed stock and cut off the system so that the conveyor(s), auger(s), and/or pump(s) may catch up when a certain level in the shaker hopper 30 or pre-weigh bin is reached. When a certain weight in the shaker hopper 30 or pre-weigh bin is reached, the conveyor(s), auger(s), and/or pump(s) 35 may be turned on to operate, the mixer door(s) may be opened to allow material from the conveyor, pump, or auger 35 into the mixer 50 and the knifegate valve(s) may be loaded to what the mixer 50 should receive based on weight.

In some embodiments, the substrate (cuttings or feed stock) may have a weight percent of water from 0 to 60 percent (values may be approximate). The oil weight percent of the substrate S entering the mixer may be anywhere from 0 to 100 percent or 0 to 90 percent (values may be approximate).

The substrate may have a water content of approximately 18 percent to approximately 50 percent, a solids content of 0 to approximately 10 percent, and an oil content of 0 to approximately 60 percent. The substrate may be introduced in a semi continuous manner into the mixer in a predetermined weight which is weighed as it in entered into the mixer.

The water W and/or surfactant T, as needed, are also added to the mixer 50 (in some instances, water may not need to be added into the mixer 50), e.g., through one or more pipes from the water tank 60, surfactant tank 162, and/or water and/or surfactant tank 161. The substrate S and the water W and/or surfactant T may be admixed or mixed under low shear conditions (via rotational movement of the shafts 151, 152) to bind the water to the oil base substrate S, forming a first mixture. The water W and/or surfactant T flow through the one or more pipes may be metered using one or more flow meters 62 and may be pumped into the mixer 50 using one or more pumps 61. To add the water W and/or surfactant T into the mixer 50, one or more valves (e.g., one or more butterfly valves) may be opened to permit water W and/or surfactant T flow from the one or more pipes into the mixer 50.

The water W may either be added in the receiving hopper 10 or the mixer reactor 50, which choice may be made by the results of the lab analysis of the sample 600, including weight percents of components, visual inspection of the substrate feed F and/or the product P, or a results of the lab analysis of a sample of the product P, including weight percents of components. The lab may make this choice, e.g., the operator may make the choice based on analytical data from the lab. When a sample 600 of the substrate feed F and/or a sample of the product P is taken, the properties of the sample(s) that are identified (e.g., weight percents of water, oil, and solids) may be plugged into a specially-designed computer program (e.g., a software program) which is capable of properly calculating and programming the delivery systems to the proper amounts of components, including water W, to be added.

A minimum amount or weight percent of water W in the mixer reactor 50 is needed by the substrate S to make the reaction take place, and water W makes the reaction(s) in the mixer 50 work efficiently. The water W flow into the mixer 50 may be controlled by one or more pumps 61, and a meter 62 measures the amount of water W added to the substrate in the mixer 50. At some times surfactant T may be added to the water W or added separately into the mixer 50, as needed. The reactor 50 may have a special designed distributor, e.g., a manifold as such as is shown in FIG. 6, inside that allows the water W to be distributed rapidly with the substrate S during the blending process. Because the process in the mixer 50 expands particles to twice their size, water and/or surfactant is needed for the reaction. In one embodiment, per one gallon added into the mixer 50 of wet materials, two gallons of dry materials result.

Surfactant T may be added in the receiving bin 10 or within the reactor 50. Whether surfactant T needs to be added and the amount of surfactant T that needs to be added is decided by the water concentration or water weight percent in the sample 600 and/or in the product sample and how the existing water in the feed F or in the product P is bound to the substrate. The lab may make this choice, e.g., the operator may make the choice based on analytical data from the lab. When a sample 600 of the substrate feed F and/or a sample of the product P is taken, the properties of the sample(s) that are identified (e.g., weight percents of water, oil, and solids) may be plugged into a specially-designed computer program (e.g., a software program) which may be capable of properly calculating and programming the delivery systems to the proper amounts of components, including water W, to be added.

The purpose of the addition of surfactant T is to make the water W bind to the substrate S in the reactor 50 to make a more effective reaction. The surfactant T may be added by one or more pumps, which may be the same pumps 61 as pump the water W such as when the water W and surfactant T may be added into the mixer 50 together, or may be added by a separate surfactant pump, and a meter, which may be the same meter 62 which measures the amount of water W to add to the substrate, or may be a separate surfactant meter, to measure the amount of surfactant T (or water W and surfactant T) added to the substrate in the mixer 50. The reactor 50 may have a specially designed distributor, e.g., a manifold as such as is shown in FIG. 6, inside that allows the surfactant T to be distributed rapidly with the substrate S during the blending process. The optional water W and/or optional surfactant T may be added quickly to the mixer 50 with the manifold.

When the substrate S, optional water W, and optional surfactant T are introduced into the mixer 50, shafts 150, 151 may rotate slowly so that the substrate does not coat the walls of the mixer 50. The shaft rotation speed may be increased when the base B is added into the mixer 50.

Next, base B and optional catalyst C may be added to the mixer 50. In some embodiments, while the substrate S is being added to the mixer 50, the base B and/or catalyst C are weighed in one or more preweigh bins (e.g., base tank/batcher 40 on load cells 151 and/or catalyst tank/batcher 45 on load cells 152), the contents of which may be automatically added to the mixer 50 as soon as the substrate S is added to the mixer 50. In some embodiments, the base B and/or catalyst C are added to the mixer 50 after the substrate S and the water W and/or surfactant T enter the mixer 50. In an alternate embodiment, the water W and/or surfactant T may be added to the mixer 50 after the base B and/or catalyst C are added.

In one embodiment, the base B and catalyst C are added at the same time, either separately or pre-mixed together. The base B and catalyst C are admixed or mixed with the substrate and optional water W and/or surfactant S (the first mixture) under low shear conditions by rotational movement of the shafts 151, 152 of the mixer 50, forming a second mixture. In some embodiments, the base B and optional catalyst C are admixed or mixed with the first mixture for a few seconds, for example approximately 15 seconds to approximately 60 seconds. The admixing or mixing of the base B and optional catalyst C with the first mixture at low shear conditions creates a first reaction, giving off heat. Mixing the base B with the contents in the mixer 50 at low shear as the base B is being added results in a heat. The first reaction may take place in the open area 182 above the shafts 151, 152 after the paddles fling material up into the open area 182 upon their rotational movement around the shafts 151, 152, creating a first plume in the open area 182. The base B and/or catalyst C may be added to the mixer via gravity upon opening of one or more slide gate valves into the mixer 50. The base B and/or catalyst C may be added to the mixer 50 quickly using a piston/cylinder assembly.

The amount of base B to add to the mixer 50 may be calculated by the computer processing system or computer software. The calculations of the processor or software are based on the information that is provided by the lab results (e.g., weight percent of oil, water, and solids) from the test/sample of the incoming substrate F and/or the test/sample of the dry product P.

The mixer 50 may speed up (mixer paddle speed may increase) once the base B is added. The base B may be added to the mixer reactor 50 by a pre-weigh system which rapidly charges the base B. A valving system, which may include one or more knifegate valves 531 or 532 and one or more butterfly valves, may be used to hold the pressure in the mixer 50 and seal the mixer airtight and to reduce the heat loss in the reactor 50 while allowing selective base B addition into the mixer 50, increasing the effectiveness of the reaction in the mixer 50. The one or more butterfly valves may be used for preloading the base B, and a chamber may be located between the one or more butterfly valves and the one or more knifegate valves 531 or 532. Base B may be gravity fed into the chamber when the one or more butterfly valves are opened and the one or more knifegate valves 531, 532 are closed. The one or more butterfly valves may be closed, and then the one or more knifegate valves 531, 532 may be opened to gravity feed the base B into the mixer 50. The one or more butterfly valves may be closed just before the one or more knifegate valves open. The one or more knifegate valves, which may remain closed during the addition of the base charge material into the chamber between the butterfly and knifegate valves, keeps raw air and extra raw materials from entering the mixture in the reactor 50.

In addition to or in lieu of the valving system, one or more piston/cylinder assemblies, such as one or more pneumatic piston/cylinder assemblies, may be included with the system to add base B to the reactor mixer 50. The one or more piston/cylinder assemblies may allow the base B to be added quickly into the mixer 50.

Addition of the catalyst C (e.g., calcium chloride or salt) is optional. In some embodiments, catalyst C is only added to the mixer 50 if a temperature boost is needed, such as if the temperature needed for an effective reaction in the mixer 50 cannot be reached with only the added base B. The catalyst C may be added to pull the water to the base B faster. The catalyst C may cut overall chemical costs of the method of embodiments.

The amount of catalyst C (e.g., calcium chloride or salt) to add to the mixer 50 may be calculated by the computer processing system or computer software. The calculations of the processor or software are based of the information that is provided by the lab results (e.g., weight percent of oil, water, and solids) from the test/sample of the incoming substrate F and/or the test/sample of the dry product P.

If catalyst C is added to the mixer 50, the timing of the catalyst C addition into the mixer 50 should be with or at or near the same time the base B is added. The same preweigh system and valving system may be used for the catalyst C as is used for the base B if the catalyst C and base B are premixed prior to their addition into the mixer 50. It is also within the scope of embodiments that an additional valving system and preweigh system may be included in the system and used to add the catalyst C to the mixer 50.

Optionally, the mixer 50 may speed up (mixer paddle speed may increase) once the base B, base/catalyst mixture, or catalyst C is added. The catalyst C or base/catalyst mixture may be added to the mixer reactor 50 by a pre-weigh system which rapidly charges the catalyst C or base/catalyst mixture. A valving system, which may include one or more knifegate valves 531 or 532 and one or more butterfly valves, may be used to hold the pressure in the mixer 50 and seal the mixer airtight and to reduce the heat loss in the reactor 50 while allowing selective catalyst C or base/catalyst mixture addition into the mixer 50, increasing the effectiveness of the reaction in the mixer 50. The one or more butterfly valves may be used for preloading the catalyst C or base/catalyst mixture, and a chamber may be located between the one or more butterfly valves and the one or more knifegate valves 531 or 532. Catalyst C or base/catalyst mixture may be gravity fed into the chamber when the one or more butterfly valves are opened and the one or more knifegate valves 531, 532 are closed. The one or more butterfly valves may be closed, and then the one or more knifegate valves 531, 532 may be opened to gravity feed the catalyst C or base/catalyst mixture into the mixer 50. The one or more butterfly valves may be closed just before the one or more knifegate valves open. The one or more knifegate valves, which may remain closed during the addition of the catalyst or base/catalyst mixture charge material into the chamber between the butterfly and knifegate valves, keeps raw air and extra raw materials from entering the mixture in the reactor 50.

In addition to or in lieu of the valving system, one or more piston/cylinder assemblies, such as one or more pneumatic piston/cylinder assemblies, may be included with the system to add catalyst C or base/catalyst mixture to the reactor mixer 50. The one or more piston/cylinder assemblies may allow the catalyst C or base/catalyst mixture to be added quickly into the mixer 50.

Once the base B and possible catalyst C (e.g., calcium chloride or salt(s)) are added to the reactor 50, the reactor 50 may be sealed off with a valve (e.g., the one or more knifegate valves 531 or 532 and/or one or more butterfly valves) to prevent air from entering or exiting the reactor 50 during the first reaction.

The pH may be adjustable by the mixture of the base B and/or catalyst C to the required pH value for the end use of the dry material. The desired pH value at this stage may be preset or adjusted in the computer software for communicating with the base B and/or catalyst C dispensing systems/units and measuring devices. In some embodiments, a pH level may be measured in the mixer 50 with a pH-measuring device. Adjusting the pH of the product P on the front end allows for the product P to be used or sold.

The timing of adding the catalyst C to the mixer 50 is critical in some embodiments. The catalyst C drives the temperature higher in the mixer 50, but it could create harmful chlorine gas or other harmful gases if it is not added to the mixer 50 at the appropriate time in relation to the other additions of materials to the mixer 50. The catalyst C should be intertwined with the base B when it enters the mixer 50 to drive the water W to the base B faster (the catalyst C is a catalyst for drawing the water W to the base B). The catalyst C and base B may be intertwined by premixing them together or by adding them into the mixer 50 at the same time or at approximately the same time.

In some embodiments, the base B and/or catalyst C participate in a staged release, where the catalyst C and base B are added into the mixer 50 in stages to spread out the reaction in the mixer 50 and utilize energy more efficiently.

In an embodiment, the mixer 50, which may include a variable speed drive thereon, may be turned on at full blast so that the paddles of the shafts in the mixer are moving fast, then reducing the speed of the variable speed drive so that the paddles are barely turning while adding the substrate S, and then having the paddles 151, 152 increase in speed to move very fast when the base B and/or catalyst C are added to the mixer 50 so that the paddles are moving very fast when the reaction is occurring. In some embodiments, the mixer reactor 50 starts and operates at a lower speed until the base B enters, which keeps the substrate from building upon the sides and lid 405 of the reactor 50.

Adding the base B to the mixer 50 or other mixing device prior to the acid A is much more efficient and provides much better results, especially in the oil content present in the dry product P. The dry product P may have a three weight percent to four weight percent lower oil content when base B is added to the mixer 50 prior to the acid A versus the acid A being added to the mixer 50 prior to the base B. FIG. 71 is a table showing results (weight percent oil and weight percent water in the dry product material P) when an acid A is added first into the mixer before the base B (“Acid First” portion of the table, in this scenario the base B being lime) and when a base B is added into the mixer before the acid A (“Lime First” or “Base First” portion of the table), both with the listed feed material or substrate, base, and acid weights fed into the mixer 50. Reaction temperature (e.g., in the mixer 50) of each scenario (if available) is also shown in the table. With the “Acid First” scenarios shown, portions of the lime shown would not discharge. The failure of the lime to discharge was due to the steam produced from the reaction of acid and water in the material rising upward and causing the lime to become hydrated and stuck to the sides of the discharge (preweigh) bin (meaning a portion of the lime could not pass through the knifegate valve). The steam pressure from the reaction also pushed up against the entry location of the base B, and since the base B is fed by gravity into the mixer, the base B would not fall down into the mixer due to that stream pressure pushing on the base B. Also, the addition of acid first did not allow an ample mix time once the lime was added. These results show that it is best to allow the lime to enter first, mix well with the material, then introduce the acid. This way, the acid is able to come into contact with both the material, water in the material, and the lime simultaneously, generating a better reaction.

A period of time (e.g., a few seconds) after the low shear mixing of the base B and/or catalyst C with the contents of the mixer 50, acid A may automatically added and weighed as it is put into the mixer 50 and blended with the contents of the mixer 50 at low shear conditions. The acid A (which may be organic or inorganic) may be added to the mixer 50 through one or more pipes from the acid tank 55. The acid A flow through the one or more pipes may be metered using one or more flow meters 57 and may be pumped into the mixer 50 using one or more pumps 56. To add the acid A, one or more valves (e.g., one or more butterfly valves) may be opened to permit acid A flow from the one or more pipes into the mixer 50. The acid A may be pumped in extremely fast, in seconds, to make the fastest contact with the contents of the mixer 50.

The amount of acid A (e.g., mineral acid) to add to the mixer 50 may be calculated by the computer processing system or computer software. The calculations of the processor or software are based of the information that is provided by the lab results (e.g., weight percent of oil, water, and solids) from the test/sample of the incoming substrate F and/or the test/sample of the dry product P. How much acid A to add to the mixer 50 may be determined by the beginning parameters of the substrate feed F, including the sample 600 and the amount of acid A needed to reach the target pH of the dry product P, which could be determined by monitoring the pH intermittently or continuously of the product P or within the mixer 50 (e.g., via the pH strip, pH tester, or other pH testing device) and/or by monitoring the temperature in the mixer 50 and/or of the dry product P via a temperature measuring device.

The acid A may be admixed or mixed with the second mixture under low shear conditions (e.g., by rotational movement of the shafts 151, 152 of the mixer 50) in an amount effective to generate an exothermic reaction to vaporize the oil and reaction products thereof. This exothermic reaction may be the second reaction. The second reaction may take place in the open area 182 above the shafts 151, 152 after the paddles fling material up into the open area 182 upon their rotational movement around the shafts 151, 152, creating a second plume in the open area 182.

At the beginning of the acid A being added into the mixer 50, the second reaction takes place and a vapor or gas G is introduced to a vapor or gas collection system. In one example, the vapor or gas G may be introduced to the vapor collection system for 40 seconds (which may be approximate). In some embodiments, in 40 seconds (which may be approximate), the vapor G will be placed in the vapor collection unit, and the treated substrate P may discharged essentially free of oil or with an oil content suited for the end use of the treated substrate P, with a pH and water level which was predetermined for the end use.

The catalyst C may be the only component added to the mixer 50 which is an empirically determined value. The amounts of base B and acid A added to the mixer may be calculated using the computer processing system and software using heat requirements for the reactions. The amount of substrate S, base B, acid A, and other feed components to add to the mixer 50 to obtain the desired product P may be based on the component weight percents in and other properties of the sample 600 of the substrate feed F and/or the component weight percents in and other properties of the sample of the product. Additionally, whether the substrate S needs to be adjusted (e.g., in weight percent of components such as oil and water) may be determined by the samples. Adjustments may be made to the feed components to be added to the mixer 50 based on the analysis of one or both of the samples to achieve the desired product P.

The mixer 50 ultimately boils off oil and water using chemical heat. A heat of solution and heat of reaction results when base B is added to the substrate feed F and then when acid A is added to the base B and feed F solution. When the base B and acid A react together, it gives off heat. The heat requirement is approximately equal to the chemical requirement in the reactor 50, as shown by the following equation:

ΔH_{SENS}+ΔH_{LATENT}≈ΔH_{RXNS},

where ΔH_{SENS} is of all of the components and products and byproducts, ΔH_{LATENT} is the heat of vaporization of oil and water, and ΔH_{RXNS} is the solution heat plus acid/base reaction, and where ΔH_{SENS}+ΔH_{LATENT} represent the heat requirement and ΔH_{RXNS} represents the chemical requirement.

A reaction temperature in the mixer 50 may be in a range from 270° F. to 500° F. in some embodiments, and reaction temperature in the mixer 50 may be in a range from 270° F. to 400° F. (values may be approximate) in some embodiments. Water may be boiled off at 270° F., while oil or diesel may be boiled off at 300° F.

In some exemplary embodiments, the amount of catalyst C (which may be calcium chloride, for example) which may be mixed with the substrate S, for example in the reactor 50, may be 0 to 50 parts by weight per 100 parts of substrate S based on the water and oil level of substrate (amounts may be approximate).

In some exemplary embodiments, the base B (and/or catalyst C) may be mixed with the substrate S, for example in the mixer 50, in a rate of from 1 to 70 parts by weight per 100 parts of substrate S (amounts may be approximate).

In some exemplary embodiments, the amount of acid A (which may be a mineral acid, for example) which may be mixed with the substrate S, for example in the reactor 50, may be from 1 to 70 parts by weight per 100 parts of substrate S (amounts may be approximate).

In an exemplary embodiment, the ratio of weight percent acid A added to the mixer 50 to the weight percent base B added to the mixer 50 is approximately 173% to make sure that all of the base B and acid A are consumed. The pH of the dry product may be manipulated by adjusting the ratio of acid A to base B fed to the mixer 50.

In an example which is not limiting of embodiments, each batch in the mixer 50 may include from approximately 25 pounds to approximately 700 pounds of base B (CaO), from approximately 25 pounds to approximately 750 pounds of acid A (H₂SO₄), and/or from 0 to approximately 100 pounds of catalyst (CaCl₂).

In some embodiments, the more water and oil that exists in the reactor 50, the more base B and acid A is needed in the reactor 50. In general, with a lower amount (lower weight percent) of water than oil in the mixer 50, less chemicals (base B, acid A, etc.) are used in the mixer 50, making the system and method less expensive, because the heat requirement is much higher to boil off the water than the oil (water boils off faster than oil). (Although it is counterintuitive, as water has a lower boiling point than oil but boils off faster than oil.) Therefore, in some embodiments, a higher amount (higher weight percent) of oil than water may be advantageous. It may be advantageous in some embodiments to provide the minimum water amount in the feed to the mixer 50 for efficiency and low cost of the method of embodiments. Adding base B and acid A into the mixer 50 changes the boiling point of the water and keeps it in solution longer.

When the reactions take place in the mixer 50, the reactor 50 should be sealed and may operate under a positive pressure of up to approximately 5 psi. The reactor 50 may be sealed when all of the valves and doors which allow access into the mixer 50 are closed.

In some embodiments, the temperature of the sludge in the mixer 50 may range from approximately 210° F. to approximately 500° F. after both reactions. Two temperatures in the mixer 50 include the temperature of the solid/liquid reaction and the temperature of the vapor. The vapor temperature in the mixer is related to oil and water content and pressure in the mixer, so that the higher the percentage of oil is the water the higher the temperature of the vapor. In an example, the solid reaction product or treated material P may be approximately 200° F. upon its exit from the mixer 50.

Under ideal conditions, the mixture in the mixer 50 may never become acidic, and even after the acid A is added to the mixture, the pH of the mixture may remain basic or generally neutral, in some examples the mixture ranging in pH from 7 to 10 (may be approximate) after the acid A is added.

The mixer 50 operation creates a clay lining in the mixer 50, serving as insulation so that the mixer 50 may reach a constant heat. The clay lining may help the mixer internal chamber retain heat for approximately 30 minutes to approximately 120 minutes, for example.

The mixer 50 outputs two separate products, a generally dry reaction product P and a fluid in vapor or gas form G. The (generally) solid reaction product P, which may be termed “dry solids” or “dry material,” is recovered from the mixer 50 after the addition and mixing in the mixer 50 of the substrate S, optional water W and/or surfactant T, base B and/or catalyst C, and acid A. In some embodiments, the mixer 50 is cooled down prior to discharge of the product P. The product P may be a dry, powder-like material that may include gypsum, rock(s), dirt, salt, and/or shale, as well as residual water and/or oil. The product may include gypsum or activated clay. In some examples, it is a goal for the final product P to be generally neutral or slightly basic, but the pH of the product P depends upon its use or disposal and the pH needed for those applications, e.g., the type of soil. The product P may be sold and may be used in paving or as a fertilizer, to firm up soil and make concrete, or in any other application, or it may instead be sent to a landfill.

The product P may be delivered from the mixer 50 gravitationally, e.g., out of the bottom of the mixer 50, in some embodiments, and the gas G may exit the mixer 50 through an overhead vent. The product P may exit or discharge from the mixer 50 through the open mixer discharge doors 140 (which may be opened and/or closed by the piston/cylinder assembly 130) into or onto one or more mixer discharge conveyors 66 and may be transported on the conveyors to dry storage or to another location, or may be sent for further treatment. The one or more conveyors 66 may be any material handling device and may include one or more screw conveyors, augers, drag conveyors, and/or pneumatic pumps. In some embodiments, the dry product P may be discharged out the bottom of the mixer 50. In one example which is not limiting of embodiments, an angle of repose of the product P from the system may be 52 degrees (may be approximate).

The dry material P may in some examples be either placed in a pile; placed in a storage unit, possibly compacted, and reloaded once sold, e.g., with a wheel loader; or placed into a bulk overhead silo and handled as fly ash with a pneumatic trailer. In some examples, a swing arm conveyor may transport the dry material P from the mixer 50 to a main storage covered pile and another conveyor may transport dry material P to loadout boxes, trucks, or other storage or transport devices. In some examples, a front end loader to roll out box may be used for the dry material P transporting from the mixer 50.

A sample of the product P may be taken, for example using a retort, to reveal the oil and water weight percent in the product P. The solids weight percent may be calculated after the oil and water weight percents in the product P are known. This sample or retort may be taken to determine if the product P meets the specifications for the desired end product. The product P, in some embodiments, is essentially oil-free with a pH which was set at a predetermined level. Although the weight percent of oil or hydrocarbons in the product P may be lower than one percent with the process described herein, and may be 0.6 percent or lower in some embodiments or 0.5 percent or lower in some embodiments, the desired specifications of the product P and desired end use ultimately determine what the target weight percent (or range of weight percents) of oil or hydrocarbons in the product P will be. The system and method of embodiments permit these very low percentages of oil to be achieved if desired. The product P is generally dry solids, including rocks, dirt, shale, and/or gypsum and may include residual water and/or oil.

In some examples, water may need to be added to the product P after it is discharged from the mixer 50, for example for transport purposes or for other specifications of the product P needed for end use of the product P. Any water source may be used for adding water, including gray water from the gray water tank 144 or other water from the system.

In addition to the dry product P, gas G or vapor generated in the mixer 50 is vented from the mixer 50. It may be vented from the mixer 50 continuously or semi-continuously in some embodiments. Optionally, the mixer 50 may include a damper to allow the mixer 50 to reach positive pressure and to limit fresh air coming into the mixer 50 so that the reaction in the mixer 50 is not hindered. In some embodiments, a manifold may discharge the vapor/steam G from the mixer 50.

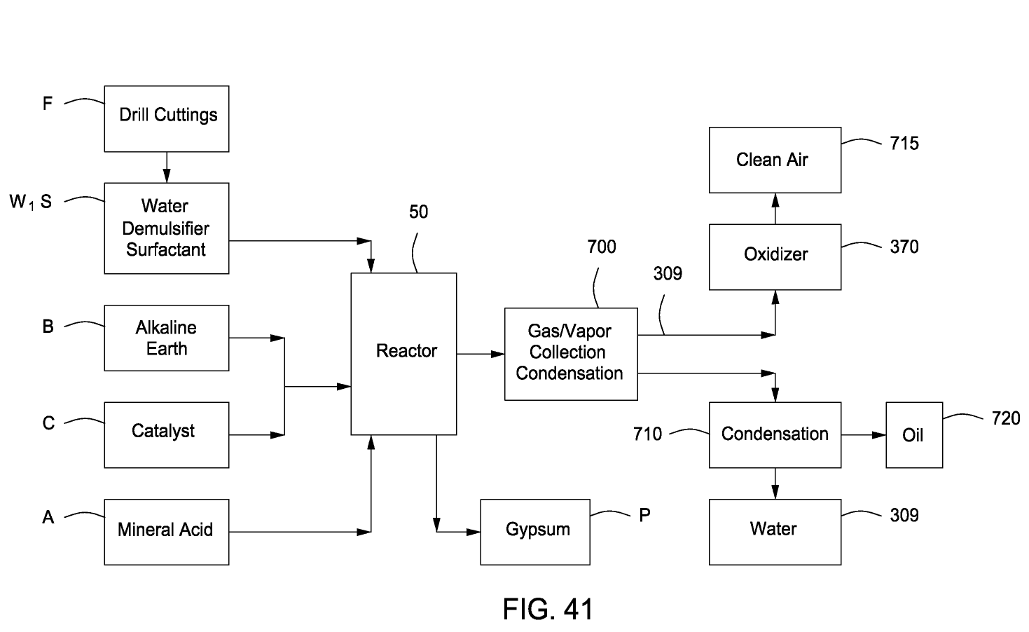

Using the gas collection and recovery system, the vapor or gas G generated from the mixer 50 may be condensed, and the non-condensed gases may be exhausted to the atmosphere. The condensed vapor may then be delivered to the clean oil/water separator. FIG. 41 is a flow chart overview of an embodiment of the reactor 50, the components that feed into the reactor 50 and the components that exit the reactor 50, and the gas/vapor collection and condensation portion 700. The components that fed into the reactor 50 may be the substrate feed F (which may include drill cuttings), the water demulsifier W and/or surfactant T, the base B and the optional catalyst C (which are shown mixed together prior to their entry into the reactor 50), and the acid A. The gas/vapor collection and condensation portion 700 may include condensation 710, resulting in water 309 and oil 720 streams as well as non-condensed gases 309, and optional oxidizing, e.g., via a thermal oxidizer 370, which may clean the non-condensed gases 309, to produce clean air 715 which may be exhausted to the atmosphere.

FIG. 36 shows an embodiment of the gas (or vapor) collection and recovery system in more detail. The scrubber of the gas collection and recovery system may include the Venturi 305, packed column 320, oil/water separator 315, and the cooling device 330 such as a chiller. Vapor or gas G, which is in the gas phase and may contain oil and water which was boiled off in the mixer 50, from the mixer 50 may flow into the Venturi scrubber 305. Prior to the gas G flowing into the Venturi scrubber 305, temperature and pressure may be measured, for example via one or more temperature measuring devices or indicators 301 and one or more pressure measuring devices or pressure indicators 302. The temperature of the gas G flowing into the Venturi 305 may in one embodiment range from 325-450 (° F.) degrees Fahrenheit (values may be approximate). Recirculating water 725 from the gas collection and recovery system or another water source may be added to the Venturi scrubber 305 through the Venturi piping system which may be located at the top of the Venturi 305. One or more flow measuring devices 307 (e.g., one or more flow meters) for measuring water stream 725 flow and one or more valves 306 for selectively allowing flow of water 725 into the Venturi 305 may be included with the water stream 725 and its piping. Flow into the Venturi 305 in some examples may be 200 gallons per minute (value may be approximate).

The Venturi 305 may condense some or all of the condensable portion of the gas G. The Venturi 305 speeds up the flow of the gas G, and evaporation cools down the gas and condenses it. The Venturi 305 forces water to contact with the gas G and chills at the same time, with a goal to chill the fastest and most efficiently as possible. Along with cooling off the gas G, the Venturi 305 also helps remove particulate from the gas G before it reaches the packed column 320. Vortexes are created in the Venturi 305. Flow in the Venturi scrubber 305 increases at the vortex, in some embodiments to 250-300 feet per second (values may be approximate). The Venturi 305 should be made to a certain vortex to provide the desired condensation of the gas G.

A two-phase stream 321 exits from the Venturi scrubber 305 and may enter the packed tower 320 at or near the bottom of the packed tower 320, e.g., below the packing 325 in the packed tower 320. One or more temperature measuring devices or indicators 322 may be included with the piping through which the two-phase stream 321 travels to measure the temperature of the stream 322. In some embodiments, the stream 321 entering the packed tower 320 ranges between 200-250 degrees Fahrenheit (° F.) (these values may be approximate). The gas in the two-phase stream 321 rises up through the packing material in the packed tower 320 to be contacted by the water 371 distributed by the water distribution system in the packed column 320.

Recirculating water 371 from the gas collection and recovery system or another water source may be added to the packed tower 320 at or near the top of the packed tower 320 above the packing material 325 and used as the water injected in the water distribution system. One or more flow measuring devices 318 such as flow indicators may measure the flow rate of the water 371, and one or more valves 319 may be used to selectively deliver water 371 into the packed tower 320 by the valves selectively opening and closing. One or more temperature measuring devices or temperature indicators may also be included in the path with the water stream 371 to measure temperature of the stream 371, which in some embodiments should be less than 100 degrees Fahrenheit (° F.) for effective condensing.

The water distribution system may be used to distribute the water 371 entering the packed column 320 within the packed column 320, for example using the water distribution spout 355 (e.g., a showerhead). The spout 355 may distribute the water 371 downward and outward from the spout 355 into the packed tower 320, for example injecting water 371 in a circle. In one embodiment which is merely exemplary, the water distribution device 355 may be a big showerhead which may shoot water out at approximately 600 gallons per hour. The water 371 in the packed tower 320 is contacted with the two-phase stream 321 in the packed tower 320 to condense some or all of the condensable portions of the gas in the two-phase stream 321. One or more level measuring devices or level indicators 341 may be disposed below the packing material 325 in the packed tower 320 to indicate the level of liquids existing at the bottom of the packed column 320.

The Venturi 305 and packed column 320 or packed tower work together to condense the condensable portion of the gas G. Although they are shown as two separate pieces of equipment, in an alternate embodiment the Venturi 305 and packed column 320 may be included in one piece of equipment.

Noncondensable gases 329, which may include noncondensable residual water vapor and oil vapor, as well as some particulate matter, exit from the packed tower 320, for example at or near the top of the packed tower 320, and condensable stream 339, which may contain water, oil, and/or solid and/or particulates, may exit from a lower end of the packed tower 320. One or more temperature measuring devices or temperature indicators 326 may be used to determine the temperature of the gases 329 exiting the packed column 320. In some embodiments, the temperature of the gases 329 exiting the packed column 320 may be approximately 100° F. One or more pumping mechanisms such as one or more pumps 327 may be used to pump the gas 329 either directly into the atmosphere or into pollution control equipment such as one or more thermal oxidizers 370. The system may include an induced draft (ID) fan 328 or centrifugal blower for treating the gas stream 329. The ID fan(s) 328 may be used to create a suction if needed.

Optionally, an additional scrubbing may be performed on gas 329 after the ID fan 328, but before the thermal oxidizer 370, to capture the “lights,” for example via one or more optional scrubbers.

Pollution control equipment such as a thermal oxidizer 370 may optionally be included in the system to treat the noncondensables or noncondensable gases 329 which exit from the packed tower 320. The pollution control equipment may be used to remove or destroy hazardous air pollutants and volatile organic compounds (VOCs) in the gas stream 329. Any thermal oxidizer or other pollution control equipment for treating gas to allow its release to the atmosphere which is known to those skilled in the art may be used as the pollution control equipment of embodiments.

The stream 339 exiting from the packed tower 320 may include water, oil, and solid particulates. One or more pumping mechanisms such as one or more pumps 342 may be used to pump the stream 339, and one or more level controls 340 such as one or more level control valves may provide level control in the packed column 320 based on the level in the packed tower 320, as measured by the level indicator 341. One or more temperature measuring devices or temperature indicators may be used to measure the temperature of the stream 339. In some embodiments, the temperature of the stream 339 may be around 200° F.

Optionally, filtration 335 or cyclonic separation may be performed on the stream 339 to filter out solids from the stream 339. Filtration 335 may be performed by any device capable of filtering out solids from a stream. In one example, the filtration 335 may be performed by one or more cyclones, one or more hydrocyclones, or any other device which uses centrifugal force to remove the solids from a stream. In another example, the filtration 335 may be performed by a self-purging filter which collects solids on the outside of the screen and has scrapers to push the solids down. In yet another example, filtration 335 may be performed by one or more gravitational separation tanks.

Solids 336 which are filtered out of the stream 339 by filtration may optionally be sent to the mixer 50 as part of the substrate feed. Stream 334 which exits from the filtration unit 335 may contain oil, water, and possibly some sludge. Stream 334 may flow into one or more cooling devices 330 for cooling of the stream 334, for example decreasing the temperature of the stream 334 to approximately 100° F. to approximately 125° F. Cooled stream 331 exits from the one or more cooling devices 330, for example at a temperature ranging from 100° F. to 125° F. (values may be approximate). In some embodiments, the cooling device 330 may reduce the temperature of the stream 334 to at or below ambient temperature. Temperature of the cooled stream 331 may be measured using one or more temperature measuring devices 332 such as one or more temperature indicators.

The cooled stream 331 may enter into the clean oil/water separator 315, which may separate the oil and water by gravity. One example of a clean oil/water separator 315 is shown in FIG. 36. The clean oil/water separator 315 separates the oil and water from one another using level control of the oil and water. A level indicator or level control 350 measures and indicates the level of the oil 352 and the level of the water 351. The level control 350 communicates with one or more pumping mechanisms such as one or more pumps 316, which may be a diaphragm pump, which selectively pumps the oil stream 720 exiting the separator 315 based on the level of oil 352 in the oil/water separator 315. The pump 316 turns on and off based on the oil level in the oil/water separator 315. Similarly, the level control 350 communicates with one or more valves 310 or other mechanisms for selectively allowing water flow therethrough, and the one or more valves 310 are selectively opened and closed based on the water level 351 in the clean oil/water separator 315. When the water reaches a certain level in the clean oil/water separator 315, the valve(s) 310 take off water from the separator 315. The oil/water separator 315 uses the density difference between oil and water and the residence time to separate the oil and water from one another. There may be a huge flow rate through the clean oil/water separator 315 in some embodiments, and flow through the oil/water separator 315 may be continuous. There is an area in the oil/water separator 315 tank where the oil floats off the top into a troph or weir where oil is collected.

Exiting the clean oil/water separator 315 may be a water stream 317, oil stream 720, and a sludge stream 333. The sludge 333 may be recirculated to the mixer 50 for further treatment as a portion of the substrate. The recovered oil 720 may be selectively pumped off by the pump 316 for disposal, sale, further treatment, or recirculation to any part of the system, or may be pumped to the oil tank 135 for possible reuse or further recirculation in the system, sale, further treatment, or disposal.

The water stream 317 may be pumped by one or more pumping mechanisms such as one or more pumps 312 to one or more locations. In one embodiment, shown in FIG. 36, a first portion of the water 317 exiting from the clean oil/water separator 315, including wastewater stream 309, may be sent to the gray water tank 144 or to any other portion of the system (or may be sold, treated, or disposed of), and a second portion of the water 317 exiting from the clean oil/water separator 315, including recirculating water 308, may be recirculated into the gas collection and recovery system and used to help condense the condensable gases. One or more temperature measuring devices such as one or more temperature indicators 311 may be used with stream 317 to measure the temperature of the water stream 317 exiting the clean oil/water separator 315. The water stream 309, if sent to the gray water tank 144, may be used as shown and described in relation to FIG. 34.

The recirculating water 308 may be split into a first recirculating water stream 725 for flow into the Venturi scrubber 305 and a second recirculating water stream 371 for flow into the packed tower 320. In an example which is not limiting of embodiments, approximately 25 percent of the recirculating water stream 308 may be used for first recirculating water stream 725 and approximately 75 percent of the recirculating water stream 308 may be used for second recirculating water stream 371.

One of the reasons that providing sufficient water in the mixer 50 is important is because the water is used as a travel agent to move water to the scrubber.

Ultimately, the substrate feed F, which may include in some embodiments approximately 20 percent oil, may be treated in the system and method of embodiments to produce a product P having 0.5 percent of oil or less.

Optionally, the system may be placed on the floor of a body of water, for example in offshore drilling rig situations.

The streams 140, 653, and 655 of FIG. 35 may be added directly to the mixer 50 or to the mixer hopper 30 instead of to the location shown in FIG. 35.

The mixer motor(s) may be, for example, one or more standard induction motors from Marathon Electric Mfg. Corp. of Wausau, Wis. The gearbox(es) for the mixer motor(s) may be, for example, one or more Dodge Torque-Arm Speed Reducers, straight bore and taper bushed, from Dodge Electric Products (Rockwell Automation, corporate headquarters of Milwaukee, Wis.). The safety cover switch(es) for the mixer may be, for example, one or more CM Series Safety, Technology and Innovation (STI) safety switches from Omron Scientific Technologies, Inc. of Fremont, Calif. Solenoid valve(s) of the mixer may be, for example, one or more Parker pneumatic ⅜-inch Valvair II/A4/A5 Series and ½-inch SK200 subbases and manifolds and/or ⅜-inch Valvair II/A4 Series Valves Single Operated from Parker Pneumatic, Pneumatic Division North America in Richland, Mich. The one or more belt drives of the mixer may be, for example, one or more V-Belt Drives from TB Wood's Incorporated, an Altra Industrial Motion Company, of Chambersburg, Pa. One or more lubricators, filters, and/or regulators may be, for example, Model Velox #3 used to lubricate the mixer, ¼-inch and ⅜-inch 15 L economy, ¼-inch, ⅜-inch, ½-inch 06 L, 16 L compact, ⅜-inch, ½-inch and ¾-inch 07 L, 17 L standard mist and/or micromist lubricators, and ¼-inch and ⅜-inch economy, ¼-inch and ⅜-inch precision, ¼-inch, ⅜-inch, ½-inch compact, ⅜-inch, ½-inch, and ¾-inch standard, and/or ¾-inch, 1-inch, 1¼-inch, and 1½-inch hi-flow regulators from Parker Pneumatic, Pneumatic Division North America in Richland, Mich. The one or more load cells for the mixer may be, for example, a Paramounts Weight Module Kit from Rice Lake Weighing Systems of Rice Lake, Wis. for mounting SB4/SB10/SB5 load cells to the mixer and SB4/SB10/SB5 load cells (this weight module kit/load cells may also be used for the other locations in the system which employ one or more weighing devices or load cells).

The batchplant may include, for example, one or more Magnetoflow mag meters, Model 7500P meter, from BadgerMeter, Inc. of Milwaukee, Wis. and Tulsa, Oklahoma, which could be used as the flow meter(s) in any location in the system employing a flow meter, including as the flow meter for the acid which may be located under the mixer. The one or more pumps in the system may be, for example, one or more TM4, TM6, and/or TM10 Mag Drive centrifuge pumps, which may be ½ through 5 horsepower pumps, for example HH-01209-054, Serial Number 3884-11, from Wilden Pump & Engineering, LLC, a Dover Company, of Grand Terrace, Calif. The shaker may be, for example, a FSI Series 5000 Model B4 single deck linear shaker from Fluid Systems, Inc. of Houston, Tex. and Belle Chasse, La., including screen panels and permanently sealed vibrators. The shaker screen may also be, for example, from Fluid, Systems, Inc. of Houston, Tex. and Belle Chasse, La. One or more of the pumps in the system may be one or more air-operated, positive displacement, self-priming diaphragm pumps from Wilden Pump & Engineering, LLC, a Dover Company, of Grand Terrace, Calif. such as P4/PX4 original series metal pumps, e.g., HH 01209-056, Serial No. 3884-11. One or more of the meters in the system may be, for example, one or more model industrial RCDL nutating disc meters from BadgerMeter, Inc. of Milwaukee, Wis. and Tulsa, Okla., which may be used with the water pump and located under the mixer.

One or more air compressors in the system may be, for example, one or more QT and/or PLT Series 2-Stage Compressors from Quincy Compressor of Quincy, Ill., such as one or more QT Series Model QT-10 reciprocating compressors, e.g., HH-01038-016 Serial No. 3884-11. One or more butterfly valves and their accessories in the system, such as the butterfly valve(s) of the fluid (water and/or surfactant and/or acid) delivery system to the mixer 50 may be, for example, WAMGROUP or WAM S.p.A VFS, WAM S.p.A. being of Cavezzo, Italy. The one or more conveyors in the system may be one or more screw conveyors such as, for example, one or more mild steel screw feeder assemblies and mild steel screw conveyor assemblies from Martin Sprocket & Gear, Inc. Conveyor Division in Fort Worth, Tex. The one or more knife gate valves in the system which may be used to selectively permit and prevent material such as base B and catalyst C from entering the mixer 50, may be, for example, one or more DeZurik 2-3 6 inch KGC Knife Gate Valves from SPX Valves & Controls of Sartell, Minn., which may also have one or more DeZurik manual actuators for knife gate valves. The one or more cement silos (which may be used for storing the base B and catalyst C, in one embodiment one cement silo for the base B and one cement silo for the catalyst C) may be, for example, one or more Belgrade 200 Barrel Low-Profile Cement Silos, which may be portable, from Belgrade Steel Tank of Belgrade, Minn., e.g., HH-01415-197, Serial No. 3884-11, and which may also include one or more dust houses such as one or more “Belle” Style Dust Houses from Belgrade Steel Tank of Belgrade, Minn. and one or more turbines for vibration such as VIBCO pneumatic air turbine vibrators. One or more axles may be included for use with the system, for example, one or more 10,000-16,000 pound axles from Rockwell American.

Ultimately, the method of embodiments is for the treatment of drilling mud/cuttings to stabilize the solids and recover the hydrocarbons (e.g., diesel oil).

The system and method of embodiments may be used in other applications other than drilling fluid applications, including but not limited to removing oil or other contaminants from contaminated soil. The system and method of embodiments may be used in application for any oil-based or water-based material, either dry material (solids) converted to slurry or liquid converted to slurry, that needs gases separated from solids through heat or to control the pH of the material with or without heat.

Embodiments may include a system and method for treating an oil, water or oil and water substrate, comprising: (a) optionally admixing water and/or surfactant under a low shear to bind water to the oil-based substrate; (b) admixing under a low shear the substrate with a base, such as lime or a compound containing alkaline earth and catalyst, such as calcium chloride, for example for a few seconds (e.g., 15 to 60 seconds, which may be approximate), which creates a reaction resulting in a heat, having a pH which is controlled, adjustable, and manipulatable to what the end use of the dry material pH is desired or required; (c) admixing the admixture with an acid, organic or inorganic, which may be a mineral acid such as sulfuric acid, under low shear conditions in an amount effective to generate an exothermic reaction to vaporize the oil and reaction products thereof; and (d) recovering a solid reaction product which may be essentially oil free or may have an oil content which meets predetermined specifications of the solid reaction product with the pH set at a predetermined level. The pH may be preset or adjusted in the software or the processing system. In some embodiments, the substrate may be contaminated with oil or other hydrocarbons. In some embodiments, the substrate may include cuttings from one or more wellbores. In some embodiments, the surfactant may be inorganic or organic.

In some exemplary embodiments, the amount of catalyst C (which may be calcium chloride, for example) which may be mixed with the substrate S, for example in the reactor 50, may be 0 to 50 parts by weight per 100 parts of substrate S based on the water and oil level of substrate (amounts may be approximate).

In some exemplary embodiments, the base B (and/or catalyst C) may be mixed with the substrate S, for example in the mixer 50, in a rate of from 1 to 70 parts by weight per 100 parts of substrate S (amounts may be approximate).

In some exemplary embodiments, the amount of acid A (which may be a mineral acid, for example) which may be mixed with the substrate S, for example in the reactor 50, may be from 1 to 70 parts by weight per 100 parts of substrate S (amounts may be approximate).

Embodiments may include a computer processing system (computer processor) or software system that is developed to act as the thinking, calibration point, and time of delivery of all the components. The processing or software system may be activated by a series of weighing devices such as load cells or scales, flow meters, level indicators, and/or temperature sensors from which a signal is sent to the processing system (wirelessly or via one or more wires electrically connecting the series of weighing devices such as load cells or scales, flow meters, level indicators, and/or temperature sensors to the computer processing system). Once a signal is sent to the computer, the computer may respond to the signal by making the plant accomplish what the programming was designed to do.

Other embodiments may include a system and method for treating an oil, water, or oil and water substrate, comprising: (a) optionally admixing water and/or surfactant under a low shear to bind water to the oil-based substrate; (b) admixing under a low shear the substrate with a base, such as lime or a compound containing alkaline earth and catalyst for a few seconds (e.g., 15 to 60 seconds, which may be approximate) which creates a reaction resulting in a heat, having a pH which is controlled, adjustable, and manipulatable to what the end use of the dry material pH is desired or required; (c) admixing the admixture with an acid, organic or inorganic, which may be a mineral acid such as sulfuric acid, under low shear conditions in an amount effective to generate an exothermic reaction to vaporize the oil and reaction products thereof; (d) recovering a solid reaction product which may be essentially oil free or may have an oil content which meets predetermined specifications of the solid reaction product with the pH set at a predetermined level; and pulverizing the substrate prior to the admixing of step (b).

Other embodiments may include a system and method for treating an oil, water, or oil and water substrate, comprising: (a) optionally admixing water and/or surfactant under a low shear to bind water to the oil-based substrate; (b) admixing under a low shear the substrate with a base, such as lime or a compound containing alkaline earth and catalyst for a few seconds (e.g., 15 to 60 seconds, which may be approximate) which creates a reaction resulting in a heat, having a pH which is controlled, adjustable, and manipulatable to what the end use of the dry material pH is desired or required; (c) admixing the admixture with an acid, organic or inorganic, which may be a mineral acid such as sulfuric acid, under low shear conditions in an amount effective to generate an exothermic reaction to vaporize the oil and reaction products thereof; (d) recovering a solid reaction product which may be essentially oil free or may have an oil content which meets predetermined specifications of the solid reaction product with the pH set at a predetermined level; and (e) recovering vapor or gas generated from the mixer, condensing the recovered vapor or gas, and exhausting non-condensed gases to the atmosphere.

Other embodiments may include a method for treating a substrate which may contain oil, water, or oil and water, comprising continuously introducing the substrate into a mixer comprising a sealable container having two rotating shafts opposed from each other, which may be rotatable in opposite directions from one another, rotatable at a lower shear speed with specially designed paddles disposed on the shafts at a certain angle. Embodiments of this method may further include recovering vapor or gas generated from the mixer, scrubbing the recovered vapor or gas and exhausting non-condensed gases to a thermal oxidizer, and then exhausting clean air into the atmosphere.

Other embodiments may include a method for treating a substrate contaminated with oil, water, and/or oil and water, wherein the substrate may be introduced into one or more mixers, for example in an amount of approximately 16 tons per mixer per hour or even 6 to 22 tons per hour or more if multiple mixers are used (values may be approximate). The method may further include adding water, surfactant, or a mixture of water and surfactant, if required to obtain the desired product from the one or more mixers. The method may further include adding a base (e.g., alkaline earth-containing compound, lime, or calcium oxide), a catalyst (e.g., a salt or calcium chloride), or a mixture of base and catalyst to the one or more mixers, for example after adding the water, surfactant, or the mixture of water and surfactant to the one or more mixers. The method may further include after adding the base or the mixture of base and catalyst to the mixer, adding acid (for example, a mineral acid such as sulfuric acid) to the mixer. The acid may be added to the mixer second, after the base, in order to get the most effective reaction in the mixer and remove the most vapor from the mixer. The method may further include adding all feed components and mixing the feed components at a low shear action. In some embodiments, the method may further include recovering the vapor to form an exhaust stream of uncondensed vapor.

Further embodiments may include an apparatus for treating a substrate which may contain oil, water, or oil and water, comprising a mixer comprising a sealable container having two rotating shafts opposed from each other, which may be rotatable in opposite directions from one another, rotatable at a lower shear speed with specially designed paddles disposed on the shafts at a certain angle.

Further embodiments may include an apparatus for treating a substrate comprising oil, water, or a mixture of oil and water, comprising a mixer for mixing substrate, optional water and optional surfactant, one or more bases, one or more optional catalysts, and one or more acids together. In some embodiments, the one or more bases may include a lime, alkaline earth containing compound, or calcium oxide. In some embodiments, the one or more bases and the one or more optional catalysts may be stored in a base tank and an optional catalyst tank, if stored separately, or they may be stored in the same tank if premixed prior their entering the mixer. The base tank may include a charge of the one or more bases for batching the mixer. The optional catalyst tank may include a charge of the one or more catalysts for batching the mixer, if catalyst is needed. If the one or more bases and the one or more catalysts are premixed, a combined base and catalyst tank may include a charge of the base/catalyst mixture for batching the mixer. In some embodiments, the water may be charged with a pump and meter to allow the proper amount of water to be delivered into the mixture to reach the desired weight percent of water in the mixture. In some embodiments, the surfactant or water and surfactant may be delivered from a tank with a pump and meter to allow the proper amount of surfactant or water and surfactant to be delivered into the mixture to reach the desired weight percent of water in the mixture. In some embodiments, the acid may be stored in an acid tank, which may include a charge of acid and a meter with calculated weight to be added to the mixture. Optionally, the acid tank may be a mobile acid tank. Optionally, the base, catalyst, and/or base and catalyst mixture tank may be one or more mobile silos. Optionally, substrate may be stored in a mobile receiving bin prior to its mixture with the other components. In some embodiments, the apparatus may further comprise a scrubber comprising a venturi, a packed column, an oil/water separator for separating oil and water from one another, and a chiller. Optionally, the scrubber may be a mobile scrubber. The scrubber may be for treating the gas from the reaction of components.

Although a mixer 50 is shown and described herein as the equipment in which the reactions take place which transform the substrate S into the dry product P, any vessel, unit, or device which is capable of receiving, mixing, and allowing the needed reactions to take place with the substrate, base, acid, and optional other components (catalyst, water, and/or surfactant) may be used as the mixer of embodiments.

Embodiments relate to the treatment of oil-based, water-based, or a mixture of water and oil based substrates for environmentally acceptable use or disposal, and more particularly to sequential treatment of substrate with an optional organic demulsifier, a base, and an acidification agent for the purpose of rapidly removing the oil and/or water from the substrate to obtain a product essentially free of oil or a product which has oil content suitable for its end use.

Embodiments include a chemical oxidation/desorption semi-continuous feed system and method for treating or developing an oil-based, water-based, or oil and water-based substrate into something reusable for sale or for disposal. The substrate may be processed by mixing optional water, optional surfactant, a base (such as lime, calcium oxide, or a compound containing alkaline earth), an optional catalyst, and an acid such as a mineral acid under low shear mixing conditions. The process steps are strongly exothermic and generate two streams of gaseous products to quickly remove the oil and water from the oils substrate, for example in a residence time of approximately 15 to 60 seconds. Embodiments thus achieve very rapid and extensive oil removal (or removal of other liquid in the substrate), reliability, efficiency, and low costs with minimal energy consumption and may be fully automated to permit one to two persons to effectively operate the process.

One embodiment includes a method particularly well-suited for treating a substrate comprising oil-contaminated, water-contaminated, or oil- and water-contaminated solid for reuse, sale, or disposal. The method may include admixing or mixing the substrate with a base (such as lime, calcium oxide, or a compound containing alkaline earth) and possible optional catalyst (salt) to lower the pH, developing the first reactions, and then adding an acid such as a mineral acid to create the main reaction at a level and in an amount to place the pH in the dry product to the level needed for its intended use. The mixture may be blended under a low shear condition in an amount to generate an exotherm to vaporize the oil and water. A solid reaction product may be developed with essentially no oil content or with oil content suitable for its intended use. The system and method of embodiments is especially attractive for treatment of drill cuttings with oil-based drilling mud.

The base may be lime. In an example of embodiments, the base or lime may be mixed or admixed with the substrate in a proportion of from 0.07 to 60 parts by weight per 100 parts of the substrate, which values may be approximate. The catalyst may be calcium chloride.

The acid may be a mineral acid such as sulfuric acid. The mineral acid may be mixed or admixed with the base and substrate in a proportion of from 0.07 to 60 parts by weight per 100 parts of substrate, which values may be approximate.

The base may be added to the substrate first (before the acid is added) at the same time the catalyst is added and blended for short period of time, for example for a few seconds. The mineral acid may then be added and blended. The method may include recovering vapor generated from a reactor in which the blending of the substrate, base, and acid may occur, condensing the recovered vapor, and exhausting non-condensed clean gas to the atmosphere.

Other embodiments may include a method for treating a substrate contaminated with oil, water or oily water. The method may include (a) semi-continuously introducing the substrate into a reactor composing at least one rotating shaft; (b) optionally adding water with or without surfactant; (c) introducing a base such as lime, calcium oxide, or a compound including alkaline earth into the reactor and blending the base with the substrate and optional water with or without surfactant; and (d) introducing an acid such as a mineral acid into the reactor and blending the acid with the contents of the reactor. Although one rotating shaft in the reactor may be used, in some embodiments, two rotating shafts in the reactor produce better results. The embodiment may further include collecting gas from the reactor. Embodiments may further include running the gas through a venturi and into a packed column. Embodiments may further include sending condensed liquids from the gas into an oil/water separator to separate oil and water from one another. Further embodiments may include chilling the water from the oil/water separator with a chiller such as a fin fan, a heat exchanger, or a refrigerator and then returning the water to the packed column and venturi.

The equipment may be installed permanently or in portable units or modules for temporary applications. These units may be designed to modularly produce from 10 to 100 tons plus in a portable or permanent unit. These units offer fast setup and little down time with rig ups as fast as 6 hours. This equipment may include hoppers, tanks, feed meters, pumps, and/or power plants conveyors. The process may include semi-continuous feed of material, allowing all the material to meet and stop in one spot, thereby allowing a point to correct any issues before discharging the product from reactor. The process may be automatic so as to insure consistent, unitary process control, and the process may include computer processing equipment and/or software that will address problem areas in the process and may document each batch as well as the daily run and lifetime run of the process. The processing system and software may allow for remote access from anywhere in the world.

The method of embodiments may be semi-continuous or batch.

Following are some examples of equipment which may be used in the system of embodiments, which examples are not limiting of embodiments. The mixer 50 may be a twin shaft mixer complete with the following features: maximum filling capacity of 8,000 pounds or 81 cubic feet, whichever comes first; two right angle gear reducers (one per shaft) with oil bath lubrication; V-belt drive, standard shaft rotation speed of 27 revolutions per minute (RPM); 150 horsepower (hP), 460 volts (v), 3 pH, 60 hertz (Hz), 1800 RPM, total enclosed, fan cooled (TEFC) electric motors; 5 horsepower hydraulic power pack, 230/460 volt, 3 pH, 60 Hertz, 1800 RPM with emergency manual hand pump; replaceable ni-hard paddles, drum liners and side wiper blades; replaceable AR (grade of steel) steel side liners; air purge shaft seals; water distribution system; hydraulically operated discharge door with heavy duty rubber seal; hinged access covers with gasketing and safety switches; cover design for batcher and vent scrubber inlet/outlets; mixer mounted on load cells with summing box; mixer weight of 28,000 pounds; and gear reducers. A mixer stand which supports the mixer 50 may have the following features: platform complete with a 48-inch high stand; open-type grating; handrails with toeboard and ladder; platform constructed of bolted and welded structural seal; mixer platform approximately 36 inches wide walkway by 8 inches long on one side of the mixer; and skid mounted. Each of the weigh batchers (there may be two weigh batchers) may be a 21 cubic foot Concrete Plant Manufacturers Bureau (CPMB) rated capacity cement weigh batcher having the following features: 3/16-inch plate; pneumatically operated butterfly cement discharge valve with single solenoid valve and limit switch; suspended above the mixer by load cells for accurate weighing of materials; vibrator for complete cleanout; connected to the mixer by a canvas sock. The shale shaker may have the following features: 36 inches wide by 6 inches long; two (2) 1.5 horsepower, 460 volt, 3 phase, 60 hertz vibrators; adjustable screen angle; 8 tons per hour capacity; liquids drip tray; 750 gallon polyethylene liquids storage tank; and support stand with walkway and access ladder. The mixer feed conveyor, which may be a screw conveyor, may have the following features: flighting; mounting flanges; adjustable support to mixer; canvas connection to mixer; 230/460 volt, 3 pH, 60 Hertz, TEFC electric motor and gear reducer drive case; live bottom; 100 cubic foot receiving hopper; isolation gate at mixer; and supports. The acid, which may be sulfuric acid, pump and meter may have the following features: acid pump; stainless steel piping to mixer; Mag Flow meter with transmitter; batching valves; and 500-gallow polyethylene sulfuric acid storage tank.

Following are some examples of equipment which may be used in the system of embodiments, which examples are not limiting of embodiments. The receiving hopper with screw conveyors may have the following features: a 10-ton mounted aggregate hopper including a 3/16-inch plate with external stiffeners for an unobstructed cone section and structural supports and live bottom; a screw conveyor including flighting and 230/460 volt, 3 pH, 60 Hz, TEFC electric motor and gear reducer drive case; and an incline screw conveyor including flighting, mounting flanges, adjustable support to shale shaker, 230/460 volt, 3 pH, 60 Hz, TEFC electric motor and gear reducer drive case, skid mounted.

In an example which is not limiting of embodiments, Model E-250 batch control may include fully automatic sequential batching of materials with a programmable logic control (PLC); a color touch screen panel with all control switching functions including manual control, arranged in a screen layout convenient for an operator; sixteen total materials maximum and seven scales maximum; admixture or admix (which includes base B and calcium chloride C) batched concurrently; one start button to begin automatic sequence; one recycle switch for pre-weighing and batching admixes (sequentially by net weight and counts); up to 50 mix designs, depending on number of materials; and two scales. Materials may be weighed sequentially, by net weight; two of two materials batched by screw or gravity, by net weight; one water meter; four of four admixture; and prebatching of admix. The controls may include the following features: control powered by 120 volt alternating current (AC), 60 Hertz, single phase electric power (which may include dedicated power); National Electrical Manufacturers Association (NEMA) four control enclosure; all switchgear rated NEMA 4x; key locked power on-off selector switch; PLC; color touch screen, 15 inch for all manual and auto control functions; manual/auto selector; emergency stop switch located on control panel; touch screen start/stop switch for mixer; aggregate gate job control; automatic gate chatter if no flow is detected through batch gates; automatic material free fall correction; one cement silo low level indicator light; material inventories of mixer feed components batched in automatic; manual moisture compensation for all aggregates from 0-20 percent; over/under weight checks; pre-weight of mixer feed components; load size selection anywhere from 0.35 yards to 3 yards; batched material weight tolerances in percent; tolerance band for each scale; full digital calibration of scales; shielded signal cable (summing junction box to control); individual discharge gate limit switch inputs; required motor status displays; required motor controls; watchdogs; error messages; scale status displays; mixer cycle information; mixer load information; batch load information; printing of mix design and inventory; control able to switch between metric and U.S. standard measurement; recordation module which may have the features of license and software for Allen Bradley RSLinx Classic Single Node OPC Server tool, recordation software module, and ability to load and install software; remote access module which may have the features of remote troubleshooting capability between job site and Manufacturing Solutions International (MSI), LogMein remote control software, license and software for Allen Bradley RSLogix 500 programming tool, license and software for CTC Interact Xpress HMI programming tool, ability to load and install software; and capability of operating with high speed/Ethernet connection on a computer such as a personal computer (PC),

Following are some examples of equipment which may be used in the system of embodiments, which examples are not limiting of embodiments. A multi-motor starter panel may have the following features: 480-volt multi-motor starter panel, mixer motor starter—soft start, screw conveyor motor starters, sulfuric acid pump motor starter, and shale shaker motor starter. Motor starters may include the following: one control transformer, one fusible disconnect switch, one NEMA 4 control box with back panel, power distribution blocks, and control wiring run to marked terminal strip. Pre-wiring of components may include the following: fiberglass NEMA 4x junction box mounted on the batchers (if removed for shipment), batcher solenoid and limit switches wired and factory set, belt conveyor safety switches and warning horn wired and factory set including pre-wiring of conveyor electric drive motor, mixer safety switches and warning horn wired and factory set including pre-wiring of mixer electric drive motor, pre-wiring on skid assembled portions, pre-wired solenoid valves and limit switches, and load cells pre-wired into a junction box.

Following are some examples of optional equipment which may be used in the system of embodiments, which examples are not limiting of embodiments. A cement silo which may be low profile portable may have the following features: 200 barrel capacity (800 cubic foot) portable low profile cement silo, legal 8 foot six inches diameter by legal 13 foot six inches height, 26 feet overall length, and 7 inch carry up screw standard, 5 horsepower gear box drive, jamgate on each hopper, two 6,000 pound axles with wheels and tires, electric brakes and lights, belle 150 square foot dust house with air vibrator, and 8,000-pound weight. A bag breaker with hopper may have the following features: 6-inch diameter screw conveyor with bag breaker hopper complete with helicoid flighting; mounting flanges; adjustable support to weigh batchers; canvas connection to weigh batchers; 230/460 volt, 3 pH, 60 hertz, TEFC electric motor and gear reducer drive case; and drive mounted on the inlet end of the screw conveyor. An air compressor, which may be a two-stage air compressor, may have the following features: tank mounted reciprocating compressor; 120 gallon tank; 35.2 cubic feet per minute (CFM) at 125 pounds per square inch (psi); start-stop control; 10 horsepower (hP), 230/460 volt, 3 pH, 60 hertz (Hz), 1800 revolutions per minute (RPM), electric motor; 7.3 full load amps (FLA) at 460 volts; automatic pressure switch that stops and starts by itself to keep a pre-determined pressure in the reservoir; pressure gauge; American Society of Mechanical Engineers (ASME) approved safety valve; discharge air valve; intake filter silencer; drain valve; refrigerated dryer complete with 115 v/60 Hz electronic and auto float draining; motor starter, pre-wiring, and pre-plumbed.

In reference to FIGS. 3A-D and 4A-C, in some examples which are not limiting of embodiments, the mixer 50 may be a twin shaft mixer complete with the following features (all values may be approximate): 30 cubic feet (1.11 cubic yard) or 3500 pounds, whichever comes first, input capacity; two (2) shaft mounted gear boxes (one per shaft); timing gears located on non-drive end; two (2) 20 horsepower (HP), 460 volts (V), 3 PH, 60 Hertz (Hz), 1800 revolutions per minute (RPM), totally enclosed, fan cooled (TEFC) electric motors; shaft rotation speed of 72 RPM; replaceable hard drum liners, wiper blades and mixing paddles; all replaceable (AR) steel side liners; secondary seals on main shaft, (center all type (CAT) seal type with grease purge); acid distribution system—rectangular tubing with round holes for acid discharge; two (2) air operated bottom discharge doors; two (2) cleanout doors on each side; hinged access covers with gasketing and safety switches; cover design for batcher and vent scrubber inlets/outlets; mixer mounted on load cells with summing box; mixer weight 7,150 pounds (lbs.) (of dead load); pneumatic isolation valve between mixer and batcher; and temperature sensor. Also in some examples which are not limiting of embodiments, the mixer discharge conveyor 66 may be a screw conveyor complete with the following features (all values may be approximate): flighting; mounting flanges; 230/460 V, 3 PH, 60 Hz, TEFC electric motor and gear reducer drive case; and supports. Also in some examples which are not limiting of embodiments, the mixer stand with cleanout platform may be a platform complete with the following features (all values may be approximate): 12 inch high stand; open type grating; handrails with toeboard and ladder; stand supports the mixer; platform is constructed of bolted and welded structural steel; mixer platform is approximately 30 inches wide walkway on two (2) sides of the mixer; and skid mounted. Also in some examples which are not limiting of embodiments, the cement weigh batcher 19 may be two, 15 cubic feet CPMB rated capacity cement weigh batchers complete with the following features (all values may be approximate): made of 3/16 inch plate; pneumatically operated butterfly cement discharge valve with single solenoid valve and limit switch; suspended above the mixer by load cells for accurate weighing of materials; vibrator for complete cleanout; and connected to the mixer by a canvas sock. Also in some examples which are not limiting of embodiments, the shale shaker 20 may be complete with the following features (all values may be approximate): 42 inches wide×9 feet long; two (2) 460 Volt, 3 Phase (PH), 60 Hertz vibrators; adjustable screen angle, (4 screens); 6 ton per hour capacity; liquids drip tray; catch tank—350 gallon; support stand with walkway and access ladder; tank high and low level probes; and air operated pump at bottom for discharge. Also in some examples which are not limiting of embodiments, the mixer feed conveyor 35 may be a screw conveyor complete with the following features (all values may be approximate): flighting; mounting flanges; adjustable support to mixer; canvas connection to mixer; 230/460 V, 3 PH, 50 HZ, TEFC electric motor and gear reducer drive case; live bottom; 80 cubic feet (Cu. Ft.) receiving hopper; isolation gate at mixer; and supports. Also in some examples which are not limiting of embodiments, the acid (e.g., sulfuric acid) pump 56 and the acid feed to the mixer may include the following features (all values may be approximate): stainless steel piping to mixer; mag flow meter with transmitter; batching valves; and 500 gallon polyethylene sulfuric acid storage tank. In some examples which are not limiting of embodiments, the receiving hopper 10 with screw conveyors may include the following features (all values may be approximate): one 10-ton mounted aggregate hopper including 3/16 inch plate with external stiffeners for an unobstructed cone section and structural supports, removable top grizzley (1-inch openings), live bottom, and manual air operated vibrator; screw conveyor complete with flighting and 230/460 V, 3 PH, 60 Hz, TEFC electric motor and gear reducer drive case; and incline screw conveyor complete with flighting, mounting flanges, adjustable support to shale shaker, 230/460 V, 3 PH, 60 Hz, TEFC electric motor and gear reducer drive case, and skid mounted. In some examples which are not limiting of embodiments, the batch control may include the following features (all values may be approximate); Model E-350 batch control with fully automatic sequential batching of materials with a programmable logic controller (PLC), the control featuring a color touch screen panel with all control switching functions including manual control, arranged in a convenient screen layout for the operator; the materials may be batched concurrently; one start motion to begin automatic sequence; one recycle switch for pre-weighing materials and batching admixes (sequentially by net weight and counts); up to 50 mix designs, depends on number of materials; two (2) scales; materials including 2 of 2 materials, weighed sequentially, by net weight, one acid meter, admixture, pre-batching of materials; controls including control powered by 120 volt alternating current (AC), 60 hertz, single phase electric power (dedicated power is recommended), NEMA 4 control enclosure, all switch gear rated NEMA 4X, key locked power on-off selector switch, programmable logic controller (PLC), manual/auto selection, emergency stop switch located on control panel, automatic gate chatter if no flow is detected through batch gate, automatic material free fall correction, one cement silo low level indicator light, material inventories batched in automatic, over/under weight checks, pre-weigh of materials, load size selection anywhere from 0.25 to 3 yards, batched material weight tolerances in percent, tolerance band for each scale, full digital calibration of scales, shielded signal cable (summing junction box to control), individual discharge gate limit switch inputs, required motor status displays, required motor controls, watchdogs, error messages, scale status displays, mixer cycle information, mixer load information, batch load information, printing of mix design and inventory, and control able to switch between metric and US standard measurement. In some examples which are not limiting of embodiments, the recordation module of the controls may include the following features (all values may be approximate): license and software for Allen Bradley RSLinx classic single node OPC server tool, recordation software module. In some examples which are not limiting of embodiments, the remote access module of the controls may include the following features (all values may be approximate): remote troubleshooting capability between job site and Manufacturing Solutions International (MSI), Logmein remote control software, license and software for Allen Bradley RSLogix 500 programming tool, license and software for CTC interact Xpress HMI programming tool, loading and installation of software, high speed/Ethernet connection on computer, and computer moveable up to 25 feet from main control on skid. In some examples which are not limiting of embodiments, the skid mount starter panel, which may be pre-wired, may include the following features (all values may be approximate): pre-wiring of plant components including fiberglass NEMA 4X junction box mounted on the cement and water batcher (if removed for shipment), all cement batcher solenoid and limit switches wired and factory set, all belt conveyor safety switches and warning horn wired and factory set, pre-wiring of conveyor electric drive motor, all aggregate bin solenoid valves wired and factory set, all mixer safety switches and warning horn wired and factory set, pre-wiring of mixer electric drive motor, pre-wiring on skid assembled portions only, solenoid valves and limit switches pre-wired, load cells already pre-wired into a junction box; the 480 volt multi motor starter panel may include mixer motor starters, screw conveyor motor starters, sulfuric acid pump motor starter, shale shaker motor starter, and reversing starter for feed hopper screw conveyor; motor starters may include one (1) control transformer, one (1) fusible disconnect switch, one (1) NEMA 4 control box with back panel, power distribution blocks, includes all control wiring run to marked terminal strip, all parts and labor included for assembling starter panel, and may only includes M.S.I. supplied motors; and plant skid mount including structural steel support system, easy loading and unloading, convenient foundation installation, equipment pre-assembled, and provides faster installation time. In some examples which are not limiting of embodiments, the cement silos may be two low profile portable silos which may include the following features (all values may be approximate): 300 Barrel Capacity (1200 cubic feet); legal 8 feet 6 inches diameter×legal 13 feet 6 inches height; 38 feet over-all length; 7 inch cross screw, 9 inch carry up screw; 5 HP and 15 HP gear box drives; jamgate on each hopper; 10,000 axles with dual wheels and electric brakes; 5^{th} wheel trailer and lights; Belle 150 square feet dust house; weight 15,000 pounds; and low level probe. In some examples which are not limiting of embodiments, the air compressor may include a two-stage air compressor with the following features (all values may be approximate): tank mounted reciprocating compressor; 80 gallon tank; 51.5 CFM at 125 PSI; start-stop control; 230/460 V, 3 PH, 60 HZ, 1800 RPM electric motor 7.3 FLA at 460 V; automatic pressure switch that stops and starts by itself to keep a pre-determined pressure in the reservoir; pressure gauge; ASME approved safety valve; discharge air valve; intake filter silencer; drain valve; and dryer. In some examples which are not limiting of embodiments, the water meter system, which may add water directly into the mixer, may include the following features (all values may be approximate): a centrifugal pump 1 HP, 230/460 V, 3 PH, 60 HZ; water meter with transmitter; batching butterfly valve, hose to mixer; motor starter and programming; and suction hose and water tank to pump. In some examples which are not limiting of embodiments, the system may include one multi-motor starter panel (one (1)×460 V, 3 PH, 305 AMP minimum service) for the following motors: mixer motor—two 20 HP each; receiving hopper screw conveyor—10 HP (reversing); shale shaker feed screw conveyor—10 HP; mixer feed screw conveyor—25 HP; shale shaker—two—2.28 HP each; acid pump—3 HP; silo horizontal screw—2X—5 HP each; silo incline screw—2X—15 HP each; compressor motor—10 HP; and silo blower motor—10 HP.

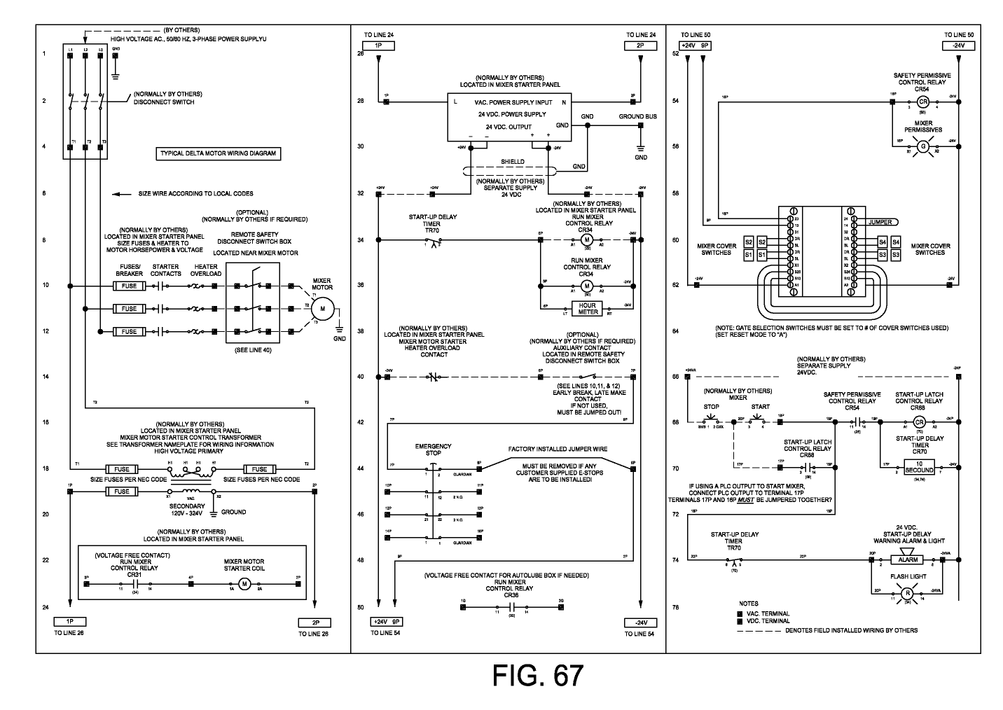

FIG. 67 is a schematic diagram of a planetary and horizontal shaft mixer interlock station with up to four cover switches and no oil pump.

Although the feed material for embodiments is often referred to herein as an oil-contaminated substrate, it is within the scope of embodiments that the system and method disclosed herein may be used on other feed materials to remove a liquid from the substrate. Other feed materials or substrates treatable by the system and method of embodiments may include a sewage slurry (either water or oil-based), rice hulls, and/or chicken litter, for example.

Where diesel oil is referred to herein, the diesel oil may instead be any other type of oil such as mineral oil, or any types of oils in combination with one another.

Although the embodiments and figures described above are described separately, any of the components, equipment, and their relation to one another and methods of using and assembling those components and equipment may be interchangeable between embodiments and figures.

After describing this invention in detail above, the ordinarily skilled artisan will be able to make many changes and modifications without departing from the spirit of the invention. All these changes and modification are contemplated as being with the scope and spirit of the appended claims.

While the foregoing is directed to embodiments, other and further embodiments of the invention may be devised without departing from the basic scope thereof, and the scope thereof is determined by the claims that follow.

1. A method for removing oil from an oil-contaminated substrate, comprising:
mixing the oil-contaminated substrate with an alkaline metal oxide to create a mixture and a first reaction; and
mixing a mineral acid with the mixture in an amount effective to generate an exothermic reaction to vaporize the oil and reaction products thereof, thereby removing oil from the oil-contaminated substrate to produce a solid reaction product with reduced oil content.

2. The method of claim 1, further comprising mixing water with the oil-contaminated substrate prior to forming the mixture to bind the water to the oil-contaminated substrate.

3. The method of claim 2, further comprising mixing a surfactant with the oil-contaminated substrate prior to forming the mixture.

4. The method of claim 1, further comprising mixing the oil-contaminated substrate with a catalyst prior to adding the mineral acid.

5. The method of claim 4, wherein the alkaline metal oxide and the catalyst are added to the oil-contaminated substrate generally simultaneously.

6. The method of claim 4, wherein the catalyst is a multivalent metallic salt.

7. The method of claim 4, wherein the catalyst is calcium chloride (CaCl₂).

8. The method of claim 1, wherein the alkaline metal oxide is lime.

9. The method of claim 1, wherein the alkaline metal oxide is calcium oxide (CaO).

10. The method of claim 1, wherein the mixing is under low shear conditions.

11. The method of claim 1, wherein the mixing the oil-contaminated substrate with the alkaline metal oxide to create a mixture results in the first reaction giving off a heat.

12. The method of claim 11, wherein the mixing occurs in a reaction chamber having an upper portion and a lower portion, the reaction chamber having one or more rotatable shafts disposed within the lower portion, the rotatable shafts having one or more paddles operatively attached thereto.

13. The method of claim 12, wherein the reactions occur in the upper portion of the reaction chamber when the paddles force material being mixed within the reaction chamber into the upper portion upon rotation of the one or more shafts.

14. The method of claim 1, further comprising determining a pH of the solid reaction product by manipulating an amount of alkaline metal oxide or mineral acid added.

15. The method of claim 1, wherein alkaline metal oxide is added to the oil-contaminated substrate in an amount of from 1 to 70 parts by weight per 100 parts by weight of substrate.

16. The method of claim 1, wherein sulfuric acid is added to the mixture in an amount from 1 to 70 parts by weight per 100 parts of substrate.

17. The method of claim 1, further comprising:
recovering vapor generated from the reaction;
condensing the recovered vapor; and
exhausting non-condensed gases to the atmosphere.

18. The method of claim 1, wherein the method is a semi-continuous or batch method.

19. The method of claim 1, wherein the solid reaction product is essentially free of oil.

20. The method of claim 1, wherein the solid reaction product has an oil content of less than one percent.

21. The method of claim 1, wherein the solid reaction product has an oil content of less than 0.5 percent.

22. The method of claim 1, wherein the base is a hydrated alkaline metal oxide.

23. A system for removing oil from an oil-contaminated substrate, comprising:
a mixer comprising:
an enclosure having an internal chamber therein;
two or more shafts in the internal chamber rotatable in opposite directions from one another, each shaft having one or more paddles operatively attached thereto; and
an upper chamber of the internal chamber disposed above the two or more shafts capable of allowing a reaction between components disposed in the internal chamber to occur therein upon manipulation of the components by the paddles upon rotation of the shafts, wherein the mixer is sealable to operate at a positive pressure.

24. The system of claim 23, further comprising:
a base storage unit for storing a base; and
one or more selective delivery devices capable of selectively and alternately delivering an amount of the base to the mixer and sealing a base entry location of the mixer.

25. The system of claim 23, further comprising:
an acid storage unit for storing an acid;
one or more selective delivery devices capable of selectively and alternately delivering an amount of the acid to the mixer and sealing an acid entry location of the mixer;
one or more metering devices capable of metering the amount of acid delivered to the mixer; and
one or more pumping devices capable of pumping the amount of acid into the mixer.

26. The system of claim 23, further comprising a scrubber for scrubbing vapor from the mixer, the scrubber comprising:
a Venturi scrubber, the scrubber adjustable in size to accommodate varying flow rates through the Venturi scrubber; and
a packed column.

27. The system of claim 26, the scrubber further comprising:
an oil/water separator for separating oil and water from one another, the oil/water separator capable of separating oil and water from one another using level control.

28. The system of claim 27, the scrubber further comprising a chiller.

29. A method for removing oil from an oil-contaminated substrate, comprising:
mixing the oil-contaminated substrate with a base to create a mixture and a first reaction, the base comprising a compound including an alkaline earth; and
mixing a mineral acid with the mixture in an amount effective to generate an exothermic reaction to vaporize the oil and reaction products thereof, thereby removing oil from the oil-contaminated substrate to produce a solid reaction product with reduced oil content.
